(19) United States
(12) Patent Application Publication
(10) Pub. No.: US 2024/0199173 A1
(43) Pub. Date: Jun. 20, 2024

(54) COATINGS FOR MARINE VESSELS THAT REDUCE CAVITATION

(71) Applicant: GRAPHITE INNOVATION AND TECHNOLOGIES INC, Dartmouth (CA)

(72) Inventors: Marciel GAIER, Truro (CA); Ilia RODIONOV, Hammonds Plains (CA); Mohammed ALGERMOZI, Halifax (CA)

(21) Appl. No.: 18/566,743

(22) PCT Filed: Jun. 10, 2022
(86) PCT No.: PCT/CA2022/050938

§ 371 Date: Dec. 4, 2023

Related U.S. Application Data
(60) Provisional application No. 63/209,278, filed on Jun. 10, 2021.

(51) Int. Cl. B63B 1/32; C09D 4/00; C09D 7/20; C09D 7/40; C09D 7/45; C09D 7/61; C09D 163/00

(52) U.S. Cl. CPC B63B 1/32; C09D 4/00; C09D 7/20; C09D 7/45; C09D 7/61; C09D 7/69; C09D 163/00

(57) ABSTRACT

Disclosed are compositions for coating substrates used in wet environments including boats, ships, other marine vessels and their parts that are submerged in water. The compositions comprise solvent-borne monomers, diluent, an adhesion promoter, a rheology modifier and a ceramic performance additive such as hollow spheres and non-hollow spheres. Once the composition is applied to a substrate, the coatings protect by minimizing cavitation and underwater radiation noise when the marine vessel is in operation. The coatings may also exhibiting improved substrate adhesion, overcoat adhesion, recoat adhesion, bending strength of at least 10 mm, reduced noise radiation, and/or improved hardness as indicated by scratch resistance (relative to a control).

### CROSS REFERENCE TO RELATED APPLICATION

This application claims priority to U.S. Provisional Patent Application No. 63/209,278, filed Jun. 10, 2021, the entire contents of which are hereby incorporated by reference.

### FIELD

The present disclosure relates generally to coatings for use in wet environments.

### BACKGROUND

The following paragraphs are not an admission that anything discussed in them is prior art or part of the knowledge of persons skilled in the art.

Underwater radiated noise (URN) generally refers to underwater noises that radiate from marine vessels, such as container or tanker ships. Typical sources of URN include mechanical noise, propeller noise, and hydrodynamic noise from marine vessels. URN includes sound that radiates in a frequency of less than 100 Hz and can extend up to 10,000 Hz. Cavitation generally refers to formation of vapour bubbles within a liquid at low-pressure regions that occur in places where the liquid has been accelerated to high velocities, as in the operation of centrifugal pumps, water turbines, and marine propellers.

Hence, underwater radiated noise and cavitation is a common consequence of using vessels such as container or tanker ships in marine environments.

### INTRODUCTION

The following introduction is intended to introduce the reader to this specification but not to define any invention. One or more inventions may reside in a combination or sub-combination of the compositions or method steps described below or in other parts of this document. The inventors do not waive or disclaim their rights to any invention or inventions disclosed in this specification merely by not describing such other invention or inventions in the claims.

### Coatings

Coatings that exhibit reduced radiated noise are expected to play an increasingly important role in the coatings market given the increasing awareness of the environmental impact of, for example, underwater radiated noise (URN). URN can have environmental impacts by increasing noise pollution, which in turn can have damaging effects on marine animals. It has been recognized that in-service marine vessels, such as container or tanker ships, can emit a wide range of frequencies that can hinder animals' abilities to communicate, hunt, migrate and echolocate. For example, URN includes sound that radiates in a frequency of less than 100 Hz and can extend up to 10,000 Hz. Research has suggested that the primary sources of URN on marine vessels are the engines and propellers, where engines produce lower frequencies (for example, 100-500 Hz) that can disturb large sea animals, and propellers produce higher frequencies (for example, 1000-10,000 Hz) that can disturb smaller marine creatures.

Means of minimizing URN that have been investigated include dispersing radiated noise by widening engine stiffeners, limiting noise by adding dampeners to engines, investigating propeller blade designs, conducting hydrodynamic tests to assess propeller efficiency and reduced cavitation, improving insulation via acoustic enclosures, and developing noise reducing coatings. For example, some marine vessels, such as submarines and ships, use rubber tiles or mounts on their engine to reduce URN. Other marine vessels may use coatings that are based off of ‘armored’ rubber resins (for example, rubber resins that include reinforcing fibers, particles, etc.) and may be formed from compositions having components such as barium sulfate, acrylic microgels, etc. Such coatings are often applied in layers as thick as 1000-3000 μm to provide a sufficient amount of URN reduction, as well as corrosion protection for the vessel's hull.

Coatings that exhibit reduced cavitation are also expected to play an increasingly important role in the coatings market. Cavitation is a generally undesirable phenomenon in which static pressure of a liquid reduces to below the liquid's vapour pressure, leading to the formation of small vapor-filled cavities in the liquid. When subjected to higher pressure, these cavities, sometimes called “bubbles” or “voids”, collapse and can generate shock waves that may cause damage. Cavitation can occur on propellers. As a propeller's blades move through a fluid, such as fresh or seawater, low-pressure areas are formed as the fluid accelerates around and moves past the blades. The faster the blade moves, the lower the pressure around it can become. As it reaches vapor pressure, the fluid vaporizes and forms small bubbles of gas. These bubbles collapse when they reach regions of higher pressure. As they collapse, they can generate very strong local shock waves in the fluid. This can result in generation of underwater radiated noise that, as described above, can have serious environmental impacts.

The collapse of these bubbles can also cause damage to components, vibrations, and/or a loss of efficiency. For example, the collapse of these bubbles can cause pitting on the surface of a propeller's blade. After pitting occurs, the propeller can erode at an accelerating pace. The pitting can also increase turbulence of fluid flow, reducing efficiency because of a distortion of flow pattern; and can create crevices that act as nucleation sites for additional cavitation bubbles. The pitting can also increase the propeller blade's surface area and cause residual stresses.

As such, coatings that exhibit increased corrosion resistance via increased hardness and/or scratch resistance are also expected to play an increasingly important role in the coatings market in view of environmental regulations. Corrosion is an chemical process by which a metal is converted into another form, such as to a metal oxide, hydroxide, or sulfide. It is the gradual destruction of materials (usually metals) by chemical and/or electrochemical reaction with their environment. Corrosion typically occur in objects which are exposed to water and/or humidity, for example those exposed to the weather, salt water, and other electrolytes, and other hostile environments.

### Coatings Based on Solvent-Borne Monomers

Solvent-borne monomers, also referred to as solvent-borne resins, are generally widely available commercially, and include such resins as allyl resins, amino resins (also called aminoplasts), polyester resins, bis-maleimides (BMI) resins, cyanate ester resins, furan resins, phenolic resins, polyurea resins, polyurethane resins, silicone resins, vinyl esters resins, epoxy resins, and/or hybrid silicone-epoxy resins. Solvent-borne monomers may be reacted (e.g., “cross-linked” or “cured”) with a wide range of hardeners, via a polymerization/crosslinking reaction, to form an infusible, insoluble polymer network on a surface of a substrate. Such hardeners may include acids (and acid anhydrides), phenols, alcohols, thiols, polyfunctional amines, phenalkamines. amine-modified phenalkamines, amides, phenalkamides, amine-modified phenalkamides, silamines, or combinations thereof.

Solvent-borne monomers refer to monomers that are dispersed in substantially anhydrous solvents, where said monomers comprise the main film-forming component of any resultant, cured coating. Solvent-borne monomers are generally used in solvent-borne compositions that are also essentially, or substantially anhydrous. While some additives of solvent-borne compositions may contain some amount of water/aqueous solution, because those additives are not the main film-forming component (the solvent-borne monomers), the amount of water they would introduce would not be sufficient to render the composition a waterborne composition. Curing solvent-borne compositions involves a polymerization and/or crosslinking reaction to form an infusible, insoluble polymer network.

Contrasted with solvent-borne compostions are waterborne and powder compositions. Waterborne compositions are aqueous compositions where the main film-forming component comprises water-borne monomers—monomers that are dispersed in a substantially aqueous solutions or solvents, often in the form of a latex. Curing waterborne compositions generally occurs without a covalent-bond forming polymerization and/or crosslinking reaction; instead, another mechanism occurs to form a cured coating, involving physical fusing of the polymer latex particles into a polymeric monolith and evaporation of the aqueous medium. As a result, cured coatings formed from waterborne compositions are generally not suitable for use in wet environments; the lack of an infusible, covalently cross-linked insoluble polymer network results in the coating peeling, bubbling, or otherwise losing adherence to the surface or substrate to which the waterborne composition was applied. Powder compositions, also referred to as powder coatings, are compositions that are on based on polymer resin systems and other additives that are melt mixed, cooled, and ground into a uniform powder. Generally, powder compositions are substantially free of, or contain minimal solvent. Powder compositions are typically applied to metal substrates, as they require electrostatic spray deposition (ESD) to be applied. In ESD, the powder composition is sprayed through an electrostatic gun onto a metal surface that is grounded. The electrical charge given to the powder by the gun is attracted to the grounded surface of the metal. The coating is cured at a specified temperature; cure temperatures vary depending on the coating being applied. After application of the powder coating, the coated metal surface is cured in a curing oven where, with the addition of heat, the powder coating chemically reacts to produce long molecular chains, resulting in high cross-link density. As a result, powder coatings are generally not broadly applicable for use on, for example, marine vessels for use in wet environments; as not all vessels are made of metal, and high-temperature curing the hull of a vessel may not be feasible in dry docks.

Coatings cured from solvent-borne monomers are not known to have significant sound dampening properties; and thus, their use on marine vessels generally does not substantially reduce any URN generated by the vessel. Further, curing compositions comprising solvent-borne monomers tend to be too expensive and time-consuming to apply a curing coating at a thickness that may otherwise be needed to provide sufficient sound dampening properties. Coatings cured from solvent-borne monomers are also not known to have significant cavitation resistance; and thus, their use on marine vessels generally does not substantially reduce any cavitation generated by a vessel's propeller. Further, following their application to a substrate, coatings cured from solvent-borne monomers may initially provide some corrosion resistance; however, water permeability happens over time, for example after several years due to coating defects, or damage from for example, scratches or abrasions. This can cause wear and failure of the coating, requiring a new coating application.

### Compositions, Uses, and Methods of the Present Disclosure

One or more embodiments of the present disclosure attempts to provide a composition that can be used to form a cured coating. In one or more embodiments, the present disclosure provides a composition that comprises solvent-borne monomers, a diluent, an adhesion promoter, and hollow ceramic spheres. In one or more embodiments, the present disclosure provides a composition that comprises solvent-borne resins, a diluent, an adhesion promoter, a rheology modifier, and a ceramic performance additive.

The solvent-borne monomers of the composition, also referred to herein as solvent-born resins, provide the film-forming base for forming the cured coating, and comprise any one or combination of liquid monomers or prepolymers such as allyl resins, amino resins (also called aminoplasts), polyester resins, bis-maleimide (BMI) resins, cyanate ester resins, furan resins, phenolic resins, polyurea resins, polyurethane resins, silicone resins, vinyl esters resins, epoxy resins and/or hybrid silicone-epoxy resins. In one or more embodiments, the solvent-borne monomers comprise a solvent-borne epoxy resin, also referred to as epoxy-functional monomers. Said epoxy-functional monomers can react, via epoxide functional groups, to form an infusible, insoluble polymer network that comprises polymerized and/or cross-linked epoxy-functional monomers.

Generally, coatings cured from solvent-borne monomers are not known to have significant sound dampening properties; nor are they generally known to have significant cavitation resistance. Further, some examples of coatings cured from solvent-borne monomers are not sufficiently hard enough after curing to offer scratch or abrasion resistance, which can impact the mechanical integrity of the coating, and subsequently the corrosion resistance offered by the coating overtime.

In one or more embodiments, a ceramic performance additive is added into the composition. The ceramic performance additive may be added into the composition to increase sound dampening properties of the cured coating; the ceramic performance additive may be added into the composition to increase hardness—otherwise measured by scratch (abrasion) resistance—of the cured coating; or for a combination thereof. In one or more embodiments wherein the ceramic performance additive is added into the composition to increase scratch resistance through increased hardness, use of the ceramic performance additive may also increase the cavitation resistance. The ceramic performance additive may comprise hollow cermics and non-hollow ceramics. As used herein, “non-hollow” refers to a particle that not does have a hollow core, or substantially does not have a hollow core. The hollow cermics and non-hollow ceramics may have a Mohs' Hardness between about 5 to about 10, or about 6 to about 9. The hollow ceramics may comprises hollow ceramic spheres, that may have a shape that is spherical, substantially spherical, sphere-like, spheroidal, substantially spheroidal, spheroidal-like, or a combination thereof. The hollow ceramic spheres may have a particle size of about 20 μm to about 40 μm, and may be present in a range of about 30 wt % to about 70 wt %, based on Part A wt %. The hollow ceramic spheres may have a particle size of about 10 μm to about 15 μm, and may be present in a range of about 5 wt % to about 70 wt %, based on Part A wt %. The non-hollow ceramics may comprise non-hollow ceramic particles, such as titanium oxide, fumed silica, brown aluminium (III) oxide, fused aluminium (III) oxide, titanium alloys, or a combination thereof. The non-hollow ceramic particles may have a particle size between about 0.1 μm to about 5 μm; and may be present in a range of about 10 wt % to about 50 wt %, based on Part A wt %.

In one or more embodiments, hollow ceramic spheres are added into the composition to increase the sound dampening properties of the cured coating. In one or more embodiments, the hollow ceramic spheres may have a size of about 20 μm to about 40 μm, a hollow core, a ceramic composition, and/or a weight percent loading in the composition of about 30 wt % to about 70 wt %, approximately equivalent to a volume percent loading of about 15 vol % to about 55 vol % (based on a density of about 1 to about 3, or about 2 to about 2.5). Without wishing to be bound by theory, use of the hollow ceramic spheres may at least provide a sufficient concentration of air-filled voids within the cured coating to provide improved sound dampening properties; and/or may at least destructively (or reflectively) interfere with radiated soundwaves to provide improved sound dampening properties. In one or more embodiments, where the hollow ceramic spheres are added into the composition to improve the sound dampening properties of the cured coating, the resultant cured coating may be applied as an undercoat to a substrate, to which a topcoat may be further applied. In one or some embodiments, the topcoat that is applied may be selected to offer anti-fouling/foul release properties, or other desired properties that align with the end use of the coating and/or the substrate to which it is applied. In some embodiments, the hollow ceramic spheres having a size of about 20 μm to about 40 μm and/or a weight percent loading in the composition of about 30 wt % to about 70 wt %, also increase the hardness or scratch resistance of the cured undercoating. In some embodiments, the hollow ceramic spheres increase the hardness or scratch resistance of the cured undercoating to at least 5H when measured according to ASTM D3363.

In one or more embodiments, hollow ceramic spheres are added into the composition to increase the hardness—otherwise measured by scratch resistance—of the cured coating. In one or more embodiments, the hollow ceramic spheres may have a size of about 10 μm to about 40 μm, a hollow core, a ceramic composition, and/or a weight percent loading in the composition or about 5 wt % to about 15%, based on Part A wt %. In one or more embodiments, the hollow ceramic spheres may have a size of about 10 μm to about 15 μm, or about 20 μm to about 40 μm, a hollow core, a ceramic composition, and/or a weight percent loading in the composition of about 5 wt % to about 20 wt %, or about 5 wt % to about 15%. Without wishing to be bound by theory, use of the hollow ceramic spheres may at least provide improved scratch and abrasion resistance due to the ceramic sphere's high hardness (for example, 7 on the Mohs Scale); in some embodiments, a smaller size (for example, about 12 μm); or a percent loading that can afford a relatively smooth surface. In one or more embodiments, where the hollow ceramic spheres are added into the composition to improve the scratch resistance of the cured coating, the resultant cured coating may be applied as a topcoat to a substrate, and may be further formulated to offer anti-fouling/foul release properties, or other desired properties that align with the end use of the coating and/or the substrate to which it is applied.

In one or more embodiments, non-hollow ceramic particles are added into the composition to increase the hardness—otherwise measured by scratch resistance—of the cured coating. In one or more embodiments, the non-hollow ceramic particles may have a size between about 0.1 μm to about 5 μm, a ceramic composition, and/or a weight percent loading in the composition of about 5 wt % to about 40 wt %, or about 10 wt % to about 20 wt %, based on Part A wt %. Without wishing to be bound by theory, use of the non-hollow ceramic particles may at least provide improved scratch and abrasion resistance due to the ceramic material's intrinsic hardness (for example, between about 5 to about 10, or about 7 to about 9 on the Mohs Scale); small particle size; and/or percent loading that can afford a relatively smooth surface. In one or more embodiments, where the non-hollow ceramic particles are added into the composition to improve the scratch resistance of the cured coating, the resultant cured coating may be applied as a topcoat to a substrate, and may be further formulated to offer anti-fouling/foul release properties, or other desired properties that align with the end use of the coating and/or the substrate to which it is applied.

In one or more embodiments, the diluent is included in the composition to help reduce viscosity and therefore improve processability of the composition. In one or more embodiments, the diluent may be added to act as a liquid vehicle to provide a composition viscosity at or below 3500 cps. In one or more embodiments, the diluent may have a lower viscosity that the solvent-borne monomers; for example, a viscosity less than 1000 cps, such as between about 1 cps to about 800 cps. In some embodiments, the diluent comprises a reactive diluent that is reactive in a polymerization of solvent-borne monomers (e.g., contains reactive functional groups that can at least react with the solvent-borne monomers, such as hydroxyl, or epoxide functional groups), a non-reactive diluent (e.g., does not contain reactive functional groups), or a combination thereof.

In one or more embodiments, the adhesion promoter is included in the composition to at least increase flexibility of the cured coating resulting from the composition; for example, as indicated by a bending strength of at least 10 mm when measured by a cylindrical bend test. In one or more embodiments wherein the cured coating is applied as an undercoat, the adhesion promoter may be included to improve intercoat adhesion between the cured undercoat and any topcoat that may be applied. The adhesion promoter may improve the flexibility and/or recoat adhesion of the cured coating formed from the composition due to promoter's reactive groups. In one or more embodiments, the adhesion promoter has at least two, or at least three functional groups capable of coupling with the ceramic performance additive, such as the hollow ceramic spheres, and/or to be incorporated into the polymerization of the solvent-borne monomers. In one or more embodiments, the adhesion promoter may act as a binder between the ceramic performance additive, such as the hollow ceramic spheres, and the solvent-borne resin to provide improved flexibility of the cured coating comprising the hollow ceramic spheres. In some embodiments, the adhesion promoter may improve cohesion of the cured coating, where cohesion refers to the mechanical strength of a single cured coating layer, and how much it resists against pull-off forces, compression forces, bending forces, or any other damaging forces. In one or more embodiments, wherein the cured coating is applied as an undercoat, the adhesion promoter may act as a binder between the cured undercoat and any topcoat that may be applied to provide improved intercoat adhesion. In one or more embodiments, the adhesion promoter is a silane, such as an alkyloxy-functionalized silane.

In one or more embodiments, the adhesion promoter is included in the composition to at least increase adhesion of the cured coating resulting from the composition to a metal substrate or a primed metal substrate. In one or more embodiments, the adhesion promoter in combination with the hardener composition may increase adhesion of the cured coating resulting from the composition to a metal substrate or a primed metal substrate. In one or more embodiments wherein the curing coating is applied directly to a metal substrate, the adhesion promoter may be included to improve substrate adhesion between the cured coating and the metal substrate. In one or more embodiments wherein the cured coating is applied to a primed metal substrate, the adhesion promoter may be included in both the primer composition and the composition for a coating to improve substrate adhesion between the cured coating and the primed metal substrate. The metal substrate may be a steel substrate, a copper substrate, a copper alloy substrate, an aluminum substrate, an iron substrate, or other metal substrate. The adhesion promoter may be a dry adhesion promoter, a wet adhesion promoter, a dry/wet adhesion promoter, or a combination thereof. The dry adhesion promoter, the dry/wet adhesion promoter, and/or the wet adhesion promoter may be non-reactive, reactive in a epoxy polymerization, reactive with a metal substrate, and/or reactive with surface oxides on a metal substrate; or a combination thereof.

In one or more embodiments, the dry adhesion promoter is non-reactive, reactive in a epoxy polymerization, reactive with a substrate, and/or reactive with metal oxides. In one or more embodiments, the dry adhesion promoter may comprise one or more functional groups that can react with an inorganic surface (e.g., ceramics, surface oxides on metal substrates). The dry adhesion promoter may also comprise one or more functional groups that are reactive in an epoxide polymerization and can react with solvent-borne epoxy resins, thus enhancing the resultant coating's adhesion to a metal substrate, such as a Cu substrate. In one or more embodiments, the dry adhesion promoter comprises an alkoxylated silane. In one or more embodiments, the wet adhesion promoter is reactive with a metal substrate. In one or more embodiments, wet adhesion promoters can become activated in a wet environment by decomposing in the presence of ions in water that permeate into a coating. Products of this decomposition can react with a metal substrate, such as a Cu-alloy, Al alloys, or Fe alloys, and also cross-react with any non-decomposed adhesion promotor. This can allow formation of a strong bonding complex between a coating layer and a metal substrate. This may also hinder corrosion of the substrate. In one or more embodiments, the wet adhesion promoter comprises a metal-doped phosphosilicate. In one or more embodiments, the dry/wet adhesion promoter is non-reactive, reactive with a substrate, and/or reactive with metal oxides. In one or more embodiments, the dry/wet adhesion promoter may provide good flow characteristics that help a curing coating to flow into areas of roughness on a metal substrate, which can facilitate formation of a grip between the cured coating and the substrate. In one or more embodiments, the dry/wet adhesion promoter may comprise one or more functional groups that can react with a metal substrate. The dry/wet adhesion promoter may also comprise one or more functional groups that are reactive in an epoxide polymerization and can react with solvent-borne epoxy resins. In one or more embodiments, the dry/wet adhesion promoter comprises a modified polyester, a modified polyester oligomer, a polyacrylic, a polyacrylate, a benzotriazole, a mercaptane-comprising polymer or pre-polymer, a hydroxyphenyl-benzotriazole, a hydroxyphenyl-triazine, or a combination thereof.

In one or more embodiments, the rheology modifier is included in the composition to provide a curing coating or coating formed from the composition having anti-settling, anti-sagging, or surface-leveling properties. In one or more embodiments, the anti-settling rheology modifier is included in the composition to at least reduce sedimentation of the ceramic performance additive in the composition or curing composition. In one or more embodiments, the anti-settling rheology modifier comprises a silica, a clay, or a combination thereof, such as fumed silica, fumed silica surface modified with silane, fumed silica surface modified with dimethyldichlorosilane; aluminum phyllosilicate clay; organo-modified derivative of aluminium phyllosilicate clay; organo-modified bentonite clay; organo-modified montmorillonite clay; or a combination thereof. In one or more embodiments, the anti-sagging rheology modifier is included in the composition to at least reduce sagging or dripping of a curing coating after it is applied onto a substrate. For example, to prevent a composition for a coating from sagging from a substrate, such as vertical substrate upon spraying. In one or more embodiments, the anti-sagging rheology modifier comprises a wax, a micronized wax, or a combination thereof; such as a polyamide wax, a micronized polyamide wax, a micronized organo-modified polyamide wax, a micronized organo-modified polyamide wax derivative, or a combination thereof. In one or more embodiments, the surface-leveling rheology modifier is included in the composition to at least provide a smoother levelling of a curing coating as it is being applied, with reduced formation of craters or cavities in the curing coating. In one or more embodiments, the surface-leveling rheology modifier comprises a polyether siloxane copolymer.

In some embodiments, the rheology modifier included in the composition comprises aluminum phyllosilicate clay; organo-modified derivative of aluminium phyllosilicate clay; organo-modified bentonite clay; organo-modified montmorillonite clay, such as Claytone-HY® or Claytone-APA®; organo-modified castor oil derivatives, such as Thixatrol ST®; micronized organo-modified derivative of polyamide wax, such as Crayvallac Super®; fumed silica; fumed silica surface modified with dimethyldichlorosilane, such as Cab-O-Sil 610®; micronized barium sulphate, such as VB Techno®; microcrystalline magnesium silicate, such as Talc Silverline 202® or Mistron 002®; or a combination there of. Some examples of rheology modifiers included in the composition may have partial rheology modifying properties (such as barium sulphate) or full rheology modifying properties. Such modifiers may be included in the composition to reduce sagging of the curing composition as it is applied to a substrate, to allow for a more uniform and/or high-built application of the composition to a substrate; and/or to facilitate formation of a cured coating having a more uniform surface. In some embodiments, the rheology modifier may improve the long term package stability or shelf-life of the pre-cured composition, and/or may improve the anti-settling properties of the pre-cured composition.

One or more compositions of the present disclosure can be used to form an cured coating by reacting the composition with a hardener, which may otherwise be referred to as curing the composition to form a cured coating. A hardener can trigger, and in some cases participate in the reaction (e.g., polymerization and/or crosslinking) that converts at least the solvent-borne monomers into an infusible, insoluble polymer network, which may be referred to as a cured coating. For example, the hardener may be reactive in an solvent-borne monomers polymerization, such that it can trigger the polymerization, as well as act as a cross-linker in the reaction. In one or more embodiments, the hardener comprises polyfunctional acids (and acid anhydrides), phenols, alcohols, and thiols; or polyfunctional amines, amides, or combinations thereof. In other embodiments, the hardener comprises an amine hardener, an amide hardener, or a combination thereof. In one or more embodiments, the hardener is reactive in curing the composition to form a coating having a resistance to abrasive treatment with organic solvents of at least 50 passes, or between 50 to 80 passes, when measured according to ASTM D1640. In some embodiments, the hardener may comprise an amine hardener, amide hardener, or a combination thereof, such as phenalkamine, amine-modified phenalkamine, phenalkamide, amine-modified phenalkamide, polyaminoamide, organo-modified polyamidoamine, or a combination thereof; or a silamine hardener, such as aminopropyltriethoxysilane.

In one or more embodiments, the cured coatings formed of the composition of the present disclosure is formed on a substrate. A substrate may comprise a surface to which a composition for a coating may be applied. In one or more embodiments, the substrate is a surface of a marine vessel (e.g., boat, ship, etc.), such as a hull or a propeller.

One or more embodiments of the present disclosure attempts to provide a composition that can be used to form a cured coating that exhibits sound dampening properties, improved hardness, improved substrate adhesion, overcoat adhesion, recoat adhesion, or a bending strength of at least 10 mm (relative to a control). In some embodiments, the adhesion promoter is included in the composition in an amount sufficient to provide a coating formed from the composition having an intercoat adhesion of at least 5 MPa when measured according to ASTM D4541, or a bending strength of at least 10 mm when measured by a cylindrical bend test (relative to a control). In some embodiments, the adhesion promoter is included in the composition in an amount sufficient to provide a coating formed from the composition having a substrate adhesion of at least 3 MPa when measured according to ASTM D4541, an overcoat adhesion of at least 3 MPa when measured according to ASTM D4541, or a recoat adhesion window of at least 4 hours when measured according to ASTM D3359. In some embodiments, the hollow ceramic spheres are provided in an amount sufficient to provide a coating formed from the composition having a reduced noise radiation of about 1 dB up to about 40 dB 50 dB 10 dB per about 100 μm of coating thickness at frequencies of about 1000 Hz or less when measured on a 3 mm thickness cold rolled steel metal plate relative to an uncoated 3 mm thickness cold rolled steel metal plate, or a hardness of at least 5H when measured according to ASTM D3363 (relative to a control). In some embodiments, the ceramic performance additive is provided in an amount sufficient to a coating formed from the composition having a reduced noise radiation of about 2 dB to about 10 dB per about 100 μm of coating thickness at frequencies of about 10 Hz to about 10 kHz when measured on a 3 mm thickness cold rolled steel metal plate relative to a 3 mm thickness cold rolled steel metal plate coated with a coating free of the ceramic performance additive; or a hardness of at least 5H when measured according to ASTM D3363.

Further, one or more embodiments of the present disclosure provides a method for forming one or more of the above-described compositions. In one or more embodiments, the method comprises mixing together solvent-borne monomers, a diluent, an adhesion promoter, and hollow ceramic spheres; and forming the composition for a coating. In one or more embodiments, the method further comprises mixing in a rheology modifier, a dispersant, a defoamer, and/or a wear inhibitor. In one or more embodiments, the method comprises mixing together solvent-borne resins, a diluent, an adhesion promoter, a rheology modifier, and a ceramic performance additive; and forming the composition for a coating. In one or more embodiments, the method further comprises mixing in a dispersant, a defoamer, and/or a wear inhibitor.

### BRIEF DESCRIPTION OF THE FIGURES

Embodiments of the present disclosure will now be described, by way of example only, with reference to the attached Figures.

FIG. 1 depicts the experimental sound encapsulation setup for measuring the sound dampening properties of cured coatings formed from the compositions of the present application.

FIG. 2 depicts intercoat adhesion and bending test for cured coatings formed from formulations BC169.5 and BC169.6 of Example 1.

FIG. 3 depicts an example application of a cured composition of the present disclosure to a metal surface of a substrate.

FIG. 4 depicts an example application of a cured composition of the present disclosure to a fiberglass surface of a substrate.

FIG. 5 depicts a cross-hatch tape adhesion test performed to determine intercoat or recoat adhesion of (A) Formulation 212.2 and (B) Formulation 212.4, where (C) depicts a visual comparison chart to grade performance of a coating by the cross-hatch test.

FIG. 6 depicts relative coating sagging results of Formulae (A) 158-URN2_SP1; (B) 158-URN2_SP2; (C) 158-URN2_ZP1/SP1; (D) 156.Blank.2; (E) 169-URN3-3.2.

FIG. 7 depicts depicting (A) an Elcometer pull-off adhesion device, for testing adhesion to steel; (B) and test results for URN Formula 200.2 (5 MPa); (C) and URN Formula 200.1 (7 MPa).

FIG. 8 depicts blistering and permeability test results for Formulas (A) BC169_URN3-3.2 on a primer coating; (B) BC169_URN3-3.2 on bare steel; (C) 242 on a primer; (D) 242 on bare steel.

FIG. 9 depicts Cu adhesion test results for PROP Formulas (A) 230.14 on a primer (dry adhesion) (The parallel test readings were: 3.5, 5.0, 5.0, and 5.0 MPa); (B) 184 w/o primer (dry adhesion of 2 MPa) (The parallel test readings were: 2.0, and 2.0 MPa); (C1) 230.14 on a primer (wet adhesion) (The parallel test readings were 6 MPa in case of image C1 and “Fail”, equivalent to 1 MPa in case of image C2); (C2) 230.14 w/o primer (wet adhesion); (D) 243.1 w/o primer (wet adhesion) (The parallel test readings were 6.5, 6.0, and 5.0 MPa).

FIG. 10 depicts bending strength test results of PROP Formulas (A) 184.Base; (B) 210.5; (C) 210.6.

FIG. 11 depicts a cavitation resistance test set-up (large propeller) including (A) Trolling motor engine; (B) Full size cavitation testing setup; (C) Propeller part of the trolling motor with the propeller mounted onto the head; (D) Propeller in water.

FIG. 12 depicts results of a cavitation resistance test (large propeller) following 2 months of running constantly in ocean water. Three sections of the propeller were separately coated with PROP coating formed from Formulation 243.5 (A), primed PROP formulation 230.14 (B), and a single-coat 243.1 PROP formulation applied directly to Cu (C).

FIG. 13 depicts wet Cu adhesion and cavitation resistance performance of a double-coat (A) primed PROP coating formed from Formula 230.14 (D), and a single-coat (B) PROP coating formed from Formula 243.1 directly applied to a Cu propeller (C). The magnified portions of (C) and (D) depict the coating after about 2-3 months of testing, where the zoomed-out portion depicts the starting point.

FIG. 14 depicts microstructure before, after cavitation test (2 months non-stop run) of (A) PROPSPEED topcoat before cavitation test; (B) Coating formed of Formula 230.14 before cavitation test; (C) PROPSPEED topcoat after cavitation test; (D) Coating formed of Formula 230.14 after cavitation test.

### DETAILED DESCRIPTION

### Definitions

Unless defined otherwise, all technical and scientific terms used herein have the same meaning as commonly understood by one of ordinary skill in the art to which this invention belongs.

As used in the specification and claims, the singular forms “a”, “an” and “the” include plural references unless the context clearly dictates otherwise.

The term “comprising” as used herein indicates that the list that follows is non-exhaustive and may or may not include any other additional suitable items, for example one or more further feature(s), component(s) and/or ingredient(s) as appropriate.

Used herein, (a) “composition for a coating”, (b) “coating composition”, (c) “pre-cured composition”, or (d) “pre-cured coating composition” refers to a composition of the present disclosure that has yet to be reacted or cured with a hardener to form a coating.

Used herein, (a) “coating formed from the composition”, (b) “coating formed from the coating composition”, (c) “cured coating”, or (d) “cured epoxy-based coating” refers to a coating comprising a reaction product of a composition of the present disclosure and a hardener (i.e., a coating that has been cured).

Used herein, a “control” refers to (i) (a) “coatings that do not comprise such additives”, (b) “control coating”, or (c) “control epoxy-based coating”, which refer to coatings consisting of a reaction product of a hardener and a composition that consists of suitably diluted solvent-borne monomers, or epoxy-functional monomers; and/or (ii) an uncoated substrate, such as 3 mm thickness cold rolled steel metal plate.

Used herein, “curing composition” refers to a pre-cured composition that has been mixed with a hardener, but has yet to cure to form a cured epoxy-based coating.

Used herein, to be “incorporated into [a/the] polymerization” refers to a compound or molecule (for example, an additive, monomer, oligomer, pre-polymer) that comprises functional groups that are reactive in polymerization of solvent-borne monomers; that are reactive in an epoxide polymerization; that are reactive with side-chain groups, pendent groups, end groups, or terminal groups of solvent-borne monomers; and/or that are reactive with side-chains groups, pendent groups, end groups, or terminal groups of epoxy-functional monomers (for example, siloxane/silicone/polysiloxane side-chains), such that the compound or molecule act as a reagent (for example, a monomer, cross-linker, etc.) in the reaction. Used herein, to be “entrapped during [a/the] polymerization” refers to a compound or molecule (for example, an additive, monomer, oligomer, pre-polymer) that becomes physically entangled in the infusible, insoluble polymer network (the cured coating) as it forms.

Used herein, “monomer(s)” or resin(s) refer to (i) a monomer or system of monomers capable of polymerization by reactive groups to a higher molecular weight, such as a cured coating; and/or (ii) a pre-polymer, which refers to a monomer or system of monomers that have been reacted to an intermediate molecular mass state that is capable of further polymerization by reactive groups to a higher molecular weight, such as a cured coating. Mixtures of reactive polymers with un-reacted monomers may also be referred to herein as “monomer(s)” or resin(s).

As used herein, “A, B, . . . X, and/or Y” refers to “A, B, . . . X, and Y”; or “one of A, B, . . . X, or Y”; or any combination of A, B, . . . X, Y.

Used herein, “Part A of a Composition for a Coating” refers to the components for the a Composition for a Coating not including a Hardener Composition (otherwise referred to herein as Part B). Used herein, “Part B of a Composition for a Coating” refers to the components for the Hardener Composition.

As used herein, “based on Part A wt %” refers to the weight percentage of a component relative to the total weight perfectage of Part A of a Composition for a Coating. Used herein, “based on total wt %” refers to the weight percentage of a component relative to the weight perfectage of Part A and Part B of a Composition for a Coating. Generally, total wt. percentages are about 1.5 times lower than that of per Part A wt %.

“Reactive in an epoxy polymerization” or “reactive in a polymerization of solvent-borne monomers” when used in the context of herein described additives or diluents, refers to comprising or containing reactive functional groups that can at least react with herein described solvent-borne monomers, or epoxy-functional monomers to form an infusible, insoluble polymer network (herein described cured coating). “Reactive in an epoxy polymerization” or “reactive in a polymerization of solvent-borne monomers” when used in the context of herein described hardeners, refers to (a) triggering the curing of a pre-cured composition; (b) being incorporated into the polymerization (for example, covalently as a monomer and/or cross-linker) of at least the solvent-borne monomers as the pre-cured compositions are cured to form cured coatings; or (c) comprising or containing reactive functional groups that can at least react with herein described solvent-borne monomers to form an infusible, insoluble polymer network (herein described cured coating).

As used herein, “non-reactive” refers to a compound or molecule (for example, a diluent, an adhesion promoter, an additive, monomer, oligomer, pre-polymer) that does not comprises functional groups that are reactive in polymerization of solvent-borne monomers; does not comprises functional groups that are reactive in an epoxide polymerization; does not comprises functional groups that are reactive with surface oxides of a substrate; and/or does not comprises functional groups that will form a covalent bond with another compound or molecule; such that the compound or molecule act does not act as a reagent (for example, a monomer, cross-linker, coupling agent, etc.) in a reaction.

As used herein, “ceramic(s)” refers to materials that are inorganic nonmetallic solids, including metal oxides and compounds of metallic elements and carbon, nitrogen, or sulfur. Ceramic(s) tend to be crystalline, although they also may contain a combination of amorphous and crystalline phases, and are recognized for properties such as hardness, contributing to resistance against wear and cavitation-induced erosion; thermal and electrical conductivity considerably lower than that of metals; and/or an ability to make a decorative and slippery finish, etc.

As used herein, “Phosphosilicates” also refers to phosphate-silicates.

As used herein, a “filler” refers generally to inorganic materials, typically in the form of powders, that may be used to reduce the amount of resin required in a composition. Filler may be used in place of resin to reduce costs, as a resin—per kg—may exceed the cost of a filler by 5-10 times depending on the resin type. Fillers may also be used to improve properties of a cured coating relative to a control coating, such as barrier performance, anti-corrosive resistance, hardness, matting effect, etc. For example, barium sulphate, talc, or wollastonite. Herein, barium sulphate may be used a rheology modifier, but may also be used as a filler having a thinning property.

As described herein, each component included in a Composition for a Coating may have chemical or physical properties that allow that component to perform multiple functions, or serve multiple purposes in the Composition, and the Coatings formed therefrom. For example, as described herein, titanium dioxide, titanium carbide, aluminium oxide, or fumed silica may be used as ceramic performance additives that—when included in a pre-cured composition—can increase the hardness of a cured coating due to having a Moh's hardness of about 6-9. However, as is also described herein, titanium dioxide and fumed silica may be used as wear inhibitors that can increase a cured coating's resistance to wear, due to abrasion resistive properties. Identifying titanium dioxide and fumed silica as both a ceramic performance additive and a wear inhibitor is not a contradiction, but an indication of the different functions or purposes these components may serve in a cured coating. Thus, as described herein, identifying a component as being two or more different types of composition additives is an indication of the different functions or purposes the component may serve in a pre-cured composition, or a cured coating.

Terms as such “modified” or “derivative” are used herein in the context of component or additive chemical names; for example, “castor oil derivative wax” or “organo-modified castor oil derivative wax”. When used in this context, terms such as “modified” or “derivative” are recognized in the art as being indicative of the class or type of component or additive, and/or its general chemical and physical properties. When used in this context, terms such as “modified” or “derivative” still allow for the identification, selection, and/or purchase of an appropriate component or additive for use in a composition for a coating as described herein.

### Solvent-Borne Monomers

As described above, one or more embodiments of the present disclosure provides compositions that can be used to form a cured coating (otherwise referred to as a pre-cured composition), wherein the compositions comprise solvent-borne monomers, otherwise refereed to a solvent-borne resins. Said solvent-borne monomers provide the base for forming the coating (otherwise referred to as forming the continuous matrix of a coating's film) as they provide the main film-forming component of the herein described cured coatings, and comprise one or a combination of liquid monomers or pre-polymers that contain functional groups reactive in polymerization.

In one or more embodiments, the solvent-borne monomers of the composition comprise any one or combination of liquid monomers or prepolymers (also referred to as solvent-borne resins) such as allyl resins, amino resins (also called aminoplasts), polyester resins, bis-maleimides (BMI) resins, cyanate ester resins, furan resins, phenolic resins, polyurea resins, polyurethane resins, silicone resins, vinyl esters resins, and/or epoxy resins (also called epoxides). In some embodiments, the solvent-borne monomers comprise allyl-functional monomers, amino-functional monomers, maleimide-functional monomers, cyanate ester-functional monomers, epoxy-functional monomers, furan-functional monomers, vinyl ester-functional monomers, or a combination thereof. In other embodiments, the solvent-borne monomers comprise solvent-borne pre-polymers, such as allyl-functional pre-polymers, amino-functional pre-polymers, polyester pre-polymers, bis-maleimide pre-polymers, cyanate ester-functional pre-polymers, epoxy-functional pre-polymers, furan-functional pre-polymers, phenolic pre-polymers, polyurea pre-polymers, polyurethane pre-polymers, silicone pre-polymers, or vinyl ester-functional pre-polymers.

In one or more embodiments, the allyl resins include transparent abrasion-resistant synthetic resins or plastics that are usually formed from esters derived from allyl alcohol or allyl chloride. In one or more embodiments the amino resins (also called aminoplasts) include pre-polymers formed by co-polymerisation of amines or amides with an aldehyde, including urea-formaldehyde and melamine-formaldehyde resins. In one or more embodiments, the polyester resins include unsaturated synthetic resins formed by the reaction of dibasic organic acids and polyhydric alcohols; for example, maleic anhydride is a commonly used raw material with diacid functionality. In one or more embodiments, the bis-maleimides (BMI) resins include those formed by the condensation reaction of a diamine with maleic anhydride, and processed similarly to epoxy resins (350° F. (177° C.) cure). In one or more embodiments, the cyanate ester resins include those formed from a reaction of bisphenols or multifunctional phenol novolac resins with cyanogen bromide or chloride, which can lead to cyanate functional monomers that can be converted in a controlled manner into cyanate ester functional pre-polymer resins by chain extension or copolymerization. In one or more embodiments, the furan resins include pre-polymers made from furfuryl alcohol, or by modification of furfural with phenol, formaldehyde, urea or other extenders, that cure via polycondensation and release of water as well as heat. While they are generally cured under the influence of heat, catalysts, and pressure, in some embodiments furan resins can also be formulated as dual-component, no-bake acid-hardened systems which are characterized by high resistance to heat, acids, and alkalies.

In one or more embodiments, the phenolic resins include products of phenolic derivatives, such as phenol resorcinol, with aldehydes, such as formaldehyde furfural, and can include novolacs and resoles. In some embodiments, novolacs can be formed with acid catalysts and a molar ratio of formaldehyde to phenol of less than one to give methylene linked phenolic oligomers. In some embodiments, resoles can be formed with alkali catalysts and a molar ratio of formaldehyde to phenol of greater than one to give phenolic oligomers with methylene and benzylic ether-linked phenol units. In one or more embodiments, the polyurea resins include elastomeric polymers with carbamide (—NH—CO—NH—) links that can be made by combining diisocyanate monomers or prepolymers with blends of long-chain amine-terminated polyether or polyester resins and short-chain diamine extenders. In one or more embodiments, the polyurethane resins include polyurethane pre-polymers with carbamate links that may be linear and elastomeric, formed by combining diisocyanates with long chain diols, or crosslinked and rigid when formed from combinations of polyisocyanates and polyols. In one or more embodiments, the vinyl esters resins include those formed by addition reactions between an epoxy resin with derivatives of acrylic acid, such as methacrylic acid, and a vinyl functional monomer such as styrene. In some embodiments, the vinyl esters resins have high adhesion, heat resistance and corrosion resistance, and may be stronger than polyesters and more resistant to impact than epoxies.

In one or more embodiments, the silicone resins are partly organic in nature with a backbone polymer structure made of alternating silicon and oxygen atoms. In some embodiments, in addition to having at least one oxygen atom bonded to each silicone atom, silicone resins may have direct bonds to carbon and therefore are known as polyorganosiloxanes. In some embodiments, they have a general formula (R₂SiO)ₙ and their physical form (liquid, gel, elastomer or solid) and use varies with molecular weight, structure (linear, branched, caged) and nature of substituent groups (R=alkyl, aryl, H, OH, alkoxy). In some embodiments, aryl substituted silicone resins may have higher thermal stability than alkyl-substituted silicone resins when polymerized (condensation cure mechanism) at temperatures between ˜300° F. (˜150° C.) and ˜400° F. (˜200° C.). Heating above ˜600° F. (˜300° C.) may convert silicone polymers into ceramics, as organic constituents pyrolytically decompose leaving crystalline silicate polymers with the general formula (—SiO₂—)ₙ. In some embodiments, silicone resins in the form of polysiloxane polymers made from silicone resins with pendant acrylate, vinyl ether or epoxy functionality find application as UV, electron beam and thermoset polymer matrix composites where they are characterized by their resistance to oxidation, heat and ultraviolet degradation.

In one or more embodiments, epoxy resins (also referred to herein as epoxy-functional monomers) are a well-known class of reactive monomers and/or pre-polymers that contain epoxide functional groups, and react to form epoxy-based coatings. Generally, epoxy resins react with a hardener, via a polymerization/crosslinking reaction, to form a solid, epoxy-based coating on a surface of a substrate. Epoxy resins may be reacted (e.g., “cross-linked” or “cured”) with a wide range of hardeners, including acids (and acid anhydrides), phenols, alcohols, thiols, polyfunctional amines, amides, or combinations thereof. Epoxy-based coatings are generally formulated based on an end product's performance requirements. When properly catalyzed and applied, epoxy resins can produce a hard, chemical and solvent resistant finish. Specific selection and combination of the epoxy resin and hardener, as well as any additionally added components (which may be referred to as additives), determine the final characteristics and suitability of the epoxy-based coating for a given environment. Epoxy-based coatings can have a wide range of applications, including metal coatings, use in electronics/electrical components/LEDs, high tension electrical insulators, paint brush manufacturing, fiber-reinforced plastic materials and structural adhesives.

In one or more embodiments, the present disclosure provides compositions that can be used to form an epoxy-based coating (otherwise referred to as a pre-cured composition), wherein the compositions comprise solvent-borne monomers that comprise epoxy-functional monomers. In one or more embodiments, the solvent-borne monomers comprise solvent-borne epoxy resins. Said epoxy-functional monomers, or epoxy resins provide the base for forming the epoxy-based coating as they provide the main film-forming component, and comprise one or a combination of liquid monomers or pre-polymers that contain epoxide functional groups.

In one or more embodiments of the present disclosure, the epoxy-functional monomers, otherwise referred to as epoxy resins, comprise, consist essentially of, or consist of a reaction product of epichlorohydrine and one or more of hydroxyl-functional aromatics, alcohols, thiols, acids, acid anhydrides, cycloaliphatics and aliphatics, polyfunctional amines, and amine functional aromatics; a reaction product of the oxidation of unsaturated cycloaliphatics; bisphenol diglycidyl ethers; epoxy-functional monomers modified with a cycloaliphatic polyglycidyl ether; epoxy-functional monomers modified with a aliphatic glycidyl ether; epoxy-functional epoxide-siloxane monomers; or a combination thereof.

In one or more embodiments, the epoxy-functional monomers otherwise referred to as epoxy resins, comprise, consist essentially of, or consists of bisphenol diglycidyl ethers, epoxy-functional monomers modified with a cycloaliphatic polyglycidyl ether; epoxy-functional monomers modified with a aliphatic glycidyl ether; epoxy-functional epoxide-siloxane monomers; or a combination thereof. In some embodiments, the bisphenol diglycidyl ethers are derived from bisphenol A, bisphenol F, or a combination thereof. In some embodiments, the bisphenol diglycidyl ethers are derived from bisphenol S, bisphenol A, bisphenol F, or a combination thereof.

In one or more embodiments, the epoxy-functional monomers comprise epoxy-functional epoxide-siloxane monomers, otherwise referred to herein as hybrid epoxy-siloxane resins. Hybrid epoxy-siloxane resins may also be referred to herein as a hybrid epoxy-polysiloxane resin, a silicone epoxy hybrid resin, or a siloxane modified hybrid epoxy resin. Epoxy-functional epoxide-siloxane monomers may be formed from epoxy-functional monomers and siloxane/silicone monomers, pre-polymers, or resins, or a system of said monomers, pre-polymers, or resins, that have been reacted and covalently bonded to form a monomer of intermediate molecular mass that is capable of further polymerization by reactive epoxy and/or siloxane groups to form a cured coating. In one or more embodiments, the epoxy-functional epoxide-siloxane monomers are not formed from a physical mixture of a pre-polymerized epoxy resin and silicone resin. In one or more embodiments, the epoxy-functional epoxide-siloxane monomers are not formed from a physical mixture of an pre-polymerized epoxy resin and silicone resin that includes coupling agents (for example, silane coupling agents), or other agents, to facilitate miscibility of the epoxy resin and silicone resins.

In one or more embodiments, the epoxy-functional epoxide-siloxane monomers, otherwise referred to herein as hybrid epoxy-siloxane resins, comprise an epoxy-backbone with at least one siloxane or polysiloxane side-chains. In some embodiments, the epoxy-functional epoxide-siloxane monomers comprise an epoxy-functional epoxide (for example, ether linkage) backbone comprising siloxane or polysiloxane side-chains. In some embodiments, the epoxy-functional epoxide-siloxane monomers comprise an epoxy-backbone with linear, branched, or crosslinked siloxane or polysiloxane side-chains. In some embodiments, each siloxane or polysiloxane side-chain has a linear structure, branched structure, or a cross-linked three-dimensional structure. In some embodiments, the siloxane side-chains are functionalized with epoxy groups, alkoxy groups, hydroxyl groups, or hydroxyalkyl groups. In some embodiments, the epoxy-functional epoxide-siloxane monomers comprise an epoxy-functional epoxide backbone comprising siloxane or polysiloxane side-chains functionalized with alkoxy groups, wherein at least one side-chain comprises a cross-linked three-dimensional structure. In some embodiments, the at least one side-chain comprising a cross-linked three-dimensional structure is a cross-linked silicone resin. In one or more embodiments, the siloxane or polysiloxane side-chains may account for about 20% to about 50% of the monomer's molecular weight. In some embodiments, the epoxy-functional epoxide-siloxane monomer is a product of a polymer analogous reaction comprising isocyanate oligomers, silane oligomers, and epoxy oligomers. In some embodiments, the epoxy-functional epoxide-siloxane monomer is a product of a polymer analogous reaction comprising polyurethane oligomers, silane oligomers, and epoxy oligomers. In some embodiments, the epoxy-functional epoxide-siloxane monomers comprise one or a combination of 3-ethylcyclohexylepoxy copolymer modified with dimethylsiloxane side-chains, epoxy bisphenol A (2,2-Bis(4′-glycidyloxyphenyl)propane) modified with the poly-dimethylsiloxane side-chains, a siloxane modified hybrid epoxy resin, a siliconeepoxide resin, or an epoxy-functional epoxide-backbone functionalized with a crosslinked silicone resin comprising terminal alkoxy groups. In some embodiments, the epoxy-functional epoxide-siloxane pre-polymer comprises, consists essentially of, or consists of Silikopon® ED (a siliconeepoxide resin, otherwise referred to as a silicone epoxy resin, having an epoxy-functional epoxide-backbone functionalized with a crosslinked silicone resin with terminal alkoxy groups), Silikopon® EF (a siliconeepoxide resin, otherwise referred to as a silicone epoxy resin, having an epoxy-functional epoxy-backbone functionalized with a crosslinked silicone resin having terminal alkoxy groups, where the Silikopon® EF may have fewer terminal alkoxy groups than Silikopon® ED), EPOSIL Resin 5550® (a siloxane modified hybrid epoxy resin), or a combination thereof.

The type and amount of solvent-borne monomer that is selected for use in the pre-cured composition is, in part, dependent on the performance requirements of the epoxy-based coating, and/or the type of surface or substrate the coating is to be formed on.

Polyurea resins or polyurethane resins may be selected if it is desired that the cured coating has elastomeric properties. Vinyl esters resins may be selected if higher adhesion, heat resistance, corrosion resistance, and mechanical strength relative to polyesters, or if higher impact resistance relative to epoxies is desired. Silicone resins such as aryl substituted silicone resins may be selected for higher thermal stability relative to alkyl-substituted silicone resins; and silicone resins in the form of polysiloxane polymers made from silicone resins with pendant acrylate, vinyl ether or epoxy functionality may be selected for application as UV, electron beam and thermoset polymer matrix composites given their resistance to oxidation, heat and ultraviolet degradation.

Generally, epoxy-functional monomers, otherwise referred to herein as epoxy resins derived from bisphenol A and bisphenol F are considered as equivalents that provide coatings with similar properties. Further, epoxy-functional monomers derived from bisphenol A and bisphenol F may be used in a blend (a mix of bisphenol A and F) or as a hybrid (one molecule comprising components of both bisphenol A and F). In some embodiments, epoxy-functional monomers derived from bisphenol A may be selected to reduce costs, as it is often less expensive than bisphenol F. In other embodiments, epoxy-functional monomers derived from bisphenol F may be selected to impart more corrosion resistance to the cured epoxy-based coating, as coating formed from bisphenol F are generally known to be more corrosion resistant than those formed from bisphenol A. Further, epoxy-functional monomers derived from bisphenol F may be selected if it is desired that the cured epoxy-based coating is food-safe. Epoxy-functional monomers derived from bisphenol F may be selected if it is desirable to reduce diluent usage, as bisphenol F is generally less viscous than bisphenol A. Epoxy-functional monomers derived from bisphenol F may be selected if it is desirable for the cured epoxy-based coating to have reduced biotoxicity.

One or more of the epoxy-functional epoxide-siloxane monomers, otherwise referred to herein as hybrid epoxy-siloxane resins, may be selected to impart increased durability to the cured epoxy-based coating, relative to silicone-oil containing coatings (for example, soft-foul release coatings). The epoxy-functional epoxide-siloxane monomers may be selected to impart increased thermal resistance to the cured epoxy-based coating; or they may be selected to contribute to the anti-fouling/foul-releasing properties of the cured coating.

Generally, solvent-borne monomers having lower viscosities, such as in a range of about 200 cps to about 1500 cps, may be selected when it is desired that the composition comprises about 80 wt % to about 90 wt % solids. In some embodiments, low-viscosity solvent-borne monomers may be selected to maintain processibility of the composition comprising a high percent loading of the ceramic performance additive, such as hollow ceramic spheres, without having to add large volumes of solvent or diluent to maintain a workable viscosity of about 3500 cps or less. In some embodiments, the low-viscosity solvent-borne monomers comprise epoxy-functional monomers modified with a cycloaliphatic polyglycidyl ether having a viscosity in a range of about 350 to about 550 cps; epoxy-functional monomers modified with a cycloaliphatic polyglycidyl ether having a viscosity in a range of about 400 to about 1000 cps; epoxy-functional monomers modified with a aliphatic glycidyl ether having a viscosity in a range of about 800 to about 1000 cps; or a combination thereof. In some embodiments, the low-viscosity solvent-borne monomers comprise low viscosity epoxy resins comprising epoxy resins having a viscosity (mPa·s) at 25° C. between about 200 to about 7000, or about 350 to about 6500. In some embodiments, the low-viscosity solvent-borne monomers comprise DLVE®-52 (ultra low viscosity epoxy resin modified with a cycloaliphatic polyglycidyl ether epoxy resin), DLVE®-18 (low viscosity epoxy resin modified with a cycloaliphatic polyglycidyl ether epoxy resin), D.E.R.® 353 (C12-C14 aliphatic glycidyl ether-modified bisphenol-A/F epoxy-based resin), or a combination thereof.

In some embodiments, solvent-borne monomers, otherwise referred to as solvent-borne epoxy resins having viscosities higher than about 1500 cps, such as about 10,000-20,000 cps, may be selected when it is suitable for the composition to comprise less than about 80 wt % to about 90 wt % solids, or when it is suitable to use larger volumes of diluent or solvent such that a mixture of the solvent-borne monomers and the diluent have a viscosity in a range sufficiently low to maintain processibility of the composition comprising a high percent loading of the hollow ceramic spheres; for example, in a range of about 200 to about 3500 cps, or about 300 to about 3500 cps.

In one or more embodiments, the solvent-borne monomers are present in the pre-cured composition at a range of about 5 wt % to about 40 wt %; or are present at any range of wt % between about 5 wt % and about 40 wt %. In some embodiments, the epoxy-functional monomers make up about 5 wt % to about 35 wt % of the pre-cured composition. In other embodiments, the epoxy-functional monomers make up about 5 wt % to about 30 wt % of the pre-cured composition. In one or more embodiments, the solvent-borne epoxy resins are present in the pre-cured composition at an amount between about 5 to about 30 wt %, between about 5 to about 20 wt %, or between about 15 to about 20 wt %, based on Part A wt %; or are present at any wt %, or at any range of wt % between about 5 wt % and about 30 wt %. In one or more embodiments, the solvent-borne epoxy resins comprise hybrid epoxy-siloxane resins, and are present in the pre-cured composition at an amount between about 30 to about 55 wt %, between about 40 to about 50 wt %, based on Part A wt %; or are present at any wt %, or at any range of wt % between about 30 wt % and about 55 wt %.

### Ceramic Performance Additive

As described above, one or more embodiments of the present disclosure provides a pre-cured composition that comprises solvent-borne resins, a diluent, an adhesion promoter, a rheology modifier, and a ceramic performance additive. In one or more embodiments, the ceramic performance additive is added into the composition to increase sound dampening properties of the cured coating; the ceramic performance additive is added into the composition to increase hardness—otherwise measured by scratch resistance—of the cured coating; or for a combination thereof (relative to a control). In one or more embodiments wherein the ceramic performance additive is added into the composition to increase scratch resistance through increased hardness, use of the ceramic performance additive may also increase the cavitation resistance. The harder, more scratch resistant a cured coating, the less damage it is likely to sustain, thus reducing the occurrence or number of pits, scratches, erosion sites, dents or other forms of damage that could otherwise contribute to cavitation.

In one or more embodiments, ceramic performance additive comprises hollow cermics and non-hollow ceramics.

Hollow Ceramics. In one or more embodiments, the hollow ceramics comprise hollow ceramic spheres. The hollow ceramic spheres may have a shape that is spherical, substantially spherical, sphere-like, spheroidal, substantially spheroidal, spheroidal-like, or a combination thereof. As described above, one or more embodiments of the present disclosure provides a pre-cured composition that comprises solvent-borne monomers, a diluent, an adhesion promoter, and hollow ceramic spheres. In one or more embodiments, the hollow ceramic spheres are included in the composition to improve the sound dampening properties and/or improve the hardness of the cured coating (relative to a control).

In one or more embodiments, the hollow ceramic spheres may offer sound dampening properties due to their size, hollow core, ceramic composition, and/or percent loading in the composition. In some embodiments, the hollow ceramic spheres comprise a particle size of about 20 μm to about 40 μm; or about 30 μm to about 40 μm, or about 35 μm. In some embodiments, the hollow ceramic spheres may be present in the pre-cured composition in a range of about 30 wt % to about 70 wt % (about 15 vol % to about 55 vol %, based on a density of about 1 to about 3, or about 2 to about 2.5). With reference to Example 1, it was found that use of hollow ceramic spheres in the present compositions offered: (i) improved absolute noise reduction (in decibels, dB) relative to hollow glass spheres of comparable or larger particle size and/or comparable percent loading; (ii) improved absolute noise reduction (in decibels, dB) relative to a mix of hollow ceramic spheres with other purported noise dampening additives, such as hollow glass spheres and/or micronized barium sulphate; and (iii) improved absolute noise reduction (in decibels, dB) relative to hollow ceramic spheres of smaller particle size, such as about 12 μm. Without wishing to be bound by theory, use of the hollow ceramic spheres having a particle size of about 20 μm to about 40 μm, at a loading of about 30 wt % to about 70 wt % (about 15 vol % to about 55 vol %), may at least provide a sufficient concentration of air-filled voids within the cured coating to provide improved sound dampening properties; and/or may at least destructively (or reflectively) interfere with radiated soundwaves to provide improved sound dampening properties.

In some embodiments, the hollow ceramic spheres may be present in the pre-cured composition in a range of about 20 wt % to about 40 wt %, or about 25 wt % to about 35 wt %; based on Part A wt % or total wt %. With reference to Example 2, it was found that use of hollow ceramic spheres in the present compositions offered: (i) improved absolute noise reduction (in decibels, dB) relative to coating compostions that did not include hollow ceramic spheres; (ii) improved absolute noise reduction (in decibels, dB) relative to hollow glass spheres of comparable or smaller particle size and/or comparable percent loading; (iii) improved absolute noise reduction (in decibels, dB) up to about 10 dB with cured coating thicknesses up to between 250 microns and 275 microns. With reference to Example 2, it was also found that use of hollow ceramic spheres in an amount of at least 45 wt % (based on Part A wt %) in at least some examples of the present compositions resulted in a cured coating having reduced impermeability to water. Without wishing to be bound by theory, it was considered that higher amounts of spheres may hinder a cohesive and/or complete film formation as the resin cures, which may result in weak points in the coating that are more susceptible to damage, or in less obstructed pathways within the coating through which water can travel.

In one or more embodiments, where the hollow ceramic spheres are added into the composition to improve the sound dampening properties of the cured coating, the resultant cured coating may be applied as an undercoat to a substrate. In some embodiments, the hollow ceramic spheres also increase the hardness or scratch resistance of the cured undercoating. In some embodiments, the hardness may be increased to at least 5H when measured according to ASTM D3363.

In some embodiments, where the hollow ceramic spheres are added into the composition to improve the sound dampening properties of the cured coating, a topcoat may be applied over the resultant cured coating. In some embodiments, the percent loading of the hollow ceramic spheres are sufficiently high enough that the resultant cured coating has a rough, non-uniform surface. As such surfaces can result in fouling of the surface, a topcoat may be applied to reduce the fouling. In some embodiments, the topcoat that is applied may be selected to offer anti-fouling/foul release properties, or other desired properties that align with the end use of the coating and/or the substrate to which it is applied. In one or more embodiments, the topcoat applied to the cured undercoat may comprise a coating as described in PCT Application No. PCT/CA2021/000042 entitled ‘Composition For A Coating, Coatings And Methods Thereof’, which claims priority to U.S. Provisional Patent Application No. 63/024,447; or PCT Application No. PCT/CA2019/050334 entitled ‘Multifunctional Coatings for Use in Wet Environments’, which claims priority to U.S. Provisional Patent Application No. 62/645,504; which are incorporated herein by reference.

In one or more embodiments, the hollow ceramic spheres are added into the composition to increase the hardness—otherwise indicated by scratch resistance—of the cured coating. In some embodiments, the hollow ceramic spheres may provide improved hardness properties due also to their size, hollow centre, composition, and/or percent loading in the composition. In some embodiments, the hollow ceramic spheres comprise a particle size of about 10 μm to about 40 μm. In some embodiments, the hollow ceramic spheres comprise a particle size of about 10 μm to about 15 μm. In some embodiments, the hollow ceramic spheres may be present in the composition in a range of about 5 wt % to about 20 wt % (about 3 vol % to about 20 vol %, based on a density of about 1 to about 3, or about 2 to about 2.5). In some embodiments, the hollow ceramic spheres are present in the composition in a range of about 5 wt % to about 15%, based on Part A wt %. Without wishing to be bound by theory, use of the hollow ceramic spheres having a particle size of about 10 μm to about 15 μm, at a loading of about 5 wt % to about 20 wt % (about 3 vol % to about 20 vol %), or hollow ceramic spheres having a particle size of about 10 μm to about 40 μm, at a loading of about 5 wt % to about 15 wt % may at least provide improved scratch resistance due to the ceramic sphere's high hardness (for example, 7 on the Mohs Scale); in some embodiments, a smaller size (for example, about 12 μm); or percent loading that can afford a relatively smooth surface. In one or more embodiments, where the hollow ceramic spheres are added into the composition to improve the scratch resistance of the cured coating, the resultant cured coating may be applied as a topcoat to a substrate, and may be further formulated to offer anti-fouling/foul release properties, or other desired properties that align with the end use of the coating and/or the substrate to which it is applied.

In one or more embodiments, the hollow ceramic spheres comprise spheres having a particle size of about 20 μm to about 40 μm, or about 25 μm to about 35 μm. In some embodiments, the hollow ceramic spheres are present at a weight percent loading in a range of about 20 wt % to about 40 wt %, or about 25 wt % to about 35 wt %; based on Part A wt % or total wt %. In some embodiments, the hollow ceramic spheres are present at a weight percent loading in a range of about 30 wt % to about 70 wt %, or about 35 wt % to about 65 wt %, or about 30 wt % to about 50 wt %, or about 35 wt % to about 50 wt %, or about 45 wt % to about 70 wt %, or about 50 to about 65 wt %. In some embodiments, the hollow ceramic spheres comprise Zeeospheres® G 600 hollow ceramic spheres, W410® hollow ceramic spheres, W610® hollow ceramic spheres, or a combination thereof.

In one or more embodiments, the hollow ceramic spheres comprise spheres having a particle size of about 10 μm to about 40 μm; about 20 μm to about 40 μm, or about 25 μm to about 35 μm; or about 10 μm to about 15 μm, or about 12 μm. In one or more embodiments, the hollow ceramic spheres comprise spheres having a particle size of about 10 μm to about 15 μm, or about 12 μm. In some embodiments, the hollow ceramic spheres are present at a weight percent loading in a range of about 5 wt % to about 15 wt %, based on Part A wt % or total wt %. In some embodiments, the hollow ceramic spheres are present at a weight percent loading in a range of about 5 wt % to about 20 wt %, or about 10 wt % to about 20 wt %, or about 10 wt % to about 18 wt %, or about 10 wt % to about 15 wt %. In some embodiments, the hollow ceramic spheres comprise Zeeospheres® N-200PC hollow ceramic spheres, W210® hollow ceramic spheres, or a combination thereof.

Non-hollow Ceramics. In one or more embodiments, the non-hollow ceramics comprise non-hollow ceramic particles. In one or more embodiments, non-hollow ceramic particles are added into the composition to increase the hardness—otherwise measured by scratch resistance—of the cured coating. In one or more embodiments wherein the non-hollow ceramic particles are added into the composition to increase scratch resistance through increased hardness, use of the non-hollow ceramic particles may also increase the cavitation resistance. Without wishing to be bound by theory, use of the non-hollow ceramic particles may at least provide improved scratch and abrasion resistance, and may thus provide improved cavitation resistance, due to the ceramic particles' hardness; small particle size; and/or percent loading that can afford a relatively smooth surface. As described above, the harder, more scratch resistant a cured coating, the less damage it is likely to sustain, thus reducing the occurrence or number of pits, scratches, dents, erosion sites, or other forms of damage that could otherwise contribute to cavitation. In one or more embodiments, the non-hollow ceramic particles have a hardness between about 5 to about 10, or about 7 to about 9 on the Mohs Scale.

In one or more embodiments, the non-hollow ceramic particles comprise a particle size of about 0.1 μm to about 5 μm; about 0.5 μm to about 5 μm, or about 1 μm to about 5 μm; or about 2 μm to about 5 μm. In one or more embodiments, the non-hollow ceramic particles are present in the composition in a range of about 10 wt % to about 50 wt %, or about 10 wt % to about 45 wt %; or about 15 wt % to about 40 wt %, based on Part A wt. In one or more embodiments, the non-hollow ceramic particles are present in the composition in a range about 5 wt % to about 40 wt %, or about 10 wt % to about 35 wt %, or about 20 wt % to about 35 wt %, or about 10 wt % to about 20 wt %; based on Part A wt % or total wt %.

In one or more embodiments, the non-hollow ceramic particles comprise titanium oxide, fumed silica, brown aluminium (III) oxide, fused aluminium (III) oxide, titanium alloys, or a combination thereof. In some embodiments, the titanium alloys comprise titanium carbonitride, titanium carbide, or a combination thereof. In some embodiments, titanium oxide and/or fumed silica further comprise wear-resistant, abrasion-resistant properties, and thus may also act as wear-inhibiting additives as described herein. In some embodiments, fumed silica may further comprise rheology-modifying properties, and thus may also act as a rheology modifier as described herein. Fused aluminium (III) oxide, relative to brown aluminium (III) oxide, has a slightly lighter density (3.8 vs 4) and relatively higher oil absorption. In one or more embodiments, fused aluminium (III) oxide may be less prone to sedimentation; may act as a rheology modifier, and/or may improve long-term stability of the pre-cured composition (e.g., shelf-life). The type and amount of non-hollow ceramic particles that is selected for use in the pre-cured composition is, in part, dependent on the performance requirements of the cured coating. As such, non-hollow ceramic particles may be selected based on hardness properties, as well as other properties such as wear-inhibiting properties, rheology-modifying properties, and/or shelf-life.

In one or more embodiments, where the non-hollow ceramic particles are added into the composition to improve the scratch resistance of the cured coating, the resultant cured coating may be applied as a topcoat to a substrate, and may be further formulated to offer anti-fouling/foul release properties, or other desired properties that align with the end use of the coating and/or the substrate to which it is applied.

In one or more embodiments, the ceramic performance additive is included at an amount sufficient to provide a coating formed from the composition having a reduced noise radiation of about 2 dB to about 10 dB per about 100 μm of coating thickness at frequencies of about 10 Hz to about 10 kHz when measured on a 3 mm thickness cold rolled steel metal plate relative to a 3 mm thickness cold rolled steel metal plate coated with a coating free of the ceramic performance additive. In one or more embodiments, the ceramic performance additive is included at an amount sufficient to provide a coating formed from the composition having a reduced noise radiation of about 3 dB to about 9 dB, about 5 dB to about 9 dB, or about 5 dB to about 7 dB per about 100 μm of coating thickness.

In one or more embodiments, the ceramic performance additive is included at an amount sufficient to provide a coating formed from the composition having a hardness of at least 5H when measured according to ASTM D3363. In one or more embodiments, the ceramic performance additive is included at an amount sufficient to provide a coating formed from the composition having a hardness of about 6H to about 8H, or about 8H.

In one or more embodiments, the ceramic performance additive, such as the hollow ceramic spheres are included at an amount sufficient to provide a coating formed from the composition having a reduced noise radiation (for example, sound dampening properties) of about 1 dB to about 50 dB per about 100 μm of coating thickness at frequencies of about 1000 Hz or less when measured on a 3 mm thickness cold rolled steel metal plate relative to an uncoated 3 mm thickness cold rolled steel metal plate, or a hardness of at least 5H when measured according to ASTM D3363. In one or more embodiments, the hollow ceramic spheres are included at an amount sufficient to provide a coating formed from the composition having reduced noise radiation of about 1 dB to about 20 dB, or to about 15 dB per about 100 μm of coating thickness for noise in a range of about 100 to about 1000 Hz, or about 100 to about 400 Hz, or a hardness of about 6H to about 8H.

### Adhesion Promoter

As described above, one or more embodiments of the present disclosure provides a pre-cured composition that comprises solvent-borne monomers, a diluent, and an adhesion promoter. In one or more embodiments, the adhesion promoter is included in the composition to improve flexibility of the cured coating resulting from the composition; for example, as indicated by a bending strength of at least 10 mm when measured by a cylindrical bend test. In one or more embodiments wherein the cured coating is applied as an undercoat, the adhesion promoter may be included to improve intercoat, or recoat adhesion between the cured undercoat and any topcoat that may be applied. In one or more embodiments wherein the cured coating is applied to a primed substrate (for example, a substrate comprising a primer coating), the adhesion promoter may be included to improve overcoat adhesion between the cured coating and the primed substrate. In one or more embodiments wherein the cured coating is applied directly to a substrate, the adhesion promoter may be included to improve substrate adhesion between the cured coating and the substrate.

In one or more embodiments, the adhesion promoter in combination with the hardener composition may increase adhesion of the cured coating to a metal substrate or a primed metal substrate (for example, see Hardener below). In one or more embodiments, the adhesion promoter in combination with wear-inhibitors such as graphite oxide, graphene, multilayered graphene flakes may improve bending strength.

In one or more embodiments, the adhesion promoter is included in an amount sufficient to provide a coating formed from the composition having an intercoat adhesion (otherwise referred to as recoat adhesion or recoat adhesion window) of at least 5 MPa when measured according to ASTM D4541, or a bending strength of at least 10 mm when measured by a cylindrical bend test. In one or more embodiments, the adhesion promoter is included in an amount sufficient to provide a coating formed from the composition having an intercoat adhesion of about 5 MPa to about 10 MPa when measured according to ASTM D4541, or a bending strength of at least 8 mm, or about 6 mm when measured by a cylindrical bend test.

In one or more embodiments, the adhesion promoter is included in an amount sufficient to provide a coating formed from the composition having a substrate adhesion of at least 3 MPa when measured according to ASTM D4541, an overcoat adhesion of at least 3 MPa when measured according to ASTM D4541, or a recoat adhesion window of at least 4 hours when measured according to ASTM D3359.

In one or more embodiments, when the adhesion promoter is included in the pre-cured composition, a coating formed from the composition has a substrate adhesion of about 3 MPa to about 15 MPa, or about 3 MPa to about 10 MPa when measured according to ASTM D4541, an overcoat adhesion of about 3 MPa to about 15 MPa, or about 3 MPa to about 10 MPa when measured according to ASTM D4541, or a recoat adhesion window between about 4 hours to about 72 hours when measured according to ASTM D3359; or a combination thereof.

In one or more embodiments, when the adhesion promoter is included in the pre-cured composition, a coating formed from the composition has a substrate adhesion of at least 3 MPa when measured according to ASTM D4541, an overcoat adhesion of at least 3 MPa when measured according to ASTM D4541, or a combination thereof. In one or more embodiments, when the adhesion promoter is included in the pre-cured composition, a coating formed from the composition has having a substrate adhesion of about 3 MPa to about 15 MPa, or about 3 MPa to about 10 MPa, or about 3 MPa to about 7 MPa, or about 5 MPa to about 7 MPa when measured according to ASTM D4541, an overcoat adhesion of about 3 MPa to about 15 MPa, or about 3 MPa to about 10 MPa, or about 3 MPa to about 7 MPa, or about 5 MPa to about 7 MPa when measured according to ASTM D4541; or a combination thereof.

The adhesion promoter may improve the flexibility and/or intercoat/recoat adhesion of the cured coating formed from the composition due to the promoter's reactive groups. In one or more embodiments, the adhesion promoter has at least two, or at least three functional groups capable of coupling to ceramic performance additive, such as the hollow ceramic spheres or non-hollow ceramics and/or being incorporated into the polymerization of the solvent-borne monomers. In one or more embodiments, the adhesion promoter may act as a binder between the ceramic performance additive, such as the hollow ceramic spheres and the solvent-borne resin of the pre-cured composition to provide improved flexibility of the cured coating comprising the hollow ceramic spheres. In some embodiments, the adhesion promoter may improve cohesion of the cured coating comprising the ceramic performance additive, such as the hollow ceramic spheres, where cohesion refers to the mechanical strength of a single cured coating layer, and how much it resists against pull-off forces, compression forces, bending forces, or any other damaging forces. In one or more embodiments, wherein the cured coating is applied as an undercoat, the adhesion promoter may act as a binder between the cured undercoat and any topcoat that may be applied to provide improved intercoat adhesion.

In one or more embodiments, the adhesion promoter is a silane. In one or more embodiments, the adhesion promoter is a functionalized silane. In some embodiments, the functionalized silane comprises two or three alkoxy (O—R) reactive groups. In some embodiments, the functionalized silane comprises functional groups that are reactive in a polymerization of solvent-borne monomers, such as an epoxy-functional group or an amino-functional group, or a combination thereof. Without wishing to be bound by theory, in embodiments wherein the adhesion promoter is a silane, the silane may improve the flexibility and/or intercoat adhesion of the cured coating due to the silane's alkoxy groups, which can form siloxane (Si—O—Si) linkages through reaction with surface hydroxyl groups on a substrate or the hollow ceramic spheres; or which can be incorporated into the polymerization of the solvent-borne monomers. Without wishing to be bound by theory, in embodiments wherein the adhesion promoter is a silane, the silane may improve the wet adhesion, hydrophobicity, and/or anti-corrosive properties of the cured coating. For example, the adhesion promoting silane can be activated by acid and/or moisture on a substrate's surface, or the surface of the hollow spheres, to form silanol (Si—OH) groups which can react with the surface hydroxyl (OH) groups by a condensation reaction (for example, Si—OH+HO-substrate⇒Si—O substrate). Further, the adhesion promoting silane may be incorporated into the polymerization of the solvent-borne monomers by reacting with the solvent-borne monomers and/or the hardener. In one or more embodiments, the adhesion promoter comprises the weather-resistance additive as described herein. In one or more embodiments, the adhesion promoter comprises the silamine hardener triamino-functional propyltrimethoxysilane as described herein.

In one or more embodiments, the adhesion promoter comprises 3-(2,3-epoxypropoxy)propyltrimethoxysilane, glycidoxypropyltrimethoxysilane (for example, Andisil 187®) aminopropyl-triethoxysilane, 3-aminopropyltriethoxysilane, a secondary amino bis-silane (for example, Silquest* A-1170®, Andisil 1100®, Dynasylan Ameo®), triamino-functional propyltrimethoxysilane (Dynasylan TRIAMO (Evonik)); or a combination thereof. In one or more embodiments, the adhesion promoter is present in the pre-cured composition in a range of about 0.1 wt % to about 5 wt %, or about 0.1 wt % to about 1 wt %, or about 1 wt % to about 5 wt %, or at any range of wt % between 0.1 wt % and about 5 wt %.

In one or more embodiments, the adhesion promoter is included in the pre-cured composition to improve adhesion of the cured coating to a metal substrate or a primed metal substrate. In one or more embodiments wherein the curing coating is applied directly to a metal substrate, the adhesion promoter may be included to improve substrate adhesion between the cured coating and the metal substrate. In one or more embodiments wherein the cured coating is applied to a primed metal substrate, the adhesion promoter may be included in both the primer composition and the composition for a coating to improve substrate adhesion between the cured coating and the primed metal substrate. The metal substrate may be a steel substrate, a copper substrate, a copper alloy substrate, or other metal substrate.

In one or more embodiments, the adhesion promoter comprises a dry adhesion promoter, a wet adhesion promoter, a dry/wet adhesion promoter, or a combination thereof. The dry adhesion promoter, the dry/wet adhesion promoter, and/or the wet adhesion promoter may be non-reactive, reactive in a epoxy polymerization, reactive with a metal substrate, and/or reactive with surface oxides on a metal substrate; or a combination thereof. The type and amount of adhesion promoter that is selected for use in the pre-cured composition is, in part, dependent on the performance requirements of the cured coating, the type of adhesion to be promoted, and/or the mechanism of adhesion that is desired.

In one or more embodiments, the dry adhesion promoter is non-reactive, reactive in a epoxy polymerization, reactive with a substrate, and/or reactive with metal oxides. In one or more embodiments, the dry adhesion promoter may comprise one or more functional groups that can react with an inorganic surface (e.g., ceramics, surface oxides on metal substrates). The dry adhesion promoter may also comprise one or more functional groups that are reactive in an epoxide polymerization and can react with solvent-borne epoxy resins, thus enhancing the resultant coating's adhesion to a metal substrate, such as a Cu substrate. In one or more embodiments, the dry adhesion promoter comprises an alkoxylated silane. Organofunctional silanes comprise at least two different reactive groups, such that they can react and couple to an inorganic surface (for example, ceramics and surface oxide layers on a metal substrate). Where organofunctional silanes include amine functional groups, the silane may co-react with an epoxy resin to facilitate adhesion to a metal substrate, such as a Cu substrate. Such dry silane promoters may also contribute to overall hydrophobicity properties of a coating. In one or more embodiments, the dry adhesion promoter comprises glycidoxypropyltrimethoxysilane (for example, Andisil 187®), aminopropyl-triethoxysilane, (for example, Andisil 1100®), triamino-functional propyltrimethoxysilane (for example, Dynasylan TRIAMO (Evonik)); or a combination thereof. In one or more embodiments, the dry adhesion promoter is present in the pre-cured composition in a range of about 1 wt % to about 10 wt %, or about 1 wt % to about 8 wt %, or at any wt % or range of wt % between 1 wt % and about 10 wt % based on Part A wt % or total wt %.

In one or more embodiments, the wet adhesion promoter is reactive with a metal substrate. In one or more embodiments, wet adhesion promoters can become activated in a wet environment, decomposing in the presence of ions in water that permeate into a coating. Products of this decomposition can react with a metal substrate, such as a Cu-alloy, and also cross-react with any non-decomposed promotor. This can allow formation of a strong bond between a coating layer and a metal substrate. This may also hinder corrosion of the substrate. In one or more embodiments, the wet adhesion promoter comprises a metal-doped phosphosilicate. In one or more embodiments, the wet adhesion promoter comprises a strontium phosphosilicate (for example, HALOX® SW-111); a zinc calcium strontium aluminum orthophosphate silicate hydrate (for example, HEUCOPHOS® ZCP-Plus); a zinc phosphosilicate (for example, InvoCor CI-3315), or a combination thereof. In one or more embodiments, the wet adhesion promoter is present in the pre-cured composition in a range of about 1 wt % to about 5 wt %, or at any wt % or range of wt % between 1 wt % and about 5 wt % based on Part A wt % or total wt %.

In one or more embodiments, the dry/wet adhesion promoter is non-reactive, reactive with a substrate, and/or reactive with metal oxides. In one or more embodiments, the dry/wet adhesion promoter may provide good flow characteristics that help a curing coating to flow into areas of roughness on a metal substrate, which can facilitate formation of a grip between the cured coating and the substrate. In one or more embodiments, the dry/wet adhesion promoter may comprise one or more functional groups that can react with a metal substrate. The dry/wet adhesion promoter may also comprise one or more functional groups that are reactive in an epoxide polymerization and can react with solvent-borne epoxy resins. In one or more embodiments, the dry/wet adhesion promoter comprises a modified polyester; a modified polyester oligomer, a polyacrylic, a polyacrylate, a benzotriazole, a mercaptane-comprising polymer or pre-polymer, a hydroxyphenyl-benzotriazole, a hydroxyphenyl-triazine, or a combination thereof. In one or more embodiments, the dry/wet adhesion promoter comprises a modified polyester having a hydroxyl value enough about 30 mg to about 100 mg KOH/g, such as Tego Addbond LTW-B®, Tego Addbond 2220 ND®, to provide good flow characteristics that help a curing coating to flow into areas of roughness on a metal substrate, which can facilitate formation of a grip between the cured coating and the substrate. In one or more embodiments, the dry/wet adhesion promoter comprises an alkyl-substituted, hydroxylamine-substituted benzotriazole, such as CCI-01 Copper Adhesion Promoter, wherein the benzotriazole of the curing coating can react with metal substrates, such as copper to form Cu-BTA, protecting the surface from corrosion and retaining a strong grip between the coating with the substrate. In one or more embodiments, the dry/wet adhesion promoter comprises a mercaptane-comprising polymer or pre-polymer, such as CAPCURE® 3-800, CAPCURE® 40 SEC HV, wherein the thiols can oxidize and bond to metal substrates, including copper; and the amine functional group (if present in the thiol-compound) can co-react with an epoxy resin to facilitate adhesion to a metal substrate, such as a Cu substrate. In one or more embodiments, the dry/wet adhesion promoter is present in the pre-cured composition in a range of about 0.1 wt % to about 1 wt %, or at any wt % or range of wt % between 0.1 wt % and about 1 wt % based on Part A wt % or total wt %.

### Rheology Modifier

As described above, the present disclosure provides a pre-cured composition that further comprises a rheology modifier. In one or more embodiments, the rheology modifier comprises an anti-settling rheology modifier; an anti-sagging rheology modifier; anti-cratering surface-leveling rheology modifier, or a combination thereof. The rheology modifier may at least be included in the composition to reduce sagging of the curing composition as it is applied to a substrate, to allow for a more uniform application of the curing composition to a substrate, at least reduce sedimentation of components or additives, and/or to facilitate formation of a cured coating having a more uniform surface (relative to a control). In one or more embodiments, the rheology modifier is included in the composition to provide a curing composition having anti-settling, anti-sagging, or surface-leveling properties.

In one or more embodiments, the rheology modifier is included in the pre-cured compositions to modify the viscosity of the pre-cured and/or curing composition. In one or more embodiments, the rheology modifier is included to provide a curing composition having anti-sagging properties. The rheology modifier may modify the viscosity of the pre-cured and/or curing composition by increasing the viscosity so that there is at least reduced sagging of the curing composition when it is applied to a surface or a substrate (relative to a control). In some embodiments, the rheology modifier may modify the viscosity of the pre-cured and/or curing composition by decreasing the viscosity so that the curing composition has a sufficiently low viscosity to be applied to a surface or a substrate via brushing, rolling, spraying, etc. (relative to a control). In some embodiments, the rheology modifier modifies the viscosity of the pre-cured and/or curing composition so that the curing composition can be applied to a surface or a substrate via brushing, rolling, spraying, etc., while also at least reducing sagging of the curing composition when it is applied to a surface or a substrate, to at least reduce formation of macroscopic defects and roughness, such as curtains, droplet runs, or other sag-related defects (relative to a control). Such defects may occur in the absence of the rheological additive, and may lead to increased roughness, or reduced uniformity of the cured coating's surface. Such defects may increase cavitation when the cured coating has been applied to a substrate such as a propeller. In some embodiments, the rheology modifier modifies the viscosity of the pre-cured and/or curing composition so that the curing composition can be applied to a surface or a substrate with at least reduced sagging to reduce formation of macroscopic defects and roughness in the surface of the cured coating, thereby facilitating formation of a cured coating having a more uniform surface. Such defects may occur in the absence of the rheological additive, and may lead to increased roughness, or reduced uniformity of the cured coating's surface. In some embodiments, the rheology modifier modifies the viscosity of the pre-cured and/or curing composition to facilitate a more uniform, high-built application of the curing composition with reduced sagging upon application of thickness around or above 10 mils. A high-built application refers to a thick application of the curing composition during a coating process. A high-built application may be selected when a single coating application is desired or necessary, instead of several consecutive applications, as a single application of high-build compositions may achieve a desired coating thickness without long wait times and/or additional labor.

In some embodiments, the rheology modifier is included in the pre-cured compositions to increase the thixotropic properties of the pre-cured or curing compositions. In one or more embodiments, the rheology modifier is included to provide a curing composition having anti-settling properties. Increasing the thixotropic properties of the pre-cured or curing compositions may improve the processibility and handling of the pre-cured or curing compositions, by making the compositions easier to mix, stir, or apply to a surface or substrate. In other embodiments, the at rheology modifier is included in the pre-cured compositions to contribute to solids suspension. In some embodiments, the rheology modifier is included in the pre-cured compositions to prolong the shelf-life, package stability, and/or anti-settling properties of the of the compositions.

In one or more embodiments, the rheology modifier is included in the pre-cured compositions to modify the viscosity of the pre-cured and/or curing composition when a relatively high percent loading of hollow ceramic spheres is used in the pre-cured compositions of the present disclosure (for example, >30 wt %), to facilitate reduced sagging, uniform application, and/or formation of a cured coating having a more uniform surface (relative to a control). Use of the hollow ceramic spheres in the pre-cured compositions may thicken the composition such that application of the composition to a substrate may be impacted. Further, use of the hollow ceramic spheres in the pre-cured compositions may add to the weight or bulk of the composition following application to a substrate, potentially causing the applied composition to sag, thereby impacting the ability to form a cured coating having a more uniform surface.

In one or more embodiments, the rheology modifier is included in the pre-cured compositions to improve flow or wetting properties of the composition, such that there is an improved flow of the composition and/or improved wetting of a substrate as a curing composition of present disclosure is being applied. In one or more embodiments, the rheology modifier is included to provide a curing composition having surface-leveling properties. In one or more embodiments, improved flow or wetting of the substrate can reduce or prevent defect formation in the cured coating. In some embodiments, said wetting may facilitate formation of a smooth cured coating with reduced micro-level roughness. In one or more embodiments, the rheology modifier included to improve flow or wetting properties of the composition comprises a polyether siloxane copolymer, such as TEGO® Glide 410® (Evonik). In one or more embodiments, the polyether siloxane copolymer, such as TEGO® Glide 410® (Evonik) may also act as a dispersant.

The type and amount of rheology modifier that is selected for use in the pre-cured composition is, in part, dependent on the performance requirements of the cured coating, and/or the type of surface or substrate the coating is to be formed on.

In one or more embodiments, the anti-settling rheology modifier is included in the composition to at least reduce sedimentation of the ceramic performance additive in the composition or curing composition. In one or more embodiments, the anti-settling rheology modifier comprises a silica, a clay, or a combination thereof. In one or more embodiments, the anti-settling rheology modifier comprises fumed silica, fumed silica surface modified with silane, fumed silica surface modified with dimethyldichlorosilane; aluminum phyllosilicate clay; organo-modified derivative of aluminium phyllosilicate clay; organo-modified bentonite clay; organo-modified montmorillonite clay; or a combination thereof. In one or more embodiments, the anti-settling rheology modifier is present in the pre-cured composition in a range of about 0.1 wt % to about 5 wt %, or about 0.3 wt % to about 3 wt %, or about 0.3 w % to about 2 wt %; or at any wt % or range of wt % between about 0.1 wt % and about 5 wt %, based on Part A wt % or total wt %.

In one or more embodiments, the fumed silica is formed by silica that was blown through a flame, and has undergone partial melting. In one or more embodiments, the fumed silica has bent sheet-like structure. When added to a pre-cured composition, the fumed silica, and modified versions thereof tend to disperse, introducing a 3D-like structure to the volume of the composition, preventing the components such as hard particles from settling and coalescencing. In one or more embodiments, fumed silica and modified versions thereof aid the thixotropy of the pre-cured or curing composition, and provide anti-settling properties during storage. In one or more embodiments, fumed silica and modified versions thereof also increase the hydrophobicity of cured coatings. In one or more embodiments, fumed silica and modified versions thereof also increase wear-inhibition of cured coatings. In one or more embodiments, the aluminum phyllosilicate clay; organo-modified derivative of aluminium phyllosilicate clay; organo-modified bentonite clay; or organo-modified montmorillonite clay provide an anti-static based 3D-structural viscosifying effect when included in a pre-cure composition. In one or more embodiments, the aluminum phyllosilicate clay; organo-modified derivative of aluminium phyllosilicate clay; organo-modified bentonite clay; or organo-modified montmorillonite clay aid the thixotropy of the pre-cured or curing composition, and provide anti-settling properties during storage.

In one or more embodiments, the anti-sagging rheology modifier is included in the composition to at least reduce sagging or dripping of a curing coating after it is applied onto a substrate; for example, to prevent a composition for a coating from sagging from a substrate, such as vertical substrate upon spraying. In one or more embodiments, the anti-sagging rheology modifier is included in the composition to allow for a high build of the curing composition. In one or more embodiments, the properties of the anti-sagging rheology modifier may be accessed, or activated via high shear and/or high temperature conditions. In one or more embodiments, the anti-sagging rheology modifier comprises a wax, a micronized wax, or a combination thereof. In one or more embodiments, the anti-sagging rheology modifier comprises such as a polyamide wax, a micronized polyamide wax, a micronized organo-modified polyamide wax, a micronized organo-modified polyamide wax derivative, or a combination thereof. In one or more embodiments, the anti-sagging rheology modifier comprises a comprises a wax, a derivatized wax, or a combination thereof. In one or more embodiments, the anti-sagging rheology modifier comprises a castor oil wax, an organically-modified castor oil-derivative wax, or a combination thereof. In one or more embodiments, the anti-sagging rheology modifier is present in the pre-cured composition in a range of about 0.1 wt % to about 1.5 wt %, or about 0.1 wt % to about 1 wt %, or about 0.1 w % to about 0.5 wt %; or at any wt % or range of wt % between about 0.1 wt % and about 1.5 wt %, based on Part A wt % or total wt %.

In one or more embodiments, when included in the pre-cured composition, the polyamide wax, micronized polyamide wax, micronized organo-modified polyamide wax, micronized organo-modified polyamide wax derivative, or combination thereof allow for a high build of the curing composition. In one or more embodiments, when included in the pre-cured composition, a castor oil wax, an organically-modified castor oil-derivative wax, or a combination thereof provide anti-caking or anti-settling properties during storage of a pre-cured composition, and anti-sagging properties to a curing composition during application to a substrate.

In one or more embodiments, the surface-leveling rheology modifier is included in the pre-cured composition to at least provide a smoother levelling of a curing coating as it is being applied, with reduced formation of craters or cavities in the curing coating. In one or more embodiments, the surface-leveling rheology modifier comprises a polyether siloxane copolymer. In one or more embodiments, when included in the pre-cured composition, polyether siloxane copolymer aids in surface-leveling by way of its wetting properties. In one or more embodiments, the surface-leveling rheology modifier is present in the pre-cured composition in a range of about 0.1 wt % to about 1.5 wt %, or about 0.1 wt % to about 1 wt %, or about 0.1 w % to about 0.5 wt %; or at any wt % or range of wt % between about 0.1 wt % and about 1.5 wt %, based on Part A wt % or total wt %.

In one or more embodiments of the present disclosure, the rheology modifier comprises, consists essentially of, or consists of aluminum phyllosilicate clay; organo-modified derivative of Aluminium phyllosilicate clay; organo-modified bentonite clay; organo-modified montmorillonite clay such as Claytone-HY® or Claytone-APA®; organo-modified castor oil, such as Thixatrol ST®; micronized organo-modified derivative of polyamide wax, such as Crayvallac Super®; fumed silica; fumed silica surface modified with dimethyldichlorosilane, such as Cab-O—Sil 610®; micronized barium sulphate, such as VB Techno®; microcrystalline magnesium silicate, such as Talc Silverline 202® or Mistron 002®; polyether siloxane copolymer, such as TEGO® Glide 410® (Evonik); or a combination there of. In one or more embodiments, to affect the rheological properties of the pre-cured or curing compositions, the rheology modifier is present in the pre-cured composition in a range of about 0.3 wt % to about 5 wt %, or about 0.3 wt % to about 3 wt %, or about 0.3 w % to about 1.5 wt %, or at any range of wt % between about 0.3 wt % and about 5 wt %.

### Diluents

As described above, one or more embodiments of the present disclosure provides pre-cured compositions that comprise solvent-borne monomers, otherwise referred to as solvent-born epoxy resins and a diluent. In one or more embodiments, the diluent is included in the pre-cured composition to help reduce viscosity of the composition and therefore improve processability. In one or more embodiments, the diluent is included in the pre-cured composition to help reduce viscosity of the composition and therefore improve processability given that use of the ceramic performance additives, such as the hollow ceramic spheres, can thicken the composition beyond working viscosities which can impact application of the curing composition (for example, at or below 3500 cps).

In one or more embodiments, the diluent is added to the composition to act as a liquid vehicle to provide a composition viscosity below 3500 cps. In one or more embodiments, the diluent has a lower viscosity that the solvent-borne monomers; for example, a viscosity less than 1000 cps, such as between about 1 cps to about 800 cps. In one or more embodiments, the diluent has a viscosity that, once added to the pre-cured composition, provides a final viscosity of the pre-cured composition that is in a range of about 200 to about 3500 cps, or about 300 to about 3500 cps, so that processability of the pre-cured composition can be maintained with use of the ceramic performance additives, such as the hollow ceramic spheres. In some embodiments, maintaining processability comprises maintaining the ability to applied to a substrate via brushing or spray coating.

In one or more embodiments, the amount of diluent that is selected for use in the pre-cured composition is, in part, dependent on the viscosity of the solvent-borne monomers/epoxy resins. For example, if the solvent-borne monomers were to have a relatively high viscosity, such as epoxy-functional monomers that have a viscosity of about 10,000 cps to about 20,000 cps, larger volumes of diluent may be added to maintain a working viscosity of about 3500 cps or less for the pre-cured composition. In one or more embodiments, the amount of diluent is, in part, dependent on whether it is desired for the composition to have a high solids content (for example, about 80 wt % to about 90 wt % solids). In such embodiments, adding smaller volumes of diluent may be desired, perhaps in combination with low-viscosity solvent-borne monomers. In one or more embodiments, the amount of diluent that is selected for use in the pre-cured composition is, in part, dependent on the processibility requirements of the pre-cured composition, and/or the type of surface or substrate the coating is to be formed on.

In one or more embodiments, the diluent is present in the pre-cured composition at a range of about 1 wt % to about 35 wt %; or at any wt %, or any range of wt % between about 1 wt % and about 35 wt %. In other embodiments, the diluent makes up about 1 wt % to about 15 wt % of the pre-cured composition. In other embodiments, the diluent make up about 1 wt % to about 20 wt % of the pre-cured composition.

In some embodiments, the diluent comprises, or consists essentially of, or consists of a reactive diluent that is reactive in a polymerization of solvent-borne monomers/epoxy resins, a non-reactive diluent, or a combination thereof. The type of diluent, or combination of diluent that is selected for use in the pre-cured composition is, in part, dependent on the performance requirements of the cured coating, and/or the type of surface or substrate the coating is to be formed on. In some embodiments, a reactive diluent may be selected if preserving or increasing the mechanical strength (for example, hardness and/or toughness) of the cured coating is desired, for example, because the diluent becomes incorporated into the polymerization. In other embodiments, a reactive diluent may be selected if it is desirable to use a non-volatile diluent, because the diluent is not a volatile organic compound (VOC). In some embodiments, a non-reactive diluent may be selected to reduce costs, as they are generally less expensive than reactive diluents. In other embodiments, a non-reactive diluent may be selected to reduce or prevent air bubbles from being trapped within the cured coating, thereby reducing the porosity of the cured coating. In one or more embodiments, the reactive diluents contribute to the solids content of the cured coating, and the non-reactive diluents do not.

In one or more embodiments, the diluent comprises about 10 wt % volatile organic compounds, or <10 wt % volatile organic compounds. Volatile organic compounds (VOC) are compounds that have a high vapour pressure, that may participate in the photochemical formation of ozone in the presence of heat (for example, as ground-level smog). Examples of VOC sources include organic solvents, industrial coating operations, paints, household chemicals, etc. Some VOCs are understood to low photochemical reactivity, such that changes in their emissions may have limited effects on ozone generation. Such VOCs may be excluded from the VOC definition for certain regulatory purposes, and thus are considered ‘VOC-exempt’ as listed by the United States Environmental Protection Agency. As such, in one or more embodiments, a combination of reactive and non-reactive diluent may be selected for pre-cured compositions comprising lower amounts of VOC components, wherein a lower amount of a non-reactive diluent and a higher amount of a reactive diluent is used. In some embodiments, such combinations of reactive and non-reactive diluents may be selected to reduce the environmental impact of the cured coating and/or to decrease off-gassing explosion risk.

Reactive diluents of the present disclosure are diluents that are reactive in a polymerization of solvent-borne monomers/epoxy resins; for example, in an epoxide polymerization, such that they become incorporated into the polymerization of at least the solvent-borne monomers as the pre-cured compositions are cured to form cured coatings. In some embodiments, the reactive diluents are reactive in a polymerization of solvent-borne monomers because they comprise functional groups that can at least react with the solvent-borne monomers, such as an epoxide functional group (which may otherwise be referred to as a glycidyl ether group), an acrylate functional group, an maleimide functional group, a hydroxyalkyl functional group, or a hydroxide functional group, otherwise referred to as a hydroxyl functional group, etc.

In one or more embodiments, the reactive diluents comprises poly[(phenyl glycidyl ether)-co-formaldehyde], alkyl (C12-C14) glycidyl ether (for example, EPODIL 748®), phenyl glycidyl ether, alkenyl-substituted phenyl glycidyl ether (for example, Ultra Lite 513 ®), butyl glycidyl ether (for example, Epodil 741®), 2-ethylhexyl glycidyl ether, o-cresol glycidyl ether, cycloaliphatic glycidyl ether, 1,2-epoxy-3-phenoxypropane; epoxy-functional polydimethylsiloxane (for example, Tegomer E-SI 2330®, BYK Silclean 3701®), silicone-amine (for example, Silamine D2 EDA, Silamine D208 EDA), or a combination thereof. In some embodiments, the reactive diluent comprises butyl glycidyl ether, alkyl (C12-C14) glycidyl ether, or a combination thereof.

In one or more embodiments, the reactive diluent comprises butyl glycidyl ether, C12-14 aliphatic glycidyl ether, phenyl glycidyl ether, alkenyl-substituted phenyl glycidyl ether, 2-ethylhexyl glycidyl ether, o-cresol glycidyl ether, cycloaliphatic glycidyl ether, 1,2-epoxy-3-phenoxypropane; epoxy-functional polydimethylsiloxane, or a combination thereof. In one or more embodiments, the reactive diluent comprises butyl glycidyl ether, C12-14 aliphatic glycidyl ether, or a combination thereof. In one or more embodiments, the reactive diluent is present in the pre-cured composition in a range of about 1 wt % to about 15 wt %, or about 1 wt % to about 10 wt %, or about 5 wt % to about 10 wt %, or about 1 wt % to about 5 wt %, based on Part A wt %; or in a range of about 1 wt % to about 10 wt %, or about 2 wt % to about 8 wt %, based on total wt %; or at any wt %, or any range of wt % between about 1 wt % to about 15 wt %, based on Part A wt % or total wt %.

In contrast to reactive diluents, non-reactive diluents of the present disclosure are not reactive in a polymerization of solvent-borne monomers/epoxy resins, such that the diluents do not comprise reactive functional groups. In one or more embodiments, the non-reactive diluents are organic solvents. In some embodiments, the non-reactive diluent (for example, benzyl alcohol) catalyze the polymerization of the pre-cured compositions as they are being cured to form cured coatings (for example, via reactive functional groups, such as hydroxyl functional groups (OH), etc.). In some embodiments, the non-reactive diluents evaporate from the curing composition and/or cured coating, which is sometimes referred to as known as off-gassing. In other embodiments, the non-reactive diluents can become entrapped during said polymerization. For example, the non-reactive diluents may be retained in the microstructure of the cured coatings. In some embodiments, this may be less desirable; depending on the volume of diluent retained, retention of the diluent may be detrimental to the coating (for example, by acting as a soft phase within the coating and reducing its hardness) and wear resistance. In some embodiments, upwards of 30 wt % of the non-reactive diluents may be retained before having a detrimental impact on the coating; however, generally, for every 5 wt % of diluent added, it can be expected that the hardness of cured coating will decrease by 3 D-shore hardness points.

In some embodiments, the non-reactive diluents comprise xylene, cyclohexane, toluene, methyl acetate, tert-butyl acetate, nonyl phenol, cyclohexanedimethanol, n-butyl alcohol, benzyl alcohol, isopropyl alcohol, ethylene glycol (for example, LIPOXOL 200, LIPOXOL 400 LIPOXOL 600), propylene glycol, phenol, methylstyrenated phenol (for example, KUMANOX-3114®), styrenated phenol (for example, KUMANOX-3111 F®), C12-C37 ether (for example, NACOL ETHER 6®, NACOL ETHER 8®), low-viscosity hydrocarbon resin (for example, EPODIL LV5®), aryl polyoxyethylene ether (for example, Pycal 94®), or a combination thereof. In some embodiments, the non-reactive diluent comprises benzyl alcohol, xylene, methyl acetate, or a combination thereof.

In some embodiments, the non-reactive diluents comprise xylene, cyclohexane, toluene, methyl acetate, methyl ethyl ketone, tert-butyl acetate, nonyl phenol, cyclohexanedimethanol, n-butyl alcohol, benzyl alcohol, isopropyl alcohol, polyethylene glycol, propylene glycol, phenol, or a combination thereof. In some embodiments, the non-reactive diluents comprise comprises benzyl alcohol, xylene, methyl ethyl ketone, methyl acetate, ethers, aromatic solvents, or a combination thereof. In one or more embodiments, the non-reactive diluent is present in the pre-cured composition in a range of about 1 wt % to about 20 wt %, or about 1 wt % to about 10 wt %, or about 5 wt % to about 20 wt %; or about 5 wt % to about 15 wt %, based on Part A wt %; or in a range of about 1 wt % to about 25 wt %, or about 5 wt % to about 20 wt %, or about 5 wt % to about 15 wt, based on total wt %; or at any wt %, or range of wt % between about 1 wt % to about 25 wt %, based on Part A wt % or total wt %.

In one or more embodiments, the non-reactive diluents are non-VOCs (non-volatile organic compounds), such as benzyl alcohol, which may reduce off-gassing from the cured coating. In one or more embodiments, the non-reactive diluent may be selected based on whether it is VOC-exempt in a jurisdiction, such as methyl acetate. In some embodiments, use of a non-VOC or VOC-exempt diluent may reduce the environmental impact of the pre-cured composition and/or the cured coating.

### Wear-Inhibitors

One or more embodiments of the present disclosure provides pre-cured compositions further comprising a wear-inhibitor. A wear-inhibitor is included in the pre-cured composition to provide the cured coatings with improved corrosion resistance, or increased mechanical strength (relative to a control). In one or more embodiments, the wear-inhibitor cooperates with the ceramic performance additive, such as the hollow ceramic spheres and non-hollow ceramics, to impart improved corrosion resistance, or increased mechanical strength.

In one or more embodiments, the wear-inhibitors comprise, or consist essentially of, or consist of graphene nanoplatelets (also referred to as multi-layered graphene flakes), graphite flakes, graphite oxide, graphene, titanium dioxide, microcrystalline magnesium silicate, fumed silica, micronized barium sulphate, or a combination thereof. In some embodiments, the wear-inhibitors comprise, or consist essentially of, or consist of graphite oxide, multilayered graphene flakes (also referred to as graphene nanoplatelets), titanium dioxide, microcrystalline magnesium silicate, fumed silica, micronized barium sulphate, or a combination thereof.

The type and amount of wear-inhibitor that is selected for use in the pre-cured composition is, in part, dependent on the performance requirements of the resultant, cured coating, and/or the type of surface or substrate the coating is to be formed on.

In some embodiments, one or a combination of graphene nanoplatelets, graphite flakes, graphite oxide, graphene, titanium dioxide, microcrystalline magnesium silicate, and micronized barium sulphate may be selected as wear-inhibitors to increase corrosion resistance, as said additives can act as high-barrier fillers. High-barrier fillers can increase the diffusion path of water, oxygen, and/or corrosive ions in a coating, making it difficult for them to reach the surface of a substrate and cause corrosion, thereby increasing the corrosion resistance of the resultant cured coating (relative to a control cured coating). In one or more embodiments, one or a combination of graphite oxide, graphene, multilayered graphene flakes, titanium dioxide, microcrystalline magnesium silicate, fumed silica, micronized barium sulphate, or a combination thereof may be selected as wear-inhibitors to increase cavitation resistance, due at least in part to their corrosion resistant properties. Lessened corrosion of a coated substrate can reduce the occurrence or number of pits or other neucleation sites that could otherwise contribute to cavitation.

In some embodiments, one or a combination of graphene nanoplatelets, graphite flakes, graphite oxide, may be selected as wear-inhibitors. Graphene nanoplatelets (GNPs) are a sub-form of graphene: instead of being one-atom thick, GNPs are thicker and can comprise up to 60 layers of graphene (and be up to about 30 nm thick). Graphene nanoplatelets may be included because they can exhibit a strength about 300 times greater than steel, a hardness that is harder than diamond, and an excellent conduction of heat and electricity, all while being very flexible. Further, graphene nanoplatelets can provide solid lubrication and reduce a coating's coefficient of friction; and/or, can increase a coating's foul-releasing efficacy. In some embodiments, selecting graphene nanoplatelets as a wear-inhibitor can impart improved mechanical strength and/or bending strength to the resultant, cured coatings (relative to a control). Further, graphene nanoplatelets can be manufactured with different flake sizes (for example, from 1 to 100 μm); such as large, thin flakes that have a high surface area. When incorporated into a coating, such large, thin flakes can act as a physical and/or chemical barrier against corrosion. Due to the high surface area, lower concentrations of graphene nanoplatelets are required to provide a barrier against corrosion. In some embodiments, selecting graphene nanoplatelets as wear-inhibitors can impart improved corrosion resistance to the resultant, cured coating (relative to a control).

In some embodiments, one or a combination of titanium dioxide and microcrystalline magnesium silicate may be selected as wear-inhibitors to impart increased corrosion resistance by acting as high-barrier fillers (relative to a control). In some embodiments, selecting titanium dioxide, a microcrystalline magnesium silicate, fumed silica, or a combination thereof as a wear-inhibitor can impart improved mechanical strength to the resultant, cured coatings (relative to a control).

As described above, one or a combination of fumed silica and titanium dioxide, may also be selected to additionally act as ceramic performance additives. In some embodiments, one or a combination of fumed silica, microcrystalline magnesium silicate, and micronized barium sulphate may be selected to additionally act as rheology modifiers. In some embodiments, micronized barium sulphate may be selected to additionally act as a sound dampening additive, and may work with the hollow ceramic spheres to reduce the noise radiation of the cured coating.

In one or more embodiments, the wear-inhibitor is present in the pre-cured composition in a range of about 0.5 wt % to about 5 wt %, or about 0.5 wt % to about 2 wt %, or at any wt %, or any range of wt % between 0.5 wt % and about 5 wt %. In one or more embodiments, the wear-inhibitor is present in the pre-cured composition in a range of about 0.01 wt % to about 1 wt %, or about 0.05 wt % to about 0.5 wt %, or about 0.05 wt % to about 0.8 wt %, based on total wt %; or at any wt %, or any range of wt % between 0.01 wt % and about 1 wt %.

### Hydrophobicity-Modifying Additives

In one or more embodiments of the present disclosure, the pre-cured composition further comprises a hydrophobicity-modifying additive. A hydrophobicity-modifying additive may be included in the pre-cured compositions to increase the hydrophobicity of the cured coatings. Increasing the hydrophobicity of a cured coating may improve the coatings' antifouling/foul-releasing properties (relative to control epoxy-based coatings). In addition to the hydrophobicity-modifying additive, one or more of the herein described hybrid epoxy-siloxane resins and silane adhesion promoters may also increase the hydrophobicity of the resultant cured coatings.

Generally, for fouling to occur, a surface has favorable characteristics for organisms to adhere, as the organisms compete with water for binding to the surface. For some organisms (for example, micro-foulers), there is a zone of minimal bio-adhesion at a surface tension of approximately 22-24 mN/m. A least favorable surface energy for bio-adhesion is around 23 mN m⁻¹, with a range from about 20 to about 25 mN m⁻¹, or from about 20 to 30 mN m⁻¹, where bio-adhesion is minimal due to formation of weak boundary layers between the surface and adhesive proteins of fouling organisms. For example, surfaces comprising methylsilicones generally have a surface energy in this range. Another factor for whether fouling will occur is surface roughness; a smoother surface (for example, defect-free surface) offers less space and surface area for adhesion of fouling organisms to occur.

Generally, surfaces with energies near the range of about 20 to about 25 mNm⁻¹ can reduce the ability of fouling organisms to adhere to the surface because the thermodynamic cost for water to rewet the surface at this value of surface energy is minimized, while the movement of the surface results in removal of weakly bonded foulers by shear stress acting on the coating. By increasing the hydrophobicity of the cured epoxy-based coating, the hydrophobicity-modifying additive contributes to reducing the coating's surface energy (for example, to a range of about 20 to about 25 mN m⁻¹), which can reduce the ability of fouling organisms to adhere to the cured coating, thereby imparting improved antifouling/foul-releasing properties. Hydrophobicity-modifying additives of the present disclosure, as well as the hybrid epoxy-siloxane resins and silane adhesion promoters described herein, may increase the hydrophobicity of the cured epoxy-based coatings due to the components' own hydrophobic properties. In some embodiments, the hydrophobicity properties of the hydrophobicity-modifying additives are, in part, due to the additives comprising alkyl-based or aryl-based functional groups. For example, the hydrophobicity-modifying additives may comprise alkyl-based or aryl-based functional groups comprising a carbon chain length of 1-15, or a carbon ring size of 1-10. In some embodiments, the hydrophobicity properties of the hydrophobicity-modifying additives are, in part, due to the additives having a higher molecular weight (for example, a polymeric additive vs. a small-molecule additive). Without wishing to be bound by theory, one or more of the hydrophobicity-modifying additives, the hybrid epoxy-siloxane resins, silane adhesion promoters described herein may increase the hydrophobicity of the cured coatings due, at least in part, to a moiety of the additive (for example, a moiety that is not reactive in an epoxide polymerization) migrating to the surface of the coating as it cures.

In one or more embodiments, the hydrophobicity-modifying additives are reactive in an epoxide polymerization, such that they become incorporated into the polymerization of at least the epoxy-functional monomers as the pre-cured compositions are being cured. In some embodiments, the hydrophobicity-modifying additives are reactive in an epoxide polymerization because they comprise functional groups that can react with at least the epoxy-functional monomers, such as an epoxy functional group. In other embodiments, the hydrophobicity-modifying additives become entrapped during said polymerization. In some embodiments, the hydrophobicity-modifying additive comprises an epoxy-functional silane, an epoxy-functional polydialkylsiloxane, or a combination thereof.

In some embodiments wherein the hydrophobicity-modifying additive comprises an epoxy-functional silane, an epoxy-functional polydialkylsiloxane, or a combination thereof, the hydrophobicity-modifying additive may further function as a reactive diluent due, at least in part, to their relatively low viscosities (for example, a viscosity less than 1000 cps, such as between about 1 cps to about 800 cps).

In some embodiments, the hydrophobicity-modifying additives are not reactive in an epoxide polymerization, but become embedded as the pre-cured compositions are being cured into a cured epoxy-based coating. In such embodiments, the hydrophobicity-modifying additives may comprise polydimethylsiloxane (PDMS)-silica or fumed-silica, which may be applied (for example, sprayed, brushed, etc.) on to the surface of the coating as it is curing into a cured epoxy-based coating to increase the cured coating's hydrophobic properties.

The type and amount of hydrophobicity-modifying additive that is selected for use in the pre-cured compositions are, in part, dependent on the performance requirements of the cured coating, and/or the type of surface or substrate the coating is to be formed on.

In some embodiments, a Si-based additives is selected for their hydrophobic properties, and are maintained at low concentrations in the pre-cured composition to avoid impacting the mechanical strength of the cured coating. In some embodiments, the hydrophobicity-modifying additive comprises, or consists essentially of an epoxy-functional polydialkylsiloxane. In some embodiments, the epoxy-functional polydialkylsiloxane comprises, or consists essentially of, or consists of epoxy-functional polydimethylsiloxane. Epoxy-functional polydimethylsiloxane, and similar epoxy-functional polydialkylsiloxanes, may be selected when a large reduction in coating surface energy (i.e., large increase in coating hydrophobicity) is required for the cured coating to have increased antifouling/foul-releasing properties (relative to a control cured coating). In some embodiments, to affect the antifouling/foul-releasing properties of the cured coating, the epoxy-functional polydimethylsiloxane is present in the pre-cured compositions in a range of about 0.05 wt % to about 5 wt %, or about 0.5 wt % to about 5 wt %; or about 1 wt % to about 3 wt %; or at any wt %, or any range of wt % between about 0.05 wt % and about 5 wt %, based on Part A wt % or total wt %.

In some embodiments, the hydrophobicity-modifying additive comprises, or consists essentially of an epoxy-functional silane. In some embodiments, the epoxy-functional silane comprises, or consists essentially of, or consists of glycidoxypropyltrimethoxysilane. Glycidoxypropyltrimethoxysilane, and similar epoxy-functional silanes, may be selected to increase adhesion of the cured coatings to a substrate, in addition to increasing coating hydrophobicity. For example, glycidoxypropyltrimethoxysilane may promote adhesion via its trimethoxysilane moiety. Such trimethoxy functional groups are susceptible to hydrolysis, thus forming reactive silanol functional groups that can react with other reactive functional groups, for example, hydroxyl (OH) groups, on the surface of a substrate, thereby promoting adhesion. In some embodiments, to affect the antifouling/foul-releasing properties of the cured coating, the glycidoxypropyltrimethoxysilane is present in a pre-cured composition in a range of about 0.05 wt % to about 5 wt %, or about 0.5 wt % to about 5 wt %; or about 1 wt % to about 3 wt %; or at any wt %, or any range of wt % between about 0.05 wt % and about 5 wt %, based on Part A wt % or total wt %.

### Dispersant

One or more embodiments of the present disclosure provides pre-cured compositions that further comprise a dispersant for dispersing solid components in the composition (for example, see Example 1, Section 1.1, Example 2, Example 3). In some embodiments, the dispersant is included in the pre-cured compositions to maintain the solid components suspended in the composition. In other embodiments, the dispersant is included in the pre-cured compositions to prolong the shelf-life of the compositions. For example, the dispersant may be included to maintain all components of the pre-cured compositions in suspension, such that none of the components settle, or precipitate out of the compositions.

In one or more embodiments of the present disclosure, the dispersant is a polymeric dispersant. In some embodiments, the polymeric dispersant comprises a polymeric non-ionic dispersant, polymeric ionic dispersant, a polymeric pigment dispersant, or a combination thereof. In one or more embodiments, the dispersant comprises ADDITOL VXW 6208® (polymeric non-ionic dispersant), K-SPERSE A504® (polymeric non-ionic dispersant), Disperbyk 140® (polymeric ionic dispersant, alkyl ammonium salt of an acidic polymer), MULTIWET EF-LQ-AP® (polymeric non-ionic dispersant), HPERMER KD6-LQ-MV® (polymeric non-ionic dispersant blend), ECO NatraSense 125 MBAL-LQ-AP® (non-ionic alcohol ethoxylate dispersant), BRIJ-03-LQ-AP® (nonionic alkyl polyglycol ethers dispersant), SP BRIJ 02 MBAL LQ-AP® (nonionic alkyl polyglycol ethers dispersant), ANTI-TERRA-204® (polymeric ionic dispersant, polycarboxylic acid salt of polyamine amides), TEGO Dispers 670® (polymeric non-ionic dispersant), TEGO Dispers 1010® (polymeric non-ionic dispersant), TEGO® Glide 410® (polyether siloxane copolymer); or a combination thereof. In one or more examples, the dispersant comprises ADDITOL VXW 6208® (polymeric non-ionic dispersant), K-SPERSE A504 (polymeric non-ionic graphene dispersant), MULTIWET EF-LQ-AP® (polymeric non-ionic dispersant), HPERMER KD6-LQ-MV® (polymeric non-ionic dispersant blend), BRIJ-03-LQ-AP® (nonionic alkyl polyglycol ethers dispersant), SP BRIJ 02 MBAL LQ-AP® (nonionic alkyl polyglycol ethers dispersant), ANTI-TERRA-204® (polymeric ionic dispersant, polycarboxylic acid salt of polyamine amides), TEGO Dispers 670® (polymeric non-ionic dispersant), TEGO Dispers 1010® (polymeric non-ionic dispersant), TEGO® Glide 410® (polyether siloxane copolymer); or a combination thereof.

The type and amount of dispersant that is selected for use in the pre-cured composition is, in part, dependent on the performance requirements of the cured coating, the types of ceramic performance additives that are used, the types of wear-inhibitors that are used, and/or the required shelf-life of the pre-cured composition.

In one or more embodiments, the dispersant comprises ADDITOL VXW 6208® (polymeric non-ionic dispersant), K-SPERSE A504 (polymeric non-ionic dispersant), Disperbyk 140® (polymeric ionic dispersant, alkyl ammonium salt of an acidic polymer), MULTIWET EF-LQ-AP® (polymeric non-ionic dispersant), HPERMER KD6-LQ-MV® (polymeric non-ionic dispersant blend), ECO NatraSense 125 MBAL-LQ-AP® (non-ionic alcohol ethoxylate dispersant), BRIJ-03-LQ-AP® (nonionic alkyl polyglycol ethers dispersant), SP BRIJ 02 MBAL LQ-AP® (nonionic alkyl polyglycol ethers dispersant), ANTI-TERRA-204® (polymeric ionic dispersant, polycarboxylic acid salt of polyamine amides), TEGO Dispers 670® (polymeric non-ionic dispersant), TEGO Dispers 1010® (polymeric non-ionic dispersant), TEGO® Glide 410® (polyether siloxane copolymer); or a combination thereof.

In some embodiments, the dispersant selected is ADDITOL VXW 6208® (polymeric non-ionic dispersant), TEGO® Glide 410® (polyether siloxane copolymer), or Disperbyk 140® (polymeric ionic dispersant, alkyl ammonium salt of an acidic polymer) any of which may provide a wetting and/or stabilization effect. In one or more embodiments, TEGO® Glide 410® (polyether siloxane copolymer) may also act as a rheology modifier. In some embodiments, the dispersant selected is K-SPERSE A504 (polymeric non-ionic dispersant), which may provide efficient dispersion of pigments, such as sub-micron pigments, or other fine grade solids, such as titanium dioxide or graphene nanoplatelets. In some embodiments, the dispersant selected is MULTIWET EF-LQ-AP® (polymeric non-ionic dispersant, HPERMER KD6-LQ-MV® (polymeric non-ionic dispersant blend), SP BRIJ 02 MBAL LQ-AP® (nonionic alkyl polyglycol ethers dispersant, or BRIJ-03-LQ-AP® (nonionic alkyl polyglycol ethers dispersant), any one of which may act as a wetting agent and/or may provide anti-settling properties depending on the steric nature of the components to be suspended. In some embodiments, the dispersant is ECO NatraSense 125 MBAL-LQ-AP® (non-ionic alcohol ethoxylate dispersant, which may provide improved dispersion for low energy surfaces (for example, hard to wet surfaces), due to the hydrophilic nature of the dispersant. In some embodiments, the dispersant selected is ANTI-TERRA-204® (polymeric ionic dispersant, polycarboxylic acid salt of polyamine amides), TEGO Dispers 670® (polymeric non-ionic dispersant), or TEGO Dispers 1010® (polymeric non-ionic dispersant), any one of which may be based on acrylics, polyester, adducts of polycarboxylic acids and amines, etc. and may provide good dispersion in both aqueous-borne and solvent-borne systems.

In one or more embodiments, the dispersant is present in the pre-cured composition in a range of about 0.1 wt % to about 5 wt %, or about 0.1 wt % to about 4 wt %, or about 0.1 wt % to about 3 wt %; or about 0.1 wt % to about 2 wt %, or about 0.1 wt % to about 1 wt %, or at any wt %, or range of wt % between about 0.1 wt % and about 5 wt %; based on Part A or total wt %.

### Defoamer

One or more embodiments of the present disclosure provides pre-cured compositions that further comprise a defoamer. In some embodiments, the defoamer is included in the pre-cured compositions to reduce or inhibit air entrapment/bubble formation in the cured coatings. In some embodiments, the defoamer is included in the pre-cured compositions to reduce or inhibit foam formation during processing and application of the compositions. Reducing or inhibiting air entrapment/bubble formation in the cured coatings also reduces or inhibits defect formation (for example, reduced roughness; reduced porosity, improved coating uniformity), which may otherwise result in corrosion of the substrate, or cavitation (for example, when the substrate is a propeller).

In one or more embodiments, the defoamer comprises a polymeric defoamer. In one or more embodiments, the defoamer comprises a silicone-based oligomeric defoamer. In some embodiments of the present disclosure, the defoamer comprises a silicone-modified defoamer, or silicone-free defoamer. Defoamers work by penetrating and destroying foam lamellas. In some embodiments, the defoamer comprises BYK-066 N, BYK-1790, ADDITOL VXW 6210 N, TEGO Airex 900, or a combination thereof. In some embodiments, the silicone-modified defoamer comprises, consists essentially of, or consists of BYK-066 N. BYK-066 N is a silicone defoamer for use in solvent-free or solvent-borne coatings. In some embodiments, the silicone-free defoamer comprises, consists essentially of, or consists of BYK-1790. BYK-1790 is a silicone-free, polymer-based defoamer for solvent-free coatings and is suitable for pigmented and unpigmented coating systems. In some embodiments, the silicone-modified defoamer comprises, consists essentially of, or consists of ADDITOL VXW 6210 N. ADDITOL VXW 6210 N is a silicone-modified defoamer that is useful as an anti-foam or air-release defoamer. In some embodiments, the silicone-modified defoamer comprises, consists essentially of, or consists of TEGO Airex 900. TEGO Airex 900 is an organo-modified polysiloxane defoamer that contains fumed silica, and is useful as a deaerator concentrate that combats both micro- and macro-foam.

The type and amount of defoamer that is selected for use in the pre-cured composition is, in part, dependent on the performance requirements of the epoxy-based coating, and/or the bubble-formation tendencies of the cured coating. In one or more embodiments, any one or combination of BYK-066 N, BYK-1790, ADDITOL VXW 6210 N, TEGO Airex 900 may be selected to reduce or inhibit bubble formation in the cured coatings, and/or foam formation during processing and application of the compositions.

In one or more embodiments, the defoamer is present in the pre-cured composition in a range of about 0.1 wt % to about 5 wt %, or about 0.1 wt % to about 1.5 wt %, or about 0.3 wt % to about 1.2 wt %, or about 0.1 wt % to about 1 wt %, or about 1 wt % to about 5 wt %, based on Part A wt % or total wt %, or at any wt % or range of wt % between about 0.1 wt % and about 5 wt %.

### Weather-Resistance Additive

One or more embodiments of the present disclosure provides pre-cured compositions that further comprise a weather-resistance additive. In some embodiments, the weather-resistance additive is included in the pre-cured compositions to provide improved chemical stability to the resultant cured coating, to protect the cured coating from UV-degradation, or to protect the cured coating from heat degradation. In some embodiments, the weather-resistance additive is included in the pre-cured compositions to provide improved UV-stability and thermal stability, wherein the additive may prevent or reduce autocatalytic degradation of the cured coating into which it's incorporated, and any mechanical disintegration that may result; for example, by quenching free radicals formed by thermal or UV irradiation. In some embodiments, the weather-resistance additive may facilitate or improve adhesion promotion to metallic substrates.

In some embodiments, the weather-resistance additive also acts as an adhesion promotor. In one or more embodiments, the weather-resistance additive is included in the pre-cured composition as an adhesion promotor when the ceramic performance additive is added into the composition to improve sound dampening properties of the cured coating, and is thus applied as an undercoat to a substrate. In one or more embodiments, the weather-resistance additive is included in the pre-cured composition when the ceramic performance additive is added into the composition to improve the scratch resistance of the cured coating, and is thus applied as a topcoat to a substrate. In one or more embodiments, the weather-resistance additive is included in the pre-cured composition when the hollow ceramic spheres having a particle size of about 10 μm to about 15 μm are added into the composition to improve the scratch resistance of the cured coating, and is thus applied as a topcoat to a substrate.

In one or more embodiments, the weather-resistance additive comprises a hydroxyphenyl-benzotriazole, a hydroxyphenyl-triazine, or a combination thereof. In one or more embodiments, the weather-resistance additive comprises 95% Benzenepropanoic acid, 3-(2H-benzotriazol-2-yl)-5-(1,1-dimethylethyl)-4-hydroxy-, C7-9-branched and linear alkyl esters and 5% 1-methoxy-2-propyl acetate (for example, Tinuvin 99-2®). In one or more embodiments, the weather-resistance additive comprises 2-(2H-benzotriazol-2-yl)-4,6-bis(1-methyl-1-phenylethyl)phenol (for example, Tinuvin 900®). In one or more embodiments, the weather-resistance additive Comprises®), 2-[4-[2-Hydroxy-3-tridecyloxypropyl]oxy]-2-hydroxyphenyl]-4,6-bis(2,4-dimethylphenyl)-1,3,5-triazine and 2-[4-[2-hydroxy-3-didecyloxypropyl]oxy]-2-hydroxyphenyl]-4,6-bis(2,4-dimethylphenyl)-1,3,5-triazine (for example, Tinuvin 400®). In one or more embodiments, the weather-resistance additive is present in the pre-cured compositions a range of about 0.5 wt % to about 5 wt %, or about 1 wt % to about 5 wt %, or at any wt % or range of wt % between about 0.5 wt % and about 5 wt %; based on Part A wt %.

### Curing Catalyst

One or more embodiments of the present disclosure provides pre-cured compositions that further comprise a curing catalyst. Curing catalysts of the present disclosure are reactive in accelerating curing the pre-cured compositions to form the cured coatings.

In some embodiments, the curing catalyst is reactive in accelerating curing, such that it catalyzes the polymerization and/or crosslinking of the pre-cured composition. In other embodiments, the curing catalyst can catalyze the polymerization and/or crosslinking of the pre-cured composition as well as act as a cross-linker in the reaction. In some embodiments, the curing catalyst can catalyze the polymerization and/or cross-linking of the pre-cured composition at lower reaction temperatures (for example, about −5° C. to about 0° C.). In some embodiments, the curing catalysts are reactive because they comprise functional groups that can react with at least the solvent-borne monomers as the pre-cured compositions are being cured, such as amine functional groups.

In some embodiments, the curing catalyst is used when the solvent-borne monomers used in the pre-cure composition comprise the epoxy-functional epoxide-siloxane monomers. In some embodiments, the curing catalyst may increase cross-linking of the epoxide component of the epoxy-functional epoxide-siloxane monomers.

In some embodiments, the curing catalyst is included in the pre-cured compositions, and does not begin to catalyze the polymerization and/or cross-linking of composition until a hardener is added to the composition (i.e., see Hardener Composition below). In other embodiments, the curing catalyst is included in the hardener composition, and begins accelerating curing upon addition to the pre-cured composition.

In some embodiments, the curing catalyst is used when the hardener selected for curing the pre-cured composition (described below) reacts slowly at or below ambient temperatures (for example, if the hardener is polyamine). In other embodiments, when the selected hardener reacts quickly at or below ambient temperatures (for example, if the hardener is phenalkamine), a curing catalyst may not be needed.

In some embodiments, the curing catalyst comprises an alcohol that may be included in the pre-cured composition or the hardener, such as 2,4,6-tris[(dimethyllamino)methyl]phenol. Using alcohols as the curing catalyst can simplify curing speed adjustments, such that there is no need to recalculate the hardener to epoxy stoichiometry. Alcohol curing catalysts can be added until either the desired reactivity is achieved, or until some performance characteristic of the cured coating declines to an unacceptable level, requiring further reformulation.

In some embodiments, the curing catalyst is included in the pre-cured composition or the hardener if: the curing composition is not completely curing; it was necessary to cure the coating at lower temperatures; and/or the coating is taking too long to cure (for example, 1 week to cure).

In some embodiments, 2,4,6-tris[(dimethyllamino)methyl]phenol may be selected as the curing catalyst. In some embodiments, 2,4,6-tris[(dimethyllamino)methyl]phenol may be added to the hardener to catalyze curing the pre-cured composition. In other embodiments, 2,4,6-tris[(dimethyllamino)methyl]phenol may be selected to catalyze curing the pre-cured composition at lower temperatures. In some embodiments, to affect catalyzing the curing the pre-cured composition, 2,4,6-tris[(dimethyllamino)methyl]phenol is present in the hardener in a range of about 1 wt % to about 5 wt %; or at any range of wt % between about 1 wt % and about 5 wt %.

In some embodiments, wet/dry adhesion promoters may also act as curing catalysts. In some embodiments wherein the wet/dry adhesion promoter comprises a mercaptane-comprising polymer or pre-polymer, or a combination thereof (also referred to herein as CAPCURE® 3-800 or CAPCURE® 40 SEC HV (Huntsman)), said wet/dry adhesion promoter may also act as a curing catalyst. In some embodiments, wherein the weather-resistance additive (which can also act as a wet/dry adhesion promoter) comprises 95% Benzenepropanoic acid, 3-(2H-benzotriazol-2-yl)-5-(1,1-dimethylethyl)-4-hydroxy-, C7-9-branched and linear alkyl esters and 5% 1-methoxy-2-propyl acetate (also referred to as Tinuvin 99-2® or Tinuvin 900®), said weather-resistance additive may also act as a curing catalyst.

### Hardener Composition

In one or more embodiments of the present disclosure, one or more pre-cured compositions can be used to form cured coatings by reacting the compositions with a hardener composition, the hardener composition comprising a hardener and optionally a diluent.

In one or more embodiments, the hardener is reactive in curing the composition to form a coating having a resistance to abrasive treatment with organic solvents of at least 50 passes when measured according to ASTM D1640. In one or more embodiments, the hardener is reactive in curing the composition to form a coating having a resistance to abrasive treatment with organic solvents of between about 50 to 80 passes when measured according to ASTM D1640. In some embodiments, the hardener is reactive in curing the composition to form a coating having a resistance to abrasive treatment with organic solvents of at least 50 passes when cured at room or ambient temperature. In some embodiments, the hardener is reactive in curing the composition to form a coating having a resistance to abrasive treatment with organic solvents of at least 50 passes when cured at room or ambient temperature, 20 hours following application.

In one or more embodiments, the hardener is present in the hardener composition a range of about 70 wt % to about 100 wt %. In one or more embodiments, wherein the hardener composition comprises a diluent, the diluent comprises a non-reactive diluent, such as methyl acetate, xylene, or a combination thereof. In one or more embodiments, wherein the hardener composition comprises a diluent, the diluent comprises xylene, benzyl alcohol, methyl ethyl ketone, methyl acetate, ethers, aromatic solvents, or a combination thereof. In one or more embodiments, wherein the hardener composition is to be stored before use, the diluent comprises xylene, benzyl alcohol, ethers, aromatic solvents, or a combination thereof. In some embodiment, use of the diluent methyl ethyl ketone, methyl acetate, or a combination thereof may reduce the shelf-life or storage stability of the hardener composition.

In one or more embodiments, the diluent is present in the hardener composition in a range of about 1 to 30 wt %, or about 1 to 25 wt %, or about 5 to 25 wt %, about 10 to 25 wt %; or about 1 to 5 wt % of the hardener composition; or at any wt % or range of wt % between about 1 to about 30 wt %. In one or more embodiments, the diluent is present in the hardener composition in a range of about 1 to 30 wt %, or about 1 to 20 wt %; or at any wt % or range of wt % between about 1 to about 30 wt %. In some embodiments, the diluent is present in the hardener composition a range of about 1 to 30% wt %. In some embodiments, the diluent comprises xylene, which is present in a range of about 1 wt % to about 5 wt %; and comprises methyl acetate, which is present in a range of about 10 wt % to about 25 wt %.

Hardeners of the present disclosure can trigger, and in some cases participate in the curing reaction (for example, the polymerization and/or crosslinking of at least the solvent-borne monomers) that converts the pre-cured composition into an infusible, insoluble polymer network that is the cured coating. In some embodiments, the hardeners participate in the curing reaction by acting as cross-linkers. Generally, curing involves crosslinking and/or chain extension through the formation of covalent bonds between individual chains of polymer (for example, formed by polymerizing at least the solvent-borne monomers), thereby forming rigid, three-dimensional structures and high molecular weights (for example, a cured coating).

In one or more embodiments, the polymerization and/or crosslinking triggered and/or participated in by the hardener, resulting in a higher molecular weight, cross-linked cured coating, contributes to the coating's hardness and/or resistance to abrasive treatment with organic solvents.

Hardeners of the present disclosure are reactive in a polymerization of solvent-borne monomers, such as an epoxide polymerization, such that they can become incorporated into the polymerization (for example, as a cross-linker) of at least the solvent-borne monomers as the pre-cured compositions are cured to form cured coatings. In some embodiments, the hardeners are reactive in polymerization because they comprise functional groups that can at least react with the solvent-borne monomers, otherwise referred to herein as solvent-borne epoxy resins, such as an amine functional group, or an amide functional group, or a silane functional group.

Hardeners of the present disclosure begin triggering the curing reaction upon addition to the pre-cured composition. As such, the pre-cured compositions and hardeners may be provided in two separate containers: one containing the compositions and another containing the hardeners. In some embodiments, these are called bi-component (or “two-component” or “two-part”) resin systems. To use such systems, the pre-cured compositions are first mixed with a hardener, which triggers the cure of the composition into the infusible, insoluble polymer network. The resulting mixture is then applied to a substrate. Generally, application of heat or radiation is not necessary to cure bi-component resin systems. In some embodiments, bi-component resin systems can cure in as little as 2 minutes, or take longer, depending on the nature and concentration of the resin/catalyst/hardener, as well as the curing conditions (for example, cooler temperatures).

In some embodiments of the present disclosure, the hardener comprises an amine hardener, an amide hardener, or a combination thereof. In some embodiments, the hardener is polymeric. In one or more embodiments, the hardener n is a resin reactive in an epoxy polymerization. In such embodiments, the hardener contributes to the total wt % of resin the a curing composition. In other embodiments, the hardener is a small molecule. For example, in some embodiments, the amine hardener, amide hardener, or combination thereof comprises: phenalkamine, amine-modified phenalkamine, phenalkamides, amine-modified phenalkamides, polyamidoamine, organo-modified polyamidoamine, or a combination thereof. In some embodiments, the amine hardener, amide hardener, or combination thereof comprises: Phenalkamine, West System® Hardener Extra Slow 209, West System® 206 Slow Hardener, WEST SYSTEM® 205 Slow Hardener, West System Hardener Fast 205, PRIAMINE 1071-LQ-GD (a polyamine), GX-1120XB80 (KH) (a polyamide), KMH-100 (phenalkamine), DNST, KH 3001-Accelerator (a triamine), EPIKURE 3292FX60, EPIKURE 3253, and GX-1120XB80 (KH) (a polyamide), Cardolite NX-5444 (Phenalkamine), DOCURE KMH-100 (phenalkamine hardener, kukdo chemecal); Ancamide 2832 (Evonik; modified poly-amidoamine), ANCAMIDE®2137 (Evonik, modified poly-amidoamine); Ancamine 2811 (Evonik; amine-modified phenalkamine), Dynasylan TRIAMO (Evonik), Ancamide 3201 (Evonik).

In one or more embodiments, the hardener may be selected to form a coating having a resistance to abrasive treatment with organic solvents of at least 50 passes when measured according to ASTM D1640 and cured at room temperature. In one or more embodiments, the hardener may be selected to form a coating having a resistance to abrasive treatment with organic solvents of between 50 to 80 passes when measured according to ASTM D1640. Hardeners selected to form a coating having a resistance to abrasive treatment with organic solvents may provide fast curing; and in embodiments where the cured coating is applied as an undercoat, may facilitate—in cooperation with an adhesion promoter—improved intercoat, or recoat adhesion with any topcoat applied. In some embodiments, such hardeners include Cardolite NX-5444 (phenalkamine), DOCURE KMH-100 (phenalkamine hardener, kukdo chemecal); Ancamide 2832 (Evonik; modified polyamidoamine), ANCAMIDE®2137 (Evonik, modified polyamidoamine); Ancamine 2811 (Evonik; amine-modified phenalkamine), or Andisil 1100, Dynasylan AMEO (aminopropyltriethoxysilane).

In some embodiments, a particular hardener may be selected if it is desirable: (i) to have more time to apply the pre-cured composition and hardener mixture to a substrate (for example, long working time), and for the cured coating to have good surface finishing (glossy) (A West System Hardener Extra Slow 209); (ii) to have low temperature curing, a fast re-coating window, and short working time (West System Hardener Fast 205); (iii) for the cured coating to have good water resistance, long pot life, increased hydrophobicity, and good surface finishing (glossy), and for the coating to cure at ambient temperatures (PRIAMINE 1071-LQ-GD, a polyamine); (iv) for the cured coating to have a very good surface appearance, and low surface defects, as well as a long curing time (GX-1120XB80 (KH), a polyamide); (v) for the cured coating to be hard and hydrophobic, to use a natural source (green chemistry) for a hardener, and to have low temperature curing (KMH-100, phenalkamine); and/or (vi) to catalyze the curing reaction, for example, in combination with polyamides/polyamines (KH 3001-Accelerator, a triamine; EPIKURE 3253); (vii) to reduce viscosity and get reduce or inhibit bubbles via VOC content (EPIKURE 3292FX60, 60% xylene/butanol; GX-1120XB80 (KH), a polyamide).

In one or more embodiments, a particular hardener may be selected if the epoxy-functional monomers of the pre-cured composition comprise an epoxy-functional epoxide-siloxane monomers, otherwise referred to herein as hybrid epoxy-siloxane resins. When the epoxy-functional monomers are an epoxy-functional epoxide-siloxane monomer, the hardener selected may comprise a silamine hardener, otherwise referred to as an aminosilane hardener. Silamine hardeners comprise silane functional groups (for example S—H), and amine functional groups, such as primary and secondary amine groups. Without wishing to be bound by theory, the silane functional groups may crosslink with the siloxane side-chains of the epoxy-functional epoxide-siloxane monomer during curing; and/or the amine functional groups may crosslink with the epoxy functional groups of the epoxy-functional epoxide-siloxane monomer during curing.

In one or more embodiments, the silamine hardener may be selected from aminopropyltriethoxysilane (Andisil 1100, or Dynasylan® AMEO), bis(3-triethoxysilylpropyl)amine (Dynasylan 1146), or N-2-aminoethyl-3-aminopropyltrimethoxysilane (Dynasylan DAMO), or a combination thereof. In one or more embodiments, the silamine hardener may be selected from aminopropyltriethoxysilane (Andisil 1100, or Dynasylan® AMEO), bis(3-triethoxysilylpropyl)amine (Dynasylan 1146), or N-2-aminoethyl-3-aminopropyltrimethoxysilane (Dynasylan DAMO), triamino-functional propyltrimethoxysilane (Dynasylan TRIAMO (Evonik)), or a combination thereof. In one or more embodiments, the amount of silamine hardener used to cure the pre-cured composition is calculated based on the amine equivalent weight of the hardener, where the epoxy-to-amine ratio is maintained equimolar (for example, see below).

In one or more embodiments when the hardener comprises an amine hardener such as phenalkamines, the stoichiometric ratio of monomer (for example, epoxy-functional monomer) to hardener is an non-equimolar stoichiometric ratio or about 1.2-1.6, or about 1.4-1.6. In one or more embodiments when the hardener comprises an amine hardener, the stoichiometric epoxy group/NH ratio is about 1.2 to about 1.4, or about 1.2. In one or more embodiments wherein the hardener comprises polyamidoamine, the stoichiometric ratio of monomer (for example, epoxy-functional monomer) to hardener is an equimolar stoichiometry (ratio 1.0). In one or more embodiments wherein the hardener comprises aminopropyltriethoxysilane or triamino-functional propyltrimethoxysilane, the stoichiometric ratio of monomer (for example, epoxy-functional monomer) to hardener is an equimolar stoichiometry (ratio 1.0). In one or more embodiments wherein the hardener comprises aminopropyltriethoxysilane or triamino-functional propyltrimethoxysilane, the epoxy group/NH ratio of about 0.9 to about 1.1, or about 1.

In some embodiments, the hardener is selected such that the degree of crosslinking that occurs during the curing of the pre-cured composition is about 60% to about 99%, or about 70% to about 99%, or about 80% to about 99%, or about 90% to about 99%, or about 99%.

In some embodiments, the hardener is reactive in curing the pre-cured compositions to form a cured coating at temperatures between about −5° C. to about 100° C. In some embodiments, the hardener is reactive in curing the pre-cured compositions to form a cured epoxy-based coating at ambient temperatures and conditions. In other embodiments, the hardener is selected such that the pre-cured composition can be cured at lower reaction temperatures (for example, about −5° C. to about 0° C.). In some embodiments, the hardener comprises phenalkamine.

In some embodiments, to affect curing of the pre-cured compositions, hardeners of the present disclosure are added to the composition at a ratio of resin to hardener of 1:1 to 1:1/5; or 1:2.3 to 1:3. In some embodiments, a ratio of 1:2.3 to 1:3 may be selected to increase the rate of the curing reaction, which can facilitate curing at lower temperatures. In some embodiments, hardeners of the present disclosure are added to the composition at a ratio of resin to hardener 1:1 up to 1:2, or are added at an epoxy group/NH ratio between about 1.2 to 1.4. Ratios of 1.1 to 1.2, or 1.2 to 1.4 use less hardener, and use of less hardener may improve recoating window, decrease the rate of the curing reaction, and/or increase flexibility of the cured coating. In other embodiments, using less hardener relative to the resin may lead to an incomplete curing reaction, low mechanical properties, and/or an non-functional coating; whereas, using too much hardener relative to the resin can accelerate the curing reaction, and can leave unreacted hardener on the coating, causing a loss or reduction in coating function.

In one or more embodiments of the present disclosure, any one or more of the graphene nanoplatelets, the adhesion promoters, the dispersants, the defoamers, the rheology modifiers, the curing catalysts—not including additives reactive in a polymerization of solvent-borne monomers, the other wear-inhibitors the hollow ceramic spheres, or the other ceramic performance additives—can be first added to and/or dispersed in the hardener prior to being added to any one or more of the pre-cured compositions of the present disclosure.

### Method and Application to Substrate

As described above, one or more embodiments of the present disclosure provides a method for forming one or more of the pre-cured compositions.

In one or more embodiments of the present disclosure, the method comprises mixing together solvent-borne resins, a diluent, an adhesion promoter, a rheology modifier, and a ceramic performance additive; and forming the composition for a coating. In one or more embodiments, the method further comprises mixing in a dispersant, a defoamer, and/or a wear inhibitor.

In one or more embodiments of the present disclosure, the method comprises mixing together solvent-borne monomers, a diluent, an adhesion promoter, and hollow ceramic spheres; and forming the composition for a coating. In some embodiments, the method further comprises mixing in a rheology modifier, a dispersant, a defoamer, and/or a wear inhibitor. In some embodiments, when a wear-inhibitor is mixed in, mixing together the solvent-borne monomers, diluent, adhesion promoter, and hollow ceramic spheres comprises mixing together the solvent-borne monomers, diluent, and adhesion promoter; grinding the wear-inhibitor, and mixing the ground wear-inhibitor into the mixture of the solvent-borne monomers, diluent, and adhesion promoter; and mixing in the hollow ceramic spheres.

In one or more embodiments, the method of forming one or more of the pre-cured compositions involves the following (for further details, see Example 1). Main components of the pre-cured coating include A) Resin paste, B) Wear-Inhibitor base, C) Letdown/Diluents paste (for example, non-reactive diluents and some additional resin), D) Hardener paste. Pastes A, C, and D may be produced in bulk by blending raw materials in a designated order, using a blade high-speed mixer; for example, Cowles or Ross models. Compositions of these pastes may be maintained constant. The wear-inhibitor base includes wear-inhibitors such as titanium dioxide, graphene, graphite, micronized barium sulphate, etc. In some embodiments, the wear-inhibitors are added one by one to the designated amount of paste A. This may instigate a spike in the viscosity of the resulting mill-base, therefore intermittent addition of the Paste C into the mill-base may be preferred. In some embodiments, every ⅓ of the Base B added to the mill-base is followed by the addition of ⅓ of the Paste C. During Base B addition, the powders may be pre-blended at blade speeds not exceeding 600-800 rpm. Once Base B is added and pre-mixed, the grinding stage may ensue, with blade revolutions adjusted to 2,500-3,000 rpm and the duration of the grinding step not to exceed 10-15 minutes, depending on the batch size. The hollow ceramic spheres are added between or during the addition of Bases B and C. The spheres are added and mixed at about 2000-3000 rpm to provide good dispersion and to minimize or avoid crushing of the spheres. In some embodiments, the efficiency of the grinding step may be detected using a Hegman spread gauge. In some embodiments, when a rheology modifier is added to the composition, the temperature is kept between about 55-60° C. In some embodiments, maintaining the temperature in this range facilitates a phase change from crystalline to amorphous for the rheology modifier. In some embodiments, the final product is supplied via a 2-component kit in the quantities as requested by the end customer.

One or more embodiments of the present disclosure provides for coating a surface of a substrate with a pre-cured composition mixed with a hardener, referred to herein as a curing composition. In some embodiments, this involves a) cleaning and drying the surface, b) optionally applying at least one primer coat to the surface, c) applying at least one coat of the curing composition on top of the optional primer coat(s); and optionally applying at least one functional topcoat, to produce a cured, coating. The substrate to be coated may be of various natures, such as metal (for example steel), ceramic, fiberglass, carbon fiber, wood, and plastic.

In some embodiments of the present disclosure, the substrate (once coated) is for use in a wet environment. Such an environment is one in which the substrate comes regularly in contact with water. Examples of substrates may include sensors to track water parameters (such as temperature, depth, salinity, dissolved gases, pH, and others in oceans, estuarine and coastal ecosystems, freshwater environments), automobile parts, agriculture equipment, aquiculture equipment, water-power generation equipment, and oil-gas industry equipment. Examples of marine equipment include boats, ships and vessels, in particular the hulls, ballasts, and propellers thereof, buoys, fish traps, underwater equipment (including underwater robotic equipment, sensors, etc.), submarines, etc. In some embodiments, the substrate includes marine equipment, preferably ship hulls or propellers.

In some embodiments, the surface of the substrate to which the curing composition will be applied is prepared by cleaning, drying and abrading it. For example, first the surface is cleaned so that it is free of contaminants such as grease, oil, wax, or mold. In some embodiments, it the surface is to be sanded, the surface is cleaned before it is sanded to avoid abrading contaminant(s) into the surface. Secondly, the surface is dried, as much as possible, to help promote adhesion of the cured coating. Then, especially in the case of hardwoods and non-porous surfaces, the surface is abraded, for example by sanding so that is become rough as this also promotes adhesion of the cured coating. In other embodiments, a surface is prepared to be coated via one of the following standards: SSPC-SP1, SSPC-SP2, SSPC-SP-5, SSPC-SP WJ-1/NACE WJ-1, and/or SSPC-SP16.

A curing composition of the present disclosure may be applied to a substrate as follows. First, a substrate, prepared as described above, is provided. Then, a primer coating is optionally applied, generally in one or two coats, on the substrate. One or more coats (preferably two or more) of the curing composition is applied on the optional primer coating, or applied on the substrate, to form a cured coating. In some embodiments, the coating is formed on the primer coating. When a primer coating is used, the primer needs to be compatible with the curing composition, such that the cured coating will adhere to the primer. In other embodiments, the coating is formed on the substrate. Once formed on the substrate, the cured coating may form a topcoating (for example, the cured coating is in direct contact with the environment); or the cured coating may form an undercoating to which a functional topcoating may be applied. In some embodiments, a curing composition of the present disclosure may be applied to a substrate according to one or more of the following standards or acts: SSPC-SP-1, SSPC-SP-11, SSPC-SP-5, SSPC-SP WJ-1/NACE WJ-1, SSPC-SP WJ-2/NACE WJ-2, SSPC-SP WJ-3/NACE WJ-3, SSPC-SP WJ-4/NACE WJ-4, SSPC-VIS-3, SSPC-VIS-4, SSPC-PA-2 LEVEL 3, SSPC-GUIDE 15, SSPC-GUIDE 6, NACE RPO 287-95, ASTM D-4285, Occupational Safety And Health (Part 11, Canada Labour Code; Policy Volume Of The Tb Manual); Canadian Environmental Protection Act, and Canadian Fishery Act.

In some embodiments of the present disclosure, the curing composition is applied uncured (or partially cured) to a substrate, and is then allowed to cure via reaction with a hardener to form the cured coating. The curing composition can be applied to the substrate by a variety of coating techniques, including painting, brushing, spraying, rolling, or dipping the composition on the substrate. The cured coatings formed from the curing composition can be from about 1 μm to about 400 μm in thickness, preferably from about 100 μm to about 200 μm in thickness; or from about 150 μm to about 200 μm.

Compositions for a Coating, and Coatings thereof

Described herein is a composition for a coating, comprising a solvent-borne epoxy resin; a diluent; an adhesion promoter; an anti-settling rheology modifier; an anti-sagging rheology modifier; and a ceramic performance additive comprising hollow ceramic spheres. In one or more embodiments, the composition further comprises one or a combination of a dispersant, a wear inhibitor, a defoamer, a curing catalyst, and a hardener composition. In one or more embodiments, said composition for a coating attempts to provide a cured coating useful for reducing underwater radiated noise (relative to a control). In one or more embodiments, said composition for a coating attempts to provide a pre-cured composition that can be applied to the hull of a ship, and form a cured coating that is useful for reducing underwater radiated noise (relative to a control) that would otherwise radiate out from the ship's engine and into a marine environment.

In one or more embodiments, the ceramic performance additive comprising hollow ceramic spheres attempts to provide sound dampening properties to coatings formed from the pre-cured composition. In one or more embodiments, the amount of spheres in the pre-cured coating is about 25 to 35 wt %, based on total wt %. In one or more embodiments, a wt % between about 25 wt % to about 35 wt % is a sufficient amount of hollow ceramic spheres to provide a coating that reduces radiated noise by about 5 dB to about 7 dB/100 μm (relative to control). In one or more embodiments, a coating comprising hollow ceramic spheres at a wt % between about 25 wt % to about 35 wt %, applied at a coating thickness of about 200 to about 300 micron, provided a reduction in radiated noise up to about 9 dB.

In one or more embodiments, if the amount of spheres in the pre-cured coating is about 45 wt % or higher, based on total wt %, there may not be sufficient resin in the composition; and the resultant cured coating may otherwise be more permeable to water, ions, or other components in a marine environment, and thus may become more susceptible to corrosion, to blistering, and/or to flaking off. In one or more embodiments, the pre-cured composition comprises at least 15 wt % to 20 wt % of the solvent-borne resin, based on Part A wt % to facilitate formation of a less permeable cured coating that may have an underwater life-time of at least 5 years.

In one or more embodiments, a curing composition comprising the pre-cured composition is applied to a substrate, such as a hull of a marine vessel. In one or more embodiments, the curing composition is applied at a coating thickness of about 200 to about 500 micron, or about 200 to about 500 micron, or about 200 to 300 micron, or about 250 micron. The curing composition may be applied directly to the substrate, which may be metal (for example, steel). The curing composition may be applied to a primed substrate, where the substrate has already been coated with a primer. Sufficient substrate adhesion or overcoat adhesion of the curing composition, and resultant cured coating, to the substrate or primed substrate reduces delamination, and/or flaking off of the cured coating from the substrate. In one or more embodiments, the adhesion promoter is included in the pre-cured composition to facilitate this adhesion. In one or more embodiments, the combination of the adhesion promoter and hardner in the curing composition facilitates this adhesion. In one or more embodiments, the hardener comprises an amine hardner, such as amine-modified phanelkamine.

In one or more embodiments, the pre-cured composition comprising hollow ceramic spheres is provided to form a cured undercoating. In one or more embodiments, the cured undercoating exhibits sound dampening properties, but not topcoat properties such as foul-releasing, surface-leveling, etc. In one or more embodiments, a topcoating is applied over the cured or curing undercoating. In one or more embodiments, the topcoating that is applied to the cured or curing undercoating is selected to offer anti-fouling/foul release properties. In one or more embodiments, the topcoat applied to the curing or cured undercoat may comprise a coating as described in PCT Application No. PCT/CA2021/000042 entitled ‘Composition For A Coating, Coatings And Methods Thereof’. In one or more embodiments, the epoxy/NH ratio in the curing composition between the epoxy resin and amine hardener is between about 1.2 to about 1.4. In one or more embodiments, having the epoxy/NH ratio in the curing composition between about 1.2 to about 1.4 provides a sufficient recoat adhesion window of about 4 to 72 hours that the topcoating being applied may adhere well to the undercoating (for example, have a good recoat adhesion).

In one or more embodiments, the anti-settling rheology modifier of the pre-cured composition attempts to reduce sedimentation of at least the hollow ceramic spheres. By reducing sedimentation, the anti-settling rheology modifier of the pre-cured composition may increase shelf-life, or long-term storage stability of the pre-cured coating. In one or more embodiments, the anti-sagging rheology modifier of the pre-cured composition attempts to reduce or prevent sagging of the curing composition while it is being applied to a substrate, such as the hull of a boat. Absent this, the thickness of the final cured coating may be distributed inconsistently across the entire coated substrate, which may reduce the sound dampening properties of the coating.

In one or more embodiments, the solvent-borne the epoxy resin comprises a bisphenol A epoxy resin, a bisphenol F epoxy resin, a bisphenol S epoxy resin, a cycloaliphatic polyglycidyl ether-modified epoxy resin, a cycloaliphatic polyglycidyl ether resin having a viscosity in a range of about 350 to about 550 cps, a cycloaliphatic polyglycidyl ether-modified resin having a viscosity in a range of about 400 to about 1000 cps, an aliphatic glycidyl ether-modified epoxy resin having a viscosity in a range of about 800 to about 1000 cps, or a combination thereof. In one or more embodiments, the adhesion promoter comprises an alkoxylated silane, the silane being optionally reactive in a epoxy polymerization; a hydroxyphenyl-benzotriazole, a hydroxyphenyl-triazine, or a combination thereof. In one or more embodiments, the anti-settling rheology modifier comprises fumed silica, fumed silica surface modified with silane, fumed silica surface modified with dimethyldichlorosilane; aluminum phyllosilicate clay; organo-modified derivative of aluminium phyllosilicate clay; organo-modified bentonite clay; organo-modified montmorillonite clay; or a combination thereof, In one or more embodiments, the an anti-sagging rheology modifier comprises a polyamide wax, a micronized polyamide wax, a micronized organo-modified polyamide wax, a micronized organo-modified polyamide wax derivative, or a combination thereof. In one or more embodiments, the hollow ceramic spheres have a particle size of about 20 μm to about 40 μm, or about 25 μm to about 35 μm. In one or more embodiments, the hardener comprises phenalkamine, amine-modified phenalkamine, or a combination thereof.

In one or more embodiments, coatings formed from the pre-cured composition have a bending strength of at least 10 mm, or at least 8 mm, or at least 6 mm when measured by a cylindrical bend test.

Described herein is a composition for a coating, the composition comprising a solvent-borne epoxy resin; a diluent; an adhesion promoter comprising a dry adhesion promoter, a wet adhesion promoter, a dry/wet adhesion promoter, or a combination thereof; a rheology modifier comprising an anti-settling rheology modifier; an anti-sagging rheology modifier; surface-leveling rheology modifier, or a combination thereof; and a ceramic performance additive comprising hollow ceramic spheres, non-hollow ceramic particles, or a combination thereof. In one or more embodiments, the composition further comprises one or a combination of a dispersant, a wear inhibitor, a defoamer, a weather-resistance additive, a curing catalyst, and a hardener composition. In one or more embodiments, said composition for a coating attempts to provide a cured coating that is useful for reducing cavitation (relative to a control). In one or more embodiments, said composition for a coating attempts to provide a pre-cured composition that forms a curing composition or cured coating that adheres well to a metal substrate, such as a copper metal substrate or aluminum substrate. In one or more embodiments, said composition for a coating attempts to provide a pre-cured composition that can be applied to a propeller of a ship, and form a cured coating that is useful for reducing cavitation that would otherwise occur when the ship's propeller was in use. In one or more embodiments, said composition for a coating attempts to provide a pre-cured composition that can be applied to a propeller, and form a cured coating that, when applied to a propeller, increases the RMP at which the propeller can rotate before caviatation occurs.

In one or more embodiments, the ceramic performance additive comprising hollow ceramic spheres, non-hollow ceramic particles, or a combination thereof, attempts to provide hardness properties to coatings formed from the pre-cured composition. In one or more embodiments, the ceramic performance additive attempts to provide coatings formed from the pre-cured composition having a hardness of at least 5H when measured according to ASTM D3363, or having a hardness of about 6H to about 8H, or about 8H. In one or more embodiments, the hollow ceramic spheres comprises hollow ceramic spheres having a particle size of about 10 μm to about 40 μm. In one or more embodiments, the non-hollow ceramic particles comprise titanium oxide, fumed silica, brown aluminium (III) oxide, fused aluminium (III) oxide, titanium alloys (such as titanium carbonitride, titanium carbide), or a combination thereof. In one or more embodiments, the hardness of a coating formed from the pre-cured composition is correlated with the cavitation resistance of the coating: the harder the coating is mechanically, the less prone it is to cavitation (for example, per the blistering or boiling tests of Example 3). In one or more embodiments, cured coatings having a hardness of at least 5H, up to 8H retain structural integrity over their service life-time, mitigating erosion and slit-cavitation, and retaining energy efficiency and low-noise profiles for a vessel to which the coating is applied, through reduced cavitation.

In one or more embodiments, the surface-leveling rheology modifier of the pre-cured composition attempts to provide a cured coating formed from the pre-cured composition that is relatively smooth and/or exhibits low-roughness. In one or more embodiments, the leveled surface of a coating formed from the pre-cured composition also correlated with the cavitation resistance of the coating: the smoother the coating surface is, the less prone it is to cavitation (for example, do to fewer nucleation sites or defects on the coating's surface). In one or more embodiments, the anti-settling rheology modifier of the pre-cured composition attempts to reduce sedimentation of at least the ceramic performance additive. By reducing sedimentation, the anti-settling rheology modifier of the pre-cured composition may increase shelf-life, or long-term storage stability of the pre-cured coating. In one or more embodiments, the anti-sagging rheology modifier of the pre-cured composition attempts to reduce or prevent sagging of the curing composition while it is being applied to a substrate, such as the propeller of a boat. Absent this, the thickness of the final cured coating may be distributed inconsistently across the entire coated substrate, which may reduce the sound dampening properties of the coating.

In one or more embodiments, the pre-cured composition is applied to a metal substrate, or a primed metal substrate. In one or more embodiments, the metal substrate or primed metal substrate is a propeller of a ship. In one or more embodiments, wherein the pre-cured composition is applied to a metal substrate, it is a one-coat system. In one or more embodiments, the pre-cured composition in the one-coat system is formulated to comprise primer-coating properties (for example, by use of adhesion promoters). In one or more embodiments, the curing composition is applied at a coating thickness of about 100 to about 200 micron, or about 125 to about 150 micron. In one or more embodiments when the pre-cured composition is applied to a primed metal substrate, it is a two-coat system where the second coat is a primer coating. In one or more embodiments, the pre-cured composition is applied to a metal substrate, or a primed metal substrate as a topcoating. In one or more embodiments, as a topcoating, the pre-cured composition is formulated to exhibit wear-inhibiting, anti-corrosion, and/or anti-fouling/foul release properties. In one or more embodiments, when the pre-cured composition is applied directly to a metal substrate, the pre-cured composition comprises at least one of the adhesion promoter comprising a dry adhesion promoter, a wet adhesion promoter, a dry/wet adhesion promoter, or a combination thereof. In one or more embodiments, when the pre-cured composition is applied to a primed metal substrate, both the primer coating applied to the metal substrate and the pre-cured composition comprises at least one of the adhesion promoter comprising a dry adhesion promoter, a wet adhesion promoter, a dry/wet adhesion promoter, or a combination thereof.

In one or more embodiments, the adhesion promoter comprising a dry adhesion promoter, a wet adhesion promoter, a dry/wet adhesion promoter, or a combination thereof attempts to provide a curing composition or cured coating formed from the pre-cured composition that adheres well to a metal substrate, such as a copper metal substrate or aluminum substrate. Generally, coatings for use in wet environments tend not to adhere well to metal substrates, However, in one or more embodiments, with use of the adhesion promoter comprising a dry adhesion promoter, a wet adhesion promoter, a dry/wet adhesion promoter, or a combination thereof, a curing composition or cured coating formed from the pre-cured composition adheres to a metal substrate, such as a copper metal substrate or aluminum substrate, with a dry adhesion of about 3 to about 15 MPa, or about 3 to about 10 MPa, to about 3 to about 5 MPa, and/or a wet adhesion of about 4 to about 15 MPa, or about 4 to about 10 MPa, or about 5 to about 7 MPa.

In one or more embodiments, the primer coating that is used in the two-coat system is any primer compatible with the pre-cured composition. In one or more embodiments, the primer coating that is used in the two-coat system is any primer compatible with the pre-cured composition that comprises the adhesion promoter comprising a dry adhesion promoter, a wet adhesion promoter, a dry/wet adhesion promoter, or a combination thereof. In one or more embodiments, the primer coating of the two-coat system comprises a reaction product of a composition for a primer coating and a hardener. In one or more embodiments, the composition for a primer coating comprises an epoxy resin or a urethane resin. In one or more embodiments, the composition for a primer coating comprises an epoxy resin, such as a solvent-born epoxy resin as described herein. In one or more embodiments, the composition for a primer coating comprises at least 10 wt % epoxy resin. In one or more embodiments, the composition for a primer coating comprises an adhesion promoter comprising a dry adhesion promoter, a wet adhesion promoter, a dry/wet adhesion promoter, or a combination thereof. In one or more embodiments, the composition for a primer coating comprises fillers for producing micro-roughness and inducing the gas-liquid barrier properties in the dried primer. In one or more embodiments, the fillers comprise magnesium silicate (talc), wollastonite, barium sulfate, fumed silica, or a combination thereof, in amount not less than 30% wt based on total formula weight; for example, to promote micro-roughness of the primer coating surface, which may facilitate in adhesion with the topcoating formed from the pre-cured composition.

In one or more embodiments, the solvent-borne epoxy resin comprises a hybrid epoxy-siloxane resin. In one or more embodiments, the dry adhesion promoter, the dry/wet adhesion promoter, and/or the wet adhesion promoter are non-reactive, reactive in a epoxy resin polymerization, reactive with a substrate, and/or reactive with metal oxides; or a combination thereof. In one or more embodiments, the dry adhesion promoter is non-reactive, reactive in a epoxy resin polymerization, reactive with a substrate, and/or reactive with metal oxides. In one or more embodiments, the dry adhesion promoter comprises an alkoxylated silane. In one or more embodiments, the dry adhesion promoter comprises an epoxy-functional alkoxylated silane, an amino-functional alkoxylated silane, or a combination thereof. In one or more embodiments, the wet adhesion promoter is reactive with a substrate. In one or more embodiments, the wet adhesion promoter comprises a metal-doped phosphosilicate. In one or more embodiments, the wet adhesion promoter comprises a strontium phosphosilicate; a zinc phosphosilicate, a zinc calcium strontium aluminum orthophosphate silicate hydrate; or a combination thereof. In one or more embodiments, the dry/wet adhesion promoter is non-reactive, reactive with a substrate, and/or reactive with metal oxides. In one or more embodiments, the dry/wet adhesion promoter comprises a modified polyester, a modified polyester oligomer, a polyacrylic, a polyacrylate, a benzotriazole, a mercaptane-comprising polymer or pre-polymer, or a combination thereof. In one or more embodiments, the anti-settling rheology modifier comprises fumed silica, fumed silica surface modified with silane, fumed silica surface modified with dimethyldichlorosilane; or a combination thereof. In one or more embodiments, the anti-sagging rheology modifier comprises a castor oil wax, an organically-modified castor oil-derivative wax, a polyamide wax, a micronized polyamide wax, a micronized organo-modified polyamide wax, a micronized organo-modified polyamide wax derivative, or a combination thereof. In one or more embodiments, the anti-sagging rheology modifier comprises a castor oil wax, an organically-modified castor oil-derivative wax, or a combination thereof. In one or more embodiments, the surface-leveling rheology modifier comprises a polyether siloxane copolymer. In one or more embodiments, the hollow ceramic spheres have a particle size of about 10 μm to about 40 μm; about 20 μm to about 40 μm, or about 25 μm to about 35 μm; or about 10 μm to about 15 μm, or about 12 μm. In one or more embodiments, the non-hollow ceramic particles comprise titanium oxide, fumed silica, brown aluminium (III) oxide, fused aluminium (III) oxide, titanium alloys, or a combination thereof. In one or more embodiments, the non-hollow ceramic particles comprise titanium alloys titanium carbonitride, titanium carbide, or a combination thereof.

In one or more embodiments, coatings formed from the pre-cured composition have a bending strength of at least 10 mm, or at least 8 mm, or at least 6 mm when measured by a cylindrical bend test. In one or more embodiments, a combination of the adhesion promoter and the wear-inhibitor comprising graphite oxide, graphene, multilayered graphene flakes contributes to that bending strength.

As described here, one or more embodiments of the present disclosure attempts to provide a pre-cured composition that can be used to form a coating that exhibits improved intercoat adhesion, a bending strength of at least 10 mm, reduced noise radiation, and/or improved hardness (as indicated by improved scratch resistance) relative to a control.

In one or more embodiments, the adhesion promoter is included in the pre-cured composition to improve flexibility and/or intercoat adhesion of the cured coating resulting from the composition. In some embodiments, the adhesion is included to improve cohesion of the cured coating, where cohesion refers to the mechanical strength of a single cured coating layer, and how much it resists against pull-off forces, compression forces, bending forces, or any other damaging forces. In one or more embodiments, the adhesion promoter is included in an amount sufficient to provide a coating formed from the composition having an intercoat adhesion of at least 5 MPa, or between about 5 MPa to about 10 MPa when measured according to ASTM D4541, or a bending strength of at least 10 mm, or at least 8 mm, or about 6 mm when measured by a cylindrical bend test.

In one or more embodiments, the hollow ceramic spheres are included in the pre-cured composition to improve the sound dampening properties and/or improve the hardness of the cured coating (relative to a control). In one or more embodiments, the hollow ceramic spheres are included at an amount sufficient to provide a coating formed from the composition having reduced noise radiation (for example, sound dampening properties) of about 1 dB to about 50 dB, or to about 40 dB, or to about 20 dB, or to about 15 dB per about 100 μm of coating thickness at frequencies of about 1000 Hz or less, or in a range of about 100 to about 1000 Hz, or about 100 to about 400 Hz; or a hardness of at least 5H, or of about 6H to about 8H when measured according to ASTM D3363.

As described above, underwater radiated noise (URN) includes sound that radiates in a frequency of less than 100 Hz and that can extend up to 10,000 Hz, with marine vessel engines and propellers being main sources. In some instances, the engines can produce low frequencies (for example, 100-1000 Hz) that can disturb large sea animals, and in some instances, the propellers can produce high frequencies (for example, 1000-10,000 Hz) that can disturb smaller marine creatures. Given that low frequency sound has a large wavelength (for example, sound at 100 Hz has a wavelength of nearly 3,000,000 m; and sound at 1000 Hz has a wavelength of nearly 300,000 m). As such, it can be difficult for sound dampening materials that are relatively thin to interact with, and thus reduce noise at low frequencies having such large wavelengths. However, in one or more embodiments of the present disclosure, there is provided a pre-cured composition comprising a sufficient amount of hollow ceramic spheres to provide a coating having reduced noise radiation (for example, of about 1 dB to about 50 dB per about 100 μm of coating thickness when measured on a 3 mm thickness cold rolled steel metal plate relative to an uncoated 3 mm thickness cold rolled steel metal plate) at coating thicknesses less than 500 μm (for example 200 μm) at frequencies of about 1000 Hz or less.

Further, as described above, including hollow ceramic spheres into the pre-cured composition may at least provide improved scratch resistance due to the ceramic sphere's high hardness (for example, 7 on the Mohs Scale). However, a relatively high percent loading of solid components in a composition for a coating can make cured coatings resulting from the composition brittle and inflexible (for example, when the solids-to-binder weight ratio is greater than 2). Yet, in one or more embodiments, there is provided a pre-cured composition comprising a sufficient amount of hollow ceramic spheres to provide a coating having a hardness of at least 5H when measured according to ASTM D3363, and a sufficient amount of an adhesion promoter to provide a bending strength of at least 10 mm. As such, in one or more embodiments, the pre-cured composition provides a coating having a high scratch resistance (as measured by hardness) while also being flexible. In one or more embodiments, there is provided a pre-cured composition comprising solids-to-binder weight ratio is greater than 2 (for example, about 2.3), while still being flexible.

In one or more embodiments of the present disclosure, there is provided a composition for a coating comprising (i) low-viscosity solvent-borne monomers, wherein the monomers comprise epoxy-functional monomers modified with a cycloaliphatic polyglycidyl ether having a viscosity in a range of about 350 to about 550 cps, epoxy-functional monomers modified with a cycloaliphatic polyglycidyl ether having a viscosity in a range of about 400 to about 1000 cps, epoxy-functional monomers modified with an aliphatic glycidyl ether having a viscosity in a range of about 800 to about 1000 cps, or a combination thereof; (ii) a diluent comprising a reactive diluent that is reactive in a polymerization of solvent-borne monomers, a non-reactive diluent, or a combination thereof, wherein the reactive diluent comprises butyl glycidyl ether, alkyl (C12-C14) glycidyl ether, or a combination thereof, and the non-reactive diluent comprises benzyl alcohol, xylene, methyl acetate, or a combination thereof; (iii) a sufficient amount of an adhesion promoter to provide a coating formed from the composition having an intercoat adhesion of at least 5 MPa when measured according to ASTM D4541, or a bending strength of at least 10 mm when measured by a cylindrical bend test, wherein the adhesion promoter comprises an epoxy-functional alkoxylated silane, an amino-functional alkoxylated silane, or a combination thereof; and (iv) a sufficient amount of hollow ceramic spheres to provide a coating formed from the composition having a reduced noise radiation of about 1 dB to about 50 dB per about 100 μm of coating thickness at frequencies of about 1000 Hz or less when measured on a 3 mm thickness cold rolled steel metal plate relative to an uncoated 3 mm thickness cold rolled steel metal plate, wherein the hollow ceramic spheres comprise spheres having a particle size of about 20 μm to about 40 μm, or about 25 μm to about 35 μm, and are present in a range of about 30 wt % to about 70 wt %, or about 35 wt % to about 65 wt %, or about 30 wt % to about 50 wt %, or about 35 wt % to about 50 wt %, or about 45 wt % to about 70 wt %, or about 50 to about 65 wt %. In one or more embodiments, the composition further comprises a rheology modifier, such as aluminum phyllosilicate clay; organo-modified derivative of aluminium phyllosilicate clay; organo-modified bentonite clay; organo-modified montmorillonite clay, such as Claytone-HY® or Claytone-APA®; micronized organo-modified polyamide wax derivative, such as Crayvallac Super®; micronized barium sulphate, such as VB Techno®; microcrystalline magnesium silicate, such as Talc SIlverline 202® or Mistron 002®; or a combination thereof. In one or more embodiments, the composition further comprises a polymeric dispersant, such as a polymeric non-ionic dispersant, polymeric ionic dispersant, a polymeric pigment dispersant, or a combination thereof, wherein the dispersant comprises ADDITOL VXW 6208® (polymeric non-ionic dispersant), K-SPERSE A504 (polymeric non-ionic dispersant), MULTIWET EF-LQ-AP® (polymeric non-ionic dispersant), or a combination thereof. In one or more embodiments, the composition further comprises a wear inhibitor, wherein the wear inhibitor comprises Graphene nanoplatelets, titanium dioxide, microcrystalline magnesium silicate, micronized barium sulphate, or a combination thereof. In one or more embodiments, the composition further comprises a defoamer, such as a polymeric defoamer, wherein the defoamer comprises BYK-066 N, BYK-1790, or a combination thereof. In one or more embodiments, the composition further comprises a weather-resistance additive, wherein the weather-resistance additive comprises 95% Benzenepropanoic acid, 3-(2H-benzotriazol-2-yl)-5-(1,1-dimethylethyl)-4-hydroxy-, C7-9-branched and linear alkyl esters, 5% 1-methoxy-2-propyl acetate (Tinuvin 99-2®), 2-(2H-benzotriazol-2-yl)-4,6-bis(1-methyl-1-phenylethyl)phenol (Tinuvin 900®), 2-[4-[2-Hydroxy-3-tridecyloxypropyl]oxy]-2-hydroxyphenyl]-4,6-bis(2,4-dimethylphenyl)-1,3,5-triazine and 2-[4-[2-hydroxy-3-didecyloxypropyl]oxy]-2-hydroxyphenyl]-4,6-bis(2,4-dimethylphenyl)-1,3,5-triazine (Tinuvin 400®), or a combination thereof. In one or more embodiments, the composition further comprises a curing catalyst, wherein the curing catalyst comprises 2,4,6-tris[(dimethylamino)methyl]phenol. In one or more embodiments, the composition further comprises a hardener composition, the hardener composition comprising a hardener and optionally a diluent, the hardener being reactive in curing the composition to form a coating having a resistance to abrasive treatment with organic solvents of at least 50 passes when measured according to ASTM D1640. In one or more embodiments, the hardener comprises an amine hardener, amide hardener, or a combination thereof, such as phenalkamine, amine-modified phenalkamine, phenalkamides, amine-modified phenalkamides, polyamidoamine, modified polyamidoamine, or a combination thereof. In one or more embodiments, the diluent comprises a non-reactive diluent, such as methyl acetate, xylene, or a combination thereof. In one or more embodiments, the composition is used for forming a coating on a substrate, wherein the substrate is a surface of marine vessel, such as a boat or ship. In one or more embodiments, the composition is used for reducing underwater radiated noise.

In one or more embodiments of the present disclosure, there is provided a composition for a coating comprising (i) solvent-borne monomers, wherein the monomers comprise epoxy-functional epoxide-siloxane monomers as described herein, such as Silikopon® ED, Silikopon® EF, EPOSIL Resin 5550®, or a combination thereof; (ii) a diluent comprising a reactive diluent that is reactive in a polymerization of solvent-borne monomers, a non-reactive diluent, or a combination thereof, wherein the reactive diluent comprises epoxy-functional polydimethylsiloxane, and the non-reactive diluent comprises xylene, methyl acetate, or a combination thereof; (iii) a sufficient amount of an adhesion promoter to provide a coating formed from the composition having an intercoat adhesion of at least 5 MPa when measured according to ASTM D4541, or a bending strength of at least 10 mm when measured by a cylindrical bend test, wherein the adhesion promoter comprises an epoxy-functional alkoxylated silane, an amino-functional alkoxylated silane, or a combination thereof; and (iv) a sufficient amount of hollow ceramic spheres to provide a coating formed from the composition a hardness of at least 5H when measured according to ASTM D3363, wherein the hollow ceramic spheres comprise spheres having a particle size of about 10 μm to about 15 μm, or about 12 μm, and are present in a range of about 5 wt % to about 20 wt %, or about 10 wt % to about 20 wt %, or about 10 wt % to about 18 wt %, or about 10 wt % to about 15 wt %. In one or more embodiments, the composition further comprises a rheology modifier, such as organo-modified castor oil, such as Thixatrol ST®; fumed silica, fumed silica surface modified with dimethyldichlorosilane, such as Cab-O—Sil TS-610®; microcrystalline magnesium silicate, such as Talc SIlverline 202® or Mistron 002®; polyether siloxane copolymer, such as TEGO® Glide 410® (Evonik); or a combination thereof. In one or more embodiments, the composition further comprises a dispersant, such as a polymeric non-ionic dispersant, polymeric ionic dispersant, a polymeric pigment dispersant, or a combination thereof, wherein the dispersant comprises TEGO® Glide 410® (polyether siloxane copolymer); or a combination thereof. In one or more embodiments, the composition further comprises a wear inhibitor, wherein the wear inhibitor comprises multilayered graphene flakes, titanium dioxide, microcrystalline magnesium silicate, or a combination thereof. In one or more embodiments, the composition further comprises a defoamer, such as a polymeric defoamer, wherein the defoamer comprises BYK-066 N, BYK-1790, or a combination thereof. In one or more embodiments, the composition further comprises a weather-resistance additive, wherein the weather-resistance additive comprises 95% Benzenepropanoic acid, 3-(2H-benzotriazol-2-yl)-5-(1,1-dimethylethyl)-4-hydroxy-, C7-9-branched and linear alkyl esters, 5% 1-methoxy-2-propyl acetate (Tinuvin 99-2®), 2-(2H-benzotriazol-2-yl)-4,6-bis(1-methyl-1-phenylethyl)phenol (Tinuvin 900®), 2-[4-[2-Hydroxy-3-tridecyloxypropyl]oxy]-2-hydroxyphenyl]-4,6-bis(2,4-dimethylphenyl)-1,3,5-triazine and 2-[4-[2-hydroxy-3-didecyloxypropyl]oxy]-2-hydroxyphenyl]-4,6-bis(2,4-dimethylphenyl)-1,3,5-triazine (Tinuvin 400®), or a combination thereof. In one or more embodiments, the composition further comprises a hardener composition, the hardener composition comprising a hardener and optionally a diluent, the hardener being reactive in curing the composition to form a coating having a resistance to abrasive treatment with organic solvents of at least 50 passes when measured according to ASTM D1640. In one or more embodiments, the hardener comprises a silamine hardener, such as aminopropyltriethoxysilane. In one or more embodiments, the hardener composition further comprises a curing catalyst, wherein the curing catalyst comprises 2,4,6-tris[(dimethylamino)methyl]phenol. In one or more embodiments, the composition is used for forming a coating on a substrate, wherein the substrate is a surface of marine equipment, such as a sensor or propeller. In one or more embodiments, the composition is used for imparting scratch resistance.

Herein, there is described:

1. A composition for a coating, comprising:
solvent-borne monomers;
a diluent;
a sufficient amount of an adhesion promoter to provide a coating formed from the composition having an intercoat adhesion of at least 5 MPa when measured according to ASTM D4541, or a bending strength of at least 10 mm when measured by a cylindrical bend test; and
a sufficient amount of hollow ceramic spheres to provide a coating formed from the composition having a reduced noise radiation of about 1 dB to about 50 dB per about 100 μm of coating thickness at frequencies of about 1000 Hz or less when measured on a 3 mm thickness cold rolled steel metal plate relative to an uncoated 3 mm thickness cold rolled steel metal plate or a hardness of at least 5H when measured according to ASTM D3363.

2. The composition of item 1, wherein the solvent-borne monomers comprise allyl-functional monomers, amino-functional monomers, maleimide-functional monomers, cyanate ester-functional monomers, epoxy-functional monomers, furan-functional monomers, vinyl ester-functional monomers, or a combination thereof.

3. The composition of item 1, wherein the solvent-borne monomers comprise solvent-borne pre-polymers, such as allyl-functional pre-polymers, amino-functional pre-polymers, polyester pre-polymers, bis-maleimide pre-polymers, cyanate ester-functional pre-polymers, epoxy-functional pre-polymers, furan-functional pre-polymers, phenolic pre-polymers, polyurea pre-polymers, polyurethane pre-polymers, silicone pre-polymers, or vinyl ester-functional pre-polymers.

4. The composition of any one of items 1 to 3, wherein the solvent-borne monomers comprise epoxy-functional monomers, wherein the epoxy-functional monomers comprise:
bisphenol diglycidyl ethers;
epoxy-functional monomers modified with a cycloaliphatic polyglycidyl ether;
epoxy-functional monomers modified with a aliphatic glycidyl ether;
epoxy-functional epoxide-siloxane monomers;
a reaction product of epichlorohydrin and one or more of hydroxyl-functional aromatics, alcohols, thiols, acids, acid anhydrides, cycloaliphatics and aliphatics, polyfunctional amines, and amine functional aromatics;
a reaction product of the oxidation of unsaturated cycloaliphatics; or
a combination thereof.

5. The composition of any one of items 1 to 4, wherein the solvent-borne monomers comprise epoxy-functional monomers, wherein the epoxy-functional monomers comprise:
bisphenol diglycidyl ethers;
epoxy-functional epoxide-siloxane monomers;
epoxy-functional monomers modified with a cycloaliphatic polyglycidyl ether;
epoxy-functional monomers modified with a aliphatic glycidyl ether; or
a combination thereof.

6. The composition of item 4 or 5, wherein the bisphenol diglycidyl ethers are derived from bisphenol A, bisphenol F, bisphenol S, or a combination thereof.

7. The composition of any one of items 4 to 6, wherein the epoxy-functional epoxide-siloxane monomers comprise an epoxide backbone comprising siloxane or polysiloxane side-chains; for example, wherein the epoxide backbone is a polyether backbone and/or the siloxane or polysiloxane side-chain are linear, branched, or crosslinked.

8. The composition of item 7, wherein at least one of the siloxane or polysiloxane side-chains is a cross-linked silicone resin.

9. The composition of any one of item 4 to 8, wherein the epoxy-functional epoxide-siloxane monomers comprise a reaction product of isocyanate and/or polyurethane oligomers, silane oligomers, and epoxy oligomers.

10. The composition of any one of items 7 to 9, wherein the epoxy-functional epoxide-siloxane monomer comprises an epoxy-functional epoxide-siloxane pre-polymer.

11. The composition of any one of items 7 to 10, wherein the epoxy-functional epoxide-siloxane monomer comprises a 3-ethylcyclohexylepoxy copolymer modified with dimethylsiloxane side-chains, an epoxy bisphenol A (2,2-Bis(4′-glycidyloxyphenyl)propane) modified with the poly-dimethylsiloxane side-chains, a siloxane modified hybrid epoxy resin, a siliconeepoxide resin, an epoxy-functional epoxide-backbone functionalized with a crosslinked silicone resin comprising terminal alkoxy groups, or a combination thereof.

12. The composition of any one of items 7 to 11, wherein the epoxy-functional epoxide-siloxane monomer comprises Silikopon® ED, Silikopon® EF, EPOSIL Resin 5550®, or a combination thereof.

13. The composition of any one of items 1 to 12, wherein the solvent-borne monomers are low-viscosity solvent-borne monomers; for example, low-viscosity solvent-borne monomers having a viscosity in a range of about 200 to about 1500 cps, or about 300 to about 1000 cps.

14. The composition of item 13, wherein the low-viscosity solvent-borne monomers comprise epoxy-functional monomers modified with a cycloaliphatic polyglycidyl ether having a viscosity in a range of about 350 to about 550 cps; epoxy-functional monomers modified with a cycloaliphatic polyglycidyl ether having a viscosity in a range of about 400 to about 1000 cps; epoxy-functional monomers modified with an aliphatic glycidyl ether having a viscosity in a range of about 800 to about 1000 cps; or a combination thereof.

15. The composition of item 13 or 14, wherein the low-viscosity solvent-borne monomers comprise DLVE®-52 (ultra low viscosity epoxy resin modified with a cycloaliphatic polyglycidyl ether epoxy resin), DLVE®-18 (low viscosity epoxy resin modified with a cycloaliphatic polyglycidyl ether epoxy resin), D.E.R.® 353 (C12-C14 aliphatic glycidyl ether-modified bisphenol-A/F epoxy-based resin), or a combination thereof.

16. The composition of any one of items 1 to 12, wherein a mixture of the solvent-borne monomers and the diluent have a viscosity in a range of about 200 to about 3500 cps, or about 300 to about 3500 cps.

17. The composition of any one of items 1 to 16, wherein the solvent-borne monomers are present in a range of about 5 wt % to about 40 wt %, or about 5 wt % to about 35 wt %, or about 5 wt % to about 30 wt %.

18. The composition of any one of items 1 to 17, wherein the diluent comprises a reactive diluent that is reactive in a polymerization of solvent-borne monomers, a non-reactive diluent, or a combination thereof.

19. The composition of item 18, wherein the reactive diluent comprises poly[(phenyl glycidyl ether)-co-formaldehyde], alkyl (C12-C14) glycidyl ether (for example, EPODIL 748®), phenyl glycidyl ether, alkenyl-substituted phenyl glycidyl ether (for example, Ultra Lite 513 ®), butyl glycidyl ether (for example, Epodil 741®), 2-ethylhexyl glycidyl ether, o-cresol glycidyl ether, cycloaliphatic glycidyl ether, 1,2-epoxy-3-phenoxypropane; epoxy-functional polydimethylsiloxane (for example, Tegomer E-SI 2330®; BYK Silclean 3701®), silicone-amine (for example, Silamine D2 EDA, Silamine D208 EDA); or a combination thereof.

20. The composition of item 18 or 19, wherein the reactive diluent comprises butyl glycidyl ether, alkyl (C12-C14) glycidyl ether, epoxy-functional polydimethylsiloxane, or a combination thereof.

21. The composition of any one of items 18 to 20, wherein the reactive diluent is present in a range of about 1 wt % to about 15 wt %, or about 1 wt % to about 10 wt %, or about 5 wt % to about 10 wt %.

22. The composition of any one of items 17 to 21, wherein the non-reactive diluent comprises xylene, cyclohexane, toluene, methyl acetate, tert-butyl acetate, nonyl phenol, cyclohexanedimethanol, n-butyl alcohol, benzyl alcohol, isopropyl alcohol, polyethylene glycol (for example, LIPOXOL 200, LIPOXOL 400 LIPOXOL 600), propylene glycol, phenol, methylstyrenated phenol (for example, KUMANOX-3114®), styrenated phenol (for example, KUMANOX-3111F®), C12-C37 ether (for example, NACOL ETHER 6®, NACOL ETHER 8®), low-viscosity hydrocarbon resin (for example, EPODIL LV5®), aryl polyoxyethylene ether (for example, Pycal 94®), or a combination thereof.

23. The composition of any one of items 17 to 22, wherein the non-reactive diluent comprises benzyl alcohol, xylene, methyl acetate, or a combination thereof.

24. The composition of any one of items 17 to 23, wherein the non-reactive diluent is present in a range of about 1 wt % to about 20 wt %, or about 1 wt % to about 10 wt %, or about 5 wt % to about 20 wt %.

25. The composition of any one of items 1 to 24, wherein the diluent comprises about 10 wt % volatile organic compounds, or <10 wt % volatile organic compounds.

26. The composition of any one of items 1 to 25, wherein the adhesion promoter comprises an alkoxylated silane, the silane being optionally reactive in a polymerization of solvent-borne monomers.

27. The composition of any one of items 1 to 26, wherein the adhesion promoter comprises an epoxy-functional alkoxylated silane, an amino-functional alkoxylated silane, or a combination thereof.

28. The composition of any one of items 1 to 27, wherein the adhesion promoter comprises 3-(2,3-Epoxypropoxy)propyltrimethoxysilane, glycidoxypropyltrimethoxysilane, aminopropyltriethoxysilane, 3-aminopropyltriethoxysilane, an secondary amino bis-silane, or a combination thereof.

29. The composition of any one of items 1 to 28, wherein the adhesion promoter is present in a range of about 0.1 wt % to about 5 wt %, or about 0.1 wt % to about 1 wt %, or about 1 wt % to about 5 wt %.

30. The composition of any one of items 1 to 29, wherein the sufficient amount of the adhesion promoter provides a coating formed from the composition having an intercoat adhesion of about 5 MPa to about 10 MPa when measured according to ASTM D4541, or a bending strength of at least 8 mm, or about 6 mm when measured by a cylindrical bend test.

31. The composition of any one of items 1 to 30, wherein the hollow ceramic spheres comprise spheres having a particle size of about 20 μm to about 40 μm, or about 25 μm to about 35 μm.

32. The composition of item 31, wherein the hollow ceramic spheres are present in a range of about 30 wt % to about 70 wt %, or about 35 wt % to about 65 wt %, or about 30 wt % to about 50 wt %.

33. The composition of item 32, wherein the hollow ceramic spheres comprise Zeeospheres® G 600 hollow ceramic spheres, W410® hollow ceramic spheres, W610® hollow ceramic spheres, or a combination thereof.

34. The composition of any one of items 1 to 30, wherein the hollow ceramic spheres comprise spheres having a particle size of about 10 μm to about 15 μm, or about 12 μm.

35. The composition of item 34, wherein the hollow ceramic spheres are present in a range of about 5 wt % to about 20 wt %, or about 10 wt % to about 20 wt %, or about 10 wt % to about 18 wt %, or about 10 wt % to about 15 wt %.

36. The composition of item 35, wherein the hollow ceramic spheres comprise Zeeospheres® N-200PC hollow ceramic spheres, W210® hollow ceramic spheres, or a combination thereof.

37. The composition of any one of items 1 to 36, wherein the sufficient amount of the hollow ceramic spheres provides a coating formed from the composition having reduced noise radiation of about 1 dB to about 20 dB, or to about 15 dB per about 100 μm of coating thickness for noise in a range of about 100 to about 1000 Hz, or about 100 to about 400 Hz, or a hardness of about 6H to about 8H.

38. The composition of any one of items 1 to 37, further comprising a rheology modifier, such as aluminum phyllosilicate clay; organo-modified derivative of Aluminium phyllosilicate clay; organo-modified bentonite clay; organo-modified montmorillonite clay, such as Claytone-HY® or Claytone-APA®; organo-modified castor oil, such as Thixatrol ST®; micronized organo-modified polyamide wax derivative, such as Crayvallac Super®; fumed silica, fumed silica surface modified with dimethyldichlorosilane, such as Cab-O—Sil TS-610®; micronized barium sulphate, such as VB Techno®; microcrystalline magnesium silicate, such as Talc SIlverline 202® or Mistron 002®; polyether siloxane copolymer, such as TEGO® Glide 410® (Evonik); or a combination thereof.

39. The composition of item 38, wherein the rheology modifier is present in a range of about 0.3 wt % to about 5 wt %, or about 0.3 wt % to about 3 wt %, or about 0.3 w % to about 1.5 wt %.

40. The composition of any one of items 1 to 39, further comprising a dispersant.

41. The composition of item 40, wherein the dispersant comprises a polymeric dispersant, such as a polymeric non-ionic dispersant, polymeric ionic dispersant, a polymeric pigment dispersant, or a combination thereof.

42. The composition of item 40 or 41, wherein the dispersant comprises ADDITOL VXW 6208® (polymeric non-ionic dispersant), K-SPERSE A504 (polymeric non-ionic dispersant), Disperbyk 140® (polymeric ionic dispersant, alkyl ammonium salt of an acidic polymer), MULTIWET EF-LQ-AP® (polymeric non-ionic dispersant), HPERMER KD6-LQ-MV® (polymeric non-ionic dispersant blend), ECO NatraSense 125 MBAL-LQ-AP® (non-ionic alcohol ethoxylate dispersant), BRIJ-03-LQ-AP® (nonionic alkyl polyglycol ethers dispersant), SP BRIJ 02 MBAL LQ-AP® (nonionic alkyl polyglycol ethers dispersant), ANTI-TERRA-204® (polymeric ionic dispersant, polycarboxylic acid salt of polyamine amides), TEGO Dispers 670® (polymeric non-ionic dispersant), TEGO Dispers 1010® (polymeric non-ionic dispersant), TEGO® Glide 410® (polyether siloxane copolymer); or a combination thereof.

43. The composition of any one of items 40 to 42, wherein the dispersant is present in a range of about 0.1 wt % to about 5 wt %, or about 0.1 wt % to about 4 wt %, or about 0.1 wt % to about 3 wt %; or about 0.1 wt % to about 2 wt %, or about 0.1 wt % to about 1 wt %.

44. The composition of any one of items 1 to 43, further comprising a wear inhibitor, such as graphite oxide, multilayered graphene flakes, titanium dioxide, microcrystalline magnesium silicate, fumed silica, micronized barium sulphate, or a combination thereof.

45. The composition of item 44, wherein the wear inhibitor is present in a range of about 0.5 wt % to about 5 wt %, or about 0.5 wt % to about 2 wt %.

46. The composition of any one of items 1 to 45, further comprising a defoamer, such as a polymeric defoamer.

47. The composition of item 46, wherein the defoamer comprises a silicone oligomer, such as a polysiloxane oligomer.

48. The composition of item 46 or 47, wherein the defoamer comprises BYK-066 N, BYK-1790, or a combination thereof; and is optionally present in a range of about 0.1 wt % to about 5 wt %, or about 0.1 wt % to about 1 wt %, or about 1 wt % to about 5 wt %.

49. The composition of any one of items 1 to 48, further comprising a weather-resistance additive.

50. The composition of item 49, wherein the weather-resistance additive comprises 95% Benzenepropanoic acid, 3-(2H-benzotriazol-2-yl)-5-(1,1-dimethylethyl)-4-hydroxy-, C7-9-branched and linear alkyl esters, 5% 1-methoxy-2-propyl acetate (Tinuvin 99-2®), 2-(2H-benzotriazol-2-yl)-4,6-bis(1-methyl-1-phenylethyl)phenol (Tinuvin 900®), 2-[4-[2-Hydroxy-3-tridecyloxypropyl]oxy]-2-hydroxyphenyl]-4,6-bis(2,4-dimethylphenyl)-1,3,5-triazine and 2-[4-[2-hydroxy-3-didecyloxypropyl]oxy]-2-hydroxyphenyl]-4,6-bis(2,4-dimethylphenyl)-1,3,5-triazine (Tinuvin 400®), or a combination thereof; optionally present in a range of about 0.5 wt % to about 5 wt %, or about 1 wt % to about 5 wt %.

51. The composition of any one of items 1 to 50, further comprising a curing catalyst.

52. The composition of item 51, wherein the curing catalyst comprises 2,4,6-tris[(dimethylamino)methyl]phenol.

53. The composition of any one of items 1 to 52, wherein the composition comprises about 80 wt % to about 90 wt % solids.

54. The composition of any one of items 1 to 53, further comprising a hardener composition, the hardener composition comprising a hardener and optionally a diluent, the hardener being reactive in curing the composition to form a coating having a resistance to abrasive treatment with organic solvents of at least 50 passes when measured according to ASTM D1640.

55. The composition of item 54, wherein the hardener comprises an amine hardener, amide hardener, or a combination thereof, such as phenalkamine, amine-modified phenalkamine, phenalkamides, amine-modified phenalkamides, polyamidoamine, organo-modified polyamidoamine, or a combination thereof; or a silamine hardener, such as aminopropyltriethoxysilane; optionally present in a range of about 70 wt % to about 100 wt %, or about 70 wt % to about 90 wt of the hardener composition.

56. The composition of item 54 or 55, wherein the diluent comprises a non-reactive diluent, such as methyl acetate, xylene, or a combination thereof; optionally present in a range of about 1 to 30% wt % of the hardener composition; for example, wherein the xylene is present in a range of about 1 wt % to about 5 wt %, and methyl acetate is present in a range of about 10 wt % to about 25 wt %.

57. A coating comprising a reaction product of a composition for a coating of any one of items 1 to 53 and a hardener.

58. Use of a composition for a coating of any one of items 1 to 56 for forming a coating on a substrate.

59. The use of item 58, wherein the substrate is a surface of marine vessel, such as a boat or ship; or marine equipment, such as a sensor or propeller.

60. Use of a coating comprising a reaction product of a composition for a coating of any one of items 1 to 53 and a hardener for reducing underwater radiated noise.

61. Use of a coating comprising a reaction product of a composition for a coating of any one of items 1 to 53 and a hardener on a substrate for imparting scratch resistance.

62. A method of forming a composition for a coating, comprising:
mixing together solvent-borne monomers, a diluent, an adhesion promoter, and hollow ceramic spheres; and
forming the composition for a coating.

63. The method of item 62, further comprising mixing in a rheology modifier, a dispersant, a defoamer, and/or a wear inhibitor.

64. The method of item 63, wherein when a wear-inhibitor is mixed in, mixing together the solvent-borne monomers, diluent, adhesion promoter, and hollow ceramic spheres comprises:
mixing together the solvent-borne monomers, diluent, and adhesion promoter;
grinding the wear-inhibitor, and
mixing the ground wear-inhibitor into the mixture of the solvent-borne monomers, diluent, and adhesion promoter; and
mixing in the hollow ceramic spheres.

Herein, there is also described:

1. A composition for a coating, comprising:
solvent-borne monomers;
a diluent;
a sufficient amount of an adhesion promoter to provide a coating formed from the composition having a substrate adhesion of at least 3 MPa when measured according to ASTM D4541, an overcoat adhesion of at least 3 MPa when measured according to ASTM D4541, or a recoat adhesion window of at least 4 hours when measured according to ASTM D3359;
a sufficient amount of rheology modifier to provide a coating formed from the composition having anti-settling, anti-sagging, or surface-leveling properties; and
a sufficient amount of a ceramic performance additive to provide a coating formed from the composition having a reduced noise radiation of about 2 dB to about 10 dB per about 100 μm of coating thickness at frequencies of about 10 Hz to about 10 kHz when measured on a 3 mm thickness cold rolled steel metal plate relative to a 3 mm thickness cold rolled steel metal plate coated with a coating free of the ceramic performance additive; or a hardness of at least 5H when measured according to ASTM D3363.

2. The composition of item 1, wherein the solvent-borne monomers comprise allyl-functional monomers, amino-functional monomers, maleimide-functional monomers, cyanate ester-functional monomers, epoxy-functional monomers, furan-functional monomers, vinyl ester-functional monomers, or a combination thereof.

3. The composition of any one of items 1 to 2, wherein the solvent-borne monomers comprise solvent-borne pre-polymers, such as allyl-functional pre-polymers, amino-functional pre-polymers, polyester pre-polymers, bis-maleimide pre-polymers, cyanate ester-functional pre-polymers, epoxy-functional pre-polymers, furan-functional pre-polymers, phenolic pre-polymers, polyurea pre-polymers, polyurethane pre-polymers, silicone pre-polymers, or vinyl ester-functional pre-polymers.

4. The composition of any one of items 1 to 3, wherein the solvent-borne monomers comprise epoxy-functional monomers, wherein the epoxy-functional monomers comprise:
bisphenol diglycidyl ethers;
epoxy-functional monomers modified with a cycloaliphatic polyglycidyl ether;
epoxy-functional monomers modified with an aliphatic glycidyl ether;
epoxy-functional epoxide-siloxane monomers;
a reaction product of epichlorohydrin and one or more of hydroxyl-functional aromatics, alcohols, thiols, acids, acid anhydrides, cycloaliphatics and aliphatics, polyfunctional amines, and amine functional aromatics;
a reaction product of the oxidation of unsaturated cycloaliphatics; or
a combination thereof.

5. The composition of any one of items 1 to 4, wherein the solvent-borne monomers comprise epoxy-functional monomers, wherein the epoxy-functional monomers comprise:
bisphenol diglycidyl ethers;
epoxy-functional epoxide-siloxane monomers;
epoxy-functional monomers modified with a cycloaliphatic polyglycidyl ether;
epoxy-functional monomers modified with a aliphatic glycidyl ether; or
a combination thereof.

6. The composition of any one of items 1 to 5, wherein the bisphenol diglycidyl ethers are derived from bisphenol A, bisphenol F, bisphenol S, or a combination thereof.

7. The composition of any one of items 1 to 6, wherein the epoxy-functional epoxide-siloxane monomers comprise an epoxide backbone comprising siloxane or polysiloxane side-chains; for example, wherein the epoxide backbone is a polyether backbone and/or the siloxane or polysiloxane side-chain are linear, branched, or crosslinked.

8. The composition of any one of items 1 to 7, wherein at least one of the siloxane or polysiloxane side-chains is a cross-linked silicone resin.

9. The composition of any one of item 1 to 8, wherein the epoxy-functional epoxide-siloxane monomers comprise a reaction product of isocyanate and/or polyurethane oligomers, silane oligomers, and epoxy oligomers.

10. The composition of any one of items 1 to 9, wherein the epoxy-functional epoxide-siloxane monomer comprises an epoxy-functional epoxide-siloxane pre-polymer.

11. The composition of any one of items 1 to 10, wherein the epoxy-functional epoxide-siloxane monomer comprises a 3-ethylcyclohexylepoxy copolymer modified with dimethylsiloxane side-chains, an epoxy bisphenol A (2,2-Bis(4′-glycidyloxyphenyl)propane) modified with the poly-dimethylsiloxane side-chains, a siloxane modified hybrid epoxy resin, a siliconeepoxide resin, an epoxy-functional epoxide-backbone functionalized with a crosslinked silicone resin comprising terminal alkoxy groups, or a combination thereof.

12. The composition of any one of items 1 to 11, wherein the epoxy-functional epoxide-siloxane monomer comprises Silikopon® ED, Silikopon® EF, EPOSIL Resin 5550®, or a combination thereof.

13. The composition of any one of items 1 to 12, wherein the solvent-borne monomers are low-viscosity solvent-borne monomers; for example, low-viscosity solvent-borne monomers having a viscosity in a range of about 200 to about 1500 cps, or about 300 to about 1000 cps.

14. The composition of any one of items 1 to 13, wherein the low-viscosity solvent-borne monomers comprise epoxy-functional monomers modified with a cycloaliphatic polyglycidyl ether having a viscosity in a range of about 350 to about 550 cps; epoxy-functional monomers modified with a cycloaliphatic polyglycidyl ether having a viscosity in a range of about 400 to about 1000 cps; epoxy-functional monomers modified with an aliphatic glycidyl ether having a viscosity in a range of about 800 to about 1000 cps; or a combination thereof.

15. The composition of any one of items 1 to 14, wherein the low-viscosity solvent-borne monomers comprise DLVE®-52 (ultra low viscosity epoxy resin modified with a cycloaliphatic polyglycidyl ether epoxy resin), DLVE®-18 (low viscosity epoxy resin modified with a cycloaliphatic polyglycidyl ether epoxy resin), D.E.R.® 353 (C12-C14 aliphatic glycidyl ether-modified bisphenol-A/F epoxy-based resin), or a combination thereof.

16. The composition of any one of items 1 to 15, wherein a mixture of the solvent-borne monomers and the diluent have a viscosity in a range of about 200 to about 3500 cps, or about 300 to about 3500 cps.

17. The composition of any one of items 1 to 16, wherein the solvent-borne monomers are present in a range of about 5 wt % to about 35 wt %, or about 5 wt % to about 30 wt %, or about 10 wt % to about 30 wt %; or about 15 wt % to about 20 wt %, based on Part A wt %; or about 5 wt % to about 25 wt %; or about 5 wt % to about 20 wt %, or about 10 wt % to about 20 wt %, or about 15 wt % to about 20 wt % based on total wt %.

18. The composition of any one of items 1 to 17, wherein the diluent comprises a reactive diluent that is reactive in a polymerization of solvent-borne monomers, a non-reactive diluent, or a combination thereof.

19. The composition of any one of items 1 to 18, wherein the reactive diluent comprises poly[(phenyl glycidyl ether)-co-formaldehyde], alkyl (C12-C14) glycidyl ether (for example, EPODIL 748®), phenyl glycidyl ether, alkenyl-substituted phenyl glycidyl ether (for example, Ultra Lite 513 ®), butyl glycidyl ether (for example, Epodil 741®), 2-ethylhexyl glycidyl ether, o-cresol glycidyl ether, cycloaliphatic glycidyl ether, 1,2-epoxy-3-phenoxypropane; epoxy-functional polydimethylsiloxane (for example, Tegomer E-SI 2330®; BYK Silclean 3701®), silicone-amine (for example, Silamine D2 EDA, Silamine D208 EDA); or a combination thereof.

20. The composition of any one of items 1 to 19, wherein the reactive diluent comprises butyl glycidyl ether, alkyl (C12-C14) glycidyl ether, epoxy-functional polydimethylsiloxane, or a combination thereof.

21. The composition of any one of items 1 to 20, wherein the reactive diluent is present in a range of about 1 wt % to about 15 wt %, or about 1 wt % to about 10 wt %, or about 1 wt % to about 5 wt %, based on Part A wt % or total wt %.

22. The composition of any one of items 1 to 21, wherein the non-reactive diluent comprises xylene, cyclohexane, toluene, methyl acetate, methyl ethyl ketone, tert-butyl acetate, nonyl phenol, cyclohexanedimethanol, n-butyl alcohol, benzyl alcohol, isopropyl alcohol, polyethylene glycol (for example, LIPOXOL 200, LIPOXOL 400 LIPOXOL 600), propylene glycol, phenol, methylstyrenated phenol (for example, KUMANOX-3114®), styrenated phenol (for example, KUMANOX-3111F®), C12-C37 ether (for example, NACOL ETHER 6®, NACOL ETHER 8®), low-viscosity hydrocarbon resin (for example, EPODIL LV5®), aryl polyoxyethylene ether (for example, Pycal 94®), or a combination thereof.

23. The composition of any one of items 1 to 22, wherein the non-reactive diluent comprises benzyl alcohol, xylene, methyl acetate, ethers, aromatic solvents, or a combination thereof.

24. The composition of any one of items 1 to 23, wherein the non-reactive diluent is present in a range of about 1 wt % to about 20 wt %, or about 1 wt % to about 10 wt %, or about 5 wt % to about 20 wt %, based on Part A wt %; or about 5 wt % to about 25 wt %, or about 5 wt % to about 20 wt %, or about 10 wt % to about 20 wt %, based on total wt %.

25. The composition of any one of items 1 to 24, wherein the diluent comprises about 10 wt % volatile organic compounds, or <10 wt % volatile organic compounds.

26. The composition of any one of items 1 to 25, wherein the adhesion promoter comprises an silane promoter, the silane being optionally reactive in a polymerization of solvent-borne monomers; a dry adhesion promoter being optionally reactive in a polymerization of solvent-borne monomers, reactive with a substrate, and/or reactive with metal oxides; a wet adhesion promoter being optionally reactive in a polymerization of solvent-borne monomers, reactive with a substrate, and/or reactive with metal oxides; a dry/wet adhesion promoter being optionally reactive being optionally reactive in a polymerization of solvent-borne monomers, reactive with a substrate, and/or reactive with metal oxides; or a combination thereof.

27. The composition of any one of items 1 to 26, wherein the adhesion promoter comprises an alkoxylated silane, such as an epoxy-functional alkoxylated silane, an amino-functional alkoxylated silane, or a combination thereof; a modified polyester, such as a modified polyester having a hydroxyl value enough about 30 mg to about 100 mg KOH/g, a polyacrylic, a modified polyester oligomer, a polyacrylate, a metal-doped phosphosilicate, a benzotriazole, a mercaptane-comprising polymer or pre-polymer, or a combination thereof.

28. The composition of any one of items 1 to 27, wherein the adhesion promoter comprises 3-(2,3-Epoxypropoxy)propyltrimethoxysilane; glycidoxypropyltrimethoxysilane; aminopropyltriethoxysilane; 3-aminopropyltriethoxysilane; an secondary amino bis-silane; a modified polyester, such as Tego Addbond LTW-B®, Tego Addbond 2220 ND®; a strontium phosphosilicate, such as HALOX® SW-111; a zinc calcium strontium aluminum orthophosphate silicate hydrate, such as HEUCOPHOS® ZCP-Plus; a zinc phosphosilicate, such as InvoCor CI-3315 (Invotec); an alkyl-substituted, hydroxylamine-substituted benzotriazole, such as CCI-01 Copper Adhesion Promoter; a mercaptane-comprising polymer or pre-polymer, such as CAPCURE® 3-800, CAPCURE® 40 SEC HV; or a combination thereof.

29. The composition of any one of items 1 to 28, wherein the adhesion promoter is present in a range about 1 wt % to about 10 wt %, or about 2 wt % to about 10 wt %, or about 2 wt % to about 8 wt %, based on Part A wt %; or of about 0.1 wt % to about 5 wt %, or about 0.1 wt % to about 1 wt %, or about 1 wt % to about 5 wt %, based on total wt %.

30. The composition of any one of items 1 to 29, wherein a sufficient amount of the adhesion promoter provides a coating formed from the composition having a substrate adhesion of about 3 MPa to about 15 MPa, or about 3 MPa to about 10 MPa when measured according to ASTM D4541, an overcoat adhesion of about 3 MPa to about 15 MPa, or about 3 MPa to about 10 MPa when measured according to ASTM D4541, or a recoat adhesion window between about 4 hours to about 72 hours when measured according to ASTM D3359; or a combination thereof.

31. The composition of any one of items 1 to 30, wherein the ceramic performance additive comprises hollow ceramics and non-hollow ceramics.

32. The composition of any one of items 1 to 31, wherein the hollow ceramics comprises hollow ceramic spheres having a particle size of about 10 μm to about 40 μm; about 20 μm to about 40 μm, or about 25 μm to about 35 μm; or about 10 μm to about 15 μm, or about 12 μm.

33. The composition of any one of items 1 to 32, wherein when the hollow ceramic spheres have a particle size of about 20 μm to about 40 μm, or about 25 μm to about 35 μm, the hollow ceramic spheres are present in a range of about 30 wt % to about 70 wt %, or about 35 wt % to about 65 wt %, or about 30 wt % to about 50 wt %, based on Part A wt %; or in a range of about 15 wt % to about 50 wt %, or about 20 wt % to about 50 wt %, or about 20 wt % to about 45 wt % about 15 wt % to about 40 wt %, based on Part A wt % or total wt %.

34. The composition of any one of items 1 to 33 wherein, when the hollow ceramic spheres have a particle size of about 10 μm to about 15 μm, or about 12 μm, the hollow ceramic spheres are present in a range of about 5 wt % to about 70 wt %, about 15 wt % to about 70 wt %, about 25 wt % to about 70 wt %, about 35 wt % to about 70 wt %, about 40 wt % to about 70 wt %, or about 5 wt % to about 20 wt %, or about 10 wt % to about 20 wt %, or about 10 wt % to about 18 wt %, or about 10 wt % to about 15 wt %, based on Part A; or in a range of about 20 wt % to about 50 wt %, or about 20 wt % to about 45 wt %, or about 15 wt % to about 40 wt %, based on total wt %.

35. The composition of any one of items 1 to 34, wherein the hollow ceramic spheres comprise Zeeospheres® G 600 hollow ceramic spheres, W410® hollow ceramic spheres, W610® hollow ceramic spheres, Zeeospheres® N-200PC hollow ceramic spheres, W210® hollow ceramic spheres, W410® hollow ceramic spheres, W610® hollow ceramic spheres, or a combination thereof.

36. The composition of any one of items 1 to 35, wherein the non-hollow ceramics comprises non-hollow ceramic particles having a particle size of about 0.1 μm to about 5 μm; about 0.5 μm to about 5 μm, or about 1 μm to about 5 μm; or about 2 μm to about 5 μm.

37. The composition of any one of items 1 to 36, wherein the non-hollow ceramic particles are present in a range of about 10 wt % to about 50 wt %, or about 10 wt % to about 45 wt %; or about 15 wt % to about 40 wt %, based on Part A wt %; or in a range of about 5 wt % to about 40 wt %, or about 10 wt % to about 35 wt %, or about 20 wt % to about 35 wt %, or about 10 wt % to about 20 wt %, based on total wt %.

38. The composition of any one of items 1 to 37, wherein the non-hollow ceramic particles comprise titanium oxide, brown aluminium (Ill) oxide, fused aluminium (Ill) oxide, titanium alloys, or a combination thereof.

39. The composition of any one of items 1 to 38, wherein the sufficient amount of the ceramic performance additive provides a coating formed from the composition having reduced noise radiation of about 3 dB to about 9 dB, or about 5 dB to about 7 dB per about 100 μm of coating thickness, or a hardness of about 6H to about 8H, or about 8H.

40. The composition of any one of items 1 to 39, wherein the rheology modifier comprises an anti-settling rheology modifier, an anti-sagging rheology modifier, or a combination thereof.

41. The composition of any one of items 1 to 40, wherein the rheology modifier comprises aluminum phyllosilicate clay; organo-modified derivative of aluminium phyllosilicate clay; organo-modified bentonite clay; organo-modified montmorillonite clay, such as Claytone-HY® or Claytone-APA®; organo-modified castor oil derivative wax, such as Thixatrol ST®; micronized organo-modified polyamide wax derivative, such as Crayvallac Super®; fumed silica, fumed silica surface modified with silane, fumed silica surface modified with dimethyldichlorosilane, such as Cab-O—Sil TS-610®; micronized barium sulphate, such as VB Techno®; microcrystalline magnesium silicate, such as Talc SIlverline 202® or Mistron 002®; polyether siloxane copolymer, such as TEGO® Glide 410® (Evonik); or a combination thereof.

42. The composition of any one of items 1 to 41, wherein the anti-settling rheology modifier comprises fumed silica, fumed silica surface modified with silane, fumed silica surface modified with dimethyldichlorosilane; aluminum phyllosilicate clay; organo-modified derivative of aluminium phyllosilicate clay; organo-modified bentonite clay; organo-modified montmorillonite clay; or a combination thereof.

43. The composition of any one of items 1 to 42, wherein the anti-sagging rheology modifier comprises micronized organo-modified polyamide wax derivative, organo-modified castor oil derivative wax, or a combination thereof.

44. The composition of any one of items 1 to 43, wherein the rheology modifier is present; or in a range of about 1 wt % to about 5 wt %, or about 1 wt % to about 3 wt %, or about 1 w % to about 1.5 wt %, based on Part A wt %; or in a range of about 0.3 wt % to about 5 wt %, or about 0.3 wt % to about 3 wt %, or about 0.3 w % to about 1.5 wt %, based on total wt %.

45. The composition of any one of items 1 to 44, wherein the anti-sagging rheology modifier or anti-settling rheology modifier is present in a range of about 0.1 wt % to about 5 wt %, or about 0.3 wt % to about 3 wt %, or about 0.3 w % to about 1.5 wt %, based on total wt %.

46. The composition of any one of items 1 to 45, further comprising a dispersant.

47. The composition of any one of items 1 to 46, wherein the dispersant comprises a polymeric dispersant, such as a polymeric non-ionic dispersant, polymeric ionic dispersant, a polymeric pigment dispersant, or a combination thereof.

48. The composition of any one of items 1 to 47, wherein the dispersant comprises ADDITOL VXW 6208® (polymeric non-ionic dispersant), K-SPERSE A504 (polymeric non-ionic dispersant), Disperbyk 140® (polymeric ionic dispersant, alkyl ammonium salt of an acidic polymer), MULTIWET EF-LQ-AP® (polymeric non-ionic dispersant), HPERMER KD6-LQ-MV® (polymeric non-ionic dispersant blend), ECO NatraSense 125 MBAL-LQ-AP® (non-ionic alcohol ethoxylate dispersant), BRIJ-03-LQ-AP® (nonionic alkyl polyglycol ethers dispersant), SP BRIJ 02 MBAL LQ-AP® (nonionic alkyl polyglycol ethers dispersant), ANTI-TERRA-204® (polymeric ionic dispersant, polycarboxylic acid salt of polyamine amides), TEGO Dispers 670® (polymeric non-ionic dispersant), TEGO Disperse 1010® (polymeric non-ionic dispersant), TEGO® Glide 410® (polyether siloxane copolymer); or a combination thereof.

49. The composition of any one of items 1 to 48, wherein the dispersant is present in a range of about 0.1 wt % to about 2 wt %, or about 0.1 wt % to about 1.5 wt %, or about 0.1 wt % to about 1 wt %, based on Part A wt %; or in a range of about 0.1 wt % to about 5 wt %, or about 0.1 wt % to about 4 wt %, or about 0.1 wt % to about 3 wt %; or about 0.1 wt % to about 2 wt %, or about 0.1 wt % to about 1 wt %, based on total wt %.

50. The composition of any one of items 1 to 49, further comprising a wear inhibitor, such as graphite oxide, multilayered graphene flakes, titanium dioxide, microcrystalline magnesium silicate, fumed silica, micronized barium sulphate, or a combination thereof.

51. The composition of any one of items 1 to 50, wherein the wear inhibitor is present in a range of about 0.01 wt % to about 5 wt %, 0.05 wt % to about 5 wt %, 0.5 wt % to about 5 wt %, or about 0.5 wt % to about 2 wt %, based on Part A wt % or total wt %.

52. The composition of any one of items 1 to 51, further comprising a hydrophobicity-modifying additive, the hydrophobicity-modifying additive comprising an epoxy-functional silane, an epoxy-functional polydialkylsiloxane, or a combination thereof.

53. The composition of any one of items 1 to 52, wherein the hydrophobicity-modifying additive comprises an epoxy-functional polydialkylsiloxane.

54. The composition of any one of items 1 to 53, wherein the hydrophobicity-modifying additive comprises an epoxy-functional polydialkylsiloxane.

55. The composition of any one of items 1 to 54, wherein the epoxy-functional silane comprises glycidoxypropyltrimethoxysilane.

56. The composition of any one of items 1 to 55, further comprising a defoamer, such as a polymeric defoamer.

57. The composition of any one of items 1 to 56, wherein the defoamer comprises a silicone-based oligomeric defoamer, such as a polysiloxane oligomer.

58. The composition of any one of items 1 to 57, wherein the defoamer comprises BYK-066 N, BYK-1790, ADDITOL VXW 6210 N, TEGO Airex 900, or a combination thereof; and is optionally present in a range of about 1 wt % to about 5 wt %, or about 1 wt % to about 3 wt %, or about 1 wt % to about 1.5 wt %, based on Part A wt %; or in a range of about 0.1 wt % to about 5 wt %, or about 0.1 wt % to about 1 wt %, or about 1 wt % to about 5 wt %, based on total wt %.

59. The composition of any one of items 1 to 58, further comprising a weather-resistance additive.

60. The composition of any one of items 1 to 59, wherein the weather-resistance additive comprises 95% Benzenepropanoic acid, 3-(2H-benzotriazol-2-yl)-5-(1,1-dimethylethyl)-4-hydroxy-, C7-9-branched and linear alkyl esters, 5% 1-methoxy-2-propyl acetate (Tinuvin 99-2®), 2-(2H-benzotriazol-2-yl)-4,6-bis(1-methyl-1-phenylethyl)phenol (Tinuvin 900®), 2-[4-[2-Hydroxy-3-tridecyloxypropyl]oxy]-2-hydroxyphenyl]-4,6-bis(2,4-dimethylphenyl)-1,3,5-triazine and 2-[4-[2-hydroxy-3-didecyloxypropyl]oxy]-2-hydroxyphenyl]-4,6-bis(2,4-dimethylphenyl)-1,3,5-triazine (Tinuvin 400®), or a combination thereof; optionally present in a range of about 0.5 wt % to about 5 wt %, or about 1 wt % to about 5 wt %.

61. The composition of any one of items 1 to 60, wherein the weather-resistance additive is a wet/dry adhesion promotor.

62. The composition of any one of items 1 to 61, further comprising a curing catalyst.

63. The composition of any one of items 1 to 62, wherein the curing catalyst comprises 2,4,6-tris[(dimethylamino)methyl]phenol.

64. The composition of any one of items 1 to 63, wherein the composition comprises about 80 wt % to about 90 wt % solids.

65. The composition of any one of items 1 to 64, further comprising a hardener composition, the hardener composition comprising a hardener and optionally a diluent, the hardener being reactive in curing the composition to form a coating having a resistance to abrasive treatment with organic solvents of at least 50 passes, or between 50 and 80 passes when measured according to ASTM D1640.

66. The composition of any one of items 1 to 65, wherein the hardener comprises an amine hardener, amide hardener, or a combination thereof, such as phenalkamine, amine-modified phenalkamine, phenalkamides, amine-modified phenalkamides, polyamidoamine, organo-modified polyamidoamine, or a combination thereof; or a silamine hardener, such as aminopropyltriethoxysilane, triamino-functional propyltrimethoxysilane; or a combination thereof; optionally present in a range of about 40 wt % to about 100 wt %, or 40 wt % to about 90 wt %, or about 70 wt % to about 100 wt %, or about 70 wt % to about 90 wt % of the hardener composition.

67. The composition of any one of items 1 to 66, wherein the diluent comprises a non-reactive diluent, such as xylene, benzyl alcohol, methyl ethyl ketone, methyl acetate, ethers, aromatic solvents, or a combination thereof; optionally present in a range of about 1 to 30% wt % of the hardener composition; optionally, wherein the xylene is present in a range of about 1 wt % to about 5 wt %, and methyl acetate is present in a range of about 10 wt % to about 25 wt %.

68. A coating comprising a reaction product of a composition for a coating of any one of items 1 to 64 and a hardener.

69. A coating comprising a reaction product of a composition for a coating of any one of items 1 to 64 and the hardener composition according to any one of items 65 to 67.

70. The coating of item 68 or 69 having a bending strength of at least 10 mm when measured by a cylindrical bend test.

71. The coating of any one of items 68 to 70 having a bending strength of at least 8 mm, or at least 6 mm when measured by a cylindrical bend test.

72. The coating of any one of items 68 to 71 having a substrate adhesion of at least 3 MPa when measured according to ASTM D4541, an overcoat adhesion of at least 3 MPa when measured according to ASTM D4541, or a recoat adhesion window of at least 4 hours when measured according to ASTM D3359, or a combination thereof.

73. The coating of any one of items 68 to 72 having a substrate adhesion of about 3 MPa to about 15 MPa, or about 3 MPa to about 10 MPa when measured according to ASTM D4541, an overcoat adhesion of about 3 MPa to about 15 MPa, or about 3 MPa to about 10 MPa when measured according to ASTM D4541, or a recoat adhesion window between about 4 hours to about 72 hours when measured according to ASTM D3359; or a combination thereof.

74. The coating of any one of items 68 to 73 having a reduced noise radiation of about 2 dB to about 10 dB per about 100 μm of coating thickness at frequencies of about 10 Hz to about 10 kHz when measured on a 3 mm thickness cold rolled steel metal plate relative to a 3 mm thickness cold rolled steel metal plate coated with a coating free of the ceramic performance additive, or a hardness of at least 5H when measured according to ASTM D3363.

75. The coating of any one of items 68 to 74 having reduced noise radiation of about 3 dB to about 9 dB, or about 5 dB to about 7 dB per about 100 μm of coating thickness, or a hardness of about 6H to about 8H, or about 8H.

76. A composition for a coating, comprising:
a solvent-borne epoxy resin;
a diluent;
an adhesion promoter;
an anti-settling rheology modifier;
an anti-sagging rheology modifier; and
a ceramic performance additive comprising hollow ceramic spheres.

77. The composition of item 76, wherein the epoxy resin comprises a bisphenol A epoxy resin, a bisphenol F epoxy resin, a bisphenol S epoxy resin, a cycloaliphatic polyglycidyl ether-modified epoxy resin, a cycloaliphatic polyglycidyl ether resin having a viscosity in a range of about 350 to about 550 cps, a cycloaliphatic polyglycidyl ether-modified resin having a viscosity in a range of about 400 to about 1000 cps, an aliphatic glycidyl ether-modified epoxy resin having a viscosity in a range of about 800 to about 1000 cps, or a combination thereof.

78. The composition of any one of items 76 to 77, wherein the epoxy resin is present at an amount between about 5 to about 30 wt %, or between about 5 to about 20 wt %, or between about 15 to about 20 wt %, or between about 10 wt % to about 20 wt %, based on Part A wt %.

79. The composition of any one of items 76 to 78, wherein the diluent comprises a reactive diluent that is reactive in a epoxy polymerization, a non-reactive diluent, or a combination thereof.

80. The composition of any one of items 76 to 79, wherein the reactive diluent comprises butyl glycidyl ether, C12-14 aliphatic glycidyl ether, phenyl glycidyl ether, alkenyl-substituted phenyl glycidyl ether, 2-ethylhexyl glycidyl ether, o-cresol glycidyl ether, cycloaliphatic glycidyl ether, 1,2-epoxy-3-phenoxypropane; epoxy-functional polydimethylsiloxane, or a combination thereof.

81. The composition of any one of items 76 to 80, wherein the reactive diluent comprises butyl glycidyl ether, C12-14 aliphatic glycidyl ether, or a combination thereof.

82. The composition of any one of items 76 to 81, wherein the reactive diluent is present in a range of about 1 wt % to about 15 wt %, or about 1 wt % to about 10 wt %, or about 5 wt % to about 10 wt %, or about 1 wt % to about 5 wt %, based on Part A wt %; or in a range of about 1 wt % to about 10 wt %, or about 2 wt % to about 8 wt %, based on total wt %.

83. The composition of any one of items 76 to 82, wherein the non-reactive diluent comprises xylene, cyclohexane, toluene, methyl acetate, methyl ethyl ketone, tert-butyl acetate, nonyl phenol, cyclohexanedimethanol, n-butyl alcohol, benzyl alcohol, isopropyl alcohol, polyethylene glycol, propylene glycol, phenol, or a combination thereof.

84. The composition of any one of items 76 to 83, wherein the non-reactive diluent comprises benzyl alcohol, xylene, methyl ethyl ketone, methyl acetate, ethers, aromatic solvents, or a combination thereof.

85. The composition of any one of items 76 to 84, wherein the non-reactive diluent is present in a range of about 1 wt % to about 20 wt %, or about 1 wt % to about 10 wt %, or about 5 wt % to about 20 wt %, based on Part wt % or total wt %.

86. The composition of any one of items 76 to 85, wherein the adhesion promoter comprises an alkoxylated silane, the silane being optionally reactive in a epoxy polymerization; a hydroxyphenyl-benzotriazole, a hydroxyphenyl-triazine, or a combination thereof.

87. The composition of any one of items 76 to 86, wherein the adhesion promoter comprises epoxy-functional alkoxylated silane, an amino-functional alkoxylated silane, a hydroxyphenyl-benzotriazole, a hydroxyphenyl-triazine, or a combination thereof.

88. The composition of any one of items 76 to 87, wherein the adhesion promoter comprises 3-(2,3-epoxypropoxy)propyl-trimethoxysilane; glycidoxypropyl-trimethoxysilane; aminopropyl-triethoxysilane; 3-aminopropyl-triethoxysilane; an secondary amino bis-silane; 95% Benzenepropanoic acid, 3-(2H-benzotriazol-2-yl)-5-(1,1-dimethylethyl)-4-hydroxy-, C7-9-branched and linear alkyl esters, 5% 1-methoxy-2-propyl acetate (Tinuvin 99-2®), 2-(2H-benzotriazol-2-yl)-4,6-bis(1-methyl-1-phenylethyl)phenol (Tinuvin 900®), 2-[4-[2-Hydroxy-3-tridecyloxypropyl]oxy]-2-hydroxyphenyl]-4,6-bis(2,4-dimethylphenyl)-1,3,5-triazine and 2-[4-[2-hydroxy-3-didecyloxypropyl]oxy]-2-hydroxyphenyl]-4,6-bis(2,4-dimethylphenyl)-1,3,5-triazine (Tinuvin 400®); or a combination thereof.

89. The composition of any one of items 76 to 88, wherein the adhesion promoter is present in a range of about 0.1 wt % to about 5 wt %, or about 0.1 wt % to about 1 wt %, or about 1 wt % to about 5 wt % based on Part A wt % or total wt %.

90. The composition of any one of items 76 to 89, wherein the anti-settling rheology modifier comprises a silica, a clay, or a combination thereof.

91. The composition of any one of items 76 to 90, wherein the anti-settling rheology modifier comprises fumed silica, fumed silica surface modified with silane, fumed silica surface modified with dimethyldichlorosilane; aluminum phyllosilicate clay; organo-modified derivative of aluminium phyllosilicate clay; organo-modified bentonite clay; organo-modified montmorillonite clay; or a combination thereof.

92. The composition of any one of items 76 to 91, wherein the anti-settling rheology modifier is present in a range of about 0.1 wt % to about 5 wt %, or about 0.3 wt % to about 3 wt %, or about 0.3 w % to about 2 wt %, based on Part A wt %; or about in a range of about 0.1 wt % to about 2 wt %, or about 0.2 wt % to about 1.5 wt %, or about 0.3 wt % to about 1.3 wt %, based on total wt %.

93. The composition of any one of items 76 to 92, wherein the anti-sagging rheology modifier comprises a wax, a micronized wax, or a combination thereof.

94. The composition of any one of items 76 to 93, wherein the an anti-sagging rheology modifier comprises a polyamide wax, a micronized polyamide wax, a micronized organo-modified polyamide wax, a micronized organo-modified polyamide wax derivative, a castor oil wax, an organically-modified castor oil-derivative wax, or a combination thereof.

95. The composition of any one of items 76 to 94, wherein the an anti-sagging rheology modifier comprises a polyamide wax, a micronized polyamide wax, a micronized organo-modified polyamide wax, a micronized organo-modified polyamide wax derivative, or a combination thereof.

96. The composition of any one of items 76 to 95, wherein the anti-sagging rheology modifier is present in a range of about 0.1 wt % to about 1.5 wt %, or about 0.1 wt % to about 1 wt %, or about 0.1 w % to about 0.5 wt %; based on Part A wt % or total wt %.

97. The composition of any one of items 76 to 96, wherein the ceramic performance additive comprises hollow ceramic spheres having a particle size of about 20 μm to about 40 μm, or about 25 μm to about 35 μm.

98. The composition of any one of items 76 to 97, wherein the hollow ceramic spheres are present in a range of about 20 wt % to about 40 wt %, or about 25 wt % to about 35 wt %; based on Part A wt % or total wt %.

99. The composition of any one of items 76 to 98, wherein the hollow ceramic spheres comprise Zeeospheres® G 600 hollow ceramic spheres, W410® hollow ceramic spheres, W610® hollow ceramic spheres, or a combination thereof.

100. The composition of any one of items 76 to 99, further comprising a dispersant.

101. The composition of any one of items 76 to 100, wherein the dispersant comprises a polymeric dispersant.

102. The composition of any one of items 76 to 101, wherein the dispersant comprises a polymeric non-ionic dispersant, polymeric ionic dispersant, a polymeric pigment dispersant, or a combination thereof.

103. The composition of any one of items 76 to 102, wherein the dispersant comprises ADDITOL VXW 6208® (polymeric non-ionic dispersant), K-SPERSE A504 (polymeric non-ionic graphene dispersant), MULTIWET EF-LQ-AP® (polymeric non-ionic dispersant), HPERMER KD6-LQ-MV® (polymeric non-ionic dispersant blend), BRIJ-03-LQ-AP® (nonionic alkyl polyglycol ethers dispersant), SP BRIJ 02 MBAL LQ-AP® (nonionic alkyl polyglycol ethers dispersant), ANTI-TERRA-204® (polymeric ionic dispersant, polycarboxylic acid salt of polyamine amides), TEGO Dispers 670® (polymeric non-ionic dispersant), TEGO Dispers 1010® (polymeric non-ionic dispersant), TEGO® Glide 410® (polyether siloxane copolymer); or a combination thereof.

104. The composition of any one of items 76 to 103, wherein the dispersant is present in a range of about 0.1 wt % to about 1.5 wt %, or about 0.1 wt % to about 1 wt %, or about 0.1 wt % to about 0.5 wt %, based on Part A wt % or total wt %.

105. The composition of any one of items 76 to 104, further comprising a wear inhibitor.

106. The composition of any one of items 76 to 105, wherein the wear inhibitor comprises graphite oxide, graphene, multilayered graphene flakes, titanium dioxide, microcrystalline magnesium silicate, fumed silica, micronized barium sulphate, or a combination thereof.

107. The composition of any one of items 76 to 106, wherein the wear inhibitor is present in a range of about 0.01 wt % to about 1 wt %, or about 0.05 wt % to about 0.5 wt % or about 0.05 wt % to about 0.8 wt %, based on Part A wt % or total wt %.

108. The composition of any one of items 76 to 107, further comprising a defoamer.

109. The composition of any one of items 76 to 108, wherein the defoamer comprises a polymeric defoamer.

110. The composition of any one of items 76 to 109, wherein the defoamer comprises a silicone-based oligomeric defoamer.

111. The composition of any one of items 76 to 110, wherein the defoamer comprises BYK-066 N, BYK-1790, ADDITOL VXW 6210 N, TEGO Airex 900, or a combination thereof.

112. The composition of any one of items 76 to 111, wherein the defoamer is optionally in a range of about 0.1 wt % to about 5 wt %, or about 0.1 wt % to about 1.5 wt %, or about 0.3 wt % to about 1.2 wt %, or about 1 wt % to about 5 wt %, based on Part A wt % or total wt %.

113. The composition of any one of items 76 to 112, further comprising a curing catalyst.

114. The composition of any one of items 76 to 113, wherein the curing catalyst comprises 2,4,6-tris[(dimethylamino)methyl]phenol.

115. The composition of any one of items 76 to 114, further comprising a hardener composition, the hardener composition comprising a hardener and optionally a diluent, the hardener being reactive in curing the composition to form a coating having a resistance to abrasive treatment with organic solvents of at least 50 passes, or between 50 and 80 passes when measured according to ASTM D1640.

116. The composition of any one of items 76 to 115, wherein the hardener comprises an amine hardener, amide hardener, or a combination thereof.

117. The composition of any one of items 76 to 116, wherein the hardener comprises phenalkamine, amine-modified phenalkamine, phenalkamides, amine-modified phenalkamides, polyamidoamine, organo-modified polyamidoamine, or a combination thereof.

118. The composition of any one of items 76 to 117, wherein the hardener is present at an amount to provide an epoxy group/NH ratio of about 1.2 to about 1.4.

119. The composition of any one of items 76 to 118, wherein the hardener is present in a range of about 70 wt % to about 100 wt %, or about 70 wt % to about 90 wt % of the hardener composition.

120. The composition of any one of items 76 to 119, wherein the diluent comprises a non-reactive diluent.

121. The composition of any one of items 76 to 120, wherein the diluent comprises such as xylene, benzyl alcohol, methyl ethyl ketone, methyl acetate, ethers, aromatic solvents, or a combination thereof.

122. The composition of any one of items 76 to 121, wherein the diluent is present in a range of about 1 to 30 wt %, or about 5 to 25 wt %, about 10 to 25 wt %; or about 1 to 5 wt % of the hardener composition.

123. A coating comprising a reaction product of a composition for a coating of any one of items 76 to 114 and a hardener.

124. A coating comprising a reaction product of a composition for a coating of any one of items 76 to 114 and the hardener composition according to any one of items 115 to 122.

125. The coating of item 123 or 124, further comprising a primer coating.

126. The coating of any one of items 123 to 125, further comprising a topcoat coating.

127. The coating of any one of items 123 to 126, having a bending strength of at least 10 mm when measured by a cylindrical bend test.

128. The coating of any one of items 123 to 127, having a bending strength of at least 8 mm, or at least 6 mm when measured by a cylindrical bend test.

129. The coating of any one of items 123 to 128, having a substrate adhesion of at least 3 MPa when measured according to ASTM D4541, an overcoat adhesion of at least 3 MPa when measured according to ASTM D4541, or a recoat adhesion window of at least 4 hours when measured according to ASTM D3359, or a combination thereof.

130. The coating of any one of items 123 to 129, having a substrate adhesion of about 3 MPa to about 15 MPa, or about 3 MPa to about 10 MPa when measured according to ASTM D4541, an overcoat adhesion of about 3 MPa to about 15 MPa, or about 3 MPa to about 10 MPa when measured according to ASTM D4541, or a recoat adhesion window between about 4 hours to about 72 hours when measured according to ASTM D3359; or a combination thereof.

131. The coating of any one of items 123 to 130, having a reduced noise radiation of about 2 dB to about 10 dB per about 100 μm of coating thickness at frequencies of about 10 Hz to about 10 kHz when measured on a 3 mm thickness cold rolled steel metal plate relative to a 3 mm thickness cold rolled steel metal plate coated with a coating free of the ceramic performance additive.

132. The coating of any one of items 123 to 131, having reduced noise radiation of about 3 dB to about 9 dB, about 5 dB to about 9 dB, or about 5 dB to about 7 dB per about 100 μm of coating thickness.

133. Use of a composition for a coating of any one of items 123 to 132 for forming a coating on a substrate.

134. The use of item 133, wherein the substrate is a surface of a marine vessel, such as a boat or ship; or marine equipment, such as a sensor or propeller.

135. The use of any one of items 133 to 134, wherein the substrate is a surface of a marine vessel hull.

136. Use of a coating comprising a reaction product of a composition for a coating of any one of items 76 to 114 and a hardener for reducing underwater radiated noise.

137. Use of a coating comprising a reaction product of a composition for a coating of any one of items 76 to 114 and the hardener composition according to items 115 to 122 for reducing underwater radiated noise.

138. A composition for a coating, comprising:
a solvent-borne epoxy resin;
a diluent;
an adhesion promoter comprising a dry adhesion promoter, a wet adhesion promoter, a dry/wet adhesion promoter, or a combination thereof;
a rheology modifier comprising an anti-settling rheology modifier; an anti-sagging rheology modifier; surface-leveling rheology modifier, or a combination thereof; and
a ceramic performance additive comprising hollow ceramic spheres, non-hollow ceramic particles, or a combination thereof.

139. The composition of item 138, wherein the epoxy resin comprises a hybrid epoxy-siloxane resin.

140. The composition of any one of items 138 to 139, wherein the epoxy resin is present at an amount between about 30 to about 55 wt %, or between about 40 to about 50 wt %, based on Part A.

141. The composition of any one of items 138 to 140, further comprising a hydrophobicity-modifying additive, the hydrophobicity-modifying additive comprising an epoxy-functional silane, an epoxy-functional polydialkylsiloxane, or a combination thereof.

142. The composition of any one of items 138 to 141, wherein the hydrophobicity-modifying additive comprises an epoxy-functional polydialkylsiloxane.

143. The composition of any one of items 138 to 142, wherein the hydrophobicity-modifying additive comprises an epoxy-functional polydialkylsiloxane.

144. The composition of any one of items 138 to 143, wherein the epoxy-functional silane comprises glycidoxypropyltrimethoxysilane.

145. The composition of any one of items 138 to 144, wherein the diluent comprises a non-reactive diluent.

146. The composition of any one of items 138 to 145, wherein the non-reactive diluent comprises xylene, cyclohexane, toluene, methyl acetate, methyl ethyl ketone, tert-butyl acetate, nonyl phenol, cyclohexanedimethanol, n-butyl alcohol, benzyl alcohol, isopropyl alcohol, polyethylene glycol, propylene glycol, phenol, or a combination thereof.

147. The composition of any one of items 138 to 146, wherein the non-reactive diluent comprises benzyl alcohol, xylene, methyl ethyl ketone, methyl acetate, ethers, or aromatic solvents, or a combination thereof.

148. The composition of any one of items 138 to 147, wherein the non-reactive diluent is present in a range of about 1 wt % to about 20 wt %, or about 1 wt % to about 10 wt %, or about 5 wt % to about 20 wt %; or about 5 wt % to about 15 wt %, based on Part A wt %; or in a range of about 1 wt % to about 25 wt %, or about 5 wt % to about 20 wt %, or about 5 wt % to about 15 wt, based on total wt %.

149. The composition of any one of items 138 to 148, wherein the dry adhesion promoter, the dry/wet adhesion promoter, and/or the wet adhesion promoter are non-reactive, reactive in a epoxy resin polymerization, reactive with a substrate, and/or reactive with metal oxides; or a combination thereof.

150. The composition of any one of items 138 to 149, wherein the dry adhesion promoter is non-reactive, reactive in a epoxy resin polymerization, reactive with a substrate, and/or reactive with metal oxides.

151. The composition of any one of items 138 to 150, wherein the dry adhesion promoter comprises an alkoxylated silane.

152. The composition of any one of items 138 to 151, wherein the dry adhesion promoter comprises an epoxy-functional alkoxylated silane, an amino-functional alkoxylated silane, or a combination thereof.

153. The composition of any one of items 138 to 152, wherein the dry adhesion promoter comprises 3-(2,3-epoxypropoxy)propyltrimethoxysilane; glycidoxypropyltrimethoxysilane; aminopropyltriethoxysilane; 3-aminopropyltriethoxysilane; an secondary amino bis-silane; or a combination thereof.

154. The composition of any one of items 138 to 153, wherein the wet adhesion promoter is reactive with a substrate.

155. The composition of any one of items 138 to 154, wherein the wet adhesion promoter comprises a metal-doped phosphosilicate.

156. The composition of any one of items 138 to 155, wherein the wet adhesion promoter comprises a strontium phosphosilicate; a zinc phosphosilicate, a zinc calcium strontium aluminum orthophosphate silicate hydrate; or a combination thereof.

157. The composition of any one of items 138 to 156, wherein the dry/wet adhesion promoter is non-reactive, reactive with a substrate, and/or reactive with metal oxides.

158. The composition of any one of items 138 to 157, wherein the dry/wet adhesion promoter comprises a modified polyester, a modified polyester oligomer, a polyacrylic, a polyacrylate, a benzotriazole, a mercaptane-comprising polymer or pre-polymer, or a combination thereof.

159. The composition of any one of items 138 to 158, wherein the modified polyester comprises a modified polyester having a hydroxyl value enough about 30 mg to about 100 mg KOH/g.

160. The composition of any one of items 138 to 159, wherein the benzotriazole comprises an alkyl-substituted, hydroxylamine-substituted benzotriazole; a hydroxyphenyl-benzotriazole; or a combination thereof.

161. The composition of any one of items 138 to 160, wherein the dry adhesion promoter, the dry/wet adhesion promoter, and/or the wet adhesion promoter are metal adhesion promoters.

162. The composition of any one of items 138 to 161, wherein the dry adhesion promoter, the dry/wet adhesion promoter, and/or the wet adhesion promoter are copper or aluminum adhesion promoters.

163. The composition of any one of items 138 to 162, wherein the adhesion promoter is present in a range of about 0.1 wt % to about 10 wt %, about 0.1 wt % to about 8 wt %, about 0.1 wt % to about 5 wt %, or about 0.1 wt % to about 1 wt %, or about 1 wt % to about 5 wt %, or about 1 wt % to about 8 wt %; based on Part A wt % or total wt %.

164. The composition of any one of items 138 to 163, wherein the anti-settling rheology modifier comprises a silica, a clay, or a combination thereof.

165. The composition of any one of items 138 to 164, wherein the anti-settling rheology modifier comprises fumed silica, fumed silica surface modified with silane, fumed silica surface modified with dimethyldichlorosilane; or a combination thereof.

166. The composition of any one of items 138 to 165, wherein the anti-settling rheology modifier is present in a range of about 0.1 wt % to about 5 wt %, or about 0.3 wt % to about 3 wt %, or about 0.3 w % to about 2 wt %; based on Part A wt % or total wt %.

167. The composition of any one of items 138 to 166, wherein the an anti-sagging rheology modifier comprises a wax, a derivatized wax, or a combination thereof.

168. The composition of any one of items 138 to 167, wherein the anti-sagging rheology modifier comprises a castor oil wax, an organically-modified castor oil-derivative wax, a polyamide wax, a micronized polyamide wax, a micronized organo-modified polyamide wax, a micronized organo-modified polyamide wax derivative, or a combination thereof.

169. The composition of any one of items 138 to 168, wherein the anti-sagging rheology modifier comprises a castor oil wax, an organically-modified castor oil-derivative wax, or a combination thereof.

170. The composition of any one of items 138 to 169, wherein the anti-sagging rheology modifier is present in a range of about 0.1 wt % to about 1.5 wt %, or about 0.1 wt % to about 1 wt %, or about 0.1 w % to about 0.5 wt %, based on Part A wt % or total wt %.

171. The composition of any one of items 138 to 170, wherein the surface-leveling rheology modifier comprises a polyether siloxane copolymer.

172. The composition of any one of items 138 to 171, wherein the surface-leveling rheology modifier is present in a range of about 0.1 wt % to about 1.5 wt %, or about 0.1 wt % to about 1 wt %, or about 0.1 w % to about 0.5 wt %; based on Part A wt % or total wt %.

173. The composition of any one of items 138 to 172, wherein the hollow ceramics comprises hollow ceramic spheres having a particle size of about 10 μm to about 40 μm; about 20 μm to about 40 μm, or about 25 μm to about 35 μm; or about 10 μm to about 15 μm, or about 12 μm.

174. The composition of any one of items 138 to 173, wherein the hollow ceramic spheres are present in a range of about 5 wt % to about 15 wt.

175. The composition of any one of items 138 to 174, wherein the non-hollow ceramics particles having a particle size of about 0.1 μm to about 5 μm; about 0.5 μm to about 5 μm, or about 1 μm to about 5 μm; or about 2 μm to about 5 μm.

176. The composition of any one of items 138 to 175, wherein the non-hollow ceramic particles are present in a range of about 5 wt % to about 40 wt %, or about 10 wt % to about 35 wt %, or about 20 wt % to about 35 wt %, or about 10 wt % to about 20 wt %; based on Part A wt % or total wt %.

177. The composition of any one of items 138 to 176, wherein the non-hollow ceramic particles comprise titanium oxide, fumed silica, brown aluminium (Ill) oxide, fused aluminium (III) oxide, titanium alloys, or a combination thereof.

178. The composition of any one of items 138 to 177, wherein the non-hollow ceramic particles comprise titanium alloys titanium carbonitride, titanium carbide, or a combination thereof.

179. The composition of any one of items 138 to 178, further comprising a dispersant.

180. The composition of any one of items 138 to 179, wherein the dispersant comprises a polymeric dispersant.

181. The composition of any one of items 138 to 180, wherein the dispersant comprises a polymeric non-ionic dispersant, polymeric ionic dispersant, a polymeric pigment dispersant, or a combination thereof.

182. The composition of any one of items 138 to 181, wherein the dispersant comprises ADDITOL VXW 6208® (polymeric non-ionic dispersant), K-SPERSE A504 (polymeric non-ionic graphene dispersant), MULTIWET EF-LQ-AP® (polymeric non-ionic dispersant), HYPERMER KD6-LQ-MV® (polymeric non-ionic dispersant blend), BRIJ-03-Lam Q-AP® (nonionic alkyl polyglycol ethers dispersant), SP BRIJ 02 MBAL LQ-AP® (nonionic alkyl polyglycol ethers dispersant), ANTI-TERRA-204® (polymeric ionic dispersant, polycarboxylic acid salt of polyamine amides), TEGO Dispers 670® (polymeric non-ionic dispersant), TEGO Disperse 1010® (polymeric non-ionic dispersant), TEGO® Glide 410® (polyether siloxane copolymer); or a combination thereof.

183. The composition of any one of items 138 to 182, wherein the dispersant is present in a range of about 0.1 wt % to about 1.5 wt %, or about 0.1 wt % to about 1 wt %, or about 0.1 wt % to about 0.5 wt %; based on Part A wt % or total wt %.

184. The composition of any one of items 138 to 183, further comprising a wear inhibitor.

185. The composition of any one of items 138 to 184, wherein the wear inhibitor comprises graphite oxide, graphene, multilayered graphene flakes, titanium dioxide, microcrystalline magnesium silicate, fumed silica, micronized barium sulphate, or a combination thereof.

186. The composition of any one of items 138 to 185, wherein the wear inhibitor is present in a range of about 0.01 wt % to about 1 wt %, or about 0.05 wt % to about 0.5 wt %; or about 0.05 wt % to about 0.8 wt %, based on total wt %.

187. The composition of any one of items 138 to 186, further comprising a defoamer.

188. The composition of any one of items 138 to 187, wherein the defoamer comprises a polymeric defoamer.

189. The composition of any one of items 138 to 188, wherein the defoamer comprises a silicone-based oligomeric defoamer.

190. The composition of any one of items 138 to 189, wherein the defoamer comprises BYK-066 N, BYK-1790, ADDITOL VXW 6210 N, TEGO Airex 900, or a combination thereof.

191. The composition of any one of items 138 to 190, wherein the defoamer is optionally in a range of about 0.1 wt % to about 5 wt %, or about 0.1 wt % to about 1 wt %, or about 1 wt % to about 5 wt %, based on Part A wt % or total wt %.

192. The composition of any one of items 138 to 191, further comprising a weather-resistance additive.

193. The composition of any one of items 138 to 192, wherein the weather-resistance additive comprises a hydroxyphenyl-benzotriazole, a hydroxyphenyl-triazine, or a combination thereof.

194. The composition of any one of items 138 to 193, wherein the weather-resistance additive comprises 95% Benzenepropanoic acid, 3-(2H-benzotriazol-2-yl)-5-(1,1-dimethylethyl)-4-hydroxy-, C7-9-branched and linear alkyl esters, 5% 1-methoxy-2-propyl acetate (Tinuvin 99-2®); 2-(2H-benzotriazol-2-yl)-4,6-bis(1-methyl-1-phenylethyl)phenol (Tinuvin 900®); 2-[4-[2-Hydroxy-3-tridecyloxypropyl]oxy]-2-hydroxyphenyl]-4,6-bis(2,4-dimethylphenyl)-1,3,5-triazine and 2-[4-[2-hydroxy-3-didecyloxypropyl]oxy]-2-hydroxyphenyl]-4,6-bis(2,4-dimethylphenyl)-1,3,5-triazine (Tinuvin 400®); or a combination thereof.

195. The composition of any one of items 138 to 194, wherein the weather-resistance additive is a wet/dry adhesion promotor.

196. The composition of any one of items 138 to 195, wherein the weather-resistance additive is present in a range of about 0.5 wt % to about 5 wt %, or about 1 wt % to about 5 wt %.

197. The composition of any one of items 138 to 196, further comprising a curing catalyst.

198. The composition of any one of items 138 to 197, wherein the curing catalyst comprises 2,4,6-tris[(dimethylamino)methyl]phenol.

199. The composition of any one of items 138 to 198, further comprising a hardener composition, the hardener composition comprising a hardener and optionally a diluent, the hardener being reactive in curing the composition to form a coating having a resistance to abrasive treatment with organic solvents of at least 50 passes, or between 50 to 80 passes when measured according to ASTM D1640.

200. The composition of any one of items 138 to 199, wherein the hardener comprises an silamine, amine hardener, amide hardener, or a combination thereof.

201. The composition of any one of items 138 to 200, wherein the hardener comprises a silamine hardener.

202. The composition of any one of items 138 to 201, wherein the silamine hardener comprises aminopropyltriethoxysilane, triamino-functional propyltrimethoxysilane; or a combination thereof.

203. The composition of any one of items 138 to 202, wherein the hardener is present at an amount to provide an epoxy group/NH ratio of about 0.9 to about 1.1, or about 1.

204. The composition of any one of items 138 to 203, wherein the hardener is present in a range of about 70 wt % to about 100 wt %, or about 70 wt % to about 90 wt % of the hardener composition.

205. The composition of any one of items 138 to 204, wherein the diluent comprises a non-reactive diluent.

206. The composition of any one of items 138 to 205, wherein the diluent comprises xylene, benzyl alcohol, methyl ethyl ketone, methyl acetate, ethers, aromatic solvents, or a combination thereof.

207. The composition of any one of items 138 to 205, wherein the diluent is present in a range of about 1 to about 20 wt %, or about 1 to about 30 wt % of the hardener composition.

208. The composition of any one of items 138 to 206, wherein the hardener composition further comprises a curing catalyst.

209. The composition of any one of items 138 to 207, wherein the curing catalyst comprises 2,4,6-tris[(dimethylamino)methyl]phenol.

210. A coating comprising a reaction product of a composition for a coating of any one of items 138 to 198 and a hardener.

211. A coating comprising a reaction product of a composition for a coating of any one of items 138 to 198 and the hardener composition according to items 199 to 209.

212. The coating of any one of items 210 to 211, further comprising a primer coating, the primer coating comprising a reaction product of a composition for a primer coating and a hardener.

213. The coating of any one of items 210 to 212, wherein the composition for a primer coating comprises an epoxy resin or a urethane resin.

214. The coating of any one of items 210 to 213, wherein the composition for a primer coating comprises an epoxy resin.

215. The coating of any one of items 210 to 214, wherein the composition for a primer coating comprises at least 10 wt % epoxy resin.

216. The coating of any one of items 210 to 215, wherein the composition for a primer coating comprises an adhesion promoter comprising a dry adhesion promoter, a wet adhesion promoter, a dry/wet adhesion promoter, or a combination thereof.

217. The coating of any one of items 210 to 216, wherein the composition for a primer coating comprises fillers for producing micro-roughness and inducing the gas-liquid barrier properties in the dried primer.

218. The coating of any one of items 210 to 217, wherein the fillers comprise magnesium silicate (talc), wollastonite, barium sulfate, fumed silica, or a combination thereof, in amount not less than 30% wt based on total formula weight.

219. The coating of any one of items 210 to 218, having a bending strength of at least 10 mm when measured by a cylindrical bend test.

220. The coating of any one of items 210 to 219, having a bending strength of at least 8 mm, or at least 6 mm when measured by a cylindrical bend test.

221. The coating of any one of items 210 to 220, having a substrate adhesion of at least 3 MPa when measured according to ASTM D4541, an overcoat adhesion of at least 3 MPa when measured according to ASTM D4541, or a combination thereof.

222. The coating of any one of items 210 to 221, having a substrate adhesion of about 3 MPa to about 15 MPa, or about 3 MPa to about 10 MPa, or about 3 MPa to about 7 MPa, or about 5 MPa to about 7 MPa when measured according to ASTM D4541, an overcoat adhesion of about 3 MPa to about 15 MPa, or about 3 MPa to about 10 MPa, or about 3 MPa to about 7 MPa, or about 5 MPa to about 7 MPa when measured according to ASTM D4541; or a combination thereof.

223. The coating of any one of items 210 to 222, having a dry adhesion to metal substrate of at least 3 MPa, wet adhesion to metal substrate of at least 4 MPa, or a combination thereof.

224. The coating of any one of items 210 to 223, having a dry adhesion of about 3 to about 15 MPa, or about 3 to about 10 MPa, to about 3 to about 5 MPa, a wet adhesion of about 4 to about 15 MPa, or about 4 to about 10 MPa, or about 5 to about 7 MPa, or a combination thereof.

225. The coating of any one of items 210 to 224, having a hardness of at least 5H when measured according to ASTM D3363.

226. The coating of any one of items 210 to 225, having a hardness of about 6H to about 8H, or about 8H.

227. Use of a composition for a coating of any one of items 210 to 226 for forming a coating on a substrate.

228. The use of item 227, wherein the substrate is a surface of a marine vessel, such as a boat or ship; or marine equipment, such as a sensor or propeller.

229. The use of any one of items 227 to 228, wherein the substrate is a surface of a propeller.

230. Use of a coating comprising a reaction product of a composition for a coating of any one of items 138 to 198 and a hardener for reducing cavitation.

231. Use of a coating comprising a reaction product of a composition for a coating of any one of items 138 to 198 and the hardener composition according to items 199 to 209 for reducing cavitation.

To gain a better understanding of the invention described herein, the following examples are set forth. It should be understood that these examples are for illustrative purposes only. Therefore, they should not limit the scope of this invention in anyway.

### EXAMPLES

### Example—Compositions for Coating, Reduced Noise Radiation and/or Increased Hardness

### 1.1 Materials Used in Compositions for a Coating, Made and Tested

| | | Alternative |
|---|---|---|
| | Trade name | Component Trade- |
| Component/Additive | (Supplier) | name (Supplier) |
| Microcrystalline magnesium silicate | Talc Silverline 202 | Mistron 002 (Imerys) |
| (particle size-median diameter, 19.8 microns; % talc- | (Imerys) | |
| >98; % dolomite/chlorite-<2; Hegman finesness of | | |
| grind-2.5; 200 mesh, % passing-99)-Wear inhibitor, | | |
| rheology modifier | | |
| Hollow ceramic meso-spheres | Zeeospheres G 600 | W410 or W610 Ceramic |
| (particle size-35 microns, 95^{th} percentile; density-2.3; | (Zeospheres Ceramics | Spheres (3M) |
| surface area-4 m²/cc) | LLC) | |
| Hollow ceramic micro-spheres | Zeeospheres G-200 | W210 Ceramic Spheres |
| (particle size-12 microns, 95^{th} percentile; density-2.5; | PC (Zeospheres | (3M) |
| surface area-5 m²/cc) | Ceramics LLC) | |
| Hollow glass meso-spheres | SPHERICAL 34P30 | S35 Glass bubbles (3M) |
| (particle size-68 microns, 97^{th} percentile; density- | (Potters) | |
| 0.34 ± 0.05) | | |
| Hollow glass micro-spheres | SPHERICAL 110P8 | S35 Glass bubbles (3M) |
| (particle size-25 microns, 97^{th} percentile; density-1.1 ± | (Potters) | |
| 0.05) | | |
| Critical CO₂-treated and mechanically ground PDMS | Aerogel IC 3110 | |
| (particle size-0.1-0.7 mm; pore diameter-~20 nm; | (Cabot) | |
| particle density-120-150 kg/m³) | | |
| 2,4,6-Tris [(dimethylamino)methyl]phenol; Curing | Docure KH-76K | Kukdo (KUKDO |
| catalyst | (Kukdo Hardener) | CHEMECAL) |
| Xylene, aromatic solvent | Xylene | Cyclohexane, toluene |
| Methyl acetate | Methyl Acetate | Tert-butyl acetate |
| Benzyl Alcohol | Benzyl Alcohol | |
| Polymer-based defoamer (proprietary chemical | BYK-066 N (BYK) | BYK-1790 (BYK), |
| formula; defoamer for solvent-free coatings, printing | | ADDITOL VXW 6210N |
| inks) | | (Allnex) |
| Butyl glycidyl ether; Reactive diluent | Epodil 741 (Evonik) | EPODIL ® LV5 (Evonik) |
| C12-14 aliphatic glycidyl ether, Reactive diluent. | XD-748 (Anhui | |
| | Xinyuan Chemical Co., | |
| | Ltd.) | |
| Organo-modified derivative of Aluminium | CLAYTONE-HY (BYK) | CLAYTONE-APA (BYK) |
| phyllosilicate clay | | |
| (density-1.6 g/cm³; dry sieve size-metric 98%, | | |
| <32 μm); Rheology modifier | | |
| Titanium dioxide (rutile); Wear Inhibitor | Ti-Pure R-706 (Du- | CR-828 (Tronox) |
| | Pont) | |
| Polymeric pigment dispersant (proprietary chemical | K-SPERSE A504 ® | |
| formula; 99% non-volatile, acid number-28; viscosity | (King Industries Inc.) | |
| @ 75° C.-22 poise; specific gravity @ 25° C.-1) | | |
| Polymeric non-ionic dispersant (proprietary chemical | ADDITOL VXW 6208 | Multiwet-EF (Croda) |
| formula; polymeric non-ionic dispersing additive) | (Allnex) | |
| Low viscosity epoxy resin (proprietary chemical | DLVE-18 Epoxy | D.E.R. 353 (Palmer |
| formula; low viscosity epoxy resin modified with a | Resin (Olin Resins) | Holland) |
| Cycloaliphatic polyglycidyl ether for high solids coating | | |
| formulations; viscosity-400-1000 cps @ 25° C.) | | |
| Cycloaliphatic polyglycidyl ether-modified epoxy | DLVE-52 Epoxy | D.E.R. 353 (Palmer |
| resin (proprietary chemical formula; ultra low viscosity | Resin (Olin Resins) | Holland) |
| epoxy resin modified with a Cycloaliphatic polyglycidyl | | |
| ether (free of organic solvent) for high solids coating | | |
| formulations; viscosity-350-550 cps @ 25° C.) | | |
| Bisphenol A epoxy resin (viscosity-11,500-13,500 | YD-128 (Kukdo | |
| cps @ 25° C.) | Chemicals Ltd.) | |
| Glycidoxypropyltrimethoxysilane (synonym-3-(2,3- | Andisil 187 (AB | Silquest* A-1170 |
| Epoxypropoxy)propyltrimethoxysilane); Adhesion | Chemicals) | (Momentive) |
| Promoter | | |
| Amine-modified Phenalkamine (proprietary chemical | Ancamine 2811 | |
| formula; viscosity-1700-3400 cps @ 25° C.; amine | (Evonik) | |
| value (mg KOH/g-173); Hardener | | |
| Phenalkamine (proprietary chemical formula; viscosity- | Cardolite NX-5444 | DOCURE KMH-100 |
| 4210 cps @ 25° C.; amine value (mg KOH/g-230); | (Cardolite) | PHENALKAMINE |
| Hardener) | | HARDENER (KUKDO |
| | | CHEMECAL) |
| Modified poly-amidoamine (proprietary chemical | Ancamide 2832 | ANCAMIDE ® 2137 |
| formula; viscosity-500-2000 cps @ 25° C.; amine value | (Evonik) | (Evonik) |
| (mg KOH/g-325-450); Hardener | | |
| Silicone-epoxy hybrid resin (proprietary chemical | SILIKOPON EF | SILIKOPON ED |
| formula; viscosity-approx. 1500 cps @ 25° C.; epoxy | | (EVONIK) |
| equivalent weight-calc. on non-volatile content-450 | | |
| g) | | |
| Castor oil, organically modified derivative | Thixatrol ST | Crayvallac Super |
| (proprietary chemical formula; (particle size-fine; | (Elementis) | (Palmer Holland) |
| density-1.02 g/cm³); Rheology modifier | | |
| 95% Benzenepropanoic acid, 3-(2H-benzotriazol-2- | Tinuvin 99-2 (BASF) | Tinuvin 900 or Tinuvin |
| yl)-5-(1, 1-dimethylethyl)- | | 400 (BASF) |
| 4-hydroxy-, C7-9-branched and linear alkyl esters, | | |
| 5% 1-methoxy-2-propyl acetate-Weather-resistant | | |
| additive | | |
| Epoxy-functional PDMS-based oligomer (epoxy | BYK Silclean 3701 | |
| equivalent weight-1600 g/equivalent; density-0.99 | | |
| g/mL) | | |
| Fumed SiO₂ (amorphous, treated with | Cab-O-Sil TS-610 | |
| dimethyldichlorosilane; B.E.T. Surface Area 125 m²/g; | Fumed silica | |
| Average Particle (Aggregate) Length 0.2-0.3 microns)- | | |
| Rheology modifier , wear inhibitor, | | |
| Polyamide wax derivative, micronized (proprietary | Crayvallac Super | Thixatrol ST (Elementis) |
| chemical formula; particle size-1.8 (DV min)-15 μm | (Palmer Holland) | |
| (DV max); density @ 25° C.-0.98 g/m³); Rheology | | |
| modifier | | |
| Multilayered graphene flakes (synonym-graphene | | |
| nanoplatelets)-Wear inhibitor | | |
| Aminopropyltriethoxysilane (synonym-Silamine); | Andisil 1100 Silane | Dynasylan AMEO |
| Hardener, Adhesion promoter | (AB Chemicals) | (Evonik) |
| Micronized barium sulphate; Wear Inhibitor, Sound | VB Techno | |
| dampening additive | | |
| Flow/Wetting Additive/Rheology modifier/Dispersant- | TEGO ® Glide 410 ® | |
| Polyether siloxane copolymer | (Evonik) | |

### 1.2 Compositions for a Coating—Formulations Made and Tested

| Batch | | | |
|---|---|---|---|
| code: | 156.blank | | |
| # Part A | Composition | %, wt | %, vol |
| 1A | Low viscosity epoxy resin modified with a cycloaliphatic | 14.81% | 14.73% |
| | polyglycidyl ether; viscosity-400-1000 cps @ 25° C. | | |
| 2A | Cycloaliphatic polyglycidyl ether-modified epoxy resin; | 14.81% | 14.73% |
| | viscosity-350-550 cps @ 25° C. | | |
| 3A | Polymeric non-ionic dispersant | 1.48% | 1.54% |
| 4A | Polymeric pigment dispersant | 0.99% | 1.08% |

Mix 5 mins @ 1 krpm, Ross

| | | | |
|---|---|---|---|
| 6A | Titanium dioxide | 4.94% | 4.94% |
| 7A | Organo-modified derivative of Aluminium phyllosilicate | 3.16% | 2.16% |
| | clay | | |
| 8A | Microcrystalline magnesium silicate | 6.91% | 2.70% |

Grind 8 mins @ 3 krpm, Ross

| | | | |
|---|---|---|---|
| 9A | C12-14 aliphatic glycidyl ether | 9.87% | 12.14% |
| 10A | 1,2-Epoxy-3-phenoxypropane | 9.87% | 11.87% |
| 11A | Polymer-based defoamer | 1.97% | 2.67% |
| 12A | Benzyl alcohol | 3.95% | 4.15% |
| 13A | 3-(2,3-Epoxypropoxy)propyltrimethoxysilane | 1.58% | 1.62% |
| 14A | Methyl acetate | 5.92% | 8.26% |
| 15A | Cycloaliphatic polyglycidyl ether-modified epoxy resin; | 19.74% | 19.64% |
| | viscosity-350-550 cps @ 25° C. | | |

Letdown 10 mins @ 1 krpm, Ross

| # Part B | Hardener Composition | %, wt | %, vol |
|---|---|---|---|
| 1B | Amidoamine | 79.48% | 76.44% |
| 2B | 2,4,6-Tris[(dimethylamino)methyl]phenol; Curing catalyst | 1.59% | 1.56% |
| 4B | Methyl acetate | 5.41% | 6.76% |
| 5B | Xylene | 13.52% | 15.24% |

156-URN2-SP1

| # Part A | Composition | %, wt | %, vol |
|---|---|---|---|
| 1A | Low viscosity epoxy resin modified with a cycloaliphatic | 9.60% | 6.66% |
| | polyglycidyl ether; viscosity-400-1000 cps @ 25° C. | | |
| 2A | Cycloaliphatic polyglycidyl ether-modified epoxy resin; | 9.60% | 6.66% |
| | viscosity-350-550 cps @ 25° C. | | |
| 3A | Polymeric non-ionic dispersant | 0.96% | 0.70% |
| 4A | Polymeric pigment dispersant | 0.64% | 0.49% |

Mix 5 mins @ 1 krpm, Ross

| | | | |
|---|---|---|---|
| 5A | Organo-modified derivative of Aluminium phyllosilicate clay | 2.05% | 0.98% |
| 6A | Titanium dioxide | 3.20% | 3.20% |

Grind 15 mins @ 5 krpm, Ross

| | | | |
|---|---|---|---|
| 7A | Hollow glass meso-spheres, particle size-68 microns | 35.19% | 56.8% |
| 8A | Microcrystalline magnesium silicate | 4.48% | 1.22% |

Grind 8 mins @ 3 krpm, Ross

| | | | |
|---|---|---|---|
| 9A | 1,2-Epoxy-3-phenoxypropane | 6.40% | 5.49% |
| 10A | Polymer-based defoamer | 6.40% | 5.37% |
| 11A | Benzyl alcohol | 1.28% | 1.21% |
| 12A | 3-(2,3-Epoxypropoxy)propyltrimethoxysilane | 2.56% | 1.88% |
| 13A | Methyl acetate | 1.02% | 0.73% |
| 14A | Cycloaliphatic polyglycidyl ether-modified epoxy resin; | 3.84% | 3.73% |
| | viscosity-350-550 cps @ 25° C. | | |

Letdown 10 mins @ 1 krpm, Ross

| # Part B | Hardener Composition | %, wt | %, vol |
|---|---|---|---|
| 1B | Amidoamine | 72.07% | 68.28% |
| 2B | Aromatic tertiary aminophenol | 7.57% | 9.31% |
| 3B | Xylene | 18.92% | 21.01% |

158_URN2_SP1/SP2

| # Part A | Composition | %, wt | %, vol |
|---|---|---|---|
| 1A | Low viscosity epoxy resin modified with a cycloaliphatic | 6.20% | 2.86% |
| | polyglycidyl ether; viscosity-400-1000 cps @ 25° C. | | |
| 2A | Cycloaliphatic polyglycidyl ether-modified epoxy resin; | 6.20% | 2.86% |
| | viscosity-350-550 cps @ 25° C. | | |
| 3A | Polymeric pigment dispersant | 0.41% | 0.21% |
| 4A | Polymeric non-ionic dispersant | 0.62% | 0.30% |

Mix 5 mins @ 1 krpm, Ross

| | | | |
|---|---|---|---|
| 5A | Titanium dioxide | 2.07% | 2.07% |
| 6A | Organo-modified derivative of Aluminium phyllosilicate clay | 2.07% | 0.62% |
| 7A | Graphene nanoplatelets | 0.13% | 0.03% |

Grind 15 mins @ 5 krpm, Ross

| | | | |
|---|---|---|---|
| 8A | Hollow glass meso-spheres, particle size-68 microns | 34.23% | 35.44% |
| 9A | Hollow glass micro-spheres, particle size-25 microns | 19.38% | 44.68% |

Grind 8 mins @ 4 krpm, Ross

| | | | |
|---|---|---|---|
| 10A | Microcrystalline magnesium silicate | 2.89% | 0.52% |
| 11A | Micronized barium sulphate | 3.88% | 0.45% |
| 12A | C12-14 aliphatic glycidyl ether | 6.46% | 3.68% |
| 13A | Polymer-based defoamer | 0.83% | 0.52% |
| 14A | Benzyl alcohol | 3.23% | 1.58% |
| 15A | 3-(2,3-Epoxypropoxy)propyltrimethoxysilane | 0.66% | 0.31% |
| 16A | Cycloaliphatic polyglycidyl ether-modified epoxy resin; | 8.27% | 3.81% |
| | viscosity-350-550 cps @ 25° C. | | |
| 17A | Methyl acetate | 2.48% | 1.60% |

Letdown 10 mins @ 1 krpm, Ross

| # Part B | Hardener Composition | %, wt | %, vol |
|---|---|---|---|
| 1B | Amidoamine | 75.82% | 71.51% |
| 2B | Xylene | 7.16% | 7.84% |
| 3B | Methyl acetate | 17.02% | 20.65% |

158_URN2_SP1/SP2
I. Blend the PasteA, Cowles mixer, 5 minutes @ 1000 rpm, r.t. (300-500 feet per minute)
Note: Add the components in the order as listed, then mix

| | | | |
|---|---|---|---|
| 1A | Low viscosity epoxy resin modified with a Cycloaliphatic polyglycidyl | 28.23 | 5-15% |
| | ether; viscosity-400-1000 cps @ 25° C. | | |
| 2A | Cycloaliphatic polyglycidyl ether-modified epoxy resin; viscosity-350- | 28.23 | 15-20% |
| | 550 cps @ 25° C. | | |
| 3A | Polymeric Pigment Dispersant | 1.88 | 0.2-1% |
| 4A | Polymeric non-ionoc dispersant | 2.82 | 0.8-2% |

II. Blend the Paste B, 5 minutes @ 1000 rpm, r.t. (300-500 feet per minute)
Note: Done separately; Add the components in the order as listed, then mix

| | | | |
|---|---|---|---|
| 5A | C12~14 aliphatic glycidyl ether | 29.41 | 5-12% |
| 6A | Polymer-based defoamer | 3.76 | 1-3% |
| 7A | Benzyl alcohol | 14.70 | 2-6% |
| 8A | 3-(2,3-Epoxypropoxy)propyltrimethoxysilane | 3.00 | 1-3% |
| 9A | Methyl Acetate | 11.29 | 1-6% |

III. Pigment Base B): Grind the pigments in Paste 1, Cowles mixer, 5 minutes @ 3000 rpm (1450
feet per minute), 50 C
Note: Add the pigments 1 by 1 into the Paste 1

| | | | |
|---|---|---|---|
| 10A | Titanium dioxide | 9.41 | 2-6% |
| 11A | Organo-modified derivative of Aluminium phyllosilicate clay | 9.41 | 1-3% |
| 12A | Graphene nanoplatelets | 0.59 | 0.3-0.5% |

IV. Add 30 g of Paste 2, 0.5 minutes @ 3000 rpm, (1450 feet per minute), r.t.
V. Grind the remaining pigments, Cowles mixer, 5 minutes @ 3000 rpm (1450 feet per minute), 50 C
Note: Add the pigments 1 by 1 into the Paste 1

| | | | |
|---|---|---|---|
| 13A | Hollow glass meso-spheres, particle size-68 microns / Hollow glass | 65.85 | 40-55% |
| | micro-spheres, particle size-25 microns | | |
| 14A | Microcrystalline Magnesium silicate | 13.18 | 1-7% |
| 15A | Barium sulfate | 17.65 | 2-7% |

VI. Add 32.17 g of Paste 2, 0.5 minutes @ 3000 rpm, 1450 feet per minute), r.t.

| | |
|---|---|
| 239.40 | 100% |

VII. Mix the catalyst Paste D, 5 minutes @ 1000 rpm, (300-500 feet per minute), r.t.

| | | | |
|---|---|---|---|
| 1B | Phenalkamine | 101.43 | 70-80% |
| 2B | Xylene | 9 | 1-9% |
| 3B | Methyl Acetate | 21 | 10-20% |
| | | 131.40 | 100% |

BC169_URN3-1

| # Part A | Composition | %, wt | %, vol |
|---|---|---|---|
| 1A | Low viscosity epoxy resin modified with a cycloaliphatic | 8.43% | 11.16% |
| | polyglycidyl ether; viscosity-400-1000 cps @ 25° C. | | |
| 2A | Cycloaliphatic polyglycidyl ether-modified epoxy resin; | 8.43% | 11.16% |
| | viscosity-350-550 cps @ 25° C. | | |
| 3A | Polymeric non-ionic dispersant | 0.84% | 1.17% |
| 4A | Polymeric pigment dispersant | 0.57% | 0.82% |

Mix 5 mins @ 1 krpm, Ross

| | | | |
|---|---|---|---|
| 5A | Graphene nanoplatelets | 0.18% | 0.18% |
| 6A | Titanium dioxide | 2.81% | 2.05% |
| 7A | Organo-modified derivative of Aluminium phyllosilicate clay | 2.81% | 2.41% |

Grind 15 mins @ 5 krpm, Ross

| | | | |
|---|---|---|---|
| 8A | rheology Modifier-Polyamide Wax Derivative, Micronized | 0.43% | 0.64% |

Grind 5 mins @ 3.55 krpm, Ross

| | | | |
|---|---|---|---|
| 9A | Hollow ceramic meso-spheres; particle size-35 microns | 35.74% | 20.81% |
| 10A | Microcrystalline magnesium silicate | 3.93% | 2.04% |
| 11A | Micronized barium sulphate | 5.27% | 1.76% |

Grind 10 mins @ 5 krpm, Ross

| | | | |
|---|---|---|---|
| 12A | 3-(2,3-Epoxypropoxy)propyltrimethoxysilane | 0.90% | 1.22% |
| 13A | C12-14 aliphatic glycidyl ether | 8.78% | 14.36% |
| 14A | Benzyl alcohol | 4.39% | 6.15% |
| 15A | Cycloaliphatic polyglycidyl ether-modified epoxy resin; | 11.24% | 14.87% |
| | viscosity-350-550 cps @ 25°° C. | | |
| 16A | Methyl acetate | 3.37% | 6.25% |
| 17A | Weather-resistant additive-95% Benzenepropanoic acid, 3- | 0.72% | 0.99% |
| | (2H-benzotriazol-2-yl)-5-(1, 1-dimethylethyl)-4-hydroxy-, C7- | | |
| | 9-branched and linear alkyl esters, 5% 1-methoxy-2-propyl | | |
| | acetate | | |
| 18A | Polymer-based defoamer | 1.13% | 2.02% |

Letdown 10 mins @ 1 krpm, Ross

| # Part B | Hardener Composition | %, wt | %, vol |
|---|---|---|---|
| 1B | Phenalkamine | 87.75% | 85.15% |
| 2B | Xylene | 3.58% | 4.03% |
| 3B | Methyl acetate | 8.67% | 10.82% |

BC169_URN3-1B

| # Part A | Composition | %, wt | %, vol |
|---|---|---|---|
| 1A | Low viscosity epoxy resin modified with a cycloaliphatic | 8.43% | 11.16% |
| | polyglycidyl ether; viscosity-400-1000 cps @ 25° C. | | |
| 2A | Cycloaliphatic polyglycidyl ether-modified epoxy resin; | 8.43% | 11.16% |
| | viscosity-350-550 cps @ 25° C. | | |
| 3A | Polymeric non-ionic dispersant | 0.84% | 1.17% |
| 4A | Polymeric pigment dispersant | 0.57% | 0.82% |

Mix 5 mins @ 1 krpm, Ross

| | | | |
|---|---|---|---|
| 5A | Graphene nanoplatelets | 0.18% | 0.18% |
| 6A | Titanium dioxide | 2.81% | 2.05% |
| 7A | Organo-modified derivative of Aluminium phyllosilicate clay | 2.81% | 2.41% |

Grind 15 mins @ 5 krpm, Ross

| | | | |
|---|---|---|---|
| 8A | Rheology Modifier-Polyamide Wax Derivative, Micronized | 0.43% | 0.64% |

Grind 5 mins @ 3.55 krpm, Ross

| | | | |
|---|---|---|---|
| 9A | Hollow ceramic meso-spheres; particle size-35 microns | 35.74% | 20.81% |
| 10A | Microcrystalline magnesium silicate | 3.93% | 2.04% |
| 11A | Micronized barium sulphate | 5.27% | 1.76% |

Grind 10 mins @ 5 krpm, Ross

| | | | |
|---|---|---|---|
| 12A | 3-(2,3-Epoxypropoxy)propyltrimethoxysilane | 0.90% | 1.22% |
| 13A | C12-14 aliphatic glycidyl ether | 8.78% | 14.36% |
| 14A | Benzyl alcohol | 4.39% | 6.15% |
| 15A | Cycloaliphatic polyglycidyl ether-modified epoxy resin; | 11.24% | 14.87% |
| | viscosity-350-550 cps @ 25° C. | | |
| 16A | Methyl acetate | 3.37% | 6.25% |
| 17A | Weather-resistant additive-95% Benzenepropanoic acid, 3- | 0.72% | 0.99% |
| | (2H-benzotriazol-2-yl)-5-(1, 1-dimethylethyl)-4-hydroxy-, C7- | | |
| | 9-branched and linear alkyl esters, 5% 1-methoxy-2-propyl | | |
| | acetate | | |
| 18A | Polymer-based defoamer | 1.13% | 2.02% |

Letdown 10 mins @ 1 krpm, Ross

| # Part B | Hardener Composition | %, wt | %, vol |
|---|---|---|---|
| 1B | Polyamidoamine | 87.75% | 85.15% |
| 2B | Xylene | 3.58% | 4.03% |
| 3B | Methyl acetate | 8.67% | 10.82% |

BC169_URN3-2

| # Part A | Composition | %, wt | %, vol |
|---|---|---|---|
| 1A | Low viscosity epoxy resin modified with a cycloaliphatic | 5.88% | 8.91% |
| | polyglycidyl ether; viscosity-400-1000 cps @ 25° C. | | |
| 2A | Cycloaliphatic polyglycidyl ether-modified epoxy resin; | 5.88% | 8.91% |
| | viscosity-350-550 cps @ 25° C. | | |
| 3A | Polymeric non-ionic dispersant | 0.59% | 0.93% |
| 4A | Polymeric pigment dispersant | 0.40% | 0.66% |

Mix 5 mins @ 1 krpm, Ross

| | | | |
|---|---|---|---|
| 5A | Graphene nanoplatelets | 0.12% | 0.12% |
| 6A | Titanium dioxide | 1.96% | 1.63% |
| 7A | Organo-modified derivative of Aluminium phyllosilicate clay | 1.96% | 1.92% |

Grind 15 mins @ 5 krpm, Ross

| | | | |
|---|---|---|---|
| 8A | Rheology Modifier-Polyamide Wax Derivative, Micronized | 0.30% | 0.51% |

Grind 5 mins @ 3.55 krpm, Ross

| | | | |
|---|---|---|---|
| 9A | Hollow ceramic meso-spheres; particle size-35 microns | 55.17% | 36.75% |
| 10A | Microcrystalline magnesium silicate | 2.74% | 1.63% |
| 11A | Micronized barium sulphate | 3.68% | 1.41% |

Grind 15 mins @ 5 krpm, Ross

| | | | |
|---|---|---|---|
| 12A | 3-(2,3-Epoxypropoxy)propyltrimethoxysilane | 0.63% | 0.98% |
| 13A | C12-14 aliphatic glycidyl ether | 6.13% | 11.47% |
| 14A | Benzyl alcohol | 3.07% | 4.91% |
| 15A | Cycloaliphatic polyglycidyl ether-modified epoxy resin; | 7.84% | 11.88% |
| | viscosity-350-550 cps @ 25° C. | | |
| 16A | Methyl acetate | 2.35% | 4.99% |
| 17A | Weather-resistant additive-95% Benzenepropanoic acid, 3- | 0.51% | 0.79% |
| | (2H-benzotriazol-2-yl)-5-(1, 1-dimethylethyl)-4-hydroxy-, C7- | | |
| | 9-branched and linear alkyl esters, 5% 1-methoxy-2-propyl | | |
| | acetate | | |
| 18A | Polymer-based defoamer | 0.79% | 1.62% |

Letdown 10 mins @ 1 krpm, Ross

| # Part B | Hardener Composition | %, wt | %, vol |
|---|---|---|---|
| 1B | Phenalkamine | 75.76% | 71.44% |
| 2B | Xylene | 7.23% | 7.91% |
| 3B | Methyl acetate | 17.02% | 20.65% |

BC169_URN3-3

| # Part A | Composition | %, wt | %, vol |
|---|---|---|---|
| 1A | Low viscosity epoxy resin modified with a cycloaliphatic | 5.88% | 8.91% |
| | polyglycidyl ether; viscosity-400-1000 cps @ 25° C. | | |
| 2A | Cycloaliphatic polyglycidyl ether-modified epoxy resin; | 5.88% | 8.91% |
| | viscosity-350-550 cps @ 25° C. | | |
| 3A | Polymeric non-ionic dispersant | 0.59% | 0.93% |
| 4A | Polymeric pigment dispersant | 0.40% | 0.66% |

Mix 5 mins @ 1 krpm, Ross

| | | | |
|---|---|---|---|
| 5A | Graphene nanoplatelets | 0.12% | 0.12% |
| 6A | Titanium dioxide | 1.96% | 1.63% |
| 7A | Organo-modified derivative of Aluminium phyllosilicate clay | 1.96% | 1.92% |

Grind 15 mins @ 5 krpm, Ross

| | | | |
|---|---|---|---|
| 8A | Rheology Modifier-Polyamide Wax Derivative, Micronized | 0.30% | 0.51% |

Grind 5 mins @ 3.55 krpm, Ross

| | | | |
|---|---|---|---|
| 9A | Hollow ceramic meso-spheres; particle size-35 | 55.17% | 36.75% |
| | micronsHollow ceramic meso-spheres; particle size-35 | | |
| | microns | | |
| 10A | Microcrystalline magnesium silicate | 2.74% | 1.63% |
| 11A | Micronized barium sulphate | 3.68% | 1.41% |

Grind 15 mins @ 5 krpm, Ross

| | | | |
|---|---|---|---|
| 12A | 3-(2,3-Epoxypropoxy)propyltrimethoxysilane | 0.63% | 0.98% |
| 13A | C12-14 aliphatic glycidyl ether | 6.13% | 11.47% |
| 14A | Benzyl alcohol | 3.07% | 4.91% |
| 15A | Cycloaliphatic polyglycidyl ether-modified epoxy resin; | 7.84% | 11.88% |
| | viscosity-350-550 cps @ 25° C. | | |
| 16A | Methyl acetate | 2.35% | 4.99% |
| 17A | Weather-resistant additive-95% Benzenepropanoic acid, 3- | 0.51% | 0.79% |
| | (2H-benzotriazol-2-yl)-5-(1, 1-dimethylethyl)-4-hydroxy-, C7- | | |
| | 9-branched and linear alkyl esters, 5% 1-methoxy-2-propyl | | |
| | acetate | | |
| 18A | Polymer-based defoamer | 0.79% | 1.62% |

Letdown 10 mins @ 1 krpm, Ross

| # Part B | Hardener Composition | %, wt | %, vol |
|---|---|---|---|
| 1B | Amine-modified phenalkamine | 75.65% | 71.11% |
| 2B | Xylene | 7.18% | 7.91% |
| 3B | Methyl acetate | 17.17% | 20.97% |

BC169_URN3-4

| # Part A | Composition | %, wt | %, vol |
|---|---|---|---|
| 1A | Low viscosity epoxy resin modified with a cycloaliphatic | 5.88% | 8.91% |
| | polyglycidyl ether; viscosity-400-1000 cps @ 25°° C. | | |
| 2A | Cycloaliphatic polyglycidyl ether-modified epoxy resin; | 5.88% | 8.91% |
| | viscosity-350-550 cps @ 25° C. | | |
| 3A | Polymeric non-ionic dispersant | 0.59% | 0.93% |
| 4A | Polymeric pigment dispersant | 0.40% | 0.66% |

Mix 5 mins @ 1 krpm, Ross

| | | | |
|---|---|---|---|
| 5A | Graphene nanoplatelets | 0.12% | 0.12% |
| 6A | Titanium dioxide | 1.96% | 1.63% |
| 7A | Organo-modified derivative of Aluminium phyllosilicate clay | 1.96% | 1.92% |

Grind 15 mins @ 5 krpm, Ross

| | | | |
|---|---|---|---|
| 8A | Rheology Modifier-Polyamide Wax Derivative, Micronized | 0.30% | 0.51% |

Grind 5 mins @ 3.55 krpm, Ross

| | | | |
|---|---|---|---|
| 9A | Hollow ceramic meso-spheres; particle size-35 microns | 55.17% | 36.75% |
| 10A | Microcrystalline magnesium silicate | 2.74% | 1.63% |
| 11A | Micronized barium sulphate | 3.68% | 1.41% |

Grind 15 mins @ 5 krpm, Ross

| | | | |
|---|---|---|---|
| 12A | 3-(2,3-Epoxypropoxy)propyltrimethoxysilane | 0.63% | 0.98% |
| 13A | C12-14 aliphatic glycidyl ether | 6.13% | 11.47% |
| 14A | Benzyl alcohol | 3.07% | 4.91% |
| 15A | Cycloaliphatic polyglycidyl ether-modified epoxy resin; | 7.84% | 11.88% |
| | viscosity-350-550 cps @ 25° C. | | |
| 16A | Methyl acetate | 2.35% | 4.99% |
| 17A | Weather-resistant additive-95% Benzenepropanoic acid, 3- | 0.51% | 0.79% |
| | (2H-benzotriazol-2-yl)-5-(1, 1-dimethylethyl)-4-hydroxy-, C7- | | |
| | 9-branched and linear alkyl esters, 5% 1-methoxy-2-propyl | | |
| | acetate | | |
| 18A | Polymer-based defoamer | 0.79% | 1.62% |

Letdown 10 mins @ 1 krpm, Ross

| # Part B | Hardener Composition | %, wt | %, vol |
|---|---|---|---|
| 1B | Amidoamine | 75.84% | 71.33% |
| 2B | Xylene | 7.11% | 7.83% |
| 3B | Methyl acetate | 17.05% | 20.84% |

| | BC169_URN3-5 | | |
|---|---|---|---|
| # Part A | Composition | %, wt | %, vol |
| 1A | Low viscosity epoxy resin modified with a cycloaliphatic | 3.41% | 5.14% |
| | polyglycidyl ether; viscosity-400-1000 cps @ 25° C. | | |
| 2A | Cycloaliphatic polyglycidyl ether-modified epoxy resin; | 3.41% | 5.14% |
| | viscosity-350-550 cps @ 25° C. | | |
| 3A | Polymeric non-ionic dispersant | 0.34% | 0.54% |
| 4A | Polymeric pigment dispersant | 0.23% | 0.38% |

Mix 5 mins @ 1 krpm, Ross

| | | | |
|---|---|---|---|
| 5A | Graphene nanoplatelets | 0.07% | 0.05% |
| 6A | Titanium dioxide | 1.14% | 1.14% |
| 7A | Organo-modified derivative of Aluminium phyllosilicate clay | 1.14% | 1.11% |

Grind 15 mins @ 5 krpm, Ross

| | | | |
|---|---|---|---|
| 8A | Rheology Modifier-Polyamide Wax Derivative, Micronized | 0.1-1% | 0.1-1% |

Grind 5 mins @ 3.55 krpm, Ross

| | | | |
|---|---|---|---|
| 9A | Hollow ceramic meso-spheres; particle size-35 microns | 62.68% | 41.54% |
| 10A | Microcrystalline magnesium silicate | 1.59% | 0.94% |
| 11A | Micronized barium sulphate | 2.13% | 0.81% |

Grind 15 mins @ 5 krpm, Ross

| | | | |
|---|---|---|---|
| 12A | 3-(2,3-Epoxypropoxy)propyltrimethoxysilane | 0.36% | 0.56% |
| 13A | C12-14 aliphatic glycidyl ether | 3.55% | 6.61% |
| 14A | Benzyl alcohol | 1.78% | 2.84% |
| 15A | Cycloaliphatic polyglycidyl ether-modified epoxy resin; | 4.55% | 6.86% |
| | viscosity-350-550 cps @ 25° C. | | |
| 16A | Methyl acetate | 3.40% | 7.17% |
| 17A | Weather-resistant additive-95% Benzenepropanoic acid, | 0.30% | 0.46% |
| | 3-(2H-benzotriazol-2-yl)-5-(1, 1-dimethylethyl)-4-hydroxy-, | | |
| | C7-9-branched and linear alkyl esters, 5% 1-methoxy- | | |
| | 2-propyl acetate | | |
| 18A | Polymer-based defoamer | 0.46% | 0.93% |
| 19A | Xylene | 0.00% | 0.00% |

Letdown 10 mins @ 1 krpm, Ross

| # Part B | Hardener Composition | %, wt | %, vol |
|---|---|---|---|
| 1B | Phenalkamine | 75.64% | 71.10% |
| 2B | Xylene | 7.17% | 7.90% |
| 3B | Methyl acetate | 17.20% | 21.00% |

| BC169_URN3-6 | | | |
|---|---|---|---|
| # Part A | Composition | %, wt | %, vol |
| 1A | Low viscosity epoxy resin modified with a cycloaliphatic | 3.41% | 5.14% |
| | polyglycidyl ether; viscosity-400-1000 cps @ 25° C. | | |
| 2A | Cycloaliphatic polyglycidyl ether-modified epoxy resin; | 3.41% | 5.14% |
| | viscosity-350-550 cps @ 25° C. | | |
| 3A | Polymeric non-ionic dispersant | 0.34% | 0.54% |
| 4A | Polymeric pigment dispersant | 0.23% | 0.38% |

Mix 5 mins @ 1 krpm, Ross

| | | | |
|---|---|---|---|
| 5A | Graphene nanoplatelets | 0.07% | 0.05% |
| 6A | Titanium dioxide | 1.14% | 1.14% |
| 7A | Organo-modified derivative of Aluminium phyllosilicate clay | 1.14% | 1.11% |

Grind 15 mins @ 5 krpm, Ross

| | | | |
|---|---|---|---|
| 8A | Rheology Modifier-Polyamide Wax Derivative, Micronized | 0.17% | 0.29% |

Grind 5 mins @ 3.55 krpm, Ross

| | | | |
|---|---|---|---|
| 9A | Hollow ceramic meso-spheres; particle size-35 microns | 62.68% | 41.54% |
| 10A | Microcrystalline magnesium silicate | 1.59% | 0.94% |
| 11A | Micronized barium sulphate | 2.13% | 0.81% |

Grind 15 mins @ 5 krpm, Ross

| | | | |
|---|---|---|---|
| 12A | 3-(2,3-Epoxypropoxy)propyltrimethoxysilane | 0.36% | 0.56% |
| 13A | C12-14 aliphatic glycidyl ether | 3.55% | 6.61% |
| 14A | Benzyl alcohol | 1.78% | 2.84% |
| 15A | Cycloaliphatic polyglycidyl ether-modified epoxy resin; | 4.55% | 6.86% |
| | viscosity-350-550 cps @ 25° C. | | |
| 16A | Methyl acetate | 3.40% | 7.17% |
| 17A | Weather-resistant additive-95% Benzenepropanoic acid, 3- | 0.30% | 0.46% |
| | (2H-benzotriazol-2-yl)-5-(1, 1-dimethylethyl)-4-hydroxy-, C7- | | |
| | 9-branched and linear alkyl esters, 5% 1-methoxy-2-propyl | | |
| | acetate | | |
| 18A | Polymer-based defoamer | 0.46% | 0.93% |

Letdown 10 mins @ 1 krpm, Ross

| # Part B | Hardener Composition | %, wt | %, vol |
|---|---|---|---|
| 1B | Phenalkamine | 75.45% | 71.09% |
| 2B | Xylene | 7.29% | 7.97% |
| 3B | Methyl acetate | 17.27% | 20.93% |

| BC169_URN3-7 | | | |
|---|---|---|---|
| # Part A | Composition | %, wt | %, vol |
| 1A | Low viscosity epoxy resin modified with a cycloaliphatic | 3.85% | 6.59% |
| | polyglycidyl ether; viscosity-400-1000 cps @ 25° C. | | |
| 2A | Cycloaliphatic polyglycidyl ether-modified epoxy resin; | 3.85% | 6.59% |
| | viscosity-350-550 cps @ 25° C. | | |
| 3A | Polymeric non-ionic dispersant | 0.38% | 0.69% |
| 4A | Polymeric pigment dispersant | 0.26% | 0.49% |

Mix 5 mins @ 1 krpm, Ross

| | | | |
|---|---|---|---|
| 5A | Graphene nanoplatelets | 0.08% | 0.08% |
| 6A | Titanium dioxide | 1.28% | 1.21% |
| 7A | Organo-modified derivative of Aluminium phyllosilicate clay | 1.28% | 1.42% |

Grind 15 mins @ 5 krpm, Ross

| | | | |
|---|---|---|---|
| 8A | Rheology Modifier-Polyamide Wax Derivative, Micronized | 0.20% | 0.38% |

Grind 5 mins @ 3.55 krpm, Ross

| | | | |
|---|---|---|---|
| 9A | Hollow ceramic meso-spheres; particle size-35 microns | 70.67% | 53.23% |
| 10A | Microcrystalline magnesium silicate | 1.80% | 1.21% |
| 11A | Micronized barium sulphate | 2.41% | 1.04% |

Grind 15 mins @ 5 krpm, Ross

| | | | |
|---|---|---|---|
| 12A | 3-(2,3-Epoxypropoxy)propyltrimethoxysilane | 0.41% | 0.72% |
| 13A | C12-14 aliphatic glycidyl ether | 4.01% | 8.48% |
| 14A | Benzyl alcohol | 2.01% | 3.63% |
| 15A | Cycloaliphatic polyglycidyl ether-modified epoxy resin; | 5.13% | 8.78% |
| | viscosity-350-550 cps @ 25° C. | | |
| 16A | Methyl acetate | 1.54% | 3.69% |
| 17A | Weather-resistant additive-95% Benzenepropanoic acid, 3- | 0.33% | 0.58% |
| | (2H-benzotriazol-2-yl)-5-(1, 1-dimethylethyl)-4-hydroxy-, | | |
| | C7-9-branched and linear alkyl esters, 5% 1-methoxy- | | |
| | 2-propyl acetate | | |
| 18A | Polymer-based defoamer | 0.51% | 1.20% |

Letdown 10 mins @ 1 krpm, Ross

| # Part B | Hardener Composition | %, wt | %, vol |
|---|---|---|---|
| 1B | Amine-modified phenalkamine | 75.66% | 71.12% |
| 2B | Xylene | 7.16% | 7.89% |
| 3B | Methyl acetate | 17.18% | 20.99% |

| BC169_URN3-8 | | | |
|---|---|---|---|
| # Part A | Composition | %, wt | %, vol |
| 1A | Low viscosity epoxy resin modified with a cycloaliphatic | 3.28% | 3.26% |
| | polyglycidyl ether; viscosity-400-1000 cps @ 25° C. | | |
| 2A | Cycloaliphatic polyglycidyl ether-modified epoxy resin; | 3.28% | 3.26% |
| | viscosity-350-550 cps @ 25° C. | | |
| 3A | Polymeric non-ionic dispersant | 0.33% | 0.34% |
| 4A | Polymeric pigment dispersant | 0.22% | 0.24% |

Mix 5 mins @ 1 krpm, Ross

| | | | |
|---|---|---|---|
| 5A | Graphene nanoplatelets | 0.07% | 0.03% |
| 6A | Titanium dioxide | 1.10% | 1.10% |
| 7A | Organo-modified derivative of Aluminium phyllosilicate clay | 1.10% | 0.71% |

Grind 15 mins @ 5 krpm, Ross

| | | | |
|---|---|---|---|
| 8A | Rheology Modifier-Polyamide Wax Derivative, Micronized | 0.16% | 0.18% |

Grind 5 mins @ 3.55 krpm, Ross

| | | | |
|---|---|---|---|
| 9A | Hollow ceramic micro-spheres; particle size-12 microns | 60.24% | 58.29% |
| 10A | Microcrystalline magnesium silicate | 1.53% | 0.60% |
| 11A | Micronized barium sulphate | 2.05% | 0.52% |
| 12A | 3-(2,3-Epoxypropoxy)propyltrimethoxysilane | 0.35% | 0.36% |
| 13A | C12-14 aliphatic glycidyl ether | 3.41% | 4.20% |
| 14A | Benzyl alcohol | 1.71% | 1.80% |
| 15A | Cycloaliphatic polyglycidyl ether-modified epoxy resin; | 4.38% | 4.35% |
| | viscosity-350-550 cps @ 25° C. | | |
| 16A | Methyl acetate | 1.31% | 1.82% |
| 17A | Weather-resistant additive-95% Benzenepropanoic acid, | 0.28% | 0.29% |
| | 3-(2H-benzotriazol-2-yl)-5-(1, 1-dimethylethyl)-4-hydroxy-, | | |
| | C7-9-branched and linear alkyl esters, 5% 1-methoxy-2- | | |
| | propyl acetate | | |
| 18A | Polymer-based defoamer | 0.44% | 0.59% |
| 19A | Microcrystalline magnesium silicate | 0.00% | 0.00% |
| 20A | Xylene | 14.77% | 18.57% |

Letdown 10 mins @ 1 krpm, Ross

| # Part B | Hardener Composition | %, wt | %, vol |
|---|---|---|---|
| 1B | Amine-modified phenalkamine | 75.47% | 70.97% |
| 2B | Xylene | 7.86% | 8.66% |
| 3B | Methyl acetate | 16.67% | 20.37% |

| BC169_URN3-9 | | | |
|---|---|---|---|
| # Part A | Composition | %, wt | %, vol |
| 1A | Low viscosity epoxy resin modified with a cycloaliphatic | 5.83% | 3.41% |
| | polyglycidyl ether; viscosity-400-1000 cps @ 25° C. | | |
| 2A | Cycloaliphatic polyglycidyl ether-modified epoxy resin; | 5.83% | 3.41% |
| | viscosity-350-550 cps @ 25° C. | | |
| 3A | Polymeric non-ionic dispersant | 0.59% | 0.36% |
| 4A | Polymeric pigment dispersant | 0.39% | 0.25% |

Mix 5 mins @ 1 krpm, Ross

| | | | |
|---|---|---|---|
| 5A | Graphene nanoplatelets | 0.12% | 0.04% |
| 6A | Titanium dioxide | 1.95% | 1.95% |
| 7A | Organo-modified derivative of Aluminium phyllosilicate clay | 1.95% | 0.74% |

Grind 15 mins @ 5 krpm, Ross

| | | | |
|---|---|---|---|
| 8A | Rheology Modifier-Polyamide Wax Derivative, Micronized | 0.29% | 0.19% |

Grind 5 mins @ 3.55 krpm, Ross

| | | | |
|---|---|---|---|
| 9A | Hollow glass micro-spheres, particle size-25 microns | 18.69% | 54.73% |
| 10A | Hollow ceramic micro-spheres; particle size-12 microns | 36.88% | 21.02% |
| 11A | Microcrystalline magnesium silicate | 2.72% | 0.63% |
| 12A | Micronized barium sulphate | 3.65% | 0.54% |

Grind 15 mins @ 5 krpm, Ross

| | | | |
|---|---|---|---|
| 13A | 3-(2,3-Epoxypropoxy)propyltrimethoxysilane | 0.62% | 0.37% |
| 14A | C12-14 aliphatic glycidyl ether | 6.07% | 4.40% |
| 15A | Benzyl alcohol | 3.04% | 1.88% |
| 16A | Cycloaliphatic polyglycidyl ether-modified epoxy resin; | 7.78% | 4.56% |
| | viscosity-350-550 cps @ 25° C. | | |
| 17A | Methyl acetate | 2.32% | 1.91% |
| 18A | Weather-resistant additive-95% Benzenepropanoic acid, | 0.51% | 0.30% |
| | 3-(2H-benzotriazol-2-yl)-5-(1, 1-dimethylethyl)-4-hydroxy-, | | |
| | C7-9-branched and linear alkyl esters, 5% 1-methoxy-2- | | |
| | propyl acetate | | |
| 19A | Polymer-based defoamer | 0.78% | 0.62% |

Letdown 10 mins @ 1 krpm, Ross

| # Part B | Hardener Composition | %, wt | %, vol |
|---|---|---|---|
| 1B | Amine-modified Phenalkamine | 75.48% | 70.93% |
| 2B | Xylene | 7.23% | 7.96% |
| 3B | Methyl acetate | 17.29% | 21.11% |

| BC169_URN3-11 | | | |
|---|---|---|---|
| # Part A | Composition | %, wt | %, vol |
| 1A | Low viscosity epoxy resin modified with a cycloaliphatic | 4.01% | 8.39% |
| | polyglycidyl ether; viscosity-400-1000 cps @ 25° C. | | |
| 2A | Cycloaliphatic polyglycidyl ether-modified epoxy resin; | 4.01% | 8.39% |
| | viscosity-350-550 cps @ 25° C. | | |
| 3A | Polymeric non-ionic dispersant | 0.40% | 0.88% |
| 4A | Polymeric pigment dispersant | 0.27% | 0.62% |

Mix 5 mins @ 1 krpm, Ross

| | | | |
|---|---|---|---|
| 5A | Graphene nanoplatelets | 0.08% | 0.08% |
| 6A | Titanium dioxide | 1.34% | 1.54% |
| 7A | Organo-modified derivative of Aluminium phyllosilicate | 1.34% | 1.81% |
| | clay | | |

Grind 15 mins @ 5 krpm, Ross

| | | | |
|---|---|---|---|
| 8A | Rheology Modifier-Polyamide Wax Derivative, | 0.20% | 0.48% |
| | Micronized | | |

Grind 5 mins @ 3.55 krpm, Ross

| | | | |
|---|---|---|---|
| 9A | Micronized barium sulphate | 62.59% | 33.14% |
| 10A | Hollow ceramic meso-spheres; particle size-35 microns | 9.39% | 8.65% |
| 11A | Microcrystalline magnesium silicate | 1.87% | 1.54% |

Grind 15 mins @ 5 krpm, Ross

| | | | |
|---|---|---|---|
| 12A | 3-(2,3-Epoxypropoxy)propyltrimethoxysilane | 0.43% | 0.92% |
| 13A | C12-14 aliphatic glycidyl ether | 4.17% | 10.80% |
| 14A | Benzyl alcohol | 2.09% | 4.62% |
| 15A | Cycloaliphatic polyglycidyl ether-modified epoxy resin; | 5.34% | 11.18% |
| | viscosity-350-550 cps @ 25° C. | | |
| 16A | Methyl acetate | 1.60% | 4.70% |
| 17A | Weather-resistant additive-95% Benzenepropanoic acid, | 0.34% | 0.74% |
| | 3-(2H-benzotriazol-2-yl)-5-(1, 1-dimethylethyl)-4-hydroxy-, | | |
| | C7-9-branched and linear alkyl esters, 5% 1-methoxy-2- | | |
| | propyl acetate | | |
| 18A | Polymer-based defoamer | 0.54% | 1.52% |

Letdown 10 mins @ 1 krpm, Ross

| # Part B | Hardener Composition | %, wt | %, vol |
|---|---|---|---|
| 1B | Amine-modified Phenalkamine | 75.68% | 71.15% |
| 2B | Xylene | 7.11% | 7.84% |
| 3B | Methyl acetate | 17.20% | 21.01% |

| BC169_URN3-12 | | | |
|---|---|---|---|
| # Part A | Composition | %, wt | %, vol |
| 1A | Bisphenol A epoxy resin | 6.42% | 8.87% |
| 2A | Cycloaliphatic polyglycidyl ether-modified epoxy resin; | 6.42% | 8.87% |
| | viscosity-350-550 cps @ 25° C. | | |
| 3A | Polymeric non-ionic dispersant | 0.64% | 0.99% |
| 4A | Polymeric pigment dispersant | 0.43% | 0.70% |

Mix 5 mins @ 1 krpm, Ross

| | | | |
|---|---|---|---|
| 5A | Graphene nanoplatelets | 0.14% | 0.14% |
| 6A | Titanium dioxide | 2.14% | 1.73% |
| 7A | Organo-modified derivative of Aluminium phyllosilicate | 2.14% | 2.04% |
| | clay | | |

Grind 15 mins @ 5 krpm, Ross

| | | | |
|---|---|---|---|
| 8A | Rheology Modifier-Polyamide Wax Derivative, | 0.33% | 0.54% |
| | Micronized | | |

Grind 5 mins @ 3.55 krpm, Ross

| | | | |
|---|---|---|---|
| 9A | Hollow ceramic meso-spheres; particle size-35 microns | 55.13% | 35.67% |
| 10A | Microcrystalline magnesium silicate | 2.99% | 1.73% |
| 11A | 3-(2,3-Epoxypropoxy)propyltrimethoxysilane | 0.68% | 1.04% |
| 12A | C12-14 aliphatic glycidyl ether | 6.68% | 12.14% |
| 13A | Benzyl alcohol | 3.34% | 5.20% |
| 14A | Cycloaliphatic polyglycidyl ether-modified epoxy resin; viscosity- | 8.55% | 12.57% |
| | 350-550 cps @ 25°° C. | | |
| 15A | Methyl acetate | 2.57% | 5.29% |
| 16A | Weather-resistant additive-95% Benzenepropanoic | 0.55% | 0.83% |
| | acid, 3-(2H-benzotriazol-2-yl)-5-(1, 1-dimethylethyl)-4- | | |
| | hydroxy-, C7-9-branched and linear alkyl esters, 5% 1- | | |
| | methoxy-2-propyl acetate | | |
| 17A | Polymer-based defoamer | 0.86% | 1.71% |

Letdown 10 mins @ 1 krpm, Ross

| # Part B | Hardener Composition | %, wt | %, vol |
|---|---|---|---|
| 1B | Amine-modified Phenalkamine | 75.63% | 71.08% |
| 2B | Xylene | 7.07% | 7.79% |
| 3B | Methyl acetate | 17.30% | 21.13% |

Grind 15 mins @ 5 krpm, Ross

| BC176_URN_1UG | | | |
|---|---|---|---|
| # Part A | Composition | %, wt | %, vol |
| 1A | Low viscosity epoxy resin modified with a cycloaliphatic | 3.41% | 5.14% |
| | polyglycidyl ether; viscosity-400-1000 cps @ 25° C. | | |
| 2A | Cycloaliphatic polyglycidyl ether-modified epoxy resin; viscosity- | 3.41% | 5.14% |
| | 350-550 cps @ 25° C. | | |
| 3A | Polymeric non-ionic dispersant | 0.34% | 0.54% |
| 4A | Polymeric pigment dispersant | 0.23% | 0.38% |

Mix 5 mins @ 1 krpm, Ross

| | | | |
|---|---|---|---|
| 5A | Graphene nanoplatelets | 0.07% | 0.05% |
| 6A | Titanium dioxide | 1.14% | 1.14% |
| 7A | Organo-modified derivative of Aluminium phyllosilicate | 1.14% | 1.11% |
| | clay | | |

Grind 15 mins @ 5 krpm, Ross

| | | | |
|---|---|---|---|
| 8A | Rheology Modifier-Polyamide Wax Derivative, | 0.17% | 0.29% |
| | Micronized | | |

Grind 5 mins @ 3.55 krpm, Ross

| | | | |
|---|---|---|---|
| 9A | Hollow ceramic meso-spheres; particle size-35 microns | 62.68% | 41.54% |
| 10A | Microcrystalline magnesium silicate | 1.59% | 0.94% |
| 11A | Micronized barium sulphate | 2.13% | 0.81% |

Grind 15 mins @ 5 krpm, Ross

| | | | |
|---|---|---|---|
| 12A | 3-(2,3-Epoxypropoxy)propyltrimethoxysilane | 0.36% | 0.56% |
| 13A | C12-14 aliphatic glycidyl ether | 3.55% | 6.61% |
| 14A | Benzyl alcohol | 1.78% | 2.84% |
| 15A | Cycloaliphatic polyglycidyl ether-modified epoxy resin; | 4.55% | 6.86% |
| | viscosity-350-550 cps @ 25° C. | | |
| 16A | Methyl acetate | 3.40% | 7.17% |
| 17A | Weather-resistant additive-95% Benzenepropanoic | 0.30% | 0.46% |
| | acid, 3-(2H-benzotriazol-2-yl)-5-(1, 1-dimethylethyl)-4- | | |
| | hydroxy-, C7-9-branched and linear alkyl esters, 5% 1- | | |
| | methoxy-2-propyl acetate | | |
| 18A | Polymer-based defoamer | 0.46% | 0.93% |
| 19A | Xylene | 0.00% | 0.00% |

Letdown 10 mins @ 1 krpm, Ross

| # Part B | Hardener Composition | %, wt | %, vol |
|---|---|---|---|
| 1B | Amine-modified Phenalkamine | 75.93% | 71.42% |
| 2B | Xylene | 7.05% | 7.78% |
| 3B | Methyl acetate | 17.02% | 20.80% |

| BC184_PROP_1 | | | |
|---|---|---|---|
| # Part A | Composition | %, wt | %, vol |
| 1A | Silicone-epoxy hybrid resin | 30.29% | 37.11% |
| 2A | Epoxy-functional PDMS-based oligomer | 1.96% | 2.67% |
| 3A | Flow-additive/wetting agent/rheology modifier/ | 0.50% | 0.66% |
| | Dispersant-Polyether siloxane copolymer | | |
| 4A | Weather-resistance additive-95% Benzenepropanoic acid, 3-(2H- | 0.94% | 1.18% |
| | benzotriazol-2-yl)-5-(1, 1-dimethylethyl)-4- | | |
| | hydroxy-, C7-9-branched and linear alkyl esters, 5% 1- | | |
| | methoxy-2-propyl acetate | | |

Mix 5 mins @ 1 krpm, Ross

| | | | |
|---|---|---|---|
| 5A | Titanium dioxide | 25.24% | 8.30% |
| 6A | Fumed silica | 1.12% | 0.76% |
| 7A | Graphene nanoplatelets | 0.32% | 0.32% |
| 8A | Graphite oxide | 0.80% | 0.50% |

Grind 15 mins @ 5 krpm, Ross

| | | | |
|---|---|---|---|
| 8A | Rheology modifier-Castor oil, organically modified | 0.60% | 0.80% |
| | derivative | | |

Grind 10 mins @ 4 krpm, Ross
Hold temperature between 55-60C for at least 5 mins

| | | | |
|---|---|---|---|
| 10A | Microcrystalline magnesium silicate | 1.96% | 0.95% |

Grind 10 mins @ 3 krpm, Ross

| | | | |
|---|---|---|---|
| 11A | Polymer-based defoamer | 0.56% | 0.79% |
| 12A | 3-(2,3-Epoxypropoxy)propyltrimethoxysilane | 1.12% | 1.42% |
| 13A | Methyl Acetate | 4.67% | 8.02% |
| 14A | Silicone-epoxy hybrid resin | 29.91% | 36.65% |

Letdown 10 mins @ 1 krpm, Ross

| # Part B | Hardener Composition | %, wt | %, vol |
|---|---|---|---|
| 1B | Aminopropyltriethoxysilane | 97.00% | 97.00% |
| 2B | 2,4,6-Tris[(dimethylamino)methyl]phenol | 3.00% | 3.00% |

BC184_PROP_3

| # Part A | Composition | %, wt | %, vol |
|---|---|---|---|
| 1A | Silicone-epoxy hybrid resin Hybrid epoxy-siloxane | 24.25% | 31.08% |
| | Solvent-borne Monomers | | |
| 2A | Rheology modifier-Castor oil, organically modified | 0.48% | 0.67% |
| | derivative | | |
| 3A | Flow-additive/wetting agent/rheology modifier/dispersant-Polyether | 0.4% | 0.56% |
| | siloxane copolymer | | |
| 4A | Weather-resistance additive-95% Benzenepropanoic | 1.1% | 1.4% |
| | acid, 3-(2H-benzotriazol-2-yl)-5-(1, 1-dimethylethyl)-4- | | |
| | hydroxy-, C7-9-branched and linear alkyl esters, 5% 1- | | |
| | methoxy-2-propyl acetate | | |

Grind 20 mins @ 5 krpm, Ross

| | | | |
|---|---|---|---|
| 5A | Titanium dioxide | 20.21% | 6.95% |
| 6A | Fumed silica | 0.90% | 0.63% |
| 7A | Graphene nanoplatelets | 0.9% | 0.68% |

Grind 20 mins @ 5 krpm, Ross

| | | | |
|---|---|---|---|
| 8A | Polymer-based defoamer | 0.45% | 0.66% |
| 9A | 3-(2,3-Epoxypropoxy)propyltrimethoxysilane | 0.90% | 1.19% |
| 10A | Microcrystalline magnesium silicate | 1.57% | 0.79% |

Mix 10 mins @ 2 krpm, Ross

| | | | |
|---|---|---|---|
| 11A | Methyl Acetate | 3.74% | 6.72% |
| 12A | Silicone-epoxy hybrid resin | 23.95% | 30.70% |
| 13A | Epoxy-functional PDMS-based oligomer | 1.57% | 2.24% |
| 14A | Hollow ceramic micro-spheres | 15.21% | 8.58% |
| | (particle size-12 microns) | | |
| 15A | Xylene | 4.72% | 7.66% |

Letdown 10 mins @ 1 krpm, Ross

| # Part B | Hardener Composition | %, wt | %, vol |
|---|---|---|---|
| 1B | Aminopropyltriethoxysilane | 97.00% | 97.00% |
| 2B | 2,4,6-Tris[(dimethylamino)methyl]phenol | 3.00% | 3.00% |

**Letdown refers to a process of combining and/or homogenizing all prepared components of a composition (for example, resins, diluents, additives, etc.). as a final mixing step.

### 1.3A General Description of Mixing Process Using Hollow Ceramic Spheres of Particle Size—12 Microns (for Example, Formulation BC184_PROP_1)

1. Check mixing vessel and confirm it is clean and free of damage, take the vessel weight and record it.
2. Perform equipment check including scale calibration, mixer blade, shaft, plugs, connections, safety sensors and ventilation system.
3. Confirm that the ratio between mixer impeller diameter and mixing vessel diameter is 2.3-3.
4. Place the empty mixing vessel on the scale and tare (Press Zero). 5. Add the required amount of the following raw materials. The scale must be tared in
between the addition of each ingredient. Record the amount and the lot number:

| | Required | Attained | Lot |
|---|---|---|---|
| Ingredient | amount (g) | amount (g) | number |
| Silicone-epoxy hybrid resin | 1153.3 | | |
| Defoamer-Silicone oligomer | 21.42 | | |
| Slip/Wetting Additive/Rheology | 19.01 | | |
| modifier/dispersant-Polyether | | | |
| siloxane copolymer | | | |
| Weather-resistance additive-95% | 35.72 | | |
| Benzenepropanoic acid, 3-(2H- | | | |
| benzotriazol-2-yl)-5-(1, 1- | | | |
| dimethylethyl)-4-hydroxy-, C7-9- | | | |
| branched and linear alkyl esters, 5% | | | |
| 1-methoxy-2-propyl acetate | | | |
| 3-(2,3-Epoxypropoxy) | 42.83 | | |
| propyltrimethoxysilane | | | |
| Total | 1272.28 | | |

6. Place the vessel on the scale and record the total weight and net weight of added ingredients (total weight−vessel weight).
7. Place the mixing vessel under the mixer and immerse the impeller into the coating solution, follow the rule of max 1.5×Dblade from the bottom of the vessel.
8. Secure the mixing vessel.
9. Set 1000 RPM and 5 minutes and start mixing the base resin.
10. Tare the scale and add the following in ingredient and amount to thin the mixture:

| | Required | Attained | Lot |
|---|---|---|---|
| Ingredient | amount (g) | amount (g) | number |
| Graphite oxide | 19.10 | | |
| Graphene nanoplatelets | 23.49 | | |
| Fumed Silica | 21.4 | | |

11. Set 1000 RPM and mix for 5 minutes to incorporate the filler.
12. Tare the scale and add the following ingredient and amount to thin the mixture:

| | Required | Attained | Lot |
|---|---|---|---|
| Ingredient | amount (g) | amount (g) | number |
| Fumed Silica | 21.4 | | |

13. Set 1000 RPM (500 feet per minute) and mix for 5 minutes to incorporate the remaining amount of filler.
14. When filler is fully incorporated, increase the speed to 2000 RPM and mix for 10 minutes.
15. Tare the scale and add the following ingredients and amounts to thin the mixture:

| | Required | Attained | Lot |
|---|---|---|---|
| Ingredient | amount (g) | amount (g) | number |
| Epoxy-functional PDMS-based | 75 | | |
| oligomer | | | |
| Silicone-epoxy hybrid resin | 196.4 | | |

16. Set 3000 RPM and start mixing.
17. Prepare the following ingredient and amount and start adding to the mixture:

| | Required | Attained | Lot |
|---|---|---|---|
| Ingredient | amount (g) | amount (g) | number |
| Titanium dioxide | 964.2 | | |
| Rheology modifier-Castor oil, | 23.08 | | |
| organically modified derivative | | | |

18. Measure temperature and record.
19. Make sure powders are incorporated, set speed to 4500 RPM and mix for 20 minutes.
20. Keep monitoring the temperature of the mixture.
21. When T=60° C., slow down the speed to 2000 RPM (1300 feet per minute) and keep monitoring the temperature, to keep between 55-60° C.
22. Make sure there is no material stuck on the wall of the mixing vessel without proper dispersion.
23. Measure temperature and record.
24. Add the remaining amount of resin as follows:

| | Required amount | Attained | Lot |
|---|---|---|---|
| Ingredient | (g) | amount (g) | number |
| Silicone-epoxy hybrid resin | 950 | | |

25. Set 2000 RPM and start mixing.
26. Prepare the following ingredient and amount and start adding to the mixture.

| | Required | Attained | Lot |
|---|---|---|---|
| Ingredient | amount (g) | amount (g) | number |
| Microcrystalline magnesium silicate | 75 | | |

27. When the addition is done, set 20 minutes at ca. 2000 rpm (1300 feet per minute).
28. Keep monitoring the temperature of the mixture.
29. Tare the scale and add the following ingredient and amount to thin the mixture:

| Ingredient | Required amount (g) | Attained amount (g) | Lot number |
|---|---|---|---|
| Methyl Acetate | 78.53 | | |

30. Set 1000 RPM and mix for 5 minutes.
31. Wait until the coating cools down to 25° C. and proceed to add the remaining amount of solvent:

| Ingredient | Required amount (g) | Attained amount (g) | Lot number |
|---|---|---|---|
| Methyl Acetate | 100 | | |

32. Set 1000 RPM and 5 Min.
33. Lift the shaft and adjust the position of the blade up to 1×Dblade from the surface of the mixture.
34. Set 500 RPM and run the blade for 20 seconds to clean and remove the excess of liquid.
35. Place the vessel on the scale and record the total weight and net weight of added ingredients (total weight−vessel weight).

### 1.3B General Description of Mixing Process Using Hollow Ceramic Spheres of Particle Size—35 Microns (for Example, Formulation BC176_URN_1UG)

### A. Preparation of the Stock Tint (Also Referred to as T1)—5 US Gallons

1. Check mixing vessel and confirm it is clean and free of damage, take the vessel weight and record it:

Vessel Weight (g):

2. Perform equipment check including scale calibration, mixer blade, shaft, plugs, connections, safety sensors and ventilation system.
3. Confirm that the ratio between mixer impeller diameter and mixing vessel diameter is 2.3-3 (Vessel D/Impeller D).
4. Place the empty mixing vessel on the scale and tare (Press Zero).
5. Add the required amount of the following raw materials. The scale must be tared in between the addition of each ingredient. Record the amount and the lot number:

| | Required | Attained | Lot |
|---|---|---|---|
| Ingredient | amount (g) | amount (g) | number |
| Low viscosity epoxy resin modified | 690.8 | | |
| with a cycloaliphatic polyglycidyl | | | |
| ether; viscosity-400-1000 cps @ | | | |
| 25° C. | | | |
| Cycloaliphatic polyglycidyl ether- | 1420 | | |
| modified epoxy resin; viscosity-350- | | | |
| 550 cps @ 25° C. | | | |
| Polymeric non-ionic dispersant | 69.4 | | |
| Polymeric pigment dispersant | 46.7 | | |
| 95% Benzenepropanoic acid, 3-(2H- | 59.9 | | |
| benzotriazol-2-yl)-5-(1, 1- | | | |
| dimethylethyl)- | | | |
| 4-hydroxy-, C7-9-branched and linear | | | |
| alkyl esters, 5% 1-methoxy-2-propyl | | | |
| acetate | | | |
| 3-(2,3- | 73.0 | | |
| Epoxypropoxy)propyltrimethoxysilane | | | |
| Subtotal | 2359.8 | | NA |

6. Place the vessel on the scale and record the total weight and net weight of added ingredients (total weight−vessel weight:

Vessel Total Weight:
Total Weight-Vessel Weight:

7. Place the mixing vessel under the mixer and immerse the impeller into the coating solution, follow the rule of max 1.5×Dblade from the bottom of the vessel.
8. Secure the mixing vessel adjusting the side screws.
9. Set 530 RPM and 10 minutes and continue mixing and check if the impeller is centralized.
10. Check the temperature of the mixture and record it:

Temperature of Mixture (° C.)

11. Make sure there is no material stuck on the wall of the mixing vessel without proper dispersion.
12. Take a sample and send to the lab for viscosity check and record it:
   CHECKPOINT 1—Lab testing

Test
Viscosity (cPs)@___ ° C.

13. Lift up the shaft and adjust the position of the blade up to 1×Dblade from the surface of the mixture.
14. Run the blade for 20 seconds to clean and remove the excess of liquid.
15. Bring the vessel to the scale and tare, double check it is showing zero.
16. Add the required amount of the following raw materials. The scale must be tared in between the addition of each ingredient. Record the amount and the lot number:

| | Required | Attained | Lot |
|---|---|---|---|
| Ingredient | amount (g) | amount (g) | number |
| Graphene nanoplatelets | 14.4 | | |
| Organo-modified derivative of | 231.1 | | |
| Aluminium phyllosilicate clay | | | |
| Micronized barium sulphate | 432.2 | | |
| Subtotal | 677.7 | | NA |

17. Place the vessel on the scale and record the total weight and net weight of added ingredients (total weight−vessel weight:

Vessel Total Weight:
Total Weight-Vessel Weight:

18. Move the vessel under the mixer blade and secure with the chain, make sure the vessel is centralized and immerse the blade in the middle of the coating solution.
19. Set 800 RPM and mix for 5 minutes or until temperature reaches 35° C., keep adjusting the position of the blade until complete incorporation of the powders.
20. Make sure the temperature of mixture is in the range of 34-36° C., record it: Temperature of Mixture (° C.)

Temperature of Mixture (° C.)

21. Make sure all the powders are incorporated, set 1100 RPM and start adding gradually the following amount of ingredient:

| | Required | Attained | Lot |
|---|---|---|---|
| Ingredient | amount (g) | amount (g) | number |
| Rheology Modifier-Polyamide Wax | 39.6 | | |
| Derivative, Micronized | | | |
| Titanium dioxide | 231.1 | | |

22. Set 2000 RPM and 20 minutes, adjust the blade position to make sure proper grinding. Measure temperature after 5, 10, 12 minutes and record the time when the mixture reach 65° C., thus, reduce the speed of the mixing blade to 1600 RPM to keep constant temperature between 60-65° C. for 20 minutes.

| T (° C.)-5 | T (°C)-10 | T (C)-12 | ___minutes |
|---|---|---|---|
| minutes | minutes | minutes | 65° C. |

23. After mixing 20 minutes under 60-65° C., reduce the speed to 850 RPM, monitor the temperature and record it:

Temperature of Mixture (° C.)

24. Scrape the sides of the mixing vessel to make sure all the powders are incorporated properly.
25. Add the remaining amount of ingredient and set 10 minutes.

| | | | |
|---|---|---|---|
| | Required | Attained | Lot |
| Ingredient | amount (g) | amount (g) | number |

| | |
|---|---|
| Cycloaliphatic polyglycidyl ether- | 193.9 |
| modified epoxy resin; | |
| viscosity - 350-550 | |
| cps @ 25° C. | |

26. Measure temperature and record:

Temperature of Mixture (° C.)

27. When mixing is complete, take a sample and send to the lab to test:
   CHECKPOINT 2—Lab testing

Test
Grinding (Hegman)
Color Match
Viscosity (cPs)@_ ° C.
Solid Content (%)

28. Lift the shaft and adjust the position of the blade up to 1×Dblade from the surface of the mixture.
29. Set 530 RPM and run the blade for 20 seconds to clean and remove the excess of liquid.
30. Place the vessel on the scale and record the total weight and net weight of added ingredients (total weight−vessel weight:

Vessel Total Weight:
Total Weight - Vessel Weight:

31. Place the lid on top of vessel and wait for lab approval before packing the base paste to be used in the URN final product.
   CHECKPOINT 3—Approval (Name and signature)

| | | | | |
|---|---|---|---|---|
| | | Judgement | | |
| Batched by | Tested By | (◯ Pass/X Fail | Approved By | Date: |

### B. Preparation of the BC176 Part A: 20 US Gallons

1. Check mixing vessel and confirm it is clean and free of damage, take the vessel weight and record it:

Vessel Weight (g):

2. Perform equipment check including scale calibration, mixer blade, shaft, plugs, connections, safety sensors and ventilation system: □ ◯—Pass □ X—Fail Notes ______
3. Confirm that the ratio between mixer impeller diameter and mixing vessel diameter is 2.3-3 (Vessel D/Impeller D).
4. Place the empty mixing vessel on the scale and tare (Press Zero).
5. Add the required amount of the following raw materials. The scale must be tared in between the addition of each ingredient. Record the amount and the lot number:

| Ingredient | Required amount (g) |
|---|---|
| Base T1URN | 22120 |
| C12-14 aliphatic glycidyl ether | 4545 |
| Benzyl Alcohol | 2276.3 |
| Polymer-based defoamer | 582.3 |
| Total | 29523.6 |

6. Place the vessel on the scale and record the total weight and net weight of added ingredients (total weight−vessel weight:

Vessel Total Weight:
Total Weight - Vessel Weight:

7. Place the mixing vessel under the mixer and immerse the impeller into the coating solution, follow the rule of max 1.5×Dblade from the bottom of the vessel.
8. Secure the mixing vessel using the locker chain and pre mix using spatula to pre dissolve the paste.
9. Set 570 RPM (20% of the driver) and 10 minutes and start mixing to dissolve the base paste.
10. Add the following ingredient and amount to thin the mixture:

| Ingredient | Required amount (g) |
|---|---|
| Xylene | 3918 |

11. Check the consistency of the mixture, if acceptable start adding the following ingredient and amount:

| Ingredient | Required amount (g) |
|---|---|
| Hollow ceramic meso-spheres; | 40085 |
| particle size - 35 microns | |

12. Add the following ingredient and amount to thin the mixture and set 663 RPM (35% of the driver):

| Ingredient | Required amount (g) |
|---|---|
| Xylene | 7955.1 |
| Methyl acetate | 1416 |

13. Check the consistency of the mixture, if acceptable start adding the following ingredient and amount:

| Ingredient | Required amount (g) |
|---|---|
| Hollow ceramic meso-spheres; | 40084 |
| particle size - 35 microns | |

14. Make sure there is no material stuck on the wall of the mixing vessel without proper dispersion.
15. Set 735 RPM and add the following ingredients and amounts to thin the mixture, mix for 20 minutes.

| Ingredient | Required amount (g) |
|---|---|
| Methyl acetate | 1308 |
| Microcrystalline magnesium silicate | 2034.3 |

16. Measure temperature and record:

Temperature of Mixture (° C.)

17. When the mixing is complete, take a sample and send to the lab to test:
   CHECKPOINT 1—Lab testing

| | | | Judgement |
|---|---|---|---|
| Test | Specification | Result | (O Pass/X Fail) |
| Grinding (Hegman) | ≥4 | | |
| Color Match | Gray | | |
| Viscosity (cPs)@___ ° C. | 18000-22000 | | |
| Solid Content (%) | 88-89 | | |
| Density (g/cm3) | 1.720-1.740 | | |

18. Check Solid Contents result, if out of specification, the technical team will inform the amount of extra VOC4 to be added and record it after adding into the mixture. After the addition stir the coating at 500 RPM for 5 minutes.

| Ingredient | Required amount (g) |
|---|---|
| (Any, as needed after solids check) Extra | |
| Methyl acetate | |

19. When the mixing is complete, take a sample and send to the lab to test:
   CHECKPOINT 2—Lab testing of Admixed composition (Part A+B)

Test
Viscosity (Sec)@___ ° C.
Sagging
Density (g/cm3)

20. Lift the shaft and adjust the position of the blade up to 1×Dblade from the surface of the mixture.
21. Set 500 RPM and run the blade for 20 seconds to clean and remove the excess of liquid
22. Place the vessel on the scale and record the total weight and net weight of added ingredients (total weight−vessel weight:

Vessel Total Weight:
Total Weight − Vessel Weight:

23. Place the lid on top of vessel and wait for lab approval before start packing.
   CHECKPOINT 3—Approval (Name and signature)

| | | | | |
|---|---|---|---|---|
| | | Judgement | | |
| Batched by | Tested By | (O Pass/X Fail | Approved By | Date: |

### 1.4 Example Generalized Method for Mixing a Formulation Comprising Hollow Spheres (Parts A&B).

158_URN2_SP1/SP2 Technological map
I. Blend the PasteA, Cowles mixer, 5 minutes @ 1000 rpm, r.t. (300-500 feet per minute)
Note: Add the components in the order as listed, then mix

| | | | |
|---|---|---|---|
| 1A | Low viscosity epoxy resin modified with a Cycloaliphatic polyglycidyl | 28.23 | 5-15% |
| | ether; viscosity - 400-1000 cps @ 25° C. | | |
| 2A | Cycloaliphatic polyglycidyl ether-modified epoxy resin; viscosity - | 28.23 | 15-20% |
| | 350-550 cps @ 25° C. | | |
| 3A | Polymeric Pigment Dispersant | 1.88 | 0.2-1% |
| 4A | Polymeric non-ionoc dispersant | 2.82 | 0.8-2% |

II. Blend the Paste B, 5 minutes @ 1000 rpm, r.t. (300-500 feet per minute)
Note: Done separately; Add the components in the order as listed, then mix

| | | | |
|---|---|---|---|
| 5A | C12~14 aliphatic glycidyl ether | 29.41 | 5-12% |
| 6A | Polymer-based defoamer | 3.76 | 1-3% |
| 7A | Benzyl alcohol | 14.70 | 2-6% |
| 8A | 3-(2,3-Epoxypropoxy)propyltrimethoxysilane | 3.00 | 1-3% |
| 9A | Methyl Acetate | 11.29 | 1-6% |

III. Pigment Base B): Grind the pigments in Paste 1, Cowles mixer, 5 minutes @ 3000 rpm
(1450 feet per minute), 50 C.
Note: Add the pigments 1 by 1 into the Paste 1

| | | | |
|---|---|---|---|
| 10A | Titanium dioxide | 9.41 | 2-6% |
| 11A | Organo-modified derivative of Aluminium phyllosilicate clay | 9.41 | 1-3% |
| 12A | Graphene nanoplatelets | 0.59 | 0.3-0.5% |

IV. Add 30 g of Paste 2, 0.5 minutes @ 3000 rpm, (1450 feet per minute), r.t.
V. Grind the remaining pigments, Cowles mixer, 5 minutes @ 3000 rpm (1450 feet
per minute), 50 C.
Note: Add the pigments 1 by 1 into the Paste 1

| | | | |
|---|---|---|---|
| 13A | Hollow glass meso-spheres, particle size - 68 microns/Hollow | 65.85 | 40-55% |
| | glass micro-spheres, particle size - 25 microns | | |
| 14A | Microcrystalline Magnesium silicate | 13.18 | 1-7% |
| 15A | Barium sulfate | 17.65 | 2-7% |

VI. Add 32.17 g of Paste 2, 0.5 minutes @ 3000 rpm, 1450 feet per minute), r.t.

| | |
|---|---|
| 239.40 | 100% |

VII. Mix the catalyst Paste D, 5 minutes @ 1000 rpm, (300-500 feet per minute), r.t.

| | | | |
|---|---|---|---|
| 1B | Phenalkamine | 101.43 | 70-80% |
| 2B | Xylene | 9 | 1-9% |
| 3B | Methyl Acetate | 21 | 10-20% |
| | | 131.40 | 100% |

### 1.5—General Method of Applying Curing Composition Comprising Hollow Ceramic Spheres to a Substrate

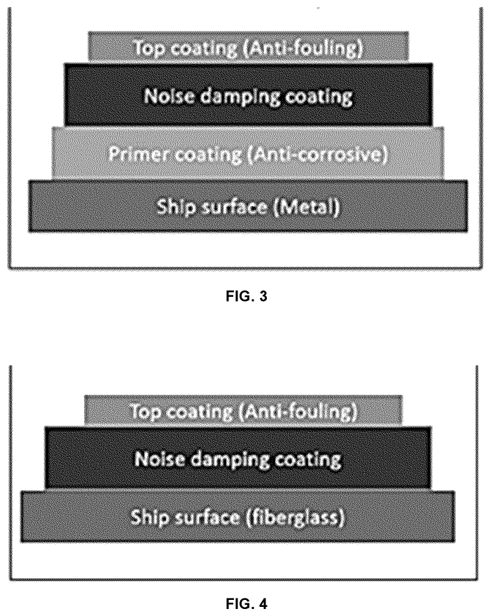

1. Clean a surface of the substrate with a solvent, such as acetone or similar solvent, and wipe with a clean cloth to remove any contaminants such as oil, grease, and dust.
2. Ensure the surface is dry, and then sand the surface with sandpaper (for example, 80 grit) or sandblast the surface. For steel surfaces, sand or grind until bright metal is visible. For surfaces that are already coated, remove any peeling or flaking material and sand down the remainder with sandpaper (for example, 60 or 80 grit). Remove any dust that results from the surface preparation. Dispose of the dust according to local environmental and health & safety regulations. Use appropriate protective equipment, such as filtered breathing masks, goggles, etc. when preparing the surface.
3. Apply the curing composition using spray methodology (air or airless) or brushing, rolling. For example, when applying to a metal surface of a substrate, a primer coating (for example, one which offers anti-corrosive properties) may be applied first; following which the curing composition (for example, noise dampening coating) may be applied to the primer coating; for example, with respect to the recoat window of the primer used; and, finally a functional top-coating (for example, one which offers anti-fouling properties) may then be applied over the curing composition once cured (see FIG. 3). In other examples, when applying to a fiberglass surface of a substrate, no primer coating may be used. Instead, the curing composition (for example, noise dampening coating) may be applied to the fiberglass surface; and, a functional top-coating (for example, one which offers anti-fouling properties) may then be applied over the curing composition once cured (see FIG. 4).

### 1.6 Overall Properties of the Formulations of Section 1.2

| | | | Approx. | | | | | |
|---|---|---|---|---|---|---|---|---|
| | Approx. | | Sphere | | Processability | | | |
| | Sphere | | Size, | Intercoat | (incorporation | | | |
| Formula | Wt % | | mcm | adhesion | efficiency) | | Hardness | Drying |
| 169-URN3-1 | 34% | wt | 35 | 5-6 MPA | 65-75% | max | 8H | 60-80 |
| 169-URN3-1B | 34% | wt | 35 | 5-8 MPA | 65-75% | max | 8H | <20 |
| 169-URN3-2 | 55% | wt | 35 | 5-8 MPA | 65-75% | max | 7H | 60-80 |
| 169-URN3-4 | 55% | wt | 35 | N/A | 65-75% | max | 5H | 30-50 |
| 169-URN3-5 | 63% | wt | 35 | 7-9 MPA | 65-75% | max | 8H+ | 60-80 |
| 169-URN3-6 | 63% | wt | 35 | 6-7 MPA | 65-75% | max | 8H+ | 60-80 |
| 169-URN3-7 | 71% | wt | 35 | N/A | 65-75% | max | 8H+ | 60-80 |
| 169-URN3-8 | 63% | wt | 12 | 5-8 MPA | 65-75% | max | 8H | 60-80 |
| 169-URN3-9 | 37/20% | wt | 12/25 | N/A | 50-60% | max | 8H | 60-80 |
| 169-URN3-11 | 9/63% | wt | 35/5 | N/A | 50-60% | max | 8H | 60-80 |
| 169-URN3-12 | 55% | wt | 35 | N/A | 65-75% | max | N/A | 60-80 |
| (11.4 mils) | | | | | | | | |
| BC176_URN_1UG | 63% | wt | 35 | 6-9 MPA | 65-75% | max | 8H | 60-80 |
| 158-URN2-SP1/SP2 | 34/19% | wt. | 68/25 | 3-5 MPA | 30% | max | 4H | <20 |
| 156-URN2-SP1 | 35% | wt. | 68 | 3-5 MPA | 30-40% | max | 4H | <20 |
| 184_Prop_3 | 16% | wt. | 12 | 3-5 MPA | 50-60% | max | 8H | 60-80 |

### Properties Legend:

Intercoat adhesion (ASTM D4541)
Processability—amount of spheres incorporated without exceeding the amount of solvent of 10% wt of total formula weight (based on the experimental analysis)
Hardness—after 1 week of drying, by pencil hardness (ASTM D3363)
Drying—at 24 hrs post-coating, dry through by MEK double-rub test (ASTM D1640)
1 mils=25.4 μm
   Note: if otherwise not accompanied with an ASTM test number, tests used to evaluate formulation properties are described below.

### 1.7 Absolute dB Reduction Properties of the Formulations of Section 1.2

| Coating | absolute dB reduction | | | | |
|---|---|---|---|---|---|
| thickness | | frequency | | | |
| (mils)** | sample | 100 | 250 | 400 | 1000 |
| No coating | *Metal plate | 5.96 | 9.29 | 10.77 | 39.42 |
| 14.6 | BC 156 SP1 | 5.38 | 6.79 | 11.41 | 36.43 |
| 11.7 | BC 169 URN 3-1 | 1.46 | 0.89 | 1.5 | 22.94 |
| 11.5 | BC 169 URN 3-1B | 2.14 | 1.51 | 4.21 | 18.99 |
| 11.2 | BC 169 URN 3-2 | 8.63 | 4.36 | 8.04 | 27.39 |
| 10.9 | BC 169 URN 3-3 | 6.09 | 3.45 | 7.47 | 23.71 |
| 11.6 | BC 169 URN 3-4 | 3.63 | 1.38 | 2.93 | 17.22 |
| 8.8 | BC 169 URN 3-5 | 9.17 | 3.74 | 4.67 | 21.15 |
| 11.4 | BC 169 URN 3-6 | 15.26 | 11.36 | 17.36 | 33.03 |
| 11 | BC 169 URN 3-7 | 8.02 | 4.45 | 6.37 | 24.29 |
| 8.2 | BC 169 URN 3-8 | 6.09 | 5.26 | 6.79 | 23.54 |
| 10.1 | BC 169 URN 3-9 | 2.32 | 1.5 | 3.12 | 24.53 |
| 11.9 | BC 169 URN 3-11 | 7.25 | 3.17 | 6.17 | 31.82 |
| 3.2 | BC 169 URN 3-12 | 1.03 | 1 | 1.94 | 18.81 |
| | 3.2 Mil | | | | |
| 4.5 | BC 169 URN 3-12 | 4.2 | 1.65 | 6.09 | 16.39 |
| | 4.5 Mil | | | | |
| 11.4 | BC 169 URN 3-12 | 9.84 | 2.66 | 5.83 | 22.86 |
| | 11.4 Mil | | | | |
| 10.5 | 184_Prop_3 | 2.55 | 3.22 | 5.13 | 7.45 |
| 12.1 | BC176_URN_1UG | 16.23 | 12.43 | 15.34 | 31.33 |
| 8 | 158-URN2-SP1/SP2 | 3.37 | 7.39 | 10.41 | 25.41 |
| 9.2 | 156-URN2-SP1 | 4.58 | 7.69 | 10.51 | 26.23 |

*(noise insulation from metal plate only - 3 mm thickness cold rolled steel; data for formulations/coatings adjusted to baseline steel plate effect);
**1 mils = approx. 25.4 μm

### 1.8 Test Descriptions

Hardness after 1 Week of Drying, by Pencil Hardness (ASTM 03363).

Pencil hardness tests are generally used in the coatings industry to assess abrasion or scratch resistance and hardness of a cured coating, and uses graphite rods as a scratching tool at different hardnesses, varying from soft (from 8B to B, B being the softest) to hard pencils (H to 8H, 8H being the hardest abrasive). Application of the pencil is performed according to the standard ASTM 03363; the pencil hardness that causes mechanical damage to the coating (such as deep scratches or grooves with paint shredding) defines the hardness threshold of the tested coating. A pass rate of 5H and above is preferred for a coating of the present disclosure. Coatings with hardness below 4H may be prone to premature failure during their lifetime.

### Intercoat Adhesion (Otherwise Referred to as Recoat Adhesion) (ASTM D4541)

An epoxy-based topcoating was used to test intercoat adhesion of the cured coatings. The procedure followed involves applying a curing composition of the present disclosure onto sand-basted steel; then at various time intervals, the cured coating was overcoated with an epoxy-topcoat of choice (recoat window varying from 6 to 140 hours) at room temperature. The resulting double-coating was then cured at room temperature for 14 days, and a pull-off adhesion strength was measured according to ASTM D4541. A failure value of about 3-4 MPa was set based on a coating's life expectancy. Coatings with intercoat adhesion of about 5-7 MPa were considered to have sufficient intercoat adhesion to at least last through a typical lifetime of 5-10 years of sea fairing.

### Drying Degree at 24 Hrs Post-Coating

In some embodiments, curing compositions the present disclosure may need to be a fast-curing; for example, capable of hard drying within a 4-hour period post-spraying, and at the same time have a recoat window for the topcoating within 2-3 days. Solvent-borne cured coatings are generally able to withstand repetitive abrasive treatment with organic solvents, such as methyl-ethyl ketone, which was used in the standardized test ASTM D1640. In this test, a cotton rag soaked in MEK was applied to the cured coating and repetitively rubbed against the coating, with the number of rubs required to penetrate the coating layer recorded to quantify curing speed. Coatings that passed the 50 MEK double-rub mark were considered to having passed the requirement for fast-drying coating. Coatings that failed this test at rates of 20-30 MEK rubs were considered slow curing, and may not fully comply to some requirements adopted by the industry.

### Absolute dB Reduction

Static sound measurements were conducted using an experimental sound encapsulation setup as depicted in FIG. 1. For testing, each coating had been applied to a 3 mm thickness cold rolled steel plate. To isolate measurements from environmental noise, sound irradiation and recordings were performed inside a Styrofoam double-chamber. Styrofoam performed a sound dampening function, and a smaller inner chamber hosted both a sound measuring device (Software—Audacity, Hardware—Amplifier, low frequency microphone) and a lab speaker that emitted frequencies from 100 Hz to 10 KHz (sound source device).

PROCESSABILITY, Amount of Hollow Ceramic Spheres Incorporated without Exceeding Amount of Solvent of 10% Wt of Total Formula Weight (Based on the Experimental Analysis):

As described above, the hollow ceramic spheres can thicken the pre-cured compositions to a degree where additions of solvent or diluent as a liquid vehicle may be required to maintain working levels of viscosity (below 3000 cps) that facilitate effective blending of the composition. If the working levels of viscosity are exceeded, a mill-base can become inoperable without further additions of the solvent. In turn, the levels of solvent in a low-VOC product preferably do not exceed 10% wt, parts A and B mixed. The higher the amount of hollow ceramic spheres that can be incorporated into the pre-cured composition without additions of solvent diluent, the greater a level of flexibility offered to formulator. As such, processability was determined (among other factors) by a maximum amount of the spheres that could be incorporated into the solvent-borne monomers without exceeding volatiles levels of 10% wt.

### Flexibility

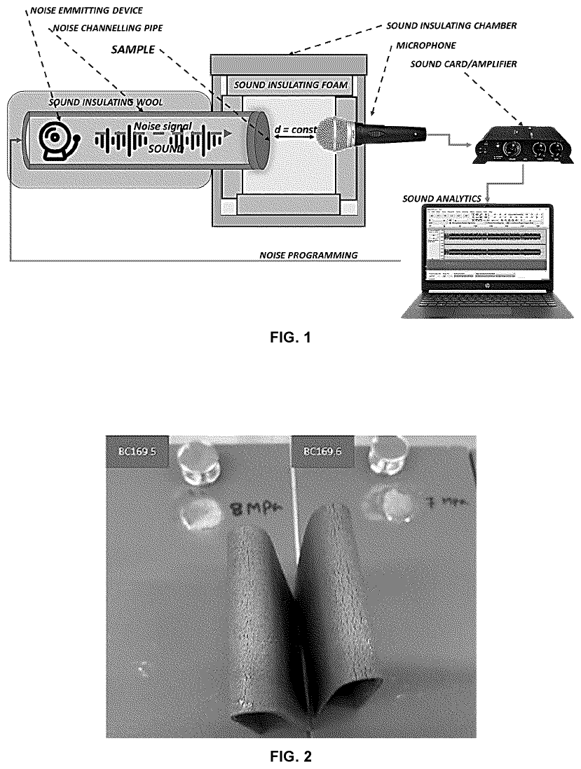

Flexibility was tested and measured by a cylindrical bend test from 14 mm to 6 mm. As per FIG. 2, formulations BC169.5 and BC169.6 passed a bending test at 6.5 mm. Generally, coatings with a pigment/solids-to-binder (PBR) weight ratio greater than 2 can be brittle and fail In some examples, cured coatings of the present disclosure have PBR values of about 2.3, and but still show flexibility and good mechanical properties.

### Example 2—Compositions for Coatings—Reduced Underwater Radiated Noise Properties (Also Referred to Below as URN Formulas/Formulations/Compositions and URN Coatings)

Materials Used in URN Compositions for a Coating, Made and/or Tested

### Also See Example 1, Materials.

| | | Exemplary |
|---|---|---|
| | | Analogous |
| Component or Additive/Function | Trade name | compounds |
| Microcrystalline magnesium silicate/barrier anti- | Talc Silverline 202 | Mistron 002 (Imerys) |
| corrosive platy filler, anti-corrosive and abrasive | (Imerys) | |
| resistance properties, thickener | | |
| Hollow ceramic meso-spheres/sound deadening | Zeeospheres G | W210, W410, or |
| performance, scratch resistance, barrier anti-corrosive | 600 (Zeospheres | W610 Ceramic |
| properties | Ceramics LLC) | Spheres (3M) |
| Hollow ceramic micro-spheres/sound deadening | Zeeospheres G- | W210 Ceramic |
| performance, scratch resistance, barrier anti-corrosive | 200 (Zeospheres | Spheres (3M) |
| properties | Ceramics LLC) | |
| Hollow glass meso-spheres/sound deadening | SPHERICAL | S35 Glass bubbles |
| performance, scratch resistance, barrier anti-corrosive | 110P8 (Potters) | (3M) |
| properties | | |
| Hollow glass micro-spheres/sound deadening | SPHERICAL | S35 Glass bubbles |
| performance, scratch resistance, barrier anti-corrosive | 34P30 (Potters) | (3M) |
| properties | | |
| 2,4,6-Tris [(dimethylamino)methyl]phenol/curing | Docure KH-76K | |
| catalyst, speeds up the curing of epoxy-resins | (Kukdo Hardener) | |
| Xylene, aromatic solvent/flow, sprayability, properties. | Xylene | Cyclohexane, toluene |
| Methyl acetate/flow, sprayability, properties, VOC- | Methyl Acetate | Tert-butyl acetate |
| exhempt. | | |
| Benzyl Alcohol/non-reactive diluent, non-volatile, flow, | Benzyl Alcohol | |
| sprayability, co-catalyst for hardener. | | |
| Silicone oligomer (proprietary chemical formula)/ | BYK-066 N (BYK) | BYK-1790 (BYK) |
| defoamer | | |
| Polymeric non-ionic dispersing additive/dispersing | ADDITOL VXW | |
| additive for organic and inorganic pigment | 6208 (Allnex) | |
| Silicone modified defoamer (proprietary chemical | ADDITOL VXW | |
| formula)/defoamer | 6210 N | |
| Fumed silica-modified organo-modified polysiloxane/ | TEGO Airex 900 | |
| Deaerator concentrate against micro- and macro-foams | (Evonik) | |
| Butyl glycidyl ether/reactive diluent, non-volatile, flow, | Epodil 741 (Evonik) | EPODIL ® LV5 |
| sprayability. | | (Evonik) |
| C12-14 aliphatic glycidyl ether/reactive diluent, non- | XD-748 (Anhui | |
| volatile, flow, sprayability. | Xinyuan Chemical | |
| | Co., Ltd.) | |
| Organo-modified derivative of the Aluminium | CLAYTONE-HY | CLAYTONE-APA |
| phyllosilicate clay/rheology modifier, anti-settling | (BYK) | (BYK) |
| additive | | |
| Titanium dioxide/pigment white, wear inhibitive | Ti-Pure R-706 (Du- | CR-828 (Tronox) |
| | Pont) | |
| Calcium inosilicate mineral/Barrier properties and anti- | NYCO Wollastonite | |
| corrosive performance | | |
| Polymeric pigment dispersant (proprietary chemical | ADDITOL VXW | Multiwet-EF (Croda) |
| formula)/dispersant, homogeneous dispersion of | 6208 (Allnex) | |
| pigments, fillers and spherical particles | | |
| Polymeric graphene dispersant/homogeneous | K-Sperse A504 | |
| dispersion of graphene pigments | | |
| Low viscosity epoxy resin (proprietary chemical | DLVE - 18 Epoxy | D.E.R. 353 (Palmer |
| formula)/polymeric resin matrix | Resin (Olin Resins) | Holland) |
| Cycloaliphatic polyglycidyl ether-modified epoxy resin/ | DLVE - 52 Epoxy | D.E.R. 353 (Palmer |
| polymeric resin matrix | Resin (Olin Resins) | Holland) |
| Bisphenol A epoxy resin/high viscosity film forming | YD-128 (Kukdo | |
| epoxy resin | Chemicals Ltd.) | |
| Hybrid epoxy-polysiloxane resin/low surface friction | Silikopon EF or | Eposil 5550 (Hexion) |
| resin for anti-fouling and cavitation resistant performance | Silikopon ED | |
| | (Evonik) | |
| Glycidoxypropyl trimethoxysilane/adhesion promotor | Andisil 187 (AB | Silquest* A-1170 |
| | Chemicals) | (Momentive) |
| Modified polyester-based adhesion promotor/ | Tego Addbond HS | Tego Addbond LTW- |
| adhesion and flexibility promotor for Cu and steel | MPA (Evonik) | B (Evonik) |
| Amine-modified Phenalkamine (proprietary chemical | Ancamine 2811 | |
| formula)/hardener, polymer matrix, mechanical integrity | (Evonik) | |
| of the coating | | |
| Phenalkamine (proprietary chemical formula)/ | Cardolite NX-5444 | DOCURE KMH-100 |
| hardener, polymer matrix, mechanical integrity of the | (Cardolite) | PHENALKAMINE |
| coating | | HARDENER |
| | | (KUKDO |
| | | CHEMECAL) |
| Triamino-functional propyltrimethoxysilane | Dynasylan | |
| (proprietary chemical formula)/Cross-linking agent for | TRIAMO (Evonik) | |
| hybrid epoxy resin, adhesion promotion; hardener | | |
| Modified poly-amidoamine (proprietary chemical | Ancamide 2832 | ANCAMIDE® 2137 |
| formula)/hardener, polymer matrix, mechanical integrity | (Evonik) | (Evonik) |
| of the coating | | |
| Formulated Polyamidoamide adduct/High humidity | Ancamide 3201 | |
| hardener for sub-zero curing and heavy duty high | (Evonik) | |
| performance applications | | |
| Silicone-epoxy hybrid resin/anti-fouling polymer matrix, | SILIKOPON EF | SILIKOPON ED |
| flexibility additive | | (EVONIK) and Eposil |
| | | 5550 |
| Castor oil derivative (proprietary chemical formula)/ | Thixatrol ST | Thixatrol PM 8056 or |
| Anti-sagging additive, thixotropic flow additive, anti- | (Elementis) | Thixatrol GST |
| settling effect, high-solids paint stability | | (Elementis); S15 - |
| | | Crayvallac Super |
| | | (Palmer Holland) |
| Polyether siloxane copolymer (proprietary formula)/ | TEGO Glide 410 | |
| slip and anti-crater properties. | (Evonik) | |
| 95% Benzenepropanoic acid, 3-(2H-benzotriazol-2-yl)- | Tinuvin 99-2 | Tinuvin 900 (BASF) |
| 5-(1, 1-dimethylethyl)- | (BASF) | |
| 4-hydroxy-, C7-9-branched and linear alkyl esters, 5% | | |
| 1-methoxy-2-propyl acetate (listed below as 95% | | |
| Benzenepropanoic acid)/UV absorbent, long-term | | |
| chemical stability of the coating, weather-resistance | | |
| Activated (fused) aluminium (III) oxide/wear-resistant | AP-22 (Evonik) | |
| armouring additive, cavitation resistance aid | | |
| Brown aluminium (III) oxide, micronized/wear-resistant | (Panadyne) | |
| armouring additive, cavitation resistance aid | | |
| Epoxy-functional PDMS-based oligomer/self-cleaning | BYK Silclean 3701 | |
| anti-fouling effect, hydrophobic profile of the propeller | | |
| application | | |
| Fumed SiO2/Abrasive resistance, anti-settling properties, | Cab-O-Sil 610 | |
| mechanical toughness | Fumed silica | |
| Polyamide wax derivative, micronized/Thixatrope, | Crayvallac Super | S21 - Thixatrol ST |
| rheology modifying additive/ aids the shear thinning | (Palmer Holland) | (Elementis) |
| behaviour, provides good high-build properties (for when | | |
| curing coating is sprayed in especially thick wet layers) | | |
| Multilayered graphene flakes/Abrasion resistant nano- | | |
| pigment, barrier (anti-corrosive properties) | | |
| Graphite/barrier properties | Novonix - Graphite | |
| | Flakes | |
| Aminopropyl triethoxysilane/Silamine hardener. | Andisil 1100 Silane | Dynasylan AMEO |
| | (AB Chemicals) | (Evonik) |
| Micronized barium sulphate/sound deadening | VB Techno | |
| performance, anti-corrosive performance, low oil- | | |
| absorption filler (low viscosity system), thinning pigment | | |
| (has low oil absorption, does not thicken the end product | | |
| as other fillers do upon dispersion) | | |
| Zinc calcium strontium aluminium orthophosphate | Heucophos ZCP | |
| silicate hydrate/Anti-corrosive pigment, adhesion | Plus (HEUBACH) | |
| promotor | | |
| Strontium Phosphosilicate/Anti-corrosive pigment, | Halox SW111 | |
| adhesion promotor | (Halox) | |
| Titanium carbonitride/abrasion and wear off resistant | Advanced | |
| aid | Engineering | |
| | Materials Limited | |
| | (AEM) | |
| Fluorohydroxylalkylated dimethyl siloxane oligomer/ | Silmer ® OHF B10 | |
| Wet friction coefficient enhancer | (Siltech) | |
| Hydroxyalkyl-modified polydimethylsiloxane oligomer/ | Silmer OHT Di-50 | |
| Wet friction coefficient enhancer | (Siltech) | |
| Quaternary ammonium-modified dimethyl siloxane | Silquat 3180 | |
| oligomer/Beading additive, amphiphilic additive | (Siltech) | |

Test Methods Used for URN Compositions for a Coating, Made and/or Tested

### Hardness, Adhesion, Bending Test Methods

In one or more examples, URN compositions as described herein form a mechanically robust and long-lasting coating upon curing, which may allow coatings formed from the URN compositions to withstand mechanical damages that can be routinely imposed on a coating during a recoating window, or the coating's working lifetime.

Here, “recoating window” may refer to a time period between applying a pre-cured primer composition for a primer coating onto a substrate and the primer composition fully curing, within which the URN composition can be applied on, and adhere to the primer coating. This can yield relatively high overcoat adhesion values, without the need to mechanically pre-treat the surface of the primer coating. “Recoating window” may also refer to a time period between applying a pre-cured URN composition onto a substrate or primed substrate and the URN composition fully curing, within which a topcoat composition can be applied on, and adhere to the URN coating. This can yield relatively high reacoat adhesion values, without the need to mechanically pre-treat the surface of the URN coating.

Such endurance may act as measure of the URN coating's technological compatibility with any primer or topcoat system that may applied along with the URN coating, and thus may act as a measure of the longevity of the entire coating (e.g., primer coating, URN coating, topcoating)—the harder the URN coating, the more flexible the URN coating, the strong the adhesions of the URN coating, the longer it may last un-ruptured, thus reducing chances of the URN coating's delamination from a substrate due to wear off or corrosive processes.

Hardness after 1 week of drying, by pencil hardness (ASTM D3363). A pencil hardness test is a method used in the paints or coatings industry to assess abrasion resistance and hardness of dried coatings. The test uses graphite rods as a scratching tool, at different hardness', varying from soft pencils (from 8B to B, B being the softest) to hard pencils (H to 8H, 8H being the hardest). Application of the pencil is performed according to the standard ASTM D3363; the pencil hardness that causes mechanical damage to a coating (e.g., such as deep scratches or grooves with paint shredding) defines the hardness threshold of the tested coating. 5H or above was generally considered a pass for the URN coatings. It was considered that URN coatings with a hardness below 4H may experience premature failure during their lifetime.

Coating adhesion (ASTM D4541, ASTM D3359). Test ASTM D4541 was used to assess adhesion to substrate (e.g., adhesion to steel) or overcoat adhesion (e.g., adhesion to primer coating), per practices in the paints or coating industry. A URN composition was applied onto sand-basted steel, then cured at room temperature for 14 days, following which a pull-off adhesion strength was measured according to ASTM D4541. Generally, an adhesion value of less than 3 MPa was considered a relative low adhesion value; an adhesion value of about 3-4 MPa was considered a relatively low to moderate adhesion value, and an adhesion value of about 5-7 MPa or higher were considered be a relatively high adhesion value that may be indicative of a coating that may last through a lifetime of 5-10 years of sea/water fairing.

Recoat adhesion (ASTM D3359 Test Method for Measuring Adhesion by Tape) cross-hatch test was used to assess recoat adhesion of URN coatings to top coatings, per practices in the paints or coating industry, to test a URN coating's ability to form a firm adhesive bond with an overlaying topcoat, such as a foul-releasing or anti-fouling topcoat as referenced herein. For this test, an epoxy-based top coating was used to test the intercoat adhesion of an URN coating. Here, the recoat window between applying the URN coating and the topcoat of choice was 48 hrs at room temperature. The resulting double-coated system was then cured for an additional 24 or 48 hour periods and a cross-hatch tape adhesion test was performed to determine the fastness of inter-coat bonding. FIG. 5C depicts a visual comparison chart to grade the performance of the coating by the cross-hatch test: grade 5 and grade 1 refer to about 0% and about 60% paint delamination rates, where herein grades 5 and 4 (0-5% delamination) and grade 3 was considered a “Pass”, grades 2 and 1 delamination was considered a “Fail”.

Another way to report recoat adhesion is a recoat window, or recoat adhesion window: the measure of it is how many hours after applying a topcoat that the topcoat still passes the cross-hatch adhesion test. Coatings tested herein had a recoat window between 4 to 72 hours, within which cross-hatch adhesion test was a pass.

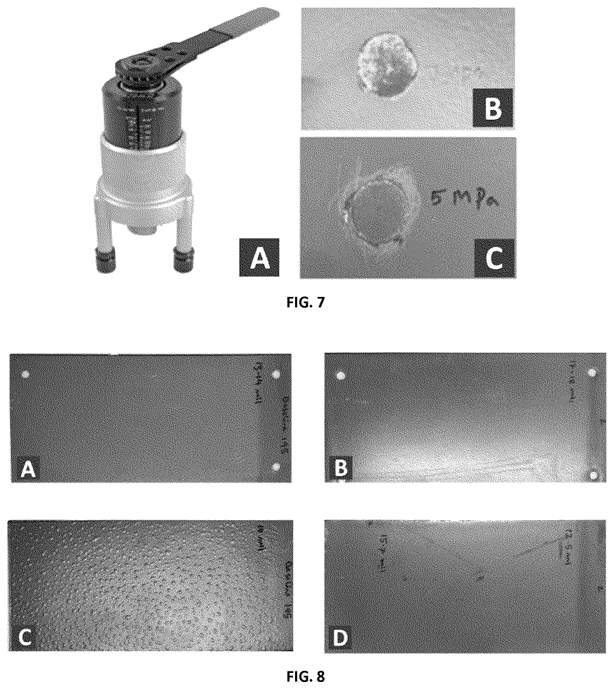

For example, see FIG. 7 depicting (A) an Elcometer pull-off adhesion device, for testing adhesion to steel; (B) and the test results for URN Formula 200.2; (C) and URN Formula 200.1.

Mandrel bending test (ASTM D522). Bending tests evaluates flexibility of a cured coating, which can be indicative of a coating's ability to sustain damage from physical impacts throughout the coating's lifetime. The Mandrel bending test of ASTM D522 uses thin cold rolled steel plates (about 1/16″) of about 4×3″ in dimensions as model substrates. Plates coated with an URN coating at a dry film thickness of about 250 micron (e.g., which corresponded to a thickness for a select end use), was dried for 7 days to average typical refloating times (e.g., period within which the painted/repaired vessels are brought back into the waters), and were bent manually over a cylindrical 10 mm or 8 mm or 6 mm diameter steel rod. As a result: a) either the coating damage and/or rupture of the coating, where the pieces of the coating delaminated from the substrate, which was considered a “Fail”; or b) the coating remained substantially un-rendered after bending, without showing substantive signs of mechanical damage or delamination from the substrate, which was considered to be a “Pass”.

### Curing, Blistering, and Permeability Tests Methods

Drying/curing degree at 24 hrs post-coating. In one or more examples, an URN composition as described herein is a fast-curing composition capable of hard curing and drying within a 4-hour period post-spraying, and at the same time have a recoat window for any topcoating within 2-3 days. Chemically cured coatings generally need to be able to withstand repetitive abrasive treatment with organic solvents, such as methyl-ethyl ketone (MEK)—which is used in the standardized test ASTM D1640. In this test, a cotton rag soaked in MEK is applied to a hardened and dried coating and repetitively rubbed against the coating, with the number of rubs required to penetrate the coating layer recorded to quantify the curing speed. Coatings that pass the 50 MEK double-rub mark are considered to have passed the requirement for a fast-drying, fast-curing coating. Coatings that fail this test at rates of 20-30 MEK rubs are considered slow curing and may not comply under the requirements adopted by the industry.

Blistering of a coating (otherwise referred to as blistering test or boiling test). In one or more examples, an URN composition as described herein is may be coated onto either a bare substrate (e.g., bare steel) or primed substrates (e.g., coated in a primer coating), and undergo from 3 to 5 years of continuous use in the immersed underwater marine environment. In order to investigate whether a URN coating may undergo delamination and/or failure due to permeation with water and electrolytes over its lifespan, a boiling test was implemented. An accelerated test that can be used to predict the coating's tendency for delamination or failure is to subject the air dried coating to boiling water and to record any damages or change of the appearance induced by the boiling water. This test relies on the enhanced diffusion coefficient of water at boiling temperatures, and accelerates detrimental effects of aqueous environments on the tested coating. A coating that develops blisters and/or delaminates after 24-48 hours of continuous boiling is generally considered a failed product, and this correlates well with in-field performance of painted coating on a submerged ship hull. A coating that lasts for more than 7 days without significant blistering or other defect is considered a “Pass”. URN coatings were tested while coated onto both bare steel and primed steel. Any type of anti-corrosive primer known in the art can be used as a priming layer for this test, and the primer should be air dried for 4 or 24 hours prior to overcoating with the URN coating.

For example, see FIG. 8, which depicts blistering and permeability test results for Formulas (A) BC169_URN3-3.2 on a primer coating; (B) BC169_URN3-3.2 on bare steel; (C) 242 on a primer; (D) 242 on bare steel.

### Processability at Low VOC

Amount of hollow ceramic spheres incorporated without exceeding amount of solvent of 10% wt of total formula weight (based on the experimental analysis): Use of hollow ceramic spheres should not hinder their incorporation into an URN composition using standard mixing techniques and equipment, such as the impeller blending. Use of hollow ceramic spheres in a URN composition should still allow for sprayability with conventional tools, drying, etc. Such spherical ceramic additives can thicken a coating composition to a degree where additions of solvent or diluent as a liquid vehicle are required to allow for working levels of viscosity (e.g., below 3000 cps), which allow for effective blending of the coating compositions. If working levels of viscosity are exceeded, the mill-base can become inoperable without further additions of the solvent. In turn, the levels of solvent in a low-VOC product should not exceed 10% wt, parts A and B mixed. The higher the amount of the hollow ceramic spheres that can be incorporated into a URN composition without additions of the solvent higher than 10 wt %, parts A and B mixed, the higher the level of flexibility presented to a formulator to reach desired levels of underwater noise reduction afforded by a URN coating. Hence, in one or more examples of the URN compositions/coatings, a maximum amount of hollow ceramic spheres that can be incorporated into the URN compositions is an amount that does not result in exceeding the volatiles levels of 10% wt.

### Reduced Radiated Noise Testing

Radiated Noise Performance. As described herein, static sound measurements of the URN compositions and coatings were measured using the experimental sound encapsulation setup had been designed and assembled in-house, as depicted on FIG. 1. To isolate the measurements from the environmental noise, the sound irradiation and recordings were performed inside a Styrofoam double-chamber. Styrofoam performed the sound deadening function, and a smaller inner chamber hosted both a sound measuring device (Software—Audacity, Hardware—Amplifier, low frequency microphone) and a lab speaker that emitted frequencies from 100 Hz to 10 KHz (sound source device).

### General Technological Steps for Mixing and Preparing an URN Composition, Including Part a (Composition for a Coating) & Part B (Composition for a Coating Further Comprising a Hardener Composition).

A typical method of preparing an URN composition is listed in a sequence of steps below:

Technological steps break-down for preparing Formula 242

| # Part A | Composition | %, wt total | %, vol |
|---|---|---|---|
| 1A | Cycloaliphatic polyglycidyl ether- modified epoxy resin | 6.32% | 13.38% |
| 3A | Polymeric pigment dispersant (proprietary chemical | 0.19% | 0.42% |
| | formula) | | |
| 4A | Polymeric graphene dispersant | 0.13% | 0.30% |
| 5A | 95% Benzenepropanoic acid | 0.17% | 0.36% |
| 6A | Glycidoxypropyl trimethoxysilane | 0.20% | 0.44% |

Blend the Paste B, 5 minutes @ 1000 rpm, r.t., Cowles mixer
Note: Done separately; Add the components in the order as listed, then mix

| | | | |
|---|---|---|---|
| 7A | Multilayered graphene flakes | 0.04% | 0.04% |
| 8A | Titanium dioxide | 0.64% | 0.36% |
| 9A | Organo-modified derivative of the Aluminium | 0.64% | 0.87% |
| | phyllosilicate clay | | |
| 10A | Micronized barium sulphate | 1.20% | 0.66% |

Pre-grind the pigments, 15 minutes @ 2000 rpm
Note: Done separately; Add the components in the order as listed, then mix

| | | | |
|---|---|---|---|
| 22A | Fumed SiO₂ | 0.86% | 1.77% |

Pre-grind the pigment, 5 minutes @ 900 rpm
Once homogenized into the pigment-base, grind for 20 mins at 5000 rpm
Reach 55 C.
Note: Avoid dusting!

| | | | |
|---|---|---|---|
| 12A | Polyamide wax derivative, micronized | 0.11% | 0.27% |

Grind for 10 mins at 2500 rpm, Keep at 50-60 C.

| | | | |
|---|---|---|---|
| 13A | Hollow ceramic meso-spheres | 35.11% | 35.26% |
| 14A | C12-14 aliphatic glycidyl ether | 1.99% | 4.94% |
| 15A | Benzyl Alcohol | 1.00% | 2.21% |
| 16A | Xylene, aromatic solvent | 5.20% | 13.97% |

Grind for 10 mins at 2000 rpm
Note: Add ceramic spheres and diluents intermittently to avoid viscosity shocks!

| | | | |
|---|---|---|---|
| 17A | Silicone modified defoamer | 0.26% | 0.64% |
| 18A | Microcrystalline magnesium silicate | 0.89% | 0.73% |
| 21A | Bisphenol A epoxy resin | 10.34% | 20.41% |

Grind for 10 mins at 1600 rpm

| | | | |
|---|---|---|---|
| 19A | Methyl acetate | 1.19% | 2.95% |

Letdown for 10 mins at 800 rpm
Note: Add when the base cools down to 20-25 C.!

| Total: | | 66.52% | 100.00% |
|---|---|---|---|
| # Part B | Hardener Composition | %, wt total | %, vol |
| 1B | Amine-modified Phenalkamine (proprietary chemical | 21.06% | 60.25% |
| | formula) | | |
| 2B | 2,4,6-Tris[(dimethylamino)methyl]phenol | 0.22% | 0.66% |
| 5B | Methyl Ethyl Ketone | 1.62% | 5.89% |
| 6B | Xylene, aromatic solvent | 9.79% | 33.20% |

Letdown for 10 mins at 800 rpm

| | | |
|---|---|---|
| Total: | 32.70% | 100.00% |

### Radiated Noise Studies

Comparisons. URN compositions were prepared, and coatings tested, with and without ceramic performance additives; and with or without other composition components.

It was found that, for compositions for a coating comprising no hollow ceramic spheres—such as Formula 156.Blank.2 (shown below) and Intershield 300 (a commercial primer)—the reduction in radiated noise in the resultant coating relative to no coating as measured using the set-up depicted in FIG. 1 was about 1 dB/100 μm of coating to about 3 db/100 μm. In contrast, it was found that, for URN compositions comprising hollow ceramic spheres—such as Formula 242 (shown below)—the reduction in radiated noise in the resultant coating relative to no coating as measured using the set-up depicted in FIG. 1 was about 6 dB/100 μm of coating to about 7 db/100 μm.

Differences between Formulae 156.Blank.2 and 242 included: a) absence of hollow ceramic spheres, b) triple the amount of the resin in 156.Blank.2 (since the hollow spheres were absent); c) ⅓ of the epoxy resin content in 242 was made up of bisphenol A resin, as it was found to have improved the permeability characteristics. However, despite these differences, the backbones of these 2 formulas were considered to be very similar, and thus it was considered that they could be used in comparisons to emphasize the impact of hollow ceramic spheres—their type and amount—on the noise radiating properties of URN coatings.

| | Formulation | |
|---|---|---|
| | | Formula |
| | Formula 242 | 156.Blank.2 |
| Select Property | URN composition | Blank formulation |
| Sphere type | Hollow ceramic | none |
| | meso-spheres | |
| Spheres amount, total formula | 35 | none |
| wt. % | | |
| Sphere size, mcm | 35 | N/A |
| Hardener type | Amine-modified | Modified |
| | phanalkamine | polyaminoamide |
| Epoxy/NH ratio | 1.2 | 1.0 |
| Resin amount, total formula | 17 | 46 |
| wt. % | | |
| Adhesion to steel, MPa | 7-8 | 7-8 |
| Overcoat adhesion to primer, | 7-8 | 7-8 |
| MPa | | |
| Recoat adhesion, grade | 5 | N/A |
| Sound dampening, dB/4 mil | 6-7 | 1-2 |
| Sagging at 10 mil | Pass | Fail |
| Blistering test (steel) | Pass | Fail |

Compositions and properties of both formulas were as follows:

| Formula 156.blank.2 | | | | | |
|---|---|---|---|---|---|
| # | | | | | |
| Part | | %, wt | | | |
| A | Composition | total | %, vol | Select Properties | |
| 1A | Low viscosity epoxy resin | 6.24% | 14.78% | Material in place | Titanium dioxide/ |
| | (proprietary chemical formula) | | | of spheres | Talc |
| 2A | Cycloaliphatic polyglycidyl ether- | 14.5% | 35.1% | Material amount, | 4-6 |
| | modified epoxy resin | | | total formula | |
| | | | | wt. % | |
| 3A | Polymeric pigment dispersant | 0.62% | 1.58% | Material amount, | 4-6 |
| | (proprietary chemical formula) | | | vol. % | |
| 4A | Polymeric graphene dispersant | 0.42% | 1.10% | Particle size, | 0.5-2 |
| | | | | mcm | |
| 6A | Titanium dioxide | 2.08% | 2.76% | Hardener type | Modified poly- |
| | | | | | amidoamine |
| | | | | | (proprietary |
| | | | | | chemical |
| | | | | | formula) |
| 7A | Organo-modified derivative of the | 1.33% | 2.21% | Epoxy/NH ratio | 1.0 |
| | Aluminium phyllosilicate clay | | | | |
| 11A | Microcrystalline magnesium silicate | 2.91% | 2.76% | Resin amount, | 46 |
| | | | | total formula | |
| | | | | wt. % | |
| 13A | C12-14 aliphatic glycidyl ether | 4.16% | 11.86% | Adhesion | Glycidoxypropyl |
| | | | | promotor type | trimethoxysilane |
| 14A | Butyl glycidyl ether | 4.16% | 12.13% | Adhesion to | 5 |
| | | | | steel, MPa | |
| 15A | Silicone oligomer (proprietary | 0.83% | 2.72% | Overcoat | 7-8 |
| | chemical formula) | | | Adhesion to | |
| | | | | Primer, MPa | |
| 16A | Benzyl Alcohol | 1.66% | 4.24% | Recoat adhesion | N/A |
| | | | | @72 hrs, grade | |
| 17A | Glycidoxypropyl trimethoxysilane | 0.67% | 1.66% | Sound | 1-2 |
| | | | | dampening, dB/4 | |
| | | | | mil | |
| 18A | Methyl acetate | 2.50% | 7.10% | Sagging at 10 mil | Fail |
| | | | | Blistering test | N/A |
| | | | | (steel) | |
| Total: | | 42.13% | 100.00 | | |
| # Part | | %, wt | | | |
| B | Hardener Composition | total | %, vol | | |
| 1B | Modified poly-amidoamine | 25.80% | 91.11% | | |
| | (proprietary chemical formula) | | | | |
| 2B | 2,4,6- | 0.51% | 1.83% | | |
| | Tris[(dimethylamino)methyl]phenol | | | | |
| 5B | Xylene, aromatic solvent | 1.69% | 7.06% | | |
| 6B | Methyl acetate | 4.21% | 1.00% | | |

| | | |
|---|---|---|
| Total: | 32.20% | 100% |

| Formula 242 | | | | | |
|---|---|---|---|---|---|
| # Part | | %, wt | | | |
| A | Composition | total | %, vol | Select Properties | |
| 1A | Cycloaliphatic polyglycidyl | 6.32% | 13.38% | Sphere type | Hollow ceramic |
| | ether- modified epoxy resin | | | | spheres |
| 3A | Polymeric pigment dispersant | 0.19% | 0.42% | Spheres amount, | 35 |
| | (proprietary chemical formula) | | | total formula wt. % | |
| 4A | Polymeric graphene dispersant | 0.13% | 0.30% | Spheres amount, | 35 |
| | | | | vol. % | |
| 5A | 95% Benzenepropanoic acid | 0.17% | 0.36% | Sphere size, mcm | 35 |
| 6A | Glycidoxypropyl | 0.20% | 0.44% | Hardener type | Amine-modified |
| | trimethoxysilane | | | | Phenalkamine |
| 7A | Multilayered graphene flakes | 0.04% | 0.04% | Epoxy/NH ratio | 1.2 |
| 8A | Titanium dioxide | 0.64% | 0.36% | Resin amount, total | 37 |
| | | | | formula wt. % | |
| 9A | Organo-modified derivative of | 0.64% | 0.87% | Adhesion promotor | Glycidoxypropyl |
| | the Aluminium phyllosilicate | | | type | trimethoxysilane |
| | clay | | | | |
| 10A | Micronized barium sulphate | 1.20% | 0.66% | Adhesion to steel, | 7-8 |
| | | | | MPa | |
| | | | | Overcoat Adhesion | 7-8 |
| | | | | to Primer, MPa | |
| 12A | Polyamide wax derivative, | 0.11% | 0.27% | Recoat adhesion | Pass (5) |
| | micronized | | | @72 hrs, grade | |
| 13A | Hollow ceramic meso-spheres | 35.11% | 35.26% | Sound dampening, | 6-7 |
| | | | | dB/4 mil | |
| 14A | C12-14 aliphatic glycidyl ether | 1.99% | 4.94% | Sagging at 10 mil | Pass |
| 15A | Benzyl Alcohol | 1.00% | 2.21% | Blistering test (steel) | Pass |

| 16A | Xylene, aromatic solvent | 5.20% | 13.97% |
|---|---|---|---|
| 17A | Silicone modified defoamer | 0.26% | 0.64% |
| 18A | Microcrystalline magnesium | 0.89% | 0.73% |
| | silicate | | |
| 19A | Methyl acetate | 1.19% | 2.95% |
| 21A | Bisphenol A epoxy resin | 10.34% | 20.41% |
| 22A | Fumed SiO₂ | 0.86% | 1.77% |
| Total: | | 66.52% | 100.00% |
| # Part | | %, wt | |
| B | Hardener Composition | total | %, vol |
| 1B | Amine-modified Phenalkamine | 21.06% | 60.25% |
| | (proprietary chemical formula) | | |
| 2B | 2,4,6- | 0.22% | 0.66% |
| | Tris[(dimethylamino)methyl]phenol | | |
| 5B | Methyl Ethyl Ketone | 1.62% | 5.89% |
| 6B | Xylene, aromatic solvent | 9.79% | 33.20% |
| 7B | Benzyl Alcohol | 0.00% | 0.00% |

| | | |
|---|---|---|
| Total: | 32.70% | 100.00% |

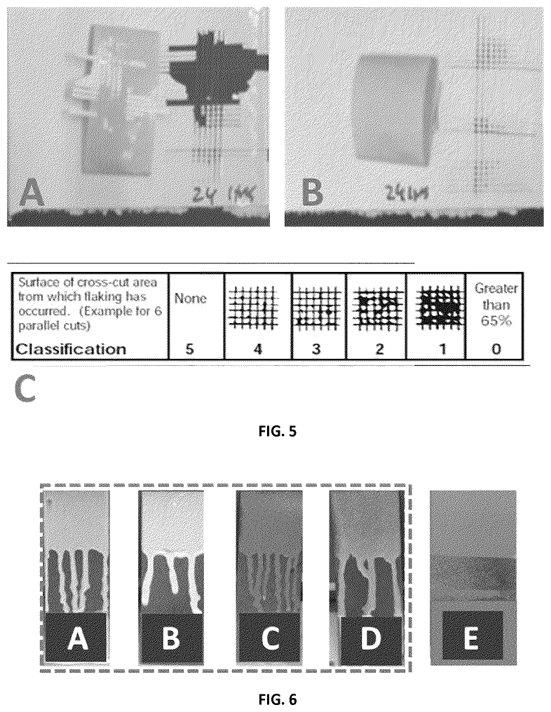

Further comparisons were made between the noise radiating properties of coating formed from Formula 242, and the noise radiating properties for coating formed from the formulation 242 without an anti-sagging rheology modifier (Formula 242.2 below) and without a silane adhesion promoter (Formula 242.3 below). For coatings formed from each formulation, 242, 242.2, and 242.3, the reduction in radiated noise relative to no coating as measured using the set-up depicted in FIG. 1 was about 6 dB/100 μm of coating to about 7 db/100 μm. These results suggested that the hollow ceramic spheres were the main component impacting the radiated noise performance of the URN coatings. Further, it was observed that the absence of an anti-sagging additive lead to inconsistent coating layer build up and sagging when wet-coated at 150-250 micron, as is depicted in FIG. 6.

| BC242.2 - No Anti-Sagging Rheology Modifier | | | | | |
|---|---|---|---|---|---|
| | | %, wt | | | |
| # Part A | Composition | total | %, vol | Select Properties | |
| 1A | Cycloaliphatic polyglycidyl | 6.4% | 12.9% | Sphere type | Hollow ceramic |
| | ether-modified epoxy resin | | | | meso-spheres |
| 3A | Polymeric pigment | 0.19% | 0.43% | Spheres amount, | 36 |
| | dispersant (proprietary | | | vol. % | |
| | chemical formula) | | | | |
| 4A | Polymeric graphene | 0.13% | 0.30% | Spheres amount, | 35 |
| | dispersant | | | total formula | |
| | | | | wt. % | |
| 5A | 95% Benzenepropanoic acid | 0.17% | 0.36% | Sphere size, | 35 |
| | | | | mcm | |
| 6A | Glycidoxypropyl | 0.20% | 0.44% | Hardener type | Amine-modified |
| | trimethoxysilane | | | | Phenalkamine |
| | | | | | (proprietary |
| | | | | | chemical |
| | | | | | formula) |
| 7A | Multilayered graphene flakes | 0.04% | 0.04% | Epoxy/NH ratio | 1.2 |
| 8A | Titanium dioxide | 0.64% | 0.36% | Resin amount, | 17 |
| | | | | total formula | |
| | | | | wt. % | |
| 10A | Micronized barium sulphate | 1.20% | 0.67% | Adhesion | Glycidoxypropyl |
| | | | | promotor type | trimethoxysilane |
| 13A | Hollow ceramic meso- | 35.38% | 35.67% | Adhesion to | 6-7 |
| | spheres | | | steel, MPa | |
| | | | | Overcoat | 7-8 |
| | | | | Adhesion to | |
| | | | | Primer, MPa | |
| 14A | C12-14 aliphatic glycidyl | 2.01% | 5.00% | Recoat adhesion | Pass (5) |
| | ether | | | @72 hrs, grade | |
| 15A | Benzyl Alcohol | 1.00% | 2.24% | Sound | 6-7 |
| | | | | dampening, dB/4 | |
| | | | | mil | |
| 16A | Xylene, aromatic solvent | 5.24% | 14.13% | Sagging at 10 mil | Fail |
| 17A | Silicone modified defoamer | 0.26% | 0.65% | Blistering test | Pass |
| | | | | (steel) | |
| 18A | Microcrystalline magnesium | 0.90% | 0.74% | Blistering test | Pass |
| | silicate | | | (primed) | |

| 19A | Methyl acetate | 1.20% | 2.99% |
|---|---|---|---|
| 21A | Bisphenol A epoxy resin | 10.41% | 20.64% |
| 22A | Fumed SiO₂ | 0.86% | 1.79% |
| Total: | | 66.27% | 100.00% |
| | | %, wt | |
| # Part B | Comp | total | %, vol |
| 1B | Amine-modified | 21.22% | 60.25% |
| | Phenalkamine (proprietary | | |
| | chemical formula) | | |
| 2B | 2,4,6- | 0.22% | 0.66% |
| | Tris[(dimethylamino)methyl]p | | |
| | henol | | |
| 5B | Methyl Ethyl Ketone | 1.64% | 5.89% |
| 6B | Xylene, aromatic solvent | 9.86% | 33.20% |

| | | |
|---|---|---|
| Total: | 32.95% | 100.00% |

| BC242.3 - No Adhesion Promoter | | | | | |
|---|---|---|---|---|---|
| # Part | | %, wt | | | |
| A | Composition | total | %, vol | Select Properties | |
| 1A | Cycloaliphatic polyglycidyl | 6.3% | 13.4% | Sphere type | Hollow ceramic |
| | ether-modified epoxy resin | | | | meso-spheres |
| 3A | Polymeric pigment | 0.19% | 0.42% | Spheres amount, | 35.4 |
| | dispersant (proprietary | | | total formula vol. % | |
| | chemical formula) | | | | |
| 4A | Polymeric graphene | 0.13% | 0.30% | Sphere size, mcm | 35 |
| | dispersant | | | | |
| 5A | 95% Benzenepropanoic | 0.17% | 0.36% | Spheres amount, | 35 |
| | acid | | | total wt. % | |
| 7A | Multilayered graphene | 0.04% | 0.04% | Hardener type | Amine-modified |
| | flakes | | | | Phenalkamine |
| | | | | | (proprietary |
| | | | | | chemical |
| | | | | | formula) |
| 8A | Titanium dioxide | 0.64% | 0.36% | Epoxy/NH ratio | 1.2 |
| 9A | Organo-modified derivative | 0.64% | 0.87% | Resin amount, | 17 |
| | of the Aluminium | | | total formula wt. % | |
| | phyllosilicate clay | | | | |
| 10A | Micronized barium sulphate | 1.20% | 0.66% | Adhesion | N/A |
| | | | | promotor type | |
| 12A | Polyamide wax derivative, | 0.11% | 0.27% | Adhesion to steel, | 6-7 |
| | micronized | | | MPa | |
| | | | | Overcoat | 7-8 |
| | | | | Adhesion to | |
| | | | | Primer, MPa | |
| 13A | Hollow ceramic meso- | 35.25% | 35.42% | Recoat adhesion | Pass (5)) |
| | spheres | | | @72 hrs, grade | |
| 14A | C12-14 aliphatic glycidyl | 2.00% | 4.97% | Sound | 6-7 |
| | ether | | | dampening, dB/4 | |
| | | | | mil | |
| 15A | Benzyl Alcohol | 1.00% | 2.22% | Sagging at 10 mil | Pass |
| 16A | Xylene, aromatic solvent | 5.22% | 14.03% | Blistering test | Pass |
| | | | | (steel) | |
| 17A | Silicone modified defoamer | 0.26% | 0.64% | Blistering test | Pass |
| | | | | (primed) | |

| 18A | Microcrystalline | 0.89% | 0.74% |
|---|---|---|---|
| | magnesium silicate | | |
| 19A | Methyl acetate | 1.20% | 2.97% |
| 20A | Polyamide wax derivative, | 0.00% | 0.00% |
| | micronized | | |
| 21A | Bisphenol A epoxy resin | 10.38% | 20.50% |
| 22A | Fumed SiO₂ | 0.86% | 1.78% |
| Total: | | 66.58% | 100.00% |
| # Part | | %, wt | |
| B | Hardener Composition | total | %, vol |
| 1B | Amine-modified | 20.96% | 60.04% |
| | Phenalkamine (proprietary | | |
| | chemical formula) | | |
| 2B | 2,4,6- | 0.22% | 0.66% |
| | Tris[(dimethylamino)methyl | | |
| | ]phenol | | |
| 5B | Methyl Ethyl Ketone | 1.63% | 5.93% |
| 6B | Xylene, aromatic solvent | 9.82% | 33.37% |

| | | |
|---|---|---|
| Total: | 32.64% | 100.00% |

Types. URN formulation 169_URN3-8.2 (shown below) was prepared containing 38% wt of hollow ceramic micro-spheres (12 micron in diameter), and the resultant coating exhibited a reduction in radiated noise—as measured relative to no coating using the set-up depicted in FIG. 1—of about 5 dB/100 micron. As shown above, Formula 242 was prepared containing 35% wt of hollow ceramic meso-spheres (35 micron in diameter), and the resultant coating exhibited a radiated noise reduction of 6-7 dB/microns. At a fixed wt. percentage and coating thickness (ca. 200 micron), the hollow ceramic meso-spheres provided a reduction of 6-7 dB/100 micron relative to the 5 dB/100 micron provided by the micro-spheres. A difference of 1-2 dB when reducing radiated noise at a frequency between 100 Hz to 1,000 Hz is generally considered a notable difference when being provided by a coating applied to a substrate (e.g., steel plate, or a boat hull). This suggested that hollow ceramic meso-spheres were a preferable ceramic performance additive to achieve desired reductions in radiating noise from the coatings formed from the URN compositions.

URN formulation 158_URN2-SP1 (shown below) was prepared containing about 35% wt. of the hollow glass meso-spheres, 158_URN2-SP2 (show below) was prepared containing 29% wt. of the hollow glass micro-spheres, and 158_URN2-SP1/SP2.2 (shown below) was prepared containing 23 and 13% wt. of the hollow glass meso- and micro-spheres, respectively. Each coating formed these compositions showed a reduction of about 2 db/100 micron of radiant noise (coating thickness at ca. 200 micron), which was slightly higher than Formula 156.Blank.2. This indicated that hollow glass spheres were not a preferred performance additive, relative to the hollow ceramic spheres.

| Batch | | | | | |
|---|---|---|---|---|---|
| code: | BC169_URN3-8.2 | | | | |
| # Part | | %, wt | | | |
| A | Composition | total | %, vol | Select Properties | |
| 1A | Low viscosity epoxy resin | 2.07% | 4.72% | Sphere type | Hollow ceramic |
| | (proprietary chemical formula) | | | | micro-spheres |
| 2A | Cycloaliphatic polyglycidyl | 4.85% | 11.2% | Spheres amount, | 38 |
| | ether-modified epoxy resin | | | total formula wt. % | |
| 3A | Polymeric pigment dispersant | 0.21% | 0.51% | Spheres amount, | 39 |
| | (proprietary chemical formula) | | | vol. % | |
| 4A | Polymeric graphene | 0.14% | 0.36% | Sphere size, mcm | 12 |
| | dispersant | | | | |
| 5A | Multilayered graphene flakes | 0.04% | 0.05% | Hardener type | |
| 6A | Titanium dioxide | 0.69% | 0.88% | Epoxy/NH ratio | 1.08 |
| 7A | Organo-modified derivative of | 0.69% | 1.04% | Resin amount, total | 18 |
| | the Aluminium phyllosilicate | | | formula wt. % | |
| | clay | | | | |
| 8A | Polyamide wax derivative, | 0.10% | 0.29% | Adhesion promotor | Glycidoxypropyl |
| | micronized | | | type | trimethoxysilane |
| 10A | Hollow ceramic micro-spheres | 38.01% | 38.88% | Adhesion to steel, | 6 |
| | | | | MPa | |
| | | | | Overcoat Adhesion | 6-8 |
| | | | | to primer, MPa | |
| 11A | Microcrystalline magnesium | 0.96% | 0.88% | Recoat adhesion | N/A |
| | silicate | | | @72 hrs, grade | |
| 12A | Micronized barium sulphate | 1.29% | 0.79% | Sound dampening, | 5 |
| | | | | dB/4 mil | |
| 13A | Glycidoxypropyl | 0.22% | 0.53% | Sagging at 10 mil | Pass |
| | trimethoxysilane | | | | |
| 14A | C12-14 aliphatic glycidyl ether | 2.15% | 5.92% | Blistering test (steel) | N/A |

| 15A | Benzyl Alcohol | 1.08% | 2.65% |
|---|---|---|---|
| 17A | Methyl acetate | 0.82% | 2.26% |
| 18A | 95% Benzenepropanoic acid | 0.18% | 0.43% |
| 19A | Silicone oligomer (proprietary | 0.28% | 0.87% |
| | chemical formula) | | |
| 21A | Xylene, aromatic solvent | 9.32% | 27.72% |
| Total: | | 63.10% | 100.00% |
| # Part | | %, wt | |
| B | Hardener Composition | total | %, vol |
| 1B | Amine-modified Phenalkamine | 11.36% | 73.26% |
| | (proprietary chemical formula) | | |
| 5B | Xylene, aromatic solvent | 1.18% | 9.05% |
| 6B | Methyl acetate | 2.51% | 17.69% |

| | | |
|---|---|---|
| Total: | 15.06% | 100.00% |

| | Batch code: | | | | |
|---|---|---|---|---|---|
| | Formula 158_URN2_SP1 | | | | |
| | | %, wt | | | |
| # Part A | Composition | total | %, vol | Select Properties | |
| 1A | RLow viscosity epoxy resin | 4.22% | 3.75% | Sphere type | Hollow Glass |
| | (proprietary chemical formula) | | | | meso-spheres |
| 2A | Cycloaliphatic polyglycidyl | 9.9% | 8.9% | Spheres amount, | 35 |
| | ether-modified epoxy resin | | | total formula wt. % | |
| 3A | Polymeric graphene | 0.28% | 0.28% | Spheres amount, | 74 |
| | dispersant | | | vol. % | |
| 4A | Polymeric pigment dispersant | 0.42% | 0.40% | Sphere size, mcm | 31 |
| | (proprietary chemical formula) | | | | |
| 6A | Titanium dioxide | 1.41% | 0.70% | Hardener type | Modified poly- |
| | | | | | amidoamine |
| 7A | Organo-modified derivative of | 1.41% | 0.82% | Epoxy/NH ratio | 1 |
| | the Aluminium phyllosilicate | | | | |
| | clay | | | | |
| 8A | Multilayered graphene flakes | 0.09% | 0.04% | Resin amount, total | 30 |
| | | | | formula wt. % | |
| 10A | Hollow glass meso-spheres | 35% | 74% | Adhesion promotor | |
| | | | | type | |
| 12A | Microcrystalline magnesium | 1.97% | 0.70% | Adhesion to steel, | N/A |
| | silicate | | | MPa | |
| | | | | Overcoat Adhesion to | N/A |
| | | | | Primer, MPa | |
| 13A | Micronized barium sulphate | 2.64% | 0.60% | Recoat adhesion | N/A |
| | | | | @72 hrs, grade | |
| 14A | C12-14 aliphatic glycidyl | 4.39% | 4.70% | Sound dampening, | 2 |
| | ether | | | dB/4 mil | |
| 15A | Silicone oligomer (proprietary | 0.56% | 0.69% | Sagging at 10 mil | Fail |
| | chemical formula) | | | | |
| 16A | Benzyl Alcohol | 2.20% | 2.10% | Blistering test (steel) | N/A |
| 17A | Glycidoxypropyltrimethoxy | 0.45% | 0.42% | | |
| | silane | | | | |
| 19A | Methyl acetate | 1.69% | 1.80% | | |

| | | |
|---|---|---|
| Total: | 68.04% | 100.00% |

| | | %, wt | |
|---|---|---|---|
| # Part B | Hardener Composition | total | %, vol |
| 1B | Modified poly-amidoamine | 15.31% | 70.53% |
| | (proprietary chemical formula) | | |
| 2B | 2,4,6- | 0.37% | 1.73% |
| | Tris[(dimethylamino)methyl] | | |
| | phenol | | |
| 5B | Xylene, aromatic solvent | 1.61% | 8.81% |
| 6B | Methyl acetate | 3.76% | 18.94% |

| | | |
|---|---|---|
| Total: | 21.05% | 100.00% |

| | Batch code: | | | | |
|---|---|---|---|---|---|
| | 158_URN2_SP2 | | | | |
| # Part | | %, wt | | | |
| A | Composition | total | %, vol | Select Properties | |
| 1A | Low viscosity epoxy resin | 4.93% | 2.68% | Sphere type | Hollow glass |
| | (proprietary chemical formula) | | | | micro-spheres |
| 2A | Cycloaliphatic polyglycidyl | 11.5% | 6.3% | Spheres amount, | 29 |
| | ether-modified epoxy resin | | | total formula wt. % | |
| 3A | Polymeric graphene | 0.33% | 0.20% | Spheres amount, | 80 |
| | dispersant | | | vol. % | |
| 4A | Polymeric pigment dispersant | 0.49% | 0.29% | Sphere size, mcm | 10 |
| | (proprietary chemical formula) | | | | |
| 6A | Titanium dioxide | 1.64% | 0.50% | Hardener type | |
| 7A | Organo-modified derivative of | 1.64% | 0.59% | Epoxy/NH ratio | 1 |
| | the Aluminium phyllosilicate | | | | |
| | clay | | | | |
| 8A | Multilayered graphene flakes | 0.10% | 0.03% | Resin amount, total | 34 |
| | | | | formula wt. % | |
| 10A | Hollow glass micro-spheres | 29.50% | 80% | Adhesion promotor | |
| | | | | type | |
| 12A | Microcrystalline magnesium | 2.30% | 0.50% | Adhesion to steel, | 4 |
| | silicate | | | MPa | |
| | | | | Overcoat Adhesion | 5-6 |
| | | | | to Primer, MPa | |
| 13A | Micronized barium sulphate | 3.08% | 0.43% | Recoat adhesion | N/A |
| | | | | @72 hrs, grade | |
| 14A | C12-14 aliphatic glycidyl ether | 5.14% | 3.36% | Sound dampening, | 2 |
| | | | | dB/4 mil | |
| 15A | Silicone oligomer (proprietary | 0.66% | 0.49% | Sagging at 10 mil | Fail |
| | chemical formula) | | | | |
| 16A | Benzyl Alcohol | 2.57% | 1.50% | Blistering test | N/A |
| | | | | (steel) | |
| 17A | Glycidoxypropyltrimethoxysilane | 0.52% | 0.30% | | |
| 19A | Methyl acetate | 1.97% | 1.29% | | |

| | | |
|---|---|---|
| Total: | 66.39% | 100.00% |

| # Part | | %, wt | |
|---|---|---|---|
| B | Hardener Composition | total | %, vol |
| 1B | Phenalkamine (proprietary | 17.72% | 75.84% |
| | chemical formula) | | |
| 5B | Xylene, aromatic solvent | 1.57% | 7.67% |
| 6B | Methyl acetate | 3.67% | 16.49% |

| | | |
|---|---|---|
| Total: | 22.96% | 100.00% |

| | Batch code: | | | | |
|---|---|---|---|---|---|
| | 158_URN2_SP1/SP2.2 | | | | |
| # Part | | %, wt | | | |
| A | Composition | total | %, vol | Select Properties | |
| 1A | Low viscosity epoxy resin | 4.25% | 2.82% | Sphere type | Mix of hollow |
| | (proprietary chemical formula) | | | | glass meso- and |
| | | | | | micro-spheres |
| 2A | Cycloaliphatic polyglycidyl ether- | 9.9% | 6.7% | Spheres amount, | 23 (micro-glass)/ |
| | modified epoxy resin | | | total formula wt. % | 13 (meso-glass) |
| 3A | Polymeric graphene dispersant | 0.28% | 0.21% | Spheres amount, | 26 (micro-glass)/ |
| | | | | vol. % | 45 (meso-glass) |
| 4A | Polymeric pigment dispersant | 0.42% | 0.30% | Sphere size, mcm | 10 (micro-glass)/ |
| | (proprietary chemical formula) | | | | 31 (meso-glass) |
| 6A | Titanium dioxide | 1.42% | 0.53% | Hardener type | |
| 7A | Organo-modified derivative of | 1.42% | 0.62% | Epoxy/NH ratio | 1 |
| | the Aluminium phyllosilicate clay | | | | |
| 8A | Multilayered graphene flakes | 0.09% | 0.03% | Resin amount, | 30 |
| | | | | total formula wt. % | |
| 10A | Hollow glass meso-spheres | 23.44% | 35.61% | Adhesion | |
| | | | | promotor type | |
| 11A | Hollow glass micro-spheres | 13.27% | 44.89% | Adhesion to steel, | N/A |
| | | | | MPa | |
| | | | | Overcoat | 3-5 |
| | | | | Adhesion to | |
| | | | | Primer, MPa | |
| 12A | Microcrystalline magnesium | 1.98% | 0.53% | Recoat adhesion | N/A |
| | silicate | | | @72 hrs, grade | |
| 13A | Micronized barium sulphate | 2.65% | 0.45% | Sound | 2 |
| | | | | dampening, dB/4 | |
| | | | | mil | |
| 14A | C12-14 aliphatic glycidyl ether | 4.42% | 3.54% | Sagging at 10 mil | Fail |
| 15A | Silicone oligomer (proprietary | 0.57% | 0.52% | Blistering test | N/A |
| | chemical formula) | | | (steel) | |
| 16A | Benzyl Alcohol | 2.21% | 1.58% | | |
| 17A | Glycidoxypropyltrimethoxysilane | 0.45% | 0.32% | | |
| 19A | Methyl acetate | 1.70% | 1.35% | | |

| | | |
|---|---|---|
| Total: | 68.46% | 100.00% |

| # Part | | %, wt | |
|---|---|---|---|
| B | Hardener Composition | total | %, vol |
| 1B | Modified poly-amidoamine | 15.40% | 72.80% |
| | (proprietary chemical formula) | | |
| 2B | 2,4,6- | 0.30% | 1.43% |
| | Tris[(dimethylamino)methyl]phenol | | |
| 5B | Xylene, aromatic solvent | 1.44% | 8.08% |
| 6B | Methyl acetate | 3.42% | 17.69% |
| Total: | | 20.56% | 100.00% |

Amounts. URN formulation 169-URN3_6.2 (shown below) was prepared containing about 45% wt of hollow ceramic meso-spheres. As shown above, URN Formula 242 was prepared containing about 35% wt of hollow ceramic meso-spheres. URN formulation Formula 169-URN3_1B.2 (shown below) was prepared containing about 20% wt of hollow ceramic meso-spheres. For coatings formed from each formulation, it was found that the reduction in radiated noise—as measured relative to no coating using the set-up depicted in FIG. 1—was respectively about 6.8, 6-7, and 4 dB/100 micron. This indicated that a reduction in radiated noise as high as about 6 dB/100 micron could be achieved at a wt. percentage of hollow ceramic meso-spheres as high as about 35% wt (total formula weight). At a fixed coating thickness of 150-200 micron, coating formed from Formula 156.Blank.2 exhibited a reduction in radiated noise of about 1-2 dB/100 micron. While coating formed from 169-URN3_6.2 exhibited the largest reduction in radiated noise, it also failed the blistering/boiling test, suggesting that 45 wt % or higher in hollow ceramic meso-spheres reduces the long-term impermeability of an URN coating in water.

| | Batch code: | | | | |
|---|---|---|---|---|---|
| | Formula BC169_URN3-6.2 | | | | |
| # Part | | %, wt | | | |
| A | Composition | total | %, vol | Select Properties | |
| 1A | Low viscosity epoxy resin | 2.43% | 4.93% | Sphere type | Hollow ceramic |
| | (proprietary chemical formula) | | | | meso-spheres |
| 2A | Cycloaliphatic polyglycidyl | 5.68% | 11.72% | Spheres amount, | 45 |
| | ether-modified epoxy resin | | | total formula wt. % | |
| 3A | Polymeric pigment dispersant | 0.24% | 0.53% | Spheres amount, | 44 |
| | (proprietary chemical formula) | | | vol. % | |
| 4A | Polymeric graphene | 0.16% | 0.37% | Sphere size, mcm | 35 |
| | dispersant | | | | |
| 5A | Multilayered graphene flakes | 0.05% | 0.05% | Hardener type | Phenalkamine |
| 6A | Titanium dioxide | 0.81% | 0.92% | Epoxy/NH ratio | 1.08 |
| 7A | Organo-modified derivative of | 0.81% | 1.09% | Resin amount, | 18 |
| | the Aluminium phyllosilicate | | | total formula wt. % | |
| | clay | | | | |
| 8A | Polyamide wax derivative, | 0.12% | 0.30% | Adhesion | Glycidoxypropyl |
| | micronized | | | promotor type | trimethoxysilane |
| 10A | Hollow ceramic meso-spheres | 44.73% | 44.11% | Adhesion to steel, | 7 |
| | | | | MPa | |
| | | | | Overcoat | 8-7 |
| | | | | Adhesion to | |
| | | | | Primer, MPa | |
| 11A | Microcrystalline magnesium | 1.13% | 0.92% | Recoat adhesion | N/A |
| | silicate | | | @72 hrs, grade | |
| 12A | Micronized barium sulphate | 1.52% | 0.82% | Sound | 6.8 |
| | | | | dampening, dB/4 | |
| | | | | mil (1 mil = 25.4 μm) | |
| 13A | Glycidoxypropyl | 0.26% | 0.55% | Sagging at 10 mil | Pass |
| | trimethoxysilane | | | | |
| 14A | C12-14 aliphatic glycidyl ether | 2.54% | 6.18% | Blistering test | Failed |
| | | | | (steel) | |
| 15A | Benzyl Alcohol | 1.27% | 2.77% | | |
| 17A | Methyl acetate | 2.43% | 5.90% | | |
| 18A | 95% Benzenepropanoic acid | 0.21% | 0.45% | | |
| 19A | Silicone oligomer (proprietary | 0.32% | 0.91% | | |
| | chemical formula) | | | | |
| 21A | Xylene, aromatic solvent | 6.62% | 17.47% | | |

| | | |
|---|---|---|
| Total: | 71.36% | 100.00% |

| # Part | | %, wt | |
|---|---|---|---|
| B | Hardener Composition | total | %, vol |
| 1B | Phenalkamine (proprietary | 9.96% | 74.05% |
| | chemical formula) | | |
| 5B | Xylene, aromatic solvent | 0.96% | 8.15% |
| 6B | Methyl acetate | 2.28% | 17.80% |

| | | |
|---|---|---|
| Total: | 13.21% | 100.00% |

| | Batch code: | | | | |
|---|---|---|---|---|---|
| | Formula BC169_URN3-1B.2 | | | | |
| # Part | | %, wt | | | |
| A | Composition | total | %, vol | Select Properties | |
| 1A | Low viscosity epoxy resin | 4.80% | 10.95% | Sphere type | Ceramic |
| | (proprietary chemical formula) | | | | hollow spheres |
| 2A | Cycloaliphatic polyglycidyl ether- | 11.2% | 26% | Spheres amount, | 20 |
| | modified epoxy resin | | | total formula wt. % | |
| 3A | Polymeric pigment dispersant | 0.48% | 1.17% | Spheres amount, | 23 |
| | (proprietary chemical formula) | | | vol. % | |
| 4A | Polymeric graphene dispersant | 0.32% | 0.82% | Sphere size, mcm | 35 |
| 6A | Multilayered graphene flakes | 0.10% | 0.12% | Hardener type | |
| 7A | Titanium dioxide | 1.60% | 2.05% | Epoxy/NH ratio | 1 |
| 8A | Organo-modified derivative of the | 1.60% | 2.41% | Resin amount, total | 33 |
| | Aluminium phyllosilicate clay | | | formula wt. % | |
| 9A | Polyamide wax derivative, | 0.24% | 0.67% | Adhesion promotor | |
| | micronized | | | type | |
| 11A | Hollow ceramic meso-spheres | 20.36% | 22.59% | Adhesion to steel, | N/A |
| | | | | MPa | |
| | | | | Overcoat Adhesion | 5-8 |
| | | | | to Primer, MPa | |
| 12A | Microcrystalline magnesium | 2.24% | 2.04% | Recoat adhesion | N/A |
| | silicate | | | @72 hrs, grade | |
| 13A | Micronized barium sulphate | 3.00% | 1.82% | Sound dampening, | 4 |
| | | | | dB/4 mil | |
| 15A | Glycidoxypropyltrimethoxysilane | 0.51% | 1.22% | Sagging at 10 mil | Pass |
| 16A | C12-14 aliphatic glycidyl ether | 5.00% | 13.73% | Blistering test (steel) | Fail |
| 17A | Benzyl Alcohol | 2.50% | 6.14% | | |
| 19A | Methyl acetate | 1.92% | 5.26% | | |
| 20A | 95% Benzenepropanoic acid | 0.41% | 0.98% | | |
| 21A | Silicone oligomer (proprietary | 0.64% | 2.02% | | |
| | chemical formula) | | | | |
| Total: | | 56.96% | 100.00% | | |

| # Part | | %, wt | |
|---|---|---|---|
| B | Hardener Composition | total | %, vol |
| 1B | Modified poly-amidoamine | 17.43% | 86.30% |
| | (proprietary chemical formula) | | |
| 5B | Xylene, aromatic solvent | 0.72% | 4.24% |
| 6B | Methyl acetate | 1.75% | 9.46% |

| | | |
|---|---|---|
| Total: | 19.90% | 100.00% |

URN formulation BC169_URN3-3.2 (shown below) was prepared containing about 30% wt. (total formula weight) hollow ceramic meso-spheres and cross-linked with a modified poly-amidoamine at a Epoxy/NH ratio of 1.0. URN formulation 156.Blank.2 (shown above) was also cross-linked with a Modified poly-amidoamine at a Epoxy/NH ratio of 1.0. Coatings formed from each formulation had an adhesion to bare steel of 5 MPa. This suggested that the hollow ceramic spheres do not the adhesive performance of URN coatings.

| | Batch code: | | | | |
|---|---|---|---|---|---|
| | Formula BC169_URN3-3.2 | | | | |
| # Part | | %, wt | | | |
| A | Composition | total | %, vol | Select Properties | |
| 1A | Low viscosity epoxy resin | 3.21% | 8.59% | Sphere type | Ceramic |
| | (proprietary chemical formula) | | | | hollow |
| | | | | | spheres |
| 2A | Cycloaliphatic polyglycidyl | 7.5% | 18.4% | Spheres amount, | 30 |
| | ether-modified epoxy resin | | | total formula | |
| | | | | wt. % | |
| 3A | Polymeric pigment dispersant | 0.32% | 0.92% | Spheres amount, | 39 |
| | (proprietary chemical formula) | | | vol. % | |
| 4A | Polymeric graphene dispersant | 0.22% | 0.65% | Sphere size, | 35 |
| | | | | mcm | |
| 6A | Multilayered graphene flakes | 0.07% | 0.09% | Hardener type | Modified |
| | | | | | poly- |
| | | | | | amidoamine |
| 7A | Titanium dioxide | 1.07% | 1.61% | Epoxy/NH ratio | 1.08 |
| 8A | Organo-modified derivative of | 1.07% | 1.89% | Resin amount, | 28 |
| | the Aluminium phyllosilicate | | | total formula | |
| | clay | | | wt. % | |
| 9A | Polyamide wax derivative, | 0.16% | 0.53% | Adhesion | |
| | micronized | | | promotor type | |
| 11A | Hollow ceramic meso-spheres | 30.09% | 39.23% | Overcoat | 5-6 |
| | | | | Adhesion to | |
| | | | | steel, MPa | |
| 12A | Microcrystalline magnesium | 1.50% | 1.60% | Recoat adhesion | N/A |
| | silicate | | | @72 hrs, grade | |
| 13A | Micronized barium sulphate | 2.01% | 1.43% | Sound | 5.7 |
| | | | | dampening, dB/4 | |
| | | | | mil | |
| 15A | Glycidoxypropyltrimethoxysilane | 0.34% | 0.96% | Sagging at 10 | Pass |
| | | | | mil | |
| 16A | C12-14 aliphatic glycidyl ether | 3.34% | 10.78% | Blistering test | N/A |
| | | | | (steel) | |
| 17A | Benzyl Alcohol | 1.67% | 4.82% | | |
| 19A | Methyl acetate | 1.28% | 4.13% | | |
| 20A | 95% Benzenepropanoic acid | 0.28% | 0.77% | | |
| 21A | Silicone oligomer (proprietary | 0.43% | 1.59% | | |
| | chemical formula) | | | | |

| | | |
|---|---|---|
| Total: | 54.55% | 100.00% |

| # Part | | %, wt | |
|---|---|---|---|
| B | Hardener Compostion | total | %, vol |
| 1B | Modified poly-amidoamine | 17.62% | 73.49% |
| | (proprietary chemical formula) | | |
| 5B | Xylene, aromatic solvent | 1.67% | 8.27% |
| 6B | Methyl acetate | 4.00% | 18.24% |

| | | |
|---|---|---|
| Total: | 23.30% | 100.00% |

Applied Coating Thickness. It was observed that increasing the applied thicknesses of the URN coatings improved the coating's radiated noise reduction properties. With reference to the Formula BC169_URN3-3.2 below, which contained 30% wt of the hollow ceramic spheres, the URN composition was applied onto bare metal at a thickness of 85, 112 or 275 microns, resulting in a cured URN coating having an average reduced radiated noise performance over a 100-1000 Hz frequency range of about 5.7, 7 and 10 db, respectively.

Permeability. URN Formulas 169_URN3-6.2 (shown above) and Formula 242 (shown above) were prepared containing about 8 and 16.5% wt of epoxy resin, and about 18 wt % and 3 wt % total resin (epoxy and hardener). As exemplified by the failed blistering/boiling test of formula 169_URN3-6.2, URN coatings (200 micron and more) containing more than 30% wt total resin (epoxy resin and hardener resin) tended to be less permeable to water and salt and passed the water boiling test. For qualitative comparison between URN coatings formed from formulas 169_URN3-6.2 and 242, refer to the FIG. 6.

### Adhesion Studies

Described herein are three different types of adhesion, as described and tested below:

| | Substrate | | |
|---|---|---|---|
| | Adhesion | | Recoat |
| | (to Steel) | Overcoat Adhesion | Adhesion |
| De- | Adhesion of a | Adhesion of a | Adhesion of a |
| scription | coating applied | coating applied onto | coating recoated |
| | onto a bare steel | a substrate (steel or | with a topcoat |
| | substrate | fiberglass) that was | layer for |
| | | primed with an | finishing |
| | | epoxy- or urethane | qualities. |
| | | primer. | |
| Where | Adhesion of a | Adhesion of a | Adhesion of a |
| adhesion is | coating to a steel | coating to a primer | topcoat to a |
| measured | substrate | | coating |
| Method | Pull-off test | Pull-off test | Cross hatch tape |
| used | (ASTM D4541) | (ASTM D4541) | adhesion test |
| | | | (ASTM D3359) |

Comparing coatings formed of Formula 242 with Formula 242.3 (see above), it was observed that 242 had a 1-2 MPa higher substrate adhesion to steel than formula 242.3 that did not contain an adhesion promotor.

As demonstrated by coatings formed from Formulae 242, 242.2, and 242.3, substrate adhesion of URN coatings to steel was generally observed to be in the range of about 6-7 absent an adhesion promoter, while the presence of an adhesion promotor helped to increase it to 7-8 MPa range. An adhesion increase of 1-2 MPa for substrate, or overcoat adhesion is generally recognized in the art as being a notable increase, as such an increase can result in a boost of the coating's working lifetime (e.g., 5-10 years of sea/water fairing) by decreasing the likelihood of delamination from the substrate (also referred to as substratum), etc.

Further, it was generally observed that overcoat adhesion properties of URN coatings to primer—regardless of the presence of an adhesion promotor or the type of hardener, or epoxy/NH ratio used—was on average about 5-15% higher than that observed for steel substrate adhesion properties. In some examples, substrate adhesion to steel and overcoat adhesion to primer was observed to be about the same. Without wishing to be bound by theory, it was considered that this may have been due to the hollow ceramic sphere's interacting with, or interfering with the resin-substrate interaction.

It was further observed that selection of type and amount of hardener could impact adhesion properties of URN coatings. With reference to Formula 169-URN3_6.2 (shown above), cross-linked with phenalkamine at an Epoxy/NH ratio of 1.08, the resultant coating had a higher substrate adhesion to steel than Formula 200.2 (shown below) cross-linked with the same phenalkamine, but at higher Epoxy/NH ratio of 1.4.

It was also observed that coating formed from Formula 200.1 (shown below), cross-linked with amine-modified phenalkamine at an Epoxy/NH ratio of 1.08, had a higher substrate adhesion to steel than the coating formed from Formula 169-URN3_6.2 cross-linked with phenalkamine at an Epoxy/NH ratio of 1.08. Coating formed from Formula 200.1 also had an recoat adhesion of 1, which is generally considered a fail for this type of adhesion. Without wishing to be bound by theory, it was considered that Epoxy/NH ratio of 1.08 resulted in relatively faster curing and thus relatively poorer recoat adhesion than formula with a higher Epoxy/NH ratio. A lower curing speed may result in a greater availability of epoxy and amine groups on the surface of an URN coating, which can enable the overlaying topcoat to adhere more strongly to the URN coating upon over-spraying.

Further, it was observed that coating formed from Formula 212.4 (shown below) cross-linked with amine-modified phenalkamine at an Epoxy/NH ratio of 1.4 had the highest recoat adhesion via cross-hatch test relative to coatings formed from Formulas 212.2 and 202.9 cross-linked with the same amine-modified phenalkamine at Epoxy/NH ratios of 1.2 and 1.08, respectively. This suggested that use of an Epoxy/NH ratio within 1.2 to 1.4 (excess of epoxy groups), may provide a good recoating window, as poor recoat adhesion may prevent formation of a coating with reliable reduced radiated noise performance.

These results suggested that a higher Epoxy/NH ratio better supported the recoat adhesion. These results also suggested that too high a ratio may impact (e.g., reduce) substrate adhesion or overcoat adhesion. In some examples, it was found that using a Epoxy/NH ratio of about 1.2 could strike a balance between these two properties.

| | Batch code: | | | | |
|---|---|---|---|---|---|
| | Formula 200.1 | | | | |
| # Part | | %, wt | | | |
| A | Composition | total | %, vol | Select Properties | |
| 1A | Low viscosity epoxy resin | 2.08% | 5.04% | Sphere type | Hollow ceramic |
| | (proprietary chemical formula) | | | | meso-spheres |
| 2A | Cycloaliphatic polyglycidyl ether- | 4.85% | 12% | Spheres amount, | 38 |
| | modified epoxy resin | | | total formula | |
| | | | | wt. % | |
| 3A | Polymeric pigment dispersant | 0.21% | 0.54% | Spheres amount, | 45 |
| | (proprietary chemical formula) | | | vol. % | |
| 4A | Polymeric graphene dispersant | 0.14% | 0.38% | Sphere size, | 35 |
| | | | | mcm | |
| 5A | 95% Benzenepropanoic acid | 0.18% | 0.46% | Hardener type | Amine-modified |
| | | | | | Phenalkamine |
| 6A | Glycidoxypropyl trimethoxysilane | 0.22% | 0.56% | Epoxy/NH ratio | 1.08 |
| 7A | Multilayered graphene flakes | 0.04% | 0.05% | Resin amount, | 18 |
| | | | | total formula | |
| | | | | wt. % | |
| 8A | Titanium dioxide | 0.69% | 0.94% | Adhesion | Glycidoxypropyl |
| | | | | promotor type | trimethoxysilane |
| 9A | Organo-modified derivative of the | 0.69% | 1.11% | Adhesion to | 8 |
| | Aluminium phyllosilicate clay | | | steel, MPa | |
| | | | | Overcoat | 8 |
| | | | | Adhesion to | |
| | | | | Primer, MPa | |
| 10A | Micronized barium sulphate | 1.30% | 0.84% | Recoat adhesion | Fail, 1 |
| | | | | @72 hrs, grade | |
| 12A | Polyamide wax derivative, | 0.12% | 0.35% | Sound | 6.5 |
| | micronized | | | dampening, | |
| | | | | dB/4 mil | |
| 13A | Hollow ceramic meso-spheres | 38.17% | 45.13% | Sagging at 10 | Pass |
| | | | | mil | |
| 14A | C12-14 aliphatic glycidyl ether | 2.16% | 6.33% | Blistering test | Fail |
| | | | | (steel) | |
| 15A | Benzyl Alcohol | 1.08% | 2.83% | | |
| 16A | Xylene, aromatic solvent | 5.65% | 17.88% | | |
| 17A | Silicone modified defoamer | 0.28% | 0.82% | | |
| 18A | Microcrystalline magnesium | 0.97% | 0.94% | | |
| | silicate | | | | |
| 19A | Methyl acetate | 1.30% | 3.78% | | |

| | | |
|---|---|---|
| Total: | 60.14% | 100.00% |

| # Part | | %, wt | |
|---|---|---|---|
| B | Hardener Composition | total | %, vol |
| 1B | Amine-modified Phenalkamine | 11.42% | 70.16% |
| | (proprietary chemical formula) | | |
| 5B | Methyl Ethyl Ketone | 1.20% | 9.38% |
| 6B | Xylene, aromatic solvent | 2.81% | 20.46% |

| | | |
|---|---|---|
| Total: | 15.43% | 100.00% |

| | Batch code: | | | | |
|---|---|---|---|---|---|
| | Formula 200.2 | | | | |
| # Part | | %, wt | Part A %, | | |
| A | Composition | total | vol | Select Properties | |
| 1A | Low viscosity epoxy resin | 2.13% | 5.04% | Sphere type | Hollow ceramic |
| | (proprietary chemical | | | | meso-spheres |
| | formula) | | | | |
| 2A | Cycloaliphatic polyglycidyl | 5% | 12% | Spheres | 39 |
| | ether-modified epoxy resin | | | amount, total | |
| | | | | formula wt. % | |
| 3A | Polymeric pigment | 0.21% | 0.54% | Spheres | 45 |
| | dispersant (proprietary | | | amount, vol. % | |
| | chemical formula) | | | | |
| 4A | Polymeric graphene | 0.14% | 0.38% | Sphere size, | 35 |
| | dispersant | | | mcm | |
| 5A | 95% Benzenepropanoic acid | 0.18% | 0.46% | Hardener type | Phenalkamine |
| | | | | | (proprietary |
| | | | | | chemical formula) |
| 6A | Glycidoxypropyltrimethoxy | 0.23% | 0.56% | Epoxy/NH | 1.4 |
| | silane | | | ratio | |
| 7A | Multilayered graphene flakes | 0.04% | 0.05% | Resin | 14 |
| | | | | amount, total | |
| | | | | formula wt. % | |
| 8A | Titanium dioxide | 0.71% | 0.94% | Adhesion | |
| | | | | promotor type | |
| 9A | Organo-modified derivative | 0.71% | 1.11% | Adhesion to | 5 |
| | of the Aluminium | | | steel, MPa | |
| | phyllosilicate clay | | | Overcoat | 4-6 |
| | | | | Adhesion to | |
| | | | | Primer, Mpa | |
| 10A | Micronized barium sulphate | 1.34% | 0.84% | Recoat | 4, Pass |
| | | | | adhesion | |
| | | | | @72 hrs, | |
| | | | | grade | |
| 12A | Polyamide wax derivative, | 0.12% | 0.35% | Sound | 6 |
| | micronized | | | dampening, | |
| | | | | dB/4 mil | |
| 13A | Hollow ceramic meso- | 39.21% | 45.13% | Sagging at 10 | Pass |
| | spheres | | | mil | |
| 14A | C12-14 aliphatic glycidyl | 2.22% | 6.33% | Blistering test | Fail |
| | ether | | | (steel) | |
| 15A | Benzyl Alcohol | 1.11% | 2.83% | | |
| 16A | Xylene, aromatic solvent | 5.81% | 17.88% | | |
| 17A | Silicone modified defoamer | 0.28% | 0.82% | | |
| 18A | Microcrystalline magnesium | 0.99% | 0.94% | | |
| | silicate | | | | |
| 19A | Methyl acetate | 1.33% | 3.78% | | |

| | | |
|---|---|---|
| Total: | 61.78% | 100.00% |

| # Part | | %, wt | |
|---|---|---|---|
| B | Hardener Composition | total | %, vol |
| 1B | Phenalkamine (proprietary | 6.74% | 47.87% |
| | chemical formula) | | |
| 5B | Methyl Ethyl Ketone | 0.82% | 7.13% |
| 6B | Xylene, aromatic solvent | 5.56% | 45.00% |

| | | |
|---|---|---|
| Total: | 13.12% | 100.00% |

| | Batch code: | | | | |
|---|---|---|---|---|---|
| | Formula 202.9 | | | | |
| # Part | | %, wt | | | |
| A | Composition | total | %, vol | Select Properties | |
| 1A | Low viscosity epoxy resin | 4% | 8.3% | Sphere type | Hollow ceramic |
| | (proprietary chemical formula) | | | | meso-spheres |
| 2A | Cycloaliphatic polyglycidyl | 3.98% | 8.76% | Spheres amount, | 43 |
| | ether-modified epoxy resin | | | total formula wt. % | |
| 3A | Polymeric pigment dispersant | 0.23% | 0.54% | Spheres amount, | 45 |
| | (proprietary chemical formula) | | | vol. % | |
| 4A | Polymeric graphene dispersant | 0.16% | 0.38% | Sphere size, mcm | 35 |
| 5A | 95% Benzenepropanoic acid | 0.20% | 0.46% | Hardener type | Amine-modified |
| | | | | | Phenalkamine |
| 6A | Glycidoxypropyltrimethoxysilane | 0.25% | 0.56% | Epoxy/NH ratio | 1.08 |
| 7A | Multilayered graphene flakes | 0.05% | 0.05% | Resin amount, | 21 |
| | | | | total formula wt. % | |
| 8A | Titanium dioxide | 0.78% | 0.94% | Adhesion promotor | Glycidoxypropyl |
| | | | | type | trimethoxysilane |
| 9A | Organo-modified derivative of | 0.78% | 1.11% | Adhesion to steel, | 7.5 |
| | the Aluminium phyllosilicate | | | Mpa | |
| | clay | | | | |
| | | | | Overcoat Adhesion | 6-8 |
| | | | | to Primer, Mpa | |
| 10A | Micronized barium sulphate | 1.46% | 0.84% | Recoat adhesion | Fail, 3 |
| | | | | @72 hrs, grade | |
| 12A | Polyamide wax derivative, | 0.13% | 0.35% | Sound dampening, | 5.5 |
| | micronized | | | dB/4 mil | |
| 13A | Hollow ceramic meso-spheres | 42.84% | 45.13% | Sagging at 10 mil | Pass |
| 14A | C12-14 aliphatic glycidyl ether | 2.43% | 6.33% | Blistering test | Fail |
| | | | | (steel) | |
| 15A | Benzyl Alcohol | 1.22% | 2.83% | | |
| 16A | Xylene, aromatic solvent | 6.35% | 17.88% | | |
| 17A | Silicone modified defoamer | 0.31% | 0.82% | | |
| 18A | Microcrystalline magnesium | 1.09% | 0.94% | | |
| | silicate | | | | |
| 19A | Methyl acetate | 1.46% | 3.78% | | |

| | | |
|---|---|---|
| Total: | 67.72% | 100.00% |

| # Part | | %, wt | |
|---|---|---|---|
| B | Hardener Composition | total | %, vol |
| 1B | Amine-modified Phenalkamine | 12.81% | 66.03% |
| | (proprietary chemical formula) | | |
| 5B | Xylene, aromatic solvent | 0.79% | 4.81% |
| 6B | Methyl acetate | 5.18% | 29.16% |

| | | |
|---|---|---|
| Total: | 18.78% | 100.00% |

| | Batch code: | | | | |
|---|---|---|---|---|---|
| | Formula 212.2 | | | | |
| # Part | | %, wt | | | |
| A | Composition | total | %, vol | Select Properties | |
| 1A | Low viscosity epoxy resin | 2.25% | 5.04% | Sphere type | Hollow ceramic |
| | (proprietary chemical | | | | meso-spheres |
| | formula) | | | | |
| 2A | Cycloaliphatic polyglycidyl | 5.26% | 12% | Spheres amount, | 41 |
| | ether-modified epoxy resin | | | total formula wt. % | |
| 3A | Polymeric pigment | 0.23% | 0.54% | Spheres amount, | 45 |
| | dispersant (proprietary | | | vol. % | |
| | chemical formula) | | | | |
| 4A | Polymeric graphene | 0.15% | 0.38% | Sphere size, mcm | 35 |
| | dispersant | | | | |
| 5A | 95% Benzenepropanoic acid | 0.20% | 0.46% | Hardener type | |
| 6A | Glycidoxypropyltrimethoxy- | 0.24% | 0.56% | Epoxy/NH ratio | 1.2 |
| | silane | | | | |
| 7A | Multilayered graphene flakes | 0.05% | 0.05% | Resin amount, total | 18 |
| | | | | formula wt. % | |
| 8A | Titanium dioxide | 0.75% | 0.94% | Adhesion promotor | Glycidoxypropyl |
| | | | | type | trimethoxysilane |
| 9A | Organo-modified derivative | 0.75% | 1.11% | Adhesion to steel, | 7 |
| | of the Aluminium | | | MPa | |
| | phyllosilicate clay | | | | |
| | | | | Overcoat Adhesion | 8-9 |
| | | | | to Primer, MPa | |
| 10A | Micronized barium sulphate | 1.41% | 0.84% | Recoat adhesion | 2, Fail |
| | | | | @72 hrs, grade | |
| 12A | Polyamide wax derivative, | 0.13% | 0.35% | Sound dampening, | 6.2 |
| | micronized | | | dB/4 mil | |
| 13A | Hollow ceramic meso- | 41.38% | 45.13% | Sagging at 10 mil | Pass |
| | spheres | | | | |
| 14A | C12-14 aliphatic glycidyl | 2.35% | 6.33% | Blistering test (steel) | Fail |
| | ether | | | | |
| 15A | Benzyl Alcohol | 1.17% | 2.83% | | |
| 16A | Xylene, aromatic solvent | 6.13% | 17.88% | | |
| 17A | Silicone modified defoamer | 0.30% | 0.82% | | |
| 18A | Microcrystalline magnesium | 1.05% | 0.94% | | |
| | silicate | | | | |
| 19A | Methyl acetate | 1.41% | 3.78% | | |

| | | |
|---|---|---|
| Total: | 65.21% | 100.00% |

| # Part | | %, wt | |
|---|---|---|---|
| B | Hardener Composition | total | %, vol |
| 1B | Amine-modified | 11.14% | 49.20% |
| | Phenalkamine (proprietary | | |
| | chemical formula) | | |
| 5B | Xylene, aromatic solvent | 1.28% | 6.72% |
| 6B | Methyl acetate | 9.13% | 44.08% |

| | | |
|---|---|---|
| Total: | 21.55% | 100.00% |

| | Batch code: | | | | |
|---|---|---|---|---|---|
| | Formula 212.4 | | | | |
| # Part | | %, wt | | | |
| A | Composition | total | %, vol | Select Properties | |
| 1A | Low viscosity epoxy resin | 2.29% | 5.04% | Sphere type | Hollow ceramic |
| | (proprietary chemical | | | | meso-spheres |
| | formula) | | | | |
| 2A | Cycloaliphatic polyglycidyl | 5.34% | 12% | Spheres | 42 |
| | ether-modified epoxy resin | | | amount, total | |
| | | | | formula wt. % | |
| 3A | Polymeric pigment | 0.23% | 0.54% | Spheres | 45 |
| | dispersant (proprietary | | | amount, vol. % | |
| | chemical formula) | | | | |
| 4A | Polymeric graphene | 0.15% | 0.38% | Sphere size, | 35 |
| | dispersant | | | mcm | |
| 5A | 95% Benzenepropanoic | 0.20% | 0.46% | Hardener type | |
| | acid | | | | |
| 6A | Glycidoxypropyl | 0.24% | 0.56% | Epoxy/NH ratio | 1.4 |
| | trimethoxysilane | | | | |
| 7A | Multilayered graphene | 0.05% | 0.05% | Resin amount, | 17 |
| | flakes | | | total formula | |
| | | | | wt. % | |
| 8A | Titanium dioxide | 0.77% | 0.94% | Adhesion | Glycidoxypropyl |
| | | | | promotor type | trimethoxysilane |
| 9A | Organo-modified derivative | 0.77% | 1.11% | Adhesion to | 7 |
| | of the Aluminium | | | steel, MPa | |
| | phyllosilicate clay | | | | |
| | | | | Overcoat | 8-9 |
| | | | | Adhesion to | |
| | | | | Primer, MPa | |
| 10A | Micronized barium sulphate | 1.43% | 0.84% | Recoat adhesion | 5, Pass |
| | | | | @72 hrs, grade | |
| 12A | Polyamide wax derivative, | 0.13% | 0.35% | Sound | 6 |
| | micronized | | | dampening, dB/4 | |
| | | | | mil | |
| 13A | Hollow ceramic meso- | 42.05% | 45.13% | Sagging at 10 | Pass |
| | spheres | | | mil | |
| 14A | C12-14 aliphatic glycidyl | 2.38% | 6.33% | Blistering test | Fail |
| | ether | | | (steel) | |
| 15A | Benzyl Alcohol | 1.19% | 2.83% | | |
| 16A | Xylene, aromatic solvent | 6.23% | 17.88% | | |
| 17A | Silicone modified defoamer | 0.31% | 0.82% | | |
| 18A | Microcrystalline magnesium | 1.07% | 0.94% | | |
| | silicate | | | | |
| 19A | Methyl acetate | 1.43% | 3.78% | | |

| | | |
|---|---|---|
| Total: | 66.26% | 100.00% |

| # Part | | %, wt | |
|---|---|---|---|
| B | Hardener Composition | total | %, vol |
| 1B | Amine-modified | 9.70% | 45.36% |
| | Phenalkamine (proprietary | | |
| | chemical formula) | | |
| 5B | Xylene, aromatic solvent | 1.30% | 7.23% |
| 6B | Methyl acetate | 9.28% | 47.41% |

| | | |
|---|---|---|
| Total: | 20.28% | 100.00% |

Shelf-Life. It was observed that use of solvents Methyl Acetate and Methyl Ethyl Ketone could, for some URN compositions, reduce shelf-life if used in the Hardener Composition. It was found that such solvents could react with components of the Hardener composition, such that the Hardener composition could not be effectively used later. It was otherwise found that neither solvent impacted the final coating if an URN composition prepared with Methyl Acetate and Methyl Ethyl Ketone in the Hardener Composition was used after it was prepared, and not stored for extended periods.

### Further Exemplary Formulae of URN Compositions:

| | Batch code: | | | | |
|---|---|---|---|---|---|
| | BC169_URN3-5.2 | | | | |
| # Part | | %, wt | | | |
| A | Composition | total | %, vol | Select Properties | |
| 1A | Low viscosity epoxy resin | 2.33% | 4.93% | Sphere type | Hollow |
| | (proprietary chemical | | | | ceramic meso- |
| | formula) | | | | sphere |
| 2A | Cycloaliphatic polyglycidyl | 5.44% | 11.72% | Spheres amount, | 43 |
| | ether-modified epoxy resin | | | total formula wt. % | |
| 3A | Polymeric pigment dispersant | 0.23% | 0.53% | Spheres amount, | 44 |
| | (proprietary chemical | | | vol. % | |
| | formula) | | | | |
| 4A | Polymeric graphene | 0.16% | 0.37% | Sphere size, mcm | 35 |
| | dispersant | | | | |
| 5A | Multilayered graphene flakes | 0.05% | 0.05% | Hardener type | H21 |
| 6A | Titanium dioxide | 0.78% | 0.92% | Epoxy/NH ratio | 1.08 |
| 7A | Organo-modified derivative of | 0.78% | 1.09% | Resin amount, total | 20 |
| | the Aluminium phyllosilicate | | | formula wt. % | |
| | clay | | | | |
| 8A | Polyamide wax derivative, | 0.12% | 0.30% | Adhesion promotor | |
| | micronized | | | type | |
| 10A | Hollow ceramic meso- | 42.81% | 44.11% | Adhesion to steel, | 8 |
| | spheres | | | MPa | |
| 11A | Microcrystalline magnesium | 1.09% | 0.92% | Adhesion to primer, | 8-10 |
| | silicate | | | MPa | |
| 12A | Micronized barium sulphate | 1.46% | 0.82% | Recoat adhesion | N/A |
| | | | | @72 hrs, grade | |
| 13A | Glycidoxypropyltrimethoxy | 0.25% | 0.55% | Sound dampening, | 4.4 |
| | silane | | | dB/4 mil | |
| 14A | C12-14 aliphatic glycidyl | 2.43% | 6.18% | Sagging at 10 mil | Pass |
| | ether | | | | |
| 15A | Benzyl Alcohol | 1.22% | 2.77% | Blistering test (steel) | N/A |
| 17A | Methyl acetate | 2.32% | 5.90% | | |
| 18A | 95% Benzenepropanoic acid | 0.20% | 0.45% | | |
| 19A | Silicone oligomer (proprietary | 0.31% | 0.91% | | |
| | chemical formula) | | | | |
| 21A | Xylene, aromatic solvent | 6.34% | 17.47% | | |

| | | |
|---|---|---|
| Total: | 68.31% | 100.00% |

| # Part | | %, wt | |
|---|---|---|---|
| B | Hardener Composition | total | %, vol |
| 1B | Amine-modified | 12.80% | 73.48% |
| | Phenalkamine (proprietary | | |
| | chemical formula) | | |
| 5B | Xylene, aromatic solvent | 1.21% | 8.26% |
| 6B | Methyl acetate | 2.91% | 18.26% |

| | | |
|---|---|---|
| Total: | 16.92% | 100.00% |

| | BC169_URN3-7.2 | | | | |
|---|---|---|---|---|---|
| Batch code: | | %, wt | | | |
| # Part A | Composition | total | %, vol | Select Properties | |
| 1A | Low viscosity epoxy resin | 2.28% | 6.25% | Sphere type | Hollow |
| | (proprietary chemical | | | | ceramic meso- |
| | formula) | | | | spheres |
| 2A | Cycloaliphatic polyglycidyl | 5.32% | 12.84% | Spheres amount, | 42 |
| | ether-modified epoxy resin | | | total formula wt. % | |
| 3A | Polymeric pigment dispersant | 0.23% | 0.67% | Spheres amount, | 56 |
| | (proprietary chemical | | | vol. % | |
| | formula) | | | | |
| 4A | Polymeric graphene | 0.15% | 0.47% | Sphere size, mcm | |
| | dispersant | | | | |
| 6A | Multilayered graphene flakes | 0.05% | 0.07% | Hardener type | H21 |
| 7A | Titanium dioxide | 0.76% | 1.17% | Epoxy/NH ratio | 1.08 |
| 8A | Organo-modified derivative of | 0.76% | 1.37% | Resin amount, total | |
| | the Aluminium phyllosilicate | | | formula wt. % | |
| | clay | | | | |
| 9A | Polyamide wax derivative, | 0.12% | 0.38% | Adhesion promotor | |
| | micronized | | | type | |
| 11A | Hollow ceramic meso- | 41.93% | 55.84% | Adhesion to steel, | 8 |
| | spheres | | | MPa | |
| 12A | Microcrystalline magnesium | 1.07% | 1.17% | Overcoat Adhesion | 7-9 |
| | silicate | | | to Primer, MPa | |
| 13A | Micronized barium sulphate | 1.43% | 1.04% | Recoat adhesion | N/A |
| | | | | @72 hrs, grade | |
| 15A | Glycidoxypropyltrimethoxysilane | 0.24% | 0.70% | Sound dampening, | 4 |
| | | | | dB/4 mil | |
| 16A | C12-14 aliphatic glycidyl | 2.38% | 7.83% | Sagging at 10 mil | Pass |
| | ether | | | | |
| 17A | Benzyl Alcohol | 1.19% | 3.50% | Blistering test (steel) | N/A |
| 19A | Methyl acetate | 0.91% | 3.00% | | |
| 20A | 95% Benzenepropanoic acid | 0.20% | 0.56% | | |
| 21A | Silicone oligomer (proprietary | 0.31% | 1.15% | | |
| | chemical formula) | | | | |

| | | |
|---|---|---|
| Total: | 59.33% | 100.00% |

| | | %, wt | |
|---|---|---|---|
| # Part B | Hardener Composition | total | %, vol |
| 1B | Amine-modified | 12.54% | 73.50% |
| | Phenalkamine (proprietary | | |
| | chemical formula) | | |
| 5B | Xylene, aromatic solvent | 1.19% | 8.25% |
| 6B | Methyl acetate | 2.85% | 18.25% |

| | | |
|---|---|---|
| Total: | 16.57% | 100.00% |

### Example 3—Compositions for Coating—Increased Adhesion and/or Hardness Properties (Also Referred to Below as PROP Formulas/Formulations/Compositions and PROP Coatings)

Materials Used in PROP Compositions for a Coating, Made and/or

### Tested

### Also See Example 1, Materials.

| | | Exemplary |
|---|---|---|
| | | Analogous |
| Component or Additive/function | Trade name | compounds |
| Microcrystalline magnesium silicate/barrier anti- | Talc Silverline 202 | Mistron 002 (Imerys) |
| corrosive platy filler, anti-corrosive and abrasive | (Imerys) | |
| resistance properties, thickener | | |
| Hollow ceramic meso-spheres/sound deadening | Zeeospheres G 600 | W210, W410, or |
| performance, scratch resistance, barrier anti-corrosive | (Zeospheres Ceramics | W610 Ceramic |
| properties | LLC) | Spheres (3M) |
| Hollow ceramic micro-spheres/sound deadening | Zeeospheres G-200 | W210 Ceramic |
| performance, scratch resistance, barrier anti-corrosive | (Zeospheres Ceramics | Spheres (3M) |
| properties | LLC) | |
| Hollow glass meso-spheres/sound deadening | SPHERICAL 110P8 | S35 Glass bubbles |
| performance, scratch resistance, barrier anti-corrosive | (Potters) | (3M) |
| properties | | |
| Hollow glass micro-spheres/sound deadening | SPHERICAL 34P30 | S35 Glass bubbles |
| performance, scratch resistance, barrier anti-corrosive | (Potters) | (3M) |
| properties | | |
| 2,4,6-Tris [(dimethylamino)methyl]phenol/curing | Docure KH-76K (Kukdo | |
| catalyst, speeds up the curing of epoxy-resins | Hardener) | |
| Xylene, aromatic solvent/flow, | Xylene | Cyclohexane, |
| sprayabilityproperties. | | toluene |
| Methyl acetate/flow, sprayabilityproperties, VOC- | Methyl Acetate | Tert-butyl acetate |
| exhempt vehicle. | | |
| Benzyl Alcohol/non-reactive diluent, non-volatile, | Benzyl Alcohol | |
| flow, sprayability, co-catalyst for hardener. | | |
| Silicone oligomer (proprietary chemical formula)/ | BYK-066 N (BYK) | BYK-1790 (BYK) |
| defoamer, | | |
| Polymeric non-ionic dispersing additive/ | ADDITOL VXW 6208 | |
| dispersing additive for organic and inorganic pigment | (Allnex) | |
| Silicone modified defoamer (proprietary chemical | ADDITOL VXW 6210 N | |
| formula)/defoamer | | |
| Fumed silica-modified organo-modified | TEGO Airex 900 | |
| polysiloxane/Deaerator concentrate against micro- | (Evonik) | |
| and macro-foams | | |
| Butyl glycidyl ether/reactive diluent, non-volatile, | Epodil 741 (Evonik) | EPODIL ® LV5 |
| flow, sprayability. | | (Evonik) |
| C12-14 aliphatic glycidyl ether/reactive diluent, | XD-748 (Anhui Xinyuan | |
| non-volatile, flow, sprayability. | Chemical Co., Ltd.) | |
| Organo-modified derivative of the Aluminium | CLAYTONE-HY (BYK) | CLAYTONE-APA |
| phyllosilicate clay/rheology modifier, anti-settling | | (BYK) |
| additive | | |
| Titanium dioxide/pigment white, wear inhibitive | Ti-Pure R-706 (Du-Pont) | CR-828 (Tronox) |
| pigment, ceramic performance additive | | |
| Calcium inosilicate mineral/Barrier properties and | NYCO Wollastonite | |
| anti-corrosive performance | | |
| Polymeric pigment dispersant (proprietary | ADDITOL VXW 6208 | Multiwet-EF (Croda) |
| chemical formula)/dispersant, homogeneous | (Allnex) | |
| dispersion of pigments, fillers and spherical particles | | |
| Polymeric graphene dispersant/homogeneous | K-Sperse A504 | |
| dispersion of graphene pigments | | |
| Low viscosity epoxy resin (proprietary chemical | DLVE - 18 Epoxy Resin | D.E.R. 353 (Palmer |
| formula)/polymeric matrix | (Olin Resins) | Holland) |
| Cycloaliphatic polyglycidyl ether-modified epoxy | DLVE - 52 Epoxy Resin | D.E.R. 353 (Palmer |
| resin/polymeric matrix | (Olin Resins) | Holland) |
| Bisphenol A epoxy resin/high viscosity, film forming | YD-128 (Kukdo | |
| epoxy resin | Chemicals Ltd.) | |
| Hybrid epoxy-polysiloxane resin/low surface | Silikopon EF or | Eposil 5550 (Hexion) |
| friction resin for anti-fouling and cavitation resistant | Silikopon ED (Evonik) | |
| performance | | |
| Glycidoxypropyl trimethoxysilane/adhesion | Andisil 187 (AB | Silquest* A-1170 |
| promotor, | Chemicals) | (Momentive) |
| Modified polyester-based adhesion promotor/ | Tego Addbond HS MPA | Tego Addbond LTW- |
| adhesion and flexibility promotor for Cu and steel | (Evonik) | B (Evonik), Tego |
| | | Addbond 2220 ND |
| | | (Evonik |
| Amine-modified Phenalkamine (proprietary | Ancamine 2811 (Evonik) | |
| chemical formula)/hardener, polymer matrix, | | |
| mechanical integrity of the coating | | |
| Phenalkamine (proprietary chemical formula)/ | Cardolite NX-5444 | DOCURE KMH-100 |
| hardener, polymer matrix, mechanical integrity of the | (Cardolite) | PHENALKAMINE |
| coating | | HARDENER |
| | | (KUKDO |
| | | CHEMECAL) |
| Triamino-functional propyltrimethoxysilane | Dynasylan TRIAMO | |
| (proprietary chemical formula)/Cross-linking agent | (Evonik) | |
| for hybrid epoxy resin, adhesion promotion, hardener | | |
| Modified poly-amidoamine (proprietary chemical | Ancamide 2832 (Evonik) | ANCAMIDE ® 2137 |
| formula)/hardener, polymer matrix, mechanical | | (Evonik) |
| integrity of the coating | | |
| Formulated Polyamidoamide adduct/High humidity | Ancamide 3201 (Evonik) | |
| hardener for sub-zero curing and heavy duty high | | |
| performance applications | | |
| Silicone-epoxy hybrid resin/anti-fouling polymer | SILIKOPON EF | SILIKOPON ED |
| matrix, flexibility additive | | (EVONIK) and Eposil |
| | | 5550 |
| Castor oil derivative (proprietary chemical | Thixatrol ST (Elementis) | Thixatrol PM 8056 or |
| formula)/Anti-sagging additive, thixotropic flow | | Thixatrol GST |
| additive, anti-settling effect, high-solids paint stability | | (Elementis); S15 - |
| | | Crayvallac Super |
| | | (Palmer Holland) |
| Polyether siloxane copolymer (proprietary | TEGO Glide 410 | |
| formula)/slip and anti-crater properties. | (Evonik) | |
| 95% Benzenepropanoic acid, 3-(2H-benzotriazol-2- | Tinuvin 99-2 (BASF) | Tinuvin 900 (BASF) |
| yl)-5-(1,1-dimethylethyl)- | | |
| 4-hydroxy-, C7-9-branched and linear alkyl esters, | | |
| 5% 1-methoxy-2-propyl acetate/UV absorbent, | | |
| long-term chemical stability of the coating, weather- | | |
| resistance | | |
| Activated (fused) aluminium (III) oxide/wear- | AP-22 (Evonik) | |
| resistant armouring additive, cavitation resistance aid | | |
| Brown aluminium (III) oxide, micronized/wear- | (Panadyne) | |
| resistant armouring additive, cavitation resistance aid | | |
| Epoxy-functional PDMS-based oligomer/self- | BYK Silclean 3701 | |
| cleaning anti-fouling effect, hydrophobic profile of the | | |
| propeller application | | |
| Fumed SiO₂/Abrasive resistance, anti-settling | Cab-O-Sil 610 Fumed | |
| properties, mechanical toughness | silica | |
| Polyamide wax derivative, micronized/Thixatrope, | Crayvallac Super | S21 - Thixatrol ST |
| rheology modifying additive/ aids the shear thinning | (Palmer Holland) | (Elementis) |
| behaviour, provides good high-build properties (for | | |
| when paint is sprayed in especially thick wet layers) | | |
| Multilayered graphene flakes/Abrasion resistant | | |
| nano-pigment, barrier (anti-corrosive properties) | | |
| Graphite/barrier properties and UV-resistance | | |
| Aminopropyl triethoxysilane/Silamine hardener | Andisil 1100 Silane (AB | Dynasylan AMEO |
| | Chemicals) | (Evonik) |
| Micronized barium sulphate/sound deadening | VB Techno | |
| performance, anti-corrosive performance, low oil- | | |
| absorption filler (low viscosity system), rheology | | |
| modifier | | |
| Zinc calcium strontium aluminium orthophosphate | Heucophos ZCP Plus | |
| silicate hydrate/Anti-corrosive pigment, adhesion | (HEUBACH) | |
| promotor | | |
| Strontium Phosphosilicate/Anti-corrosive pigment, | Halox SW111 (Halox) | |
| adhesion promotor | | |
| Titanium carbonitride/abrasion and wear off | Advanced Engineering | |
| resistant aid | Materials Limited (AEM) | |
| Titanium carbide/abrasion and wear off resistant aid | | |
| Fluorohydroxylalkylated dimethyl siloxane | Silmer ®OHF B10 | |
| oligomer/Wet friction coefficient enhancer | (Siltech) | |
| Hydroxyalkyl-modified polydimethylsiloxane | Silmer OHT Di-50 | |
| oligomer/Wet friction coefficient enhancer | (Siltech) | |
| Quaternary ammonium-modified dimethyl siloxane | Silquat 3180 (Siltech) | |
| oligomer/Beading additive, amphiphilic additive | | |

Test Methods Used for PROP Compositions for a Coating, Made and/or Tested

### Hardness, Adhesion, Bending Test Methods

Hardness after 1 Week of Drying, by Pencil Hardness (ASTM D3363).

A pencil hardness test is a method used in the paints or coatings industry to assess abrasion resistance and hardness of dried coatings. The test uses graphite rods as a scratching tool, at different hardness', varying from soft pencils (from 8B to B, B being the softest) to hard pencils (H to 8H, 8H being the hardest). Application of the pencil is performed according to the standard ASTM D3363; the pencil hardness that causes mechanical damage to the tested coating (e.g., such as deep scratches or grooves with paint shredding) defines the hardness threshold of the tested coating. 5H or above was generally considered a pass for the PROP coatings. Through the comparison between the pencil hardness and the cavitation resistance test results, it was considered that PROP coatings with a hardness below 4H may experience premature failure during their lifetime.

Coating's adhesion (ASTM D4541, ASTM D3359). Test ASTM D4541 was used to assess adhesion to substrate (e.g., adhesion to steel) or overcoat adhesion (e.g., adhesion to primer coating), per practices in the paints or coating industry. A PROP composition was applied onto the sand-basted steel, then cured at room temperature for 14 days, following which a pull-off adhesion strength was measured according to ASTM D4541. Generally, an adhesion value of less than 3 MPa was considered a relative low adhesion value; an adhesion value of about 3-4 MPa was considered a relatively low to moderate adhesion value, and an adhesion value of about 5-7 MPa or higher were considered be a relatively high adhesion value that may be indicative of a coating that may last through a lifetime of 5-10 years of sea/water fairing.

In one version of this testing procedure, a PROP composition was applied onto sand-basted steel, or Cu, or Cu-alloy substrate, then cured in a dry environment (humidity less than 80%, at ambient temperature and atmospheric pressure) for 14 days after spray-coating and without any submersion of the resultant PROP coating in an aqueous environment. Results of this test are referred to herein as “Dry adhesion”. Dry adhesions at or higher than about 3 MPa, such as between about 3-5 MPa were observed to lead to reliable performance long term (e.g., a 3-12 months horizon). Dry adhesions less than 3, such as about 1-2 MPa, were observed to fail in water, in some instances quite quickly.

In another version of this testing procedure, a PROP composition was applied onto sand-basted steel, or Cu, or Cu-alloy substrate, then cured in a dry environment (humidity less than 80%, at ambient temperature and atmospheric pressure) for 14 days after spray-coating, which was followed by a certain period of time spent in an aqueous environment (saline or DI water). Results of this test are referred to herein as “Wet adhesion”, where the period of time throughout which the coating was submerged in the wet environment is referenced. Wet adhesions higher than about 4 MPa, such as between about 5-7 MPa were observed to lead to reliable performance long term (e.g., a 3-12 months horizon). Wet adhesions less than 3, such as about 1-2 MPa, were observed to fail in water, in some instances quite quickly (days or weeks following application).

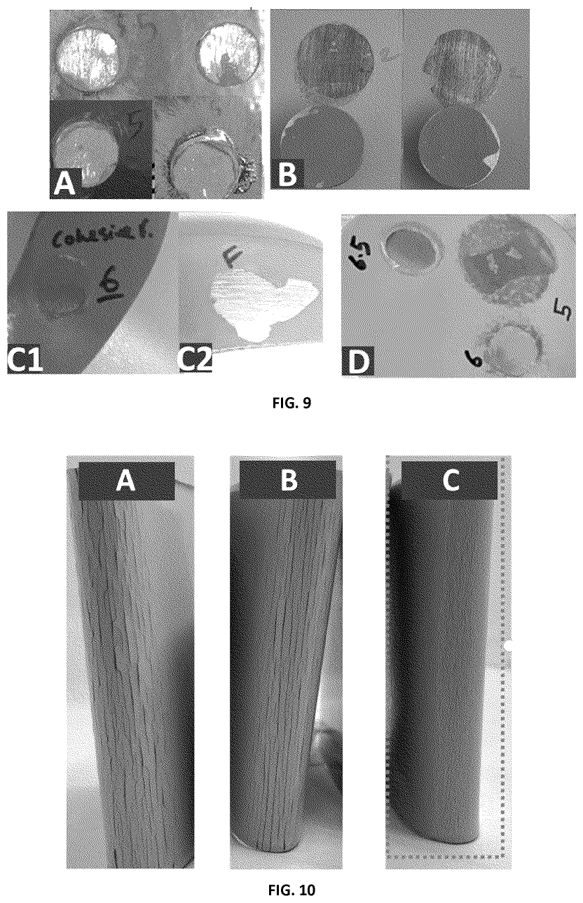

For example, see FIG. 9 depicting Cu adhesion test results for PROP Formulas (A) 230.14 on a primer (dry adhesion); (B) 184 w/o primer (dry adhesion of 2 MPa); (C1) 230.14 on a primer (wet adhesion); (C2) 230.14 w/o primer (wet adhesion); (D) 243.1 w/o primer (wet adhesion).

Mandrel bending test (ASTM D522). Bending tests evaluates flexibility of a cured coating, which can be indicative of a coating's ability to withstand cavitation-induced stresses and/or sustain damage from physical impacts throughout the coating's lifetime. The Mandrel bending test of ASTM D522 uses thin cold rolled steel plates (about 1/16″) of about 4×3″ in dimensions as model substrates. Plates coated with a PROP coating at a dry film thickness of about 125 micron (e.g., which corresponded to a thickness for a select end use), was dried for 7 days to average typical refloating times (e.g., period within which the painted/repaired vessels are brought back into the waters), and were bent manually over a cylindrical 10 mm or 8 mm or 6 mm diameter steel rod. As a result: a) either the coating damage and/or rupture of the coating, where the pieces of the coating delaminated from the substrate, which was considered a “Fail”; or b) the coating remained substantially un-rendered after bending, without showing substantive signs of mechanical damage or delamination from the substrate, which was considered to be a “Pass”.

For example, see FIG. 10, which depicts bending strength test results of PROP Formulas (A) 184.Base; (B) 210.5; (C) 210.6.

### Curing, Blistering, and Permeability Tests Methods

Drying/curing degree at 24 hrs post-coating. In one or more examples, a PROP composition as described herein is a fast-curing composition capable of hard curing and drying within a 4-hour period post-spraying. Chemically cured coatings generally need to be able to withstand repetitive abrasive treatment and cleaning with organic solvents, such as methyl-ethyl ketone (MEK)—which is used in the standardized test ASTM D1640. In this test, a cotton rag soaked in MEK is applied to a hardened and dried coating and repetitively rubbed against the coating, with the number of rubs required to penetrate the coating layer recorded to quantify the curing speed. Coatings that pass the 50 MEK double-rub mark are considered to have passed the requirement for a fast-drying, fast-curing coating. Coatings that fail this test at rates of 20-30 MEK rubs are considered slow curing and may not comply under the requirements adopted by the industry.

Blistering of a PROP coating (otherwise referred to as blistering test or boiling test). In one or more examples, a PROP composition as described herein may be coated onto either a bare substrate (e.g., bare steel) or primed substrates (e.g., coated in a primer coating), and undergo from 3 to 5 years of continuous use in the immersed underwater marine environment. In order to investigate whether a PROP coating may undergo delamination and/or failure due to permeation with water and electrolytes over its lifespan, a boiling test was implemented. An accelerated test that can be used to predict the coating's tendency for delamination or failure is to subject the air-dried coating to boiling water and to record any damages or change of the appearance induced by the boiling water. This test relies on the enhanced diffusion coefficient of water at boiling temperatures, and accelerates detrimental effects of aqueous environments on the tested coating. A coating that develops blisters and/or delaminates after 24-48 hours of continuous boiling is generally considered a failed product, and this correlates well with in-field performance of painted coating on a submerged ship hull. A coating that lasts for more than 7 days without significant blistering or other defect is considered a “Pass”. PROP coatings were tested while coated onto both bare steel and primed steel. Any type of adhesion primer as described herein or as known in the art can be used as a priming layer for this test, and the primer should be air dried for 4 or 24 hours prior to overcoating with the PROP coating.

For example, see FIG. 8, which depicts blistering and permeability test results for Formulas (A) BC169_URN3-3.2 on a primer coating; (B) BC169_URN3-3.2 on bare steel; (C) 242 on a primer; (D) 242 on bare steel. PROP Formula 242 was sprayed at a thickness of 16-18 mils DFT (400-450 micron).

### Cavitation Tests Methods

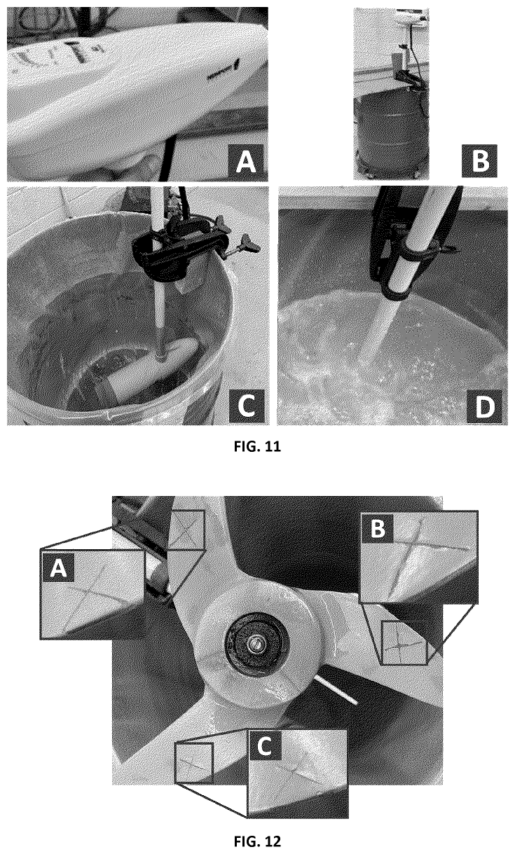

Cavitation resistance (PROP). In one or more examples, PROP compositions as described herein may be useful for protecting screws, propellers, and/or rudders of boats, ships, or marine vessels from corrosion, biofouling, erosion and noise generation while in a working state. Erosion of a propeller and a propeller's protective coatings tends to cause development of micro-cavities, pinholes, slits, and cracks on the outer finish of the coatings, which can result in cavitation (e.g., formation of vapor bubbles within a liquid at low-pressure regions that occur in places where the liquid has been accelerated to high velocities) of the water during high shear contact with the propeller. To test PROP coating for cavitation resistance, a Propeller coating was painted onto a steel panel, air dried for 48 hours to imitate the typical coating conditions at a wharf site, and subjected to boiling in deionized water for 8 hours, which was followed by a visual and microscopic phenomenological inspection of the tested coating. A “Pass” was given to PROP coatings that did not display any visible change of the coating's morphology and did not develop any defects. Otherwise, the coating was rated as “Failed”. In another version of the cavitation test, a PROP coating was painted directly onto a mechanically pretreated Cu-propeller (3-sectioned, 16″ in diameter). The propeller was then mounted onto a trolling motor head and was run at 3000 rpm for not less than 2,000 hours in ocean water (see FIG. 11). This was followed by a visual and microscopic phenomenological inspection of the tested finish (see. FIG. 12). A “Pass” was given to PROP coatings that did not display any visible change of the coating's morphology and did not develop any defects. Otherwise, the coating was rated as “Failed”.

### General Technological Steps for Mixing and Preparing a PROP Composition, Including Part a (Composition for a Coating) & Part B (Composition for a Coating Further Comprising a Hardener Composition).

A typical method of preparing a PROP composition is listed in a sequence of steps below:

Formula 243.1

| Component # | Composition | %, wt total | %, vol |
|---|---|---|---|
| 1A | Hybrid epoxy-polysiloxane resin | 27.94% | 37.29% |
| 2A | Fumed silica-modified organo-modified | 0.35% | 0.64% |
| | polysiloxane | | |
| 3A | Glycidoxypropyl trimethoxysilane | 0.71% | 1.15% |
| 4A | 95% Benzenepropanoic acid, 3-(2H-benzotriazol- | 0.59% | 0.96% |
| | 2-yl)-5-(1,1-dimethylethyl)- | | |
| | 4-hydroxy-, C7-9-branched and linear alkyl | | |
| | esters, 5% 1-methoxy-2-propyl acetate | | |
| 5A | Polyether siloxane copolymer (proprietary | 0.31% | 0.54% |
| | formula) | | |
| 6A | Polymeric graphene dispersant | 0.23% | 0.40% |

Mixing of the resin and additive mix, 10 mins, 1000 rpm, r.t.

| | | | |
|---|---|---|---|
| 7A | Multilayered graphene flakes | 0.47% | 0.38% |
| 8A | Graphite | 0.58% | 0.47% |
| 9A | Titanium dioxide | 9.04% | 3.83% |
| 10A | Brown aluminium (III) oxide, micronized | 9.04% | 3.97% |
| 11A | Fumed SiO2 | 0.71% | 0.55% |
| 12A | Activated (fused) aluminium (III) oxide | 9.61% | 4.37% |

Grind the pigments and fillers into the resin mix, 30 mins, 2500 rpm, r.t.
Note: Reach 50 C.

| | | | |
|---|---|---|---|
| 13A | Castor oil derivative | 0.38% | 0.65% |
| 14A | Modified polyester-based adhesion promotor | 2.79% | 4.57% |

Grind the pigments and fillers into the resin mix, 10 mins, 1700 rpm, r.t.
Note: Reach 60 C.

| | | | |
|---|---|---|---|
| 15A | Epoxy-functional PDMS-based oligomer | 1.24% | 2.17% |
| 16A | Zinc calcium strontium aluminium | 4.34% | 2.16% |
| | orthophosphate silicate hydrate | | |
| 17A | Hybrid epoxy-polysiloxane resin | 10.0% | 20.0% |

Grind the fillers into the grind base and resin mix, 10 mins, 1400 rpm, r.t.

| | | | |
|---|---|---|---|
| 18A | Methyl acetate | 8.55% | 15.92% |

Admixing of the solvent, 10 mins, 800 rpm, r.t.
Note: Add when cooled off to 20-25 C.

| | | |
|---|---|---|
| Total: | 86.89% | 100.00% |

| # Part B | Hardener Composition | %, wt total | %, vol |
|---|---|---|---|
| 1B | Triamino-functional propyltrimethoxysilane | 5.84% | 38.65% |
| 2B | 2,4,6-Tris [(dimethylamino) methyl]phenol | 0.53% | 3.71% |

Mixing of the resin and additive mix, 10 mins, 1000 rpm, r.t.

| | | | |
|---|---|---|---|
| 3B | Methyl Ethyl Ketone | 6.74% | 57.64% |

Letdown, 10 mins, 1000 rpm, r.t.
Note: Add when cooled off to 20-25 C.

| | | |
|---|---|---|
| Total: | 13.11% | 100.00% |

### Hardness Studies

Types. PROP compositions were prepared, and coatings tested, containing different ceramic performance additives including hollow ceramic micro-spheres, and non-hollow ceramic particles, present in amounts of about 10-30% wt based on total formula weight. PROP formula 164 (shown below) was prepared containing titanium dioxide as the performance additive, and PROP formula 184_PROP_3.2 was prepared containing hollow ceramic micro-spheres as the performance additive (shown below). Coating from Formula 164 was found to have a pencil hardness at the level of about 4-5H, while Coating from Formula 184_PROP_3.2 had hardness of 7-8H. PROP Formula 230.14 was prepared containing micronized brown and fused alumina at 20-30% wt as the performance additives. Coating formed from Formula 230.14 was found to have a hardness of 8H+ Two variations of Formula 230.14 where prepared where fused alumina was substituted with titanium carbide (Formula 230.12, shown below) or titanium carbonitride (Formula 230.15, shown below) non-hollow micro-ceramics. Coatings formed from Formulas 230.14 and 230.15 were found to have a hardness of 6H, despite the Ti-based additives each having intrinsic Moh's hardness of about 9. This suggested that not every performance additive having Moh's hardness of 9 or more may not result in a PROP coating hardness of 8H and more. It also suggested that other non-hollow ceramics, such as alumina, could contribute to a PROP coating's hardness in a more efficient way. PROP Formula 184_PROP_3.2 was prepared containing about 12% wt of hollow ceramic micro-spheres (sphere size 12 micron). Formula 184_PROP_8 (shown below) was prepared containing about 12% wt of hollow ceramic meso-spheres (sphere size 35 micron). It was found that both Formulae formed coatings having a pencil hardness of 7-8H. This suggested that the size of the hollow ceramic micro-spheres and meso-spheres did not hinder their ability to contribute to the hardness of a PROP coating.

Formula 164

| | |
|---|---|
| Batch code: | %, wt |

| | | | | |
|---|---|---|---|---|
| # Part A | Composition | total | %, vol | Select Properties |

| | | | | | |
|---|---|---|---|---|---|
| 1A | Hybrid epoxy-polysiloxane resin | 54% | 70.5% | Type of | Titanium dioxide |
| | | | | Performance | |
| | | | | Additive | |
| 2A | Titanium dioxide | 22.63% | 16.63% | Particle size | 0.5 micron |
| 3A | Fumed silica-modified organo- | 1.01% | 0.74% | Amount of the | 25 |
| | modified polysiloxane | | | additive, wt % | |
| | | | | total formula | |
| | | | | weight | |
| 4A | Polyether siloxane copolymer | 0.50% | 0.77% | Type of hardener | Aminopropyl |
| | | | | | triethoxysilane |
| 5A | 95% Benzenepropanoic acid, 3- | 0.84% | 1.15% | Pencil hardness | 4-5H |
| | (2H-benzotriazol-2-yl)-5-(1,1- | | | | |
| | dimethylethyl)- | | | | |
| | 4-hydroxy-, C7-9-branched and | | | | |
| | linear alkyl esters, 5% 1- | | | | |
| | methoxy-2-propyl acetate | | | | |
| 6A | Microcrystalline magnesium | 1.76% | 0.92% | Primer used | none |
| | silicat | | | (yes/no) | |
| 7A | Methyl acetate | 4.19% | 6.60% | Adhesion to Cu | 1 |
| | | | | by pull-off, MPa | |
| 9A | Epoxy-functional PDMS-based | 1.76% | 2.61% | Cavitation | Failed |
| | oligomer | | | resistance | |
| | | | | (pass/not pass) | |
| | | | | Tape adhesion to | Fail |
| | | | | Cu | |
| | | | | Wet adhesion to | 0.5-1 |
| | | | | Cu by pull-off, | |
| | | | | MPa | |
| | | | | Bending test | |
| | | | | Fail | |

| | | |
|---|---|---|
| Total: | 86.68% | 100.00% |

| | | %, wt | |
|---|---|---|---|
| # Part B | Hardener Composition | total | %, vol |
| 1B | Aminopropyl triethoxysilane | 13.32% | 100.00% |

| | | |
|---|---|---|
| Total: | 13.32% | 100.00% |

| | Formula 230.14 | | | | |
|---|---|---|---|---|---|
| Batch code: | | %, wt | | | |
| # Part A | Composition | total | %, vol | Select Properties | |
| 1A | Hybrid epoxy-polysiloxane | 36.48% | 58.81% | Type of | Titanium dioxide/ |
| | resin | | | performance | Brown aluminium |
| | | | | additive | (III) oxide/ |
| | | | | | Activated (fused) |
| | | | | | aluminium (III) |
| | | | | | oxide |
| 2A | Fumed silica-modified organo- | 0.34% | 0.66% | Particle size | 0.5/3-5/1-2, |
| | modified polysiloxane | | | | resp. |
| 3A | Glycidoxypropyl | 0.68% | 1.18% | Amount of the | 8.7/8.7/9.2, |
| | trimethoxysilane | | | additive, wt % | resp. |
| | | | | total formula | |
| | | | | weight | |
| 4A | 95% Benzenepropanoic acid, | 0.57% | 0.98% | Type of | Triamino- |
| | 3-(2H-benzotriazol-2-yl)-5-(1, | | | hardener | functional |
| | 1-dimethylethyl)- | | | | propyltri- |
| | 4-hydroxy-, C7-9-branched | | | | methoxy- |
| | and linear alkyl esters, 5% 1- | | | | silane |
| | methoxy-2-propyl acetate | | | | |
| 5A | Polyether siloxane copolymer | 0.30% | 0.55% | Pencil hardness | 8H+ |
| 6A | Multilayered graphene flakes | 0.45% | 0.39% | Primer used | Was tested w. |
| | | | | (yes/no) | and w/o primer |
| 7A | Graphite | 0.56% | 0.48% | Adhesion to Cu | 2-3 |
| | | | | by pull-off, Mpa | |
| 8A | Titanium dioxide | 8.69% | 3.93% | Cavitation | Pass |
| | | | | resistance | |
| | | | | (pass/not pass) | |
| 9A | Brown aluminium (III) oxide, | 8.69% | 4.08% | Tape adhesion | Pass |
| | micronized | | | | |
| | | | | Wet adhesion to | 0.5-1 |
| | | | | Cu by pull-off, | |
| | | | | MPa | |
| | | | | Bending test | Pass |
| 10A | Fumed SiO₂ | 0.68% | 0.56% | | |
| 11A | Castor oil derivative | 0.37% | 0.67% | | |
| 12A | Modified polyester-based | 2.68% | 4.65% | | |
| | adhesion promotor | | | | |
| 15A | Epoxy-functional PDMS-based | 1.19% | 2.23% | | |
| | oligomer | | | | |
| 17A | Activated (fused) aluminium | 9.24% | 4.48% | | |
| | (III) oxide | | | | |
| 18A | Methyl acetate | 8.22% | 16.34% | | |

| | | |
|---|---|---|
| Total: | 79.13% | 100.00% |

| | | %, wt | |
|---|---|---|---|
| # Part B | Hardener Composition | total | %, vol |
| 1B | Triamino-functional | 5.62% | 40.00% |
| | propyltrimethoxysilane | | |
| 2B | 2,4,6-Tris[(dimethylamino) | 0.51% | 3.84% |
| | methyl]phenol | | |
| 6B | Methyl Ethyl Ketone | 6.10% | 56.16% |

| | | |
|---|---|---|
| Total: | 12.23% | 100.00% |

| | Formula 230.12 | | | | |
|---|---|---|---|---|---|
| Batch code: | | %, wt | | | |
| # Part A | Composition | total | %, vol | Select Properties | |
| 1A | Hybrid epoxy-polysiloxane resin | 43.84% | 74.28% | Type of | Titanium dioxide/ |
| | | | | performance | Brown aluminium |
| | | | | additive | (III) oxide/ |
| | | | | | Titanium carbide |
| 2A | Fumed silica-modified organo- | 0.41% | 0.83% | Particle size | 0.5/3-5/1-2, |
| | modified polysiloxane | | | | resp. |
| 3A | Glycidoxypropyl trimethoxysilane | 0.82% | 1.49% | Amount of | 10/10/11, |
| | | | | the additive, | resp. |
| | | | | wt % total | |
| | | | | formula | |
| | | | | weight | |
| 4A | 95% Benzenepropanoic acid, 3- | 0.68% | 1.24% | Type of | Triamino- |
| | (2H-benzotriazol-2-yl)-5-(1,1- | | | hardener | functional |
| | dimethylethyl)- | | | | propyltri-methoxy |
| | 4-hydroxy-, C7-9-branched and | | | | silane |
| | linear alkyl esters, 5% 1-methoxy- | | | | |
| | 2-propyl acetate | | | | |
| 5A | Polyether siloxane copolymer | 0.36% | 0.70% | Pencil | 6H |
| | (proprietary formula) | | | hardness | |
| 6A | Multilayered graphene flakes | 0.55% | 0.49% | Primer used | none |
| | | | | (yes/no) | |
| 7A | Graphite | 0.67% | 0.61% | Adhesion to | 1-3 |
| | | | | Cu by pull-off, | |
| | | | | Mpa | |
| 8A | Titanium dioxide | 10.44% | 4.96% | Cavitation | Pass |
| | | | | resistance | |
| | | | | (pass/not | |
| | | | | pass) | |
| 9A | Brown aluminium (III) oxide, | 10.44% | 5.15% | Tape | Pass |
| | micronized | | | adhesion | |
| 10A | Fumed SiO₂ | 0.82% | 0.71% | Bending test | Pass |
| 11A | Castor oil derivative | 0.44% | 0.84% | | |
| 12A | Modified polyester-based adhesion | 3.21% | 5.88% | | |
| | promotor | | | | |
| 15A | Epoxy-functional PDMS-based | 1.43% | 2.81% | | |
| | oligomer | | | | |
| 17A | Titanium carbide | 11.11% | 0.00% | | |

| | | |
|---|---|---|
| Total: | 85.23% | 100.00% |

| | | %, wt | |
|---|---|---|---|
| # Part B | Hardener Composition | total | %, vol |
| 1B | Triamino-functional | 6.75% | 39.75% |
| | propyltrimethoxysilane | | |
| 2B | 2,4,6-Tris[(dimethylamino) | 0.61% | 3.81% |
| | methyl]phenol | | |
| 6B | Methyl Ethyl Ketone | 7.41% | 56.43% |

| | | |
|---|---|---|
| Total: | 14.77% | 100.00% |

| | Formula 230.15 | | | | |
|---|---|---|---|---|---|
| Batch code: | | %, wt | | | |
| # Part A | Composition | total | %, vol | Select Properties | |
| 1A | Hybrid epoxy-polysiloxane resin | 43.84% | 71.25% | Type of | Titanium dioxide/ |
| | | | | performance | Brown aluminium |
| | | | | additive | (III) oxide/ |
| | | | | | Titanium |
| | | | | | carbonitride |
| 2A | Fumed silica-modified organo- | 0.41% | 0.79% | Particle size | 0.5/3-5/1-2, |
| | modified polysiloxane | | | | resp |
| 3A | Glycidoxypropyl trimethoxysilane | 0.82% | 1.43% | Amount of | 10/10/11, |
| | | | | additive, | resp. |
| | | | | wt % total | |
| | | | | formula | |
| | | | | weight | |
| 4A | 95% Benzenepropanoic acid, 3- | 0.68% | 1.19% | Type of | Triamino- |
| | (2H-benzotriazol-2-yl)-5-(1,1- | | | hardener | functional |
| | dimethylethyl)- | | | | propyltrimethoxy |
| | 4-hydroxy-, C7-9-branched and | | | | silane |
| | linear alkyl esters, 5% 1-methoxy- | | | | |
| | 2-propyl acetate | | | | |
| 5A | Polyether siloxane copolymer | 0.36% | 0.67% | Pencil | 6H |
| | (proprietary formula) | | | hardness | |
| 6A | Multilayered graphene flakes | 0.55% | 0.47% | Primer used | none |
| | | | | (yes/no) | |
| 7A | Graphite | 0.67% | 0.59% | Adhesion to | 1-3 |
| | | | | Cu by pull- | |
| | | | | off, MPa | |
| 8A | Titanium dioxide | 10.44% | 4.76% | Cavitation | Pass |
| | | | | resistance | |
| | | | | (pass/not | |
| | | | | pass) | |
| 9A | Brown aluminium (III) oxide, | 10.44% | 4.94% | Tape | Pass |
| | micronized | | | adhesion | |
| 10A | Fumed SiO₂ | 0.82% | 0.68% | Bending test | Fail |
| 11A | Castor oil derivative | 0.44% | 0.81% | | |
| 12A | Modified polyester-based adhesion | 3.21% | 5.63% | | |
| | promotor | | | | |
| 15A | Epoxy-functional PDMS-based | 1.43% | 2.70% | | |
| | oligomer | | | | |
| 17A | Titanium carbonitride | 11.11% | 4.09% | | |

| | | |
|---|---|---|
| Total: | 85.23% | 100.00% |

| | | %, wt | |
|---|---|---|---|
| # Part B | Hardener Composition | total | %, vol |
| 1B | Triamino-functional | 6.75% | 39.85% |
| | propyltrimethoxysilane | | |
| 3B | 2,4,6-Tris[(dimethylamino) | 0.61% | 3.59% |
| | methyl]phenol | | |
| 6B | Methyl Ethyl Ketone | 7.41% | 56.56% |

| | | |
|---|---|---|
| Total: | 14.77% | 100.00% |

| | Formula 184_PROP_3.2 | | | | |
|---|---|---|---|---|---|
| Batch code: | | %, wt | | | |
| # Part A | Composition | total | %, vol | Select Properties | |
| 1A | Hybrid epoxy-polysiloxane | 38.3% | 62.44% | Type of | Hollow ceramic |
| | resin | | | performance | micro-spheres/ |
| | | | | additive | Titanium dioxide |
| 2A | Castor oil derivative | 0.38% | 0.68% | Particle size | 12/0.5, |
| | | | | | resp. |
| 4A | Titanium dioxide | 16.06% | 7.02% | Amount of | 12/16, |
| | | | | additive, wt % | resp. |
| | | | | total formula | |
| | | | | weight | |
| 5A | Fumed SiO₂ | 0.71% | 0.57% | Type of | Aminopropyl |
| | | | | hardener | triethoxysilane |
| 6A | Multilayered graphene flakes | 0.20% | 0.17% | Pencil | 7-8H |
| | | | | hardness | |
| 7A | Graphite | 0.51% | 0.42% | Primer used | none |
| | | | | (yes/no) | |
| 9A | Fumed silica-modified | 0.36% | 0.67% | Adhesion to Cu | 1-2 |
| | organo-modified polysiloxane | | | by pull-off, MPa | |
| 10A | Glycidoxypropyl | 0.71% | 1.20% | Cavitation | Pass |
| | trimethoxysilane | | | resistance | |
| | | | | (pass/not pass) | |
| 11A | Microcrystalline magnesium | 1.25% | 0.80% | Tape adhesion | Fail |
| | silicate | | | to Cu | |
| 12A | 95% Benzenepropanoic acid, | 0.59% | 1.00% | Wet adhesion | 0.5-1 |
| | 3-(2H-benzotriazol-2-yl)-5-(1, | | | to Cu by pull- | |
| | 1-dimethylethyl)- | | | off, MPa | |
| | 4-hydroxy-, C7-9-branched | | | | |
| | and linear alkyl esters, 5% 1- | | | | |
| | methoxy-2-propyl acetate | | | | |
| 14A | Methyl acetate | 2.97% | 5.71% | Bending test | Fail |
| 16A | Epoxy-functional PDMS- | 1.25% | 2.26% | | |
| | based oligomer | | | | |
| 17A | Polyether siloxane copolymer | 0.32% | 0.56% | | |
| 20A | Hollow ceramic micro- | 12.09% | 8.67% | | |
| | spheres | | | | |
| 21A | Xylene, aromatic solvent | 3.75% | 7.83% | | |

| | | |
|---|---|---|
| Total: | 79.45% | 100.00% |

| | | %, wt | |
|---|---|---|---|
| # Part B | Hardener Compostion | total | %, vol |
| 1B | Aminopropyl triethoxysilane | 9.78% | 100.00% |

| | | |
|---|---|---|
| Total: | 9.78% | 100.00% |

| | Formula 184_PROP_8 | | | | |
|---|---|---|---|---|---|
| Batch code: | | %, wt | | | |
| # Part A | Composition | total | %, vol | Select Properties | |
| 1A | Hybrid epoxy-polysiloxane resin | 38.3% | 62.44% | Type of | Titanium dioxide/ |
| | | | | performance | Hollow ceramic |
| | | | | additive | meso-spheres |
| 2A | Castor oil derivative | 0.38% | 0.68% | Particle size | 0.5/35 |
| 4A | Titanium dioxide | 16.06% | 7.02% | Amount of | 16/ |
| | | | | additive, wt % | |
| | | | | total formula | |
| | | | | weight | |
| 5A | Fumed SiO₂ | 0.71% | 0.57% | Type of | Aminopropyl |
| | | | | hardener | triethoxy |
| | | | | | silane |
| 6A | Multilayered graphene flakes | 0.20% | 0.17% | Pencil hardness | 7-8H |
| 7A | Graphite | 0.51% | 0.42% | Primer used | none |
| | | | | (yes/no) | |
| 9A | Fumed silica-modified organo- | 0.36% | 0.67% | Adhesion to Cu | 1-2 |
| | modified polysiloxane | | | by pull-off, MPa | |
| 10A | Glycidoxypropyl | 0.71% | 1.20% | Cavitation | Pass |
| | trimethoxysilane | | | resistance | |
| | | | | (pass/not pass) | |
| 11A | Microcrystalline magnesium | 1.25% | 0.80% | Tape adhesion | Fail |
| | silicate | | | | |
| 12A | 95% Benzenepropanoic acid, 3- | 0.59% | 1.00% | Wet adhesion to | 0.5-1 |
| | (2H-benzotriazol-2-yl)-5-(1,1- | | | Cu by pull-off, | |
| | dimethylethyl)- | | | MPa | |
| | 4-hydroxy-, C7-9-branched and | | | | |
| | linear alkyl esters, 5% 1- | | | | |
| | methoxy-2-propyl acetate | | | | |
| 14A | Methyl acetate | 2.97% | 5.71% | Bending test | Pass |
| 16A | Epoxy-functional PDMS-based | 1.25% | 2.26% | | |
| | oligomer | | | | |
| 17A | Polyether siloxane copolymer | 0.32% | 0.56% | | |
| 20A | Hollow ceramic meso-spheres | 12.09% | 8.67% | | |
| 21A | Xylene, aromatic solvent | 3.75% | 7.83% | | |

| | | |
|---|---|---|
| Total: | 79.45% | 100.00% |

| | | %, wt | |
|---|---|---|---|
| # Part B | Hardener Composition | total | %, vol |
| 1B | Aminopropyl triethoxysilane | 9.78% | 100.00% |

| | | |
|---|---|---|
| Total: | 9.78% | 100.00% |

Comparisons. PROP Formula 184.Base was prepared containing titanium dioxide as the performance additive (shown below). PROP Formula 184.4 was prepared containing titanium dioxide as the performance additive without the silane adhesion promotor of Formula 184.Base (see below). PROP Formula 184.5 was prepared containing titanium dioxide as the performance additive without the castor oil derivative rheology additive of Formula 184.Base (see below). Each Formula formed a Coating that had a pencil hardness of about 7-8H. This suggested that the adhesion promotor and rheology modifier was not substantively contributing to, or impacting the hardness of the resultant coatings.

PROP Formulas 243.5 and 243.6 (shown below) were prepared containing a hydroxyalkyl-modified polydimethylsiloxane oligomer (2.55 and 4.83% wt, respectively), a fluorohydroxylalkylated dimethyl siloxane oligomer (1.04 and 1.96% wt, respectively), and a quaternary ammonium-modified dimethyl siloxane oligomer (1.04 and 2.07% wt, respectively). These components were added to promote anti-fouling amphiphilic properties in the resultant coating. These coatings had a hardness of 4H and 2H, respectively. The hardness of these coatings was less than that of the coating formed from PROP formulation 243.1, which suggested that amphiphilic components can impact the hardness of a PROP coating; for example, that the hardness is reversely proportional to the amount of amphiphilic components included.

| | Formula 184.Base | | | | |
|---|---|---|---|---|---|
| Batch code: | | %, wt | | | |
| # Part A | Composition | total | %, vol | Select Properties | |
| 1A | Hybrid epoxy-polysiloxane resin | 49.2% | 72.77% | Type of | Titanium |
| | | | | performance | dioxide |
| | | | | additive | |
| 2A | Castor oil derivative | 0.49% | 0.81% | Particle size, | 0.5 |
| | | | | micron | |
| 4A | Titanium dioxide | 20.63% | 8.41% | Amount of the | 21 |
| | | | | additive, wt % total | |
| | | | | formula weight | |
| 5A | Fumed SiO₂ | 0.92% | 0.68% | Type of hardener | Aminopropyl |
| | | | | | triethyoxy |
| | | | | | silane |
| 6A | Multilayered graphene flakes | 0.26% | 0.20% | Pencil hardness | 7-8H |
| 7A | Graphite | 0.65% | 0.51% | Primer used | None |
| | | | | (yes/no) | |
| 9A | Fumed silica-modified organo- | 0.46% | 0.80% | Adhesion to Cu by | 1-2 |
| | modified polysiloxane | | | pull-off, MPa | |
| 10A | Glycidoxypropyl trimethoxysilane | 0.92% | 1.44% | Cavitation | Fail |
| | | | | resistance | |
| | | | | (pass/not pass) | |
| 11A | Microcrystalline magnesium | 1.60% | 0.96% | Wet Adhesion to | 1 |
| | silicate | | | Cu by pull-off, MPa | |
| 12A | 95% Benzenepropanoic acid, 3- | 0.76% | 1.19% | Bending test | Fail |
| | (2H-benzotriazol-2-yl)-5-(1,1- | | | | |
| | dimethylethyl)- | | | | |
| | 4-hydroxy-, C7-9-branched and | | | | |
| | linear alkyl esters, 5% 1- | | | | |
| | methoxy-2-propyl acetate | | | | |
| 14A | Methyl acetate | 3.82% | 6.84% | | |
| 16A | Epoxy-functional PDMS-based | 1.60% | 2.71% | | |
| | oligomer | | | | |
| 17A | Polyether siloxane copolymer | 0.41% | 0.67% | | |
| | (proprietary formula) | | | | |

| | | |
|---|---|---|
| Total: | 81.72% | 100.00% |

| | | %, wt | |
|---|---|---|---|
| # Part B | Hardener Composition | total | %, vol |
| 1B | Aminopropyl triethoxysilane | 12.56% | 67.42% |
| 5B | Xylene, aromatic solvent | 2.86% | 16.95% |
| 6B | Methyl acetate | 2.86% | 15.63% |

| | | |
|---|---|---|
| Total: | 18.28% | 100.00% |

| | Formula 184.4 | | | | |
|---|---|---|---|---|---|
| Batch code: | | %, wt | | | |
| # Part A | Composition | total | %, vol | Select Properties | |
| 1A | Hybrid epoxy-polysiloxane resin | 49.1% | 71.17% | Type of | Titanium |
| | | | | performance | dioxide |
| | | | | additive | |
| 2A | Castor oil derivative | 0.59% | 0.81% | Particle size, | 0.5 |
| | | | | micron | |
| 4A | Titanium dioxide | 20.53% | 9.41% | Amount of the | 21 |
| | | | | additive, wt % total | |
| | | | | formula weight | |
| 5A | Fumed SiO₂ | 0.92% | 0.68% | Type of hardener | Aminopropyl |
| | | | | | triethoxy |
| | | | | | silane |
| 6A | Multilayered graphene flakes | 0.36% | 0.70% | Pencil hardness | 7-8H |
| 7A | Graphite | 0.65% | 0.51% | Primer used | None |
| | | | | (yes/no) | |
| 9A | Fumed silica-modified organo- | 0.56% | 0.80% | Adhesion to Cu by | 0.5-1 |
| | modified polysiloxane | | | pull-off, MPa | |
| 11A | Microcrystalline magnesium | 1.50% | 0.56% | Cavitation | Fail |
| | silicate | | | resistance | |
| | | | | (pass/not pass) | |
| 12A | 95% Benzenepropanoic acid, 3- | 0.76% | 1.19% | Wet Adhesion to | 1 |
| | (2H-benzotriazol-2-yl)-5-(1,1- | | | Cu by pull-off, MPa | |
| | dimethylethyl)- | | | | |
| | 4-hydroxy-, C7-9-branched and | | | | |
| | linear alkyl esters, 5% 1- | | | | |
| | methoxy-2-propyl acetate | | | | |
| 14A | Methyl acetate | 3.62% | 6.24% | Bending test | Fail |
| 16A | Epoxy-functional PDMS-based | 1.60% | 2.71% | | |
| | oligomer | | | | |
| 17A | Polyether siloxane copolymer | 0.61% | 0.67% | | |
| | (proprietary formula) | | | | |

| | | |
|---|---|---|
| Total: | 81.5% | 100.00% |

| | | %, wt | |
|---|---|---|---|
| # Part B | Hardener Composition | total | %, vol |
| 1B | Aminopropyl triethoxysilane | 12.56% | 67.42% |
| 5B | Xylene, aromatic solvent | 2.86% | 16.95% |
| 6B | Methyl acetate | 2.86% | 15.63% |

| | | |
|---|---|---|
| Total: | 18.28% | 100.00% |

| | Formula 184.5 | | | | |
|---|---|---|---|---|---|
| Batch code: | | %, wt | | | |
| # Part A | Composition | total | %, vol | Select Properties | |
| 1A | Hybrid epoxy-polysiloxane resin | 49.2% | 72.77% | Type of | Titanium |
| | | | | performance | dioxide |
| | | | | additive | |
| 4A | Titanium dioxide | 20.63% | 8.41% | Particle size, | 0.5 |
| | | | | micron | |
| 5A | Fumed SiO₂ | 0.92% | 0.68% | Amount of the | 21 |
| | | | | additive, wt % | |
| | | | | total formula | |
| | | | | weight | |
| 6A | Multilayered graphene flakes | 0.26% | 0.20% | Type of | Aminopropyl |
| | | | | hardener | triethoxy |
| | | | | | silane |
| 7A | Graphite | 0.65% | 0.51% | Pencil hardness | 7-8H |
| 9A | Fumed silica-modified organo- | 0.46% | 0.80% | Primer used | none |
| | modified polysiloxane | | | (yes/no) | |
| 10A | Glycidoxypropyl | 0.92% | 1.44% | Adhesion to Cu | 2 |
| | trimethoxysilane | | | by pull-off, MPa | |
| 11A | Microcrystalline magnesium | 1.60% | 0.96% | Cavitation | Fail |
| | silicate | | | resistance | |
| | | | | (pass/not pass) | |
| 12A | 95% Benzenepropanoic acid, 3- | 0.76% | 1.19% | Wet Adhesion | 1 |
| | (2H-benzotriazol-2-yl)-5-(1,1- | | | to Cu by pull- | |
| | dimethylethyl)- | | | off, MPa | |
| | 4-hydroxy-, C7-9-branched and | | | | |
| | linear alkyl esters, 5% 1- | | | | |
| | methoxy-2-propyl acetate | | | | |
| 14A | Methyl acetate | 3.82% | 6.84% | Bending test | Pass |
| | | | | | (tentatively) |
| 16A | Epoxy-functional PDMS-based | 1.60% | 2.71% | | |
| | oligomer | | | | |
| 17A | Polyether siloxane copolymer | 0.41% | 0.67% | | |
| | (proprietary formula) | | | | |

| | | |
|---|---|---|
| Total: | 81.72% | 100.00% |

| | | %, wt | |
|---|---|---|---|
| # Part B | Hardener Composition | total | %, vol |
| 1B | Aminopropyl triethoxysilane | 12.56% | 67.42% |
| 5B | Xylene, aromatic solvent | 2.86% | 16.95% |
| 6B | Methyl acetate | 2.86% | 15.63% |

| | | |
|---|---|---|
| Total: | 18.28% | 100.00% |

| | Formula 243.5 | | | | |
|---|---|---|---|---|---|
| Batch code: | | %, wt | | | |
| # Part A | Composition | total | %, vol | Select Properties | |
| 1A | Hybrid epoxy-polysiloxane resin | 37.5% | 55.1% | Type of | Titanium Dioxide/ |
| | | | | performance | Activated |
| | | | | additive | (fused) |
| | | | | | aluminium (III) |
| | | | | | oxide |
| 2A | Fumed silica-modified organo- | 0.35% | 0.62% | Particle size, | 0.5/3-5 |
| | modified polysiloxane | | | micron | |
| 3A | Glycidoxypropyl | 0.70% | 1.11% | Amount of the | 9/10 |
| | trimethoxysilane | | | additive, % wt. | |
| | | | | total formula | |
| | | | | weight | |
| 4A | 95% Benzenepropanoic acid, 3- | 0.58% | 0.92% | Type of | Triamino- |
| | (2H-benzotriazol-2-yl)-5-(1,1- | | | hardener | functional |
| | dimethylethyl)- | | | | propyltrimethoxy |
| | 4-hydroxy-, C7-9-branched and | | | | silane |
| | linear alkyl esters, 5% 1- | | | | |
| | methoxy-2-propyl acetate | | | | |
| 5A | Polyether siloxane copolymer | 0.31% | 0.52% | Pencil hardness | 4H |
| | (proprietary formula) | | | | |
| 6A | Multilayered graphene flakes | 0.47% | 0.37% | Primer used | None |
| | | | | (yes/no) | |
| 7A | Graphite | 0.58% | 0.45% | Adhesion to Cu | 1-3 |
| | | | | by pull-off, Mpa | |
| 8A | Titanium Dioxide | 8.93% | 3.69% | Cavitation | Pass |
| | | | | resistance | |
| | | | | (pass/not pass) | |
| 9A | Modified polyester-based | 11.68% | 8.2% | Tape adhesion | Pass |
| | adhesion promotor | | | | |
| 10A | Fumed silica-modified organo- | 0.70% | 0.53% | Wet adhesion | 1-2 |
| | modified polysiloxane | | | to Cu by pull- | |
| | | | | off, MPa | |
| 11A | Castor oil derivative (proprietary | 0.38% | 0.62% | Bending test | Pass |
| | chemical formula) | | | | |
| 15A | Epoxy-functional PDMS-based | 1.22% | 2.09% | | |
| | oligomer | | | | |
| 17A | Activated (fused) aluminium (III) | 9.50% | 4.21% | | |
| | oxide | | | | |
| 18A | Methyl acetate | 8.45% | 15.33% | | |
| 19A | Hydroxyalkyl-modified | 2.55% | 4.41% | | |
| | polydimethylsiloxane oligomer | | | | |
| 20A | Fluorohydroxylalkylated | 1.04% | 1.76% | | |
| | dimethyl siloxane oligomer | | | | |

| | | |
|---|---|---|
| Total: | 84.89% | 100.00% |

| | | %, wt | |
|---|---|---|---|
| # Part B | Hardener Composition | total | %, vol |
| 1B | Triamino-functional | 5.92% | 33.98% |
| | propyltrimethoxysilane | | |
| 2B | 2,4,6-Tris[(dimethylamino) | 0.60% | 3.67% |
| | methyl]phenol | | |
| 5B | Quaternary ammonium- | 1.04% | 6.40% |
| | modified dimethyl siloxane | | |
| | oligomer | | |
| 6B | Methyl Ethyl Ketone | 7.54% | 55.95% |

| | | |
|---|---|---|
| Total: | 15.11% | 100.00% |

| | Formula 243.6 | | | | |
|---|---|---|---|---|---|
| Batch code: | | %, wt | | | |
| # Part A | Composition | total | %, vol | Select Properties | |
| 1A | Hybrid epoxy-polysiloxane resin | 35% | 52% | Type of | Brown aluminium |
| | | | | performance | (III) oxide, |
| | | | | additive | micronized/ |
| | | | | | Activated (fused) |
| | | | | | aluminium (III) |
| | | | | | oxide |
| 2A | Fumed silica-modified organo- | 0.33% | 0.58% | Particle size | 0.5/3-5 |
| | modified polysiloxane | | | | |
| 3A | Glycidoxypropyl trimethoxysilane | 0.65% | 1.04% | Amount of | 8.3/8.8 |
| | | | | the additive, | |
| | | | | % wt. total | |
| | | | | formula | |
| | | | | weight | |
| 4A | 95% Benzenepropanoic acid, 3- | 0.54% | 0.87% | Type of | Triamino- |
| | (2H-benzotriazol-2-yl)-5-(1,1- | | | hardener | functional |
| | dimethylethyl)- | | | | propyltrimeth |
| | 4-hydroxy-, C7-9-branched and | | | | oxysilane |
| | linear alkyl esters, 5% 1- | | | | |
| | methoxy-2-propyl acetate | | | | |
| 5A | Polyether siloxane copolymer | 0.29% | 0.49% | Pencil | 2H |
| | (proprietary formula) | | | hardness | |
| 6A | Multilayered graphene flakes | 0.44% | 0.35% | Primer used | Yes |
| | | | | (yes/no) | |
| 7A | Graphite | 0.54% | 0.43% | Adhesion to | 2 |
| | | | | Cu by pull- | |
| | | | | off, Mpa | |
| 8A | Titanium Dioxide | 8.35% | 3.47% | Cavitation | Pass |
| | | | | resistance | |
| | | | | (pass/not | |
| | | | | pass) | |
| 9A | Brown aluminium (III) oxide, | 8.35% | 3.60% | Tape | Pass |
| | micronized | | | adhesion | |
| 10A | Fumed SiO₂ | 0.65% | 0.49% | Wet | 1-2 |
| | | | | adhesion to | |
| | | | | Cu by pull- | |
| | | | | off, MPa | |
| 11A | Castor oil derivative (proprietary | 0.35% | 0.59% | Bending test | Pass |
| | chemical formula) | | | | |
| 12A | Modified polyester-based | 2.58% | 4.11% | | |
| | adhesion promotor | | | | |
| 15A | Epoxy-functional PDMS-based | 1.14% | 1.97% | | |
| | oligomer | | | | |
| 17A | Activated (fused) aluminium (III) | 8.88% | 3.96% | | |
| | oxide | | | | |
| 18A | Methyl Acetate | 7.90% | 14.42% | | |
| 19A | Hydroxyalkyl-modified | 4.83% | 8.38% | | |
| | polydimethylsiloxane oligomer | | | | |
| 20A | Fluorohydroxylalkylated dimethyl | 1.96% | 3.34% | | |
| | siloxane oligomer | | | | |

| | | |
|---|---|---|
| Total: | 82.85% | 100.00% |

| | | %, wt | |
|---|---|---|---|
| # Part B | Hardener Composition | total | %, vol |
| 1B | Triamino-functional | 5.69% | 28.55% |
| | propyltrimethoxysilane | | |
| 2B | 2,4,6-Tris[(dimethylamino) | 0.60% | 3.22% |
| | methyl]phenol | | |
| 5B | Quaternary ammonium-modified | 2.07% | 11.17% |
| | dimethyl siloxane oligomer | | |
| 6B | Methyl Ethyl Ketone | 8.78% | 57.06% |

| | | |
|---|---|---|
| Total: | 17.15% | 100.00% |

Amounts. PROP Formula 184_PROP2 (shown below) was prepared containing about 6% of hollow ceramic micro-spheres. PROP Formula 184_PROP3.3 was prepared containing about 12% wt of the same sized microspheres. Coatings formed from both Formulas had a hardness of about 7-8H. This suggested that the range of hollow ceramic spheres that provides a PROP coating has a hardness of up to 8H is about 5 to 15% wt.

| | Formula 184_PROP_2 | | | | |
|---|---|---|---|---|---|
| Batch code: | | %, wt | | | |
| # Part A | Composition | total | %, vol | Select Properties | |
| 1A | Hybrid epoxy-polysiloxane resin | 44.3% | 62.44% | Type of | Hollow ceramic |
| | | | | performance | micro-spheres/ |
| | | | | additive | Titanium dioxide |
| 2A | Castor oil derivative | 0.38% | 0.68% | Particle size | 12/0.5 |
| 4A | Titanium dioxide | 16.06% | 7.02% | Amount of the | 6/16 |
| | | | | additive, wt % | |
| | | | | total formula | |
| | | | | weight | |
| 5A | Fumed SiO₂ | 0.71% | 0.57% | Type of | Aminopropyl |
| | | | | hardener | triethoxy |
| | | | | | silane |
| 6A | Multilayered graphene flakes | 0.20% | 0.17% | Pencil hardness | 7-8H |
| 7A | Graphite | 0.51% | 0.42% | Primer used | none |
| | | | | (yes/no) | |
| 9A | Fumed silica-modified organo- | 0.36% | 0.67% | Adhesion to Cu | 1 |
| | modified polysiloxane | | | by pull-off, MPa | |
| 10A | Glycidoxypropyl | 0.71% | 1.20% | Cavitation | Pass |
| | trimethoxysilane | | | resistance | |
| | | | | (pass/not pass) | |
| 11A | Microcrystalline magnesium | 1.25% | 0.80% | Tape adhesion | Pass |
| | silicate | | | | |
| 12A | 95% Benzenepropanoic acid, 3- | 0.59% | 1.00% | Wet adhesion to | 0.5-1 |
| | (2H-benzotriazol-2-yl)-5-(1,1- | | | Cu by pull-off, | |
| | dimethylethyl)- | | | MPa | |
| | 4-hydroxy-, C7-9-branched and | | | | |
| | linear alkyl esters, 5% 1- | | | | |
| | methoxy-2-propyl acetate | | | | |
| 14A | Methyl acetate | 2.97% | 5.71% | Bending test | Pass |
| 16A | Epoxy-functional PDMS-based | 1.25% | 2.26% | | |
| | oligomer | | | | |
| 17A | Polyether siloxane copolymer | 0.32% | 0.56% | | |
| 20A | Hollow ceramic micro-spheres | 6.09% | 8.67% | | |
| 21A | Xylene, aromatic solvent | 3.75% | 7.83% | | |

| | | |
|---|---|---|
| Total: | 79.45% | 100.00% |

| | | %, wt | |
|---|---|---|---|
| # Part B | Hardener Composition | total | %, vol |
| 1B | Aminopropyl triethoxysilane | 9.78% | 100.00% |

| | | |
|---|---|---|
| Total: | 9.78% | 100.00% |

### Bending Strength Studies.

Comparisons. PROP Formula 184.Base was prepared containing about 0.26 wt % graphene flake wear inhibitor, and no dry, wet, dry/wet adhesion promoter (shown above). PROP Formula 210.5 was prepared containing about 0.4 wt % graphene flake wear inhibitor and about 5 wt % dry, wet, dry/wet adhesion promoter (i.e., modified polyester-based adhesion promotor). PROP Formula 210.6 was prepared containing about 0.6 wt % graphene flake wear inhibitor and about 5 wt % dry, wet, dry/wet adhesion promoter (i.e., modified polyester-based adhesion promotor). See Formulas below. Coatings formed from Formula 184.Base and Formula 210.5 did not pass the bending test. Coating formed from Formula 210.6 did pass. See FIG. 10. This suggested that the combination of graphene flake wear inhibitor concentration and presence of a dry, wet, dry/wet adhesion promotor contributed to, or impacted the bending strength of PROP coatings.

PROP Formula 210.3 (shown below) was prepared containing half of the amount of the dry, wet, dry/wet adhesion promotor (about 0.26 wt % of modified polyester-based adhesion promotor) relative to Formula 210.6. Coating prepared from Formula 210.3 did not pass the bending test. PROP Formula 210.6 prepared containing about 5 wt % of the dry, wet, dry/wet adhesion promoter (i.e., modified polyester-based adhesion promotor) did form a coating that passed the bending test. This suggested that, for bending strength, a preferred amount of dry, wet, dry/wet adhesion promotor was between about 4 wt % to about 6 wt %.

| | Formula 210.5 | | | | |
|---|---|---|---|---|---|
| Batch code: | | %, wt | | | |
| # Part A | Composition | total | %, vol | Select Properties | |
| 1A | Hybrid epoxy-polysiloxane resin | 49.4% | 68.4% | TType of | Titanium |
| | | | | performance | dioxide |
| | | | | additive | |
| 2A | Castor oil derivative | 0.49% | 0.77% | Particle size | 0.5 |
| 4A | Titanium dioxide | 20.55% | 8.05% | Amount of the | 21 |
| | | | | additive, wt % total | |
| | | | | formula weight | |
| 5A | Fumed SiO₂ | 0.91% | 0.65% | Type of hardener | Amino |
| | | | | | propyl |
| | | | | | triethoxy |
| | | | | | silane |
| 6A | Multilayered graphene flakes | 0.41% | 0.30% | Pencil hardness | 4-6H |
| 7A | Graphite | 0.50% | 0.37% | Primer used | none |
| | | | | (yes/no) | |
| 9A | Polyether siloxane copolymer | 0.46% | 0.76% | Adhesion to Cu by | 1-2 |
| | | | | pull-off, Mpa | |
| 10A | Glycidoxypropyl trimethoxysilane | 0.91% | 1.38% | Cavitation | Pass |
| | | | | resistance | |
| | | | | (pass/not pass) | |
| 11A | Microcrystalline magnesium | 1.60% | 0.92% | Tape adhesion | Pass |
| | silicate | | | | |
| 12A | 95% Benzenepropanoic acid, 3- | 0.76% | 1.14% | Wet Adhesion to | 0.5-1 |
| | (2H-benzotriazol-2-yl)-5-(1,1- | | | Cu by pull-off, | |
| | dimethylethyl)- | | | Mpa | |
| | 4-hydroxy-, C7-9-branched and | | | | |
| | linear alkyl esters, 5% 1-methoxy- | | | | |
| | 2-propyl acetate | | | | |
| 14A | Methyl acetate | 3.81% | 6.55% | Bending strength | Fail |
| 16A | Epoxy-functional PDMS-based | 1.60% | 2.59% | | |
| | oligomer | | | | |
| 17A | Polyether siloxane copolymer | 0.41% | 0.64% | | |
| | (proprietary formula) | | | | |
| 18A | Modified polyester-based | 5.20% | 7.45% | | |
| | adhesion promotor | | | | |

| | | |
|---|---|---|
| Total: | 86.63% | 100.00% |

| | | %, wt | |
|---|---|---|---|
| # Part B | Hardener Composition | total | %, vol |
| 1B | Aminopropyl triethoxysilane | 12.52% | 93.92% |
| 2B | 2,4,6-Tris[(dimethylamino) | 0.85% | 6.08% |
| | methyl]phenol | | |

| | | |
|---|---|---|
| Total: | 13.37% | 100.00% |

Formula 210.6

| | |
|---|---|
| Batch code: | %, wt |

| | | | | |
|---|---|---|---|---|
| # Part A | Composition | total | %, vol | Select Properties |

| | | | | | |
|---|---|---|---|---|---|
| 1A | Hybrid epoxy-polysiloxane resin | 49.2% | 68% | Type of | Titanium |
| | | | | performance | dioxide |
| | | | | additive | |
| 2A | Castor oil derivative | 0.49% | 0.77% | Particle size | 0.5 |
| 4A | Titanium dioxide | 20.46% | 8.02% | Amount of the | 21 |
| | | | | additive, wt % total | |
| | | | | formula weight | |
| 5A | Fumed SiO₂ | 0.91% | 0.65% | Type of hardener | Amino |
| | | | | | propyl |
| | | | | | triethoxy |
| | | | | | silane |
| 6A | Multilayered graphene flakes | 0.61% | 0.45% | Pencil hardness | 4-6H |
| 7A | Graphite | 0.75% | 0.56% | Primer used | None |
| | | | | (yes/no) | |
| 9A | Polyether siloxane copolymer | 0.45% | 0.76% | Adhesion to Cu | 1-3 |
| | | | | by pull-off, MPa | |
| 10A | Glycidoxypropyl trimethoxysilane | 0.91% | 1.37% | Wet Adhesion to | 1 |
| | | | | Cu by pull-off, Mpa | |
| 11A | Microcrystalline magnesium | 1.59% | 0.91% | Cavitation | Pass |
| | silicate | | | resistance | |
| | | | | (pass/not pass) | |
| 12A | 95% Benzenepropanoic acid, 3- | 0.76% | 1.14% | Tape adhesion | Pass |
| | (2H-benzotriazol-2-yl)-5-(1,1- | | | | |
| | dimethylethyl)- | | | | |
| | 4-hydroxy-, C7-9-branched and | | | | |
| | linear alkyl esters, 5% 1-methoxy- | | | | |
| | 2-propyl acetate | | | | |
| 14A | Methyl acetate | 3.79% | 6.52% | Bending test | Pass |
| 16A | Epoxy-functional PDMS-based | 1.59% | 2.58% | | |
| | oligomer | | | | |
| 17A | Polyether siloxane copolymer | 0.40% | 0.64% | | |
| | (proprietary formula) | | | | |
| 18A | Modified polyester-based | 5.18% | 7.43% | | |
| | adhesion promotor | | | | |

| | | |
|---|---|---|
| Total: | 86.69% | 100.00% |

| | | %, wt | |
|---|---|---|---|
| # Part B | Hardener Composition | total | %, vol |
| 1B | Aminopropyl triethoxysilane | 12.46% | 93.92% |
| 2B | 2,4,6-Tris[(dimethylamino) | 0.85% | 6.08% |
| | methyl]phenol | | |

| | | |
|---|---|---|
| Total: | 13.31% | 100.00% |

Formula 210.3

| | |
|---|---|
| Batch code: | %, wt |

| | | | | |
|---|---|---|---|---|
| # Part A | Composition | total | %, vol | Select Properties |

| | | | | | |
|---|---|---|---|---|---|
| 1A | Hybrid epoxy-polysiloxane | 50.4% | 71% | Type of | Titanium |
| | resin | | | performance | dioxide |
| | | | | additive | |
| 2A | Castor oil derivative | 0.51% | 0.80% | Particle size | 0.5 |
| 4A | Titanium dioxide | 21.12% | 8.37% | Amount of the | 21 |
| | | | | additive, wt % | |
| | | | | total formula | |
| | | | | weight | |
| 5A | Fumed SiO₂ | 0.94% | 0.68% | Type of hardener | Amino |
| | | | | | propyl |
| | | | | | triethoxy |
| | | | | | silane |
| 6A | Multilayered graphene flakes | 0.42% | 0.32% | Pencil hardness | 4-6H |
| 7A | Graphite | 0.51% | 0.39% | Primer used | none |
| | | | | (yes/no) | |
| 9A | Fumed silica-modified | 0.47% | 0.79% | Adhesion to Cu | 1-2 |
| | organo-modified polysiloxane | | | by pull-off, MPa | |
| 10A | Glycidoxypropyl | 0.94% | 1.43% | Cavitation | Pass |
| | trimethoxysilane | | | resistance | |
| | | | | (pass/not pass) | |
| 11A | Microcrystalline magnesium | 1.64% | 0.95% | Tape adhesion | Pass |
| | silicate | | | | |
| 12A | 95% Benzenepropanoic acid, | 0.78% | 1.19% | Wet adhesion to | 0.5-1 |
| | 3-(2H-benzotriazol-2-yl)-5-(1, | | | Cu by pull-off, | |
| | 1-dimethylethyl)- | | | MPa | |
| | 4-hydroxy-, C7-9-branched | | | | |
| | and linear alkyl esters, 5% 1- | | | | |
| | methoxy-2-propyl acetate | | | | |
| 14A | Methyl acetate | 3.91% | 6.81% | Bending test | Pass |
| 16A | Epoxy-functional PDMS- | 1.64% | 2.69% | | |
| | based oligomer | | | | |
| 17A | Polyether siloxane copolymer | 0.42% | 0.67% | | |
| | (proprietary formula) | | | | |
| 18A | Modified polyester-based | 2.60% | 3.77% | | |
| | adhesion promotor | | | | |

| | | |
|---|---|---|
| Total: | 86.26% | 100.00% |

| | | %, wt | |
|---|---|---|---|
| # Part B | Hardener Composition | total | %, vol |
| 1B | Aminopropyl triethoxysilane | 12.86% | 93.92% |
| 2B | 2,4,6-Tris[(dimethylamino) | 0.88% | 6.08% |
| | methyl]phenol | | |
| 7B | Benzyl alcohol | 0.00% | 0.00% |

| | | |
|---|---|---|
| Total: | 13.74% | 100.00% |

### Adhesion Studies

Examples of dry, wet, dry/wet adhesion promotors and their respective adhesion mechanisms are provided below. These dry, wet, dry/wet adhesion promotors are useful for adhering to Cu substrates.

| Type of adhesion | | |
|---|---|---|
| promotor | Trade name | A mechanism of action |
| Polyester-modified | Tego Addbond LTW- | Dry adhesion/Wet adhesion: These promotors |
| adhesion promotor/ | B (Evonik), Tego | provide good flow characteristics that help the coating |
| polyacrylates | Addbond 2220 ND | to flow into a substrates' roughness and faciliate a fast |
| | (Evonik | grip between the cured coating and the substrate. |
| | | Another mechanism of action of this type of adhesion |
| | | promotors includes promoted non-covalent |
| | | interactions between the coating and the substrate. |
| Metal-doped | HEUCOPHOS ® ZCP | Wet adhesion: presence of the promoter based on Zn, |
| phosphosilicates | PLUS (Heubach), | Ca, Sr, or other metals used in the field of anti- |
| | HALOX ® SW-111 | corrosive protection. These promoters are activated in |
| | (Halox), InvoCor CI - | a wet environment by decomposing in the presence of |
| | 3315 (Invotec). | ions in water that permeate a coating The products of |
| | | decomposition react with a metal substrate, such as a |
| | | Cu-alloy and cross-react with unreacted promotor, |
| | | forming a strong bond between the coating layer and |
| | | the substrate, also hampering any further corrosion of |
| | | the substrate and preventing the adhesive bond from |
| | | rupturing; |
| Benzotriazole-based | Copper Adhesion | Dry adhesion/Wet adhesion: It is a bicyclic nitrogen- |
| compounds | Promote Product ID: | containing heterocyclic organic compound containing |
| | CCI-01 | a benzene ring and a 1,2,3-triazole ring. Benzotriazole |
| | R (Allucid Inc.) | (BTA) will react with metal substrates, such as copper |
| | | to form Cu-BTA, protecting the surface of Cu from |
| | | corrosion and retaining a strong grip of the coating |
| | | with the substrate. |
| Silane coupling | Andisil 187 Silane, | Dry adhesion: Organofunctional silanes are molecules |
| agents | Andisil 1100 (AB | carrying two different types of reactive groups |
| | Silicones). | attached to the silicon atom so that they can react and |
| | | couple to an inorganic surface (e.g., ceramics and |
| | | oxide layers on metals). Also, the amine functional |
| | | group in the silane-compound can co-react with an |
| | | epoxy resin of thus enhancing its adhesion to a metal |
| | | substrate, such as a Cu substrate. Such promoters |
| | | can also contribute to overall hydrophobicity |
| | | properties of a coating. |
| Mercaptane-modified | CAPCURE ® 3-800 | Dry adhesion/Wet adhesion: Thiol are known to |
| compounds | CAPCURE ® 40 SEC | oxidize and bond to the metallic surfaces, including |
| | HV (Huntsman) | copper. Further, the amine function in a thiol- |
| | | compound can co-react with an epoxy resin of thus |
| | | enhancing adhesion to a metal substrate, such as a |
| | | Cu substrate. |

### Dry, Wet, Dry/Wet Cu Adhesion.

With or Without Cu Adhesion Promoters. Coating formed from PROP Formula 164 (shown above) prepared without any dry, wet, dry/wet adhesion promotors had pull-off (dry) adhesion strength to Cu of about 1 MPa. Coating formed from PROP Formula 184.Base (shown above) was prepared containing about 0.9% wt. of a silane coupling agent, and coating formed from PROP Formula 230.1 was prepared containing about 0.65% wt. of a silane coupling agent and about 2.6% wt of a modified polyester adhesion promotor. Formula 184.Base with one type of dry adhesion promotor formed a coating having a pull-off (dry) Cu adhesion of about 2, and Formula 230.1 formed a coating having a slightly higher pull-off (dry) Cu adhesion of about 2.5 MPa. Upon wet adhesion tests, coatings formed from both formulas which lacked a wet adhesion promotor, yielded a wet Cu adhesion of 0.5-1 MPa. PROP Formula 243.1 was prepared containing about 5% wt of wet adhesion promotor zinc calcium strontium aluminum orthophosphate silicate hydrate (shown below). PROP Formula 230.14 (shown above) was prepared containing a dry/wet adhesion promoter (modified polyester-based adhesion promotor). Coating formed from PROP Formula 243.1 had a wet Cu adhesion of about 6 MPa. Coating formed from PROP Formula 230.14 had a wet Cu adhesion of about 2-3 MPa, and coating formed from PROP formula 243.1 had a wet adhesion of about 6 MPa.

PROP Formula 210.3 (shown below) was prepared containing about 0.26 wt % of modified polyester-based adhesion promotor PROP Formula 210.6 prepared containing about 5 wt % of modified polyester-based adhesion promotor. In terms of dry adhesion, Formulas 210.3 and 210.6 respectively exhibited a dry Cu adhesion strength of about 2 MPa to Cu, which suggests that the minimum amount of such adhesion promotor is 3% wt. This suggested that, for Cu adhesion strength, a preferred amount of dry/wet adhesion promotor is at least 3 wt %.

Hardeners. It was found that Cu adhesion strength of PROP coatings was, to a certain extent, impacted by the type of hardener. PROP Formula 230.1 (shown below) was prepared containing about 0.65 wt % of a silane coupling agent and about 2.6% wt. modified polyester adhesion promotor, using hardener aminopropyl triethoxysilane. Coating formed from Formula 230.1 had a dry Cu adhesion of 2 MPa. PROP Formula 230.7 (shown below) was prepared containing the same dry, wet, dry/wet adhesion promotors using a formulated polyamidoamide adduct hardener. Coating formed of Formula 230.7 had a dry Cu adhesion of about 4 Mpa.

| | Formula 230.1 | | | | |
|---|---|---|---|---|---|
| Batch code: | | %, wt | | | |
| # Part A | Composition | total | %, vol | Select Properties | |
| 1A | Hybrid epoxy-polysiloxane resin | 35.16% | 54.28% | Type of | Titanium dioxide/ |
| | | | | performance | Brown aluminium |
| | | | | additive | (III) oxide, |
| | | | | | micronized/ |
| | | | | | Titanium dioxide |
| 2A | Fumed silica-modified organo- | 0.33% | 0.83% | Particle size | 0.5/3-5/1-3, resp. |
| | modified polysiloxane | | | | |
| 3A | Glycidoxypropyl | 0.65% | 1.49% | Amount of the | 8/11.2/11.2, |
| | trimethoxysilane | | | additive, wt % | resp. |
| | | | | total formula | |
| | | | | weight | Aminopropyl |
| 4A | 95% Benzenepropanoic acid, 3- | 0.55% | 1.24% | Type of | triethoxy |
| | (2H-benzotriazol-2-yl)-5-(1,1- | | | hardener | silane |
| | dimethylethyl)-4-hydroxy-, | | | | |
| | C7-9-branched and linear alkyl | | | | |
| | esters, 5% 1-methoxy-2-propyl | | | | |
| | acetate | | | | |
| 5A | Polyether siloxane copolymer | 0.29% | 0.70% | Pencil hardness | 7-8H |
| 6A | Multilayered graphene flakes | 0.44% | 0.49% | Primer used | none |
| | | | | (yes/no) | |
| 7A | Graphite | 0.54% | 0.61% | Wet adhesion to | 1-2 |
| | | | | Cu by pull-off, | |
| | | | | MPa | |
| 8A | Titanium dioxide | 8.38% | 4.96% | Adhesion to Cu | 2 |
| | | | | by pull-off, MPa | |
| 9A | Brown aluminium (III) oxide, | 8.38% | 5.15% | Cavitation | Fail |
| | micronized | | | resistance | |
| | | | | (pass/not pass) | |
| 10A | Fumed SiO₂ | 0.65% | 0.71% | Tape adhesion | Pass |
| 11A | Castor oil derivative | 0.35% | 0.84% | W | 1 |
| 12A | Modified polyester-based | 2.59% | 5.88% | Bending test | Pass |
| | adhesion promotor | | | | |
| 15A | Epoxy-functional PDMS-based | 1.15% | 2.81% | | |
| | oligomer | | | | |

| | | |
|---|---|---|
| Total: | 59.45% | 100.00% |

| | | %, wt | |
|---|---|---|---|
| # Part B | Hardener Composition | total | %, vol |
| 1B | Aminopropyl triethoxysilane | 8.98% | 70.60% |
| 2B | 2,4,6-Tris[(dimethylamino) | 0.73% | 5.60% |
| | methyl]phenol | | |
| 6B | Methyl acetate | 2.97% | 23.80% |

| | | |
|---|---|---|
| Total: | 12.69% | 100.00% |

| | Formula 230.7 | | | | |
|---|---|---|---|---|---|
| Batch code: | | %, wt | | | |
| # Part A | Composition | total | %, vol | Select Properties | |
| 1A | Hybrid epoxy-polysiloxane resin | 46.93% | 74.28% | Type of | Titanium dioxide/ |
| | | | | performance | Brown aluminium |
| | | | | additive | (III) oxide, |
| | | | | | micronized/ |
| | | | | | Titanium dioxide |
| 2A | Fumed silica-modified organo- | 0.44% | 0.83% | Particle size | 0.5/3-5/1-3, |
| | modified polysiloxane | | | | resp. |
| 3A | Glycidoxypropyl trimethoxysilane | 0.87% | 1.49% | Amount of the | 8/11.2/11.2, |
| | | | | additive, wt % | resp. |
| | | | | total formula | |
| | | | | weight | |
| 4A | 95% Benzenepropanoic acid, 3- | 0.73% | 1.24% | Type of | Formulated |
| | (2H-benzotriazol-2-yl)-5-(1,1- | | | hardener | Polyamido |
| | dimethylethyl)- | | | | amide adduct |
| | 4-hydroxy-, C7-9-branched and | | | | |
| | linear alkyl esters, 5% 1- | | | | |
| | methoxy-2-propyl acetate | | | | |
| 5A | Polyether siloxane copolymer | 0.39% | 0.70% | Pencil | 7H |
| | | | | hardness | |
| 6A | Multilayered graphene flakes | 0.58% | 0.49% | Primer used | none |
| | | | | (yes/no) | |
| 7A | Graphite | 0.72% | 0.61% | Adhesion to | 4 |
| | | | | Cu by pull-off, | |
| | | | | Mpa | |
| 8A | Titanium dioxide | 11.18% | 4.96% | Cavitation | Pass |
| | | | | resistance | |
| | | | | (pass/not | |
| | | | | pass) | |
| 9A | Brown aluminium (III) oxide, | 11.18% | 5.15% | Wet Adhesion | 1-2 |
| | micronized | | | to Cu by pull- | |
| | | | | off, Mpa | |
| 10A | Fumed SiO₂ | 0.87% | 0.71% | Bending test | Pass |
| 11A | Castor oil derivative | 0.47% | 0.84% | | |
| 12A | Modified polyester-based | 3.55% | 5.88% | | |
| | adhesion promotor | | | | |
| 15A | Epoxy-functional PDMS-based | 1.53% | 2.81% | | |
| | oligomer | | | | |

| | | |
|---|---|---|
| Total: | 79.35% | 100.00% |

| | | %, wt | |
|---|---|---|---|
| # Part B | Hardener Composition | total | %, vol |
| 1B | Formulated Polyamidoamide | 12.53% | 55.33% |
| | adduct | | |
| 3B | 2,4,6-Tris[(dimethylamino) | 0.98% | 4.35% |
| | methyl]phenol | | |
| 6B | Methyl Ethyl Ketone | 7.14% | 40.32% |

| | | |
|---|---|---|
| Total: | 20.65% | 100.00% |

| | Formula 243.1 | | | | |
|---|---|---|---|---|---|
| Batch code: | | %, wt | | | |
| # Part A | Composition | total | %, vol | Select Properties | |
| 1A | Hybrid epoxy-polysiloxane resin | 37.94% | 57.29% | Type of | Titanium dioxide/ |
| | | | | performance | Brown aluminium |
| | | | | additive | (III) oxide, |
| | | | | | micronized/ |
| | | | | | Activated (fused) |
| | | | | | aluminium (III) |
| | | | | | oxide |
| 2A | Fumed silica-modified organo- | 0.35% | 0.64% | Particle size | 0.5/3-5/1-3, |
| | modified polysiloxane | | | | resp. |
| 3A | Glycidoxypropyl trimethoxysilane | 0.71% | 1.15% | Amount of the | 9/9/10, resp. |
| | | | | additive, wt % | |
| | | | | total formula | |
| | | | | weight | |
| 4A | 95% Benzenepropanoic acid, 3- | 0.59% | 0.96% | Type of | Triamino- |
| | (2H-benzotriazol-2-yl)-5-(1,1- | | | hardener | functional |
| | dimethylethyl)- | | | | propyltrimethoxysilane |
| | 4-hydroxy-, C7-9-branched and | | | | |
| | linear alkyl esters, 5% 1- | | | | |
| | methoxy-2-propyl acetate | | | | |
| 5A | Polyether siloxane copolymer | 0.31% | 0.54% | Pencil | 7-8H |
| | (proprietary formula) | | | hardness | |
| 6A | Multilayered graphene flakes | 0.47% | 0.38% | Primer used | none |
| | | | | (yes/no) | |
| 7A | Graphite | 0.58% | 0.47% | Wet Adhesion | 6 |
| | | | | to Cu by pull- | |
| | | | | off, Mpa | |
| 8A | Titanium dioxide | 9.04% | 3.83% | Adhesion to | 6 |
| | | | | Cu by pull-off, | |
| | | | | Mpa | |
| 9A | Brown aluminium (III) oxide, | 9.04% | 3.97% | Cavitation | 3 |
| | micronized | | | resistance | |
| | | | | (pass/not | |
| | | | | pass) | |
| 10A | Fumed SiO₂ | 0.71% | 0.55% | Tape adhesion | Pass |
| 11A | Castor oil derivative | 0.38% | 0.65% | | |
| 12A | Modified polyester-based | 2.79% | 4.57% | Bending test | Pass |
| | adhesion promotor | | | | |
| 15A | Epoxy-functional PDMS-based | 1.24% | 2.17% | | |
| | oligomer | | | | |
| 17A | Activated (fused) aluminium (III) | 9.61% | 4.37% | | |
| | oxide | | | | |
| 18A | Methyl acetate | 8.55% | 15.92% | | |
| 19A | Polymeric graphene dispersant | 0.23% | 0.40% | | |
| 20A | Zinc calcium strontium | 4.34% | 2.16% | | |
| | aluminium orthophosphate | | | | |
| | silicate hydrate | | | | |

| | | |
|---|---|---|
| Total: | 86.89% | 100.00% |

| | | %, wt | |
|---|---|---|---|
| # Part B | Hardener Composition | total | %, vol |
| 1B | Triamino-functional | 5.84% | 38.65% |
| | propyltrimethoxysilane | | |
| 2B | 2,4,6-Tris[(dimethylamino) | 0.53% | 3.71% |
| | methyl]phenol | | |
| 6B | Methyl Ethyl Ketone | 6.74% | 57.64% |

| | | |
|---|---|---|
| Total: | 13.11% | 100.00% |

Primers. PROP Primer Formula 245 was prepared containing a combination of Cu adhesion promoters, including strontium phosphosilicate, zinc calcium strontium aluminium orthophosphate silicate hydrate, modified polyester-based adhesion promotor (see below). PROP primer 245 was applied onto Cu substrates, such as Cu alloys. PROP Formula 230.14 (containing about 0.68% wt. silane coupling agent and 2.7% wt. modified polyester adhesion promotor) was applied onto PROP Primer, forming a 2-coat PROP coating. The 2-coat PROP coating exhibited dry and wet adhesions to Cu of about 4-6 and about 6-7 MPa respectively. A 1-coat PROP coating, involving PROP Formula 230.14 applied direct onto a Cu substrate, exhibited dry and wet adhesions of 2-3 MPa and about 1 MPa, respectively. See below.

### Comparison Between the 1-Coat and 2-Coat PROP Coatings

| | PROP Coatings | | | |
|---|---|---|---|---|
| | | | 243.1 | |
| | | | Single-coat | |
| | 230.14 | 230.14 + Primer | PROP coating, | |
| | Single-coat | Double-coat | Reinforced wet | 164 |
| Features | PROP coating | PROP coating | adhesion | Base |
| Number of coats | 1 | 2 | 1 | 1 |
| Dry adhesion to | 2-3 | 4-6 | 2-3 | 1 |
| Cu, MPa | | | | |
| Wet adhesion to | 1 | 6-7 | 6-7 | 1 |
| Cu, MPa | | | | |
| Cavitation | Pass | Pass | Pass | Fail |
| resistance | | | | |
| Hardness | >8H | >8H | >8H | 5-6H |
| Propeller test, 6 | Fail | Pass | Pass | Fail |
| months w/o | | | | |
| delamination and | | | | |
| visible defect | | | | |

With reference to the table above, there was prepared a 1-coat PROP coating formed from Formula 230.14, a 2-coat PROP coating formed from Formula 230.14 that was coated onto an adhesion primer, and a 1-coat PROP coating formed from Formula 243.1, which was a variation on PROP Formula 230.14 that was doped with a wet adhesion promotor (zinc calcium strontium aluminium orthophosphate silicate hydrate).

Each coating was found to have excellent hardness of 8H+, which was considered to be due to the ceramic performance additives. The 2-coat coating and 1-coat PROP coating formed from Formula 243.1 exhibited a wet Cu adhesion of about 6-7 MPa. This was found to be higher than the 1-coat PROP coating formed from Formula 230.14 (about 1 MPa) which did not contain the wet adhesion promotor (zinc calcium strontium aluminium orthophosphate silicate hydrate).

The 2-coat coating exhibited a dry Cu adhesion of about 4-6 MPa, about double of that of the 1-coat coating, which can be useful when a durable conservation of the coated item (a propeller, a screw, etc.) is required, i.e. large size propeller, mudded waters on the refloat, excessive debris during the initial refloat, etc.

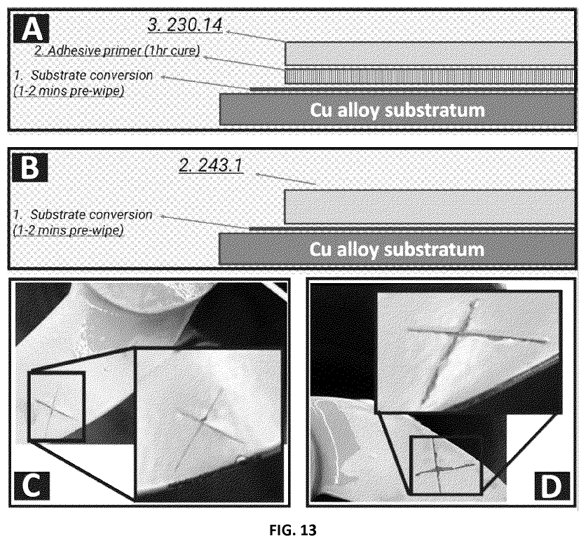

Application of a primer, or use of a wet adhesion promotor resulted in excellent resistance to water and delamination when used on a Cu substrate, such as a Cu propeller. As depicted in FIG. 13, the coatings did not develop blistering or slit erosion. Regardless of the adhesion promoter used, it was found that all three coatings exhibited excellent cavitation resistance.

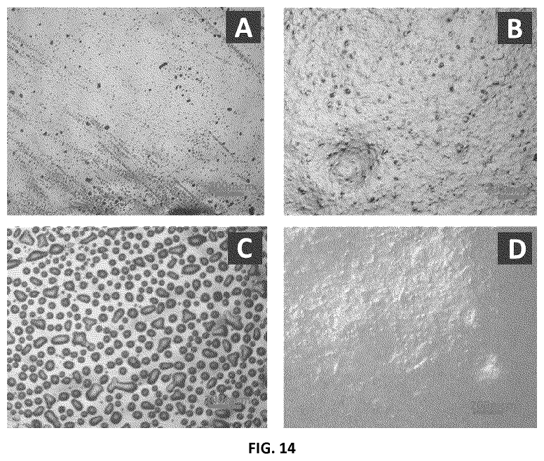

Commercial primer PROPSPEED, a chromate-based primer, was also tested relative to the PROP primer 245. PROPSPEED contains a chromate complex. The wet Cu adhesion results for each primer were within the range of about 5-7 MPa after 2 months of testing. Further, PROPSPEED was tested on top of the PROPSPEED PRIMER (PROPSPEED Etching Primer) as a topcoat for cavitation resistance relative to a coating formed from PROP Formula 230.14 coated onto PROP Primer 245. Microstructure observed for PROPSPEED topcoat suggested a failed cavitation result. For example, see FIG. 14. Comparing the micrographs of the coating formed from formulation 230.14 before and after the boiling-based cavitation test, the microstructure of the topcoat was unrendered by the testing medium, which suggested a “Pass”. The microstructure of PROPSPEED topcoat significantly changed during the test, which was considered a “Fail”.

PROP primer 245, shown below, was found to exhibit anti-corrosive properties, with a measured rust creep of 2-3.5 mm after 2000 hours in a salt spray chamber, at a coating thickness 75-90 micron.

| | Formula BC245 | | |
|---|---|---|---|
| Batch code: | | %, wt | |
| # Part A | Composition | total | %, vol |
| 1A | Bisphenol A epoxy resin | 11.57% | 19.61% |
| 2A | Polymeric non-ionic dispersing additive | 0.76% | 1.44% |
| 3A | Polymeric graphene dispersant | 0.15% | 0.30% |
| 4A | Glycidoxypropyl trimethoxysilane | 0.69% | 1.28% |
| 5A | Xylene | 6.5% | 15% |
| 6A | Silicone oligomer (proprietary chemical | 0.56% | 1.36% |
| | formula) | | |
| 7A | Multilayered graphene flakes | 0.22% | 0.21% |
| 8A | Graphite | 3.03% | 2.80% |
| 9A | Titanium dioxide | 3.10% | 1.50% |
| 10A | Organo-modified derivative of the Aluminium | 1.72% | 2.00% |
| | phyllosilicate clay | | |
| 11A | Calcium inosilicate mineral | 17.6% | 12.2% |
| 13A | Micronized barium sulphate | 9.53% | 4.50% |
| 14A | Polyamide wax derivative, micronized | 0.39% | 0.82% |
| 15A | Benzyl Alcohol | 2.53% | 4.82% |
| 16A | Cycloaliphatic polyglycidyl ether-modified | 6.94% | 12.51% |
| | epoxy resin | | |
| 17A | Methyl Ethyl Ketone | 3.84% | 9.47% |
| 19A | Strontium Phosphosilicate | 3.79% | 2.68% |
| 20A | Zinc calcium strontium aluminium | 3.79% | 2.15% |
| | orthophosphate silicate hydrate | | |
| 21A | Modified polyester-based adhesion | 3.03% | 5.37% |
| | promotor | | |

| | | |
|---|---|---|
| Total: | 79.82% | 100.00% |

| # Part B | Hardener Composition | %, eq | %, vol |
|---|---|---|---|
| 1B | Formulated Polyamidoamide adduct | 100.00% | 55.55% |
| 3B | 2,4,6-Tris[(dimethylamino) methyl]phenol | 12.00% | 4.44% |

| | | |
|---|---|---|
| Total: | 112.00% | 100.00% |

Shelf-Life. It was observed that use of solvents Methyl Acetate and Methyl Ethyl Ketone could, for some PROP compositions, reduce shelf-life if used in the Hardener Composition. It was found that such solvents could react with components of the Hardener composition, such that the Hardener composition could not be effectively used later. It was otherwise found that neither solvent impacted the final coating if an PROP composition prepared with Methyl Acetate and Methyl Ethyl Ketone in the Hardener Composition was used after it was prepared, and not stored for extended periods.

### Further Exemplary Formulae of PROP Compositions

Shown below is PROP formulation BC255.14, a variation on PROP formulation 243.1. BC255.14 was designed for application with brushes and rolls (manual tools). This formula was designed to provide a smooth levelling upon manual application and to reduce any visual roughness resulting from the application process. This formula was designed to include an increased amount of surface levelling rheology modifier, polyether siloxane copolymer.

| | | | | Select Properties | |
|---|---|---|---|---|---|
| | | | | | Activated |
| | | | | | (fused) |
| | | | | | aluminium (III) |
| | | | | | oxide/Brown |
| | Formulation BC255.14 | | | Type of | aluminium (III) |
| Batch code: | | %, wt | | performance | oxide, |
| # Part A | Composition | total | %, vol | additive | micronized |
| 1A | Hybrid epoxy-polysiloxane | 29% | 39% | Particle size, | 1-5 |
| | resin | | | micron | |
| 2A | Fumed silica-modified | 0.36% | 0.57% | Amount of the | |
| | organo-modified | | | additive, wt % | |
| | polysiloxane | | | total formula | |
| | | | | weight | |
| 3A | Glycidoxypropyl | 0.71% | 1.03% | Type of hardener | Triamino- |
| | trimethoxysilane | | | | functional |
| | | | | | propyltrimethox |
| | | | | | ysilane |
| 4A | 95% Benzenepropanoic | 0.59% | 0.85% | Pencil hardness | 7H+ |
| | acid, 3-(2H-benzotriazol-2- | | | | |
| | yl)-5-(1,1-dimethylethyl)- | | | | |
| | 4-hydroxy-, C7-9-branched | | | | |
| | and linear alkyl esters, 5% | | | | |
| | 1-methoxy-2-propyl | | | | |
| | acetate | | | | |
| 5A | Polyether siloxane | 1.2% | 1.8% | Primer used | No |
| | copolymer | | | (yes/no) | |
| 6A | Polymeric pigment | 0.33% | 0.00% | Wet Adhesion to | 3-5 |
| | dispersant | | | Cu by pull-off, | |
| | | | | MPa | |
| 7A | Multilayered graphene | 0.47% | 0.34% | Adhesion to Cu | 2 |
| | flakes | | | by pull-off, Mpa | |
| 8A | Graphite | 0.59% | 0.42% | Cavitation | Pass |
| | | | | resistance | |
| | | | | (pass/not pass) | |
| 9A | Titanium Dioxide | 8.44% | 3.17% | Tape adhesion | Pass |
| 10A | Activated (fused) | 8.57% | 3.34% | | |
| | aluminium (III) oxide | | | | |
| 11A | Fumed silica | 0.67% | 0.46% | | |
| 12A | Brown aluminium (III) | 9.07% | 3.54% | | |
| | oxide, micronized | | | | |
| 13A | Zinc calcium strontium | 5.13% | 2.26% | | |
| | aluminium orthophosphate | | | | |
| | silicate hydrate | | | | |
| 14A | Castor oil derivative | 0.14% | 0.21% | | |
| 16A | Modified polyester-based | 2.8% | 4.04% | | |
| | adhesion promotor | | | | |
| 19A | Epoxy-functional PDMS- | 1.24% | 1.93% | | |
| | based oligomer | | | | |
| 20A | Methyl acetate | 15.19% | 25.06% | | |

| | | |
|---|---|---|
| Total: | 93.55% | 100.00% |

| | | %, wt | |
|---|---|---|---|
| # Part B | Hardener Composition | total | %, vol |
| 1B | Triamino-functional | 5.87% | 91.03% |
| | propyltrimethoxysilane | | |
| 3B | 2,4,6-Tris[(dimethylamino) | 0.58% | 8.97% |
| | methyl]phenol | | |

| | | |
|---|---|---|
| Total: | 6.45% | 100.00% |

The embodiments described herein are intended to be examples only. Alterations, modifications and variations can be effected to the particular embodiments by those of skill in the art. The scope of the claims should not be limited by the particular embodiments set forth herein, but should be construed in a manner consistent with the specification as a whole.

All publications, patents and patent applications mentioned in this Specification are indicative of the level of skill those skilled in the art to which this invention pertains and are herein incorporated by reference to the same extent as if each individual publication patent, or patent application was specifically and individually indicated to be incorporated by reference.

The invention being thus described, it will be obvious that the same may be varied in many ways. Such variations are not to be regarded as a departure from the spirit and scope of the invention, and all such modification as would be obvious to one skilled in the art are intended to be included within the scope of the following claims.

What is claimed is:

1. A composition for a coating, comprising:
solvent-borne monomers;
a diluent;
a sufficient amount of an adhesion promoter to provide a coating formed from the composition having a substrate adhesion of at least 3 MPa when measured according to ASTM D4541, an overcoat adhesion of at least 3 MPa when measured according to ASTM D4541, or a recoat adhesion window of at least 4 hours when measured according to ASTM D3359;
a sufficient amount of rheology modifier to provide a coating formed from the composition having anti-settling, anti-sagging, or surface-leveling properties; and
a sufficient amount of a ceramic performance additive to provide a coating formed from the composition having a reduced noise radiation of about 2 dB to about 10 dB per about 100 μm of coating thickness at frequencies of about 10 Hz to about 10 kHz when measured on a 3 mm thickness cold rolled steel metal plate relative to a 3 mm thickness cold rolled steel metal plate coated with a coating free of the ceramic performance additive; or a hardness of at least 5H when measured according to ASTM D3363.

2. The composition of claim 1, wherein the solvent-borne monomers comprise allyl-functional monomers, amino-functional monomers, maleimide-functional monomers, cyanate ester-functional monomers, epoxy-functional monomers, furan-functional monomers, vinyl ester-functional monomers, or a combination thereof.

3. The composition of any one of claims 1 to 2, wherein the solvent-borne monomers comprise solvent-borne pre-polymers, such as allyl-functional pre-polymers, amino-functional pre-polymers, polyester pre-polymers, bis-maleimide pre-polymers, cyanate ester-functional pre-polymers, epoxy-functional pre-polymers, furan-functional pre-polymers, phenolic pre-polymers, polyurea pre-polymers, polyurethane pre-polymers, silicone pre-polymers, or vinyl ester-functional pre-polymers.

4. The composition of any one of claims 1 to 3, wherein the solvent-borne monomers comprise epoxy-functional monomers, wherein the epoxy-functional monomers comprise:
bisphenol diglycidyl ethers;
epoxy-functional monomers modified with a cycloaliphatic polyglycidyl ether;
epoxy-functional monomers modified with an aliphatic glycidyl ether;
epoxy-functional epoxide-siloxane monomers;
a reaction product of epichlorohydrin and one or more of hydroxyl-functional aromatics, alcohols, thiols, acids, acid anhydrides, cycloaliphatics and aliphatics, polyfunctional amines, and amine functional aromatics;
a reaction product of the oxidation of unsaturated cycloaliphatics; or
a combination thereof.

5. The composition of any one of claims 1 to 4, wherein the solvent-borne monomers comprise epoxy-functional monomers, wherein the epoxy-functional monomers comprise:
bisphenol diglycidyl ethers;
epoxy-functional epoxide-siloxane monomers;
epoxy-functional monomers modified with a cycloaliphatic polyglycidyl ether;
epoxy-functional monomers modified with a aliphatic glycidyl ether; or
a combination thereof.

6. The composition of any one of claims 1 to 5, wherein the bisphenol diglycidyl ethers are derived from bisphenol A, bisphenol F, bisphenol S, or a combination thereof.

7. The composition of any one of claims 1 to 6, wherein the epoxy-functional epoxide-siloxane monomers comprise an epoxide backbone comprising siloxane or polysiloxane side-chains.

8. The composition of any one of claims 1 to 7, wherein at least one of the siloxane or polysiloxane side-chains is a cross-linked silicone resin.

9. The composition of any one of claim 1 to 8, wherein the epoxy-functional epoxide-siloxane monomers comprise a reaction product of isocyanate and/or polyurethane oligomers, silane oligomers, and epoxy oligomers.

10. The composition of any one of claims 1 to 9, wherein the epoxy-functional epoxide-siloxane monomer comprises an epoxy-functional epoxide-siloxane pre-polymer.

11. The composition of any one of claims 1 to 10, wherein the epoxy-functional epoxide-siloxane monomer comprises a 3-ethylcyclohexylepoxy copolymer modified with dimethylsiloxane side-chains, an epoxy bisphenol A (2,2-Bis(4′-glycidyloxyphenyl)propane) modified with the poly-dimethylsiloxane side-chains, a siloxane modified hybrid epoxy resin, a siliconeepoxide resin, an epoxy-functional epoxide-backbone functionalized with a crosslinked silicone resin comprising terminal alkoxy groups, or a combination thereof.

12. The composition of any one of claims 1 to 11, wherein the epoxy-functional epoxide-siloxane monomer comprises Silikopon® ED, Silikopon® EF, EPOSIL Resin 5550®, or a combination thereof.

13. The composition of any one of claims 1 to 12, wherein the solvent-borne monomers are low-viscosity solvent-borne monomers.

14. The composition of any one of claims 1 to 13, wherein the low-viscosity solvent-borne monomers comprise epoxy-functional monomers modified with a cycloaliphatic polyglycidyl ether having a viscosity in a range of about 350 to about 550 cps; epoxy-functional monomers modified with a cycloaliphatic polyglycidyl ether having a viscosity in a range of about 400 to about 1000 cps; epoxy-functional monomers modified with an aliphatic glycidyl ether having a viscosity in a range of about 800 to about 1000 cps; or a combination thereof.

15. The composition of any one of claims 1 to 14, wherein the low-viscosity solvent-borne monomers comprise DLVE®-52 (ultra low viscosity epoxy resin modified with a cycloaliphatic polyglycidyl ether epoxy resin), DLVE®-18 (low viscosity epoxy resin modified with a cycloaliphatic polyglycidyl ether epoxy resin), D.E.R.® 353 (C12-C14 aliphatic glycidyl ether-modified bisphenol-A/F epoxy-based resin), or a combination thereof.

16. The composition of any one of claims 1 to 15, wherein a mixture of the solvent-borne monomers and the diluent have a viscosity in a range of about 200 to about 3500 cps, or about 300 to about 3500 cps.

17. The composition of any one of claims 1 to 16, wherein the solvent-borne monomers are present in a range of about 5 wt % to about 35 wt %, or about 5 wt % to about 30 wt %, or about 10 wt % to about 30 wt %; or about 15 wt % to about 20 wt %, based on Part A wt %; or about 5 wt % to about 25 wt %; or about 5 wt % to about 20 wt %, or about 10 wt % to about 20 wt %, or about 15 wt % to about 20 wt % based on total wt %.

18. The composition of any one of claims 1 to 17, wherein the diluent comprises a reactive diluent that is reactive in a polymerization of solvent-borne monomers, a non-reactive diluent, or a combination thereof.

19. The composition of any one of claims 1 to 18, wherein the reactive diluent comprises poly[(phenyl glycidyl ether)-co-formaldehyde], alkyl (C12-C14) glycidyl ether, phenyl glycidyl ether, alkenyl-substituted phenyl glycidyl ether, butyl glycidyl ether, 2-ethylhexyl glycidyl ether, o-cresol glycidyl ether, cycloaliphatic glycidyl ether, 1,2-epoxy-3-phenoxypropane; epoxy-functional polydimethylsiloxane, silicone-amine (; or a combination thereof.

20. The composition of any one of claims 1 to 19, wherein the reactive diluent comprises butyl glycidyl ether, alkyl (C12-C14) glycidyl ether, epoxy-functional polydimethylsiloxane, or a combination thereof.

21. The composition of any one of claims 1 to 20, wherein the reactive diluent is present in a range of about 1 wt % to about 15 wt %, or about 1 wt % to about 10 wt %, or about 1 wt % to about 5 wt %, based on Part A wt % or total wt %.

22. The composition of any one of claims 1 to 21, wherein the non-reactive diluent comprises xylene, cyclohexane, toluene, methyl acetate, methyl ethyl ketone, tert-butyl acetate, nonyl phenol, cyclohexanedimethanol, n-butyl alcohol, benzyl alcohol, isopropyl alcohol, polyethylene glycol, propylene glycol, phenol, methylstyrenated phenol, styrenated phenol, C12-C37 ether, low-viscosity hydrocarbon resin, aryl polyoxyethylene ether, or a combination thereof.

23. The composition of any one of claims 1 to 22, wherein the non-reactive diluent comprises benzyl alcohol, xylene, methyl acetate, ethers, aromatic solvents, or a combination thereof.

24. The composition of any one of claims 1 to 23, wherein the non-reactive diluent is present in a range of about 1 wt % to about 20 wt %, or about 1 wt % to about 10 wt %, or about 5 wt % to about 20 wt %, based on Part A wt %; or about 5 wt % to about 25 wt %, or about 5 wt % to about 20 wt %, or about 10 wt % to about 20 wt %, based on total wt %.

25. The composition of any one of claims 1 to 24, wherein the diluent comprises about 10 wt % volatile organic compounds, or <10 wt % volatile organic compounds.

26. The composition of any one of claims 1 to 25, wherein the adhesion promoter comprises an silane promoter, the silane being optionally reactive in a polymerization of solvent-borne monomers; a dry adhesion promoter being optionally reactive in a polymerization of solvent-borne monomers, reactive with a substrate, and/or reactive with metal oxides; a wet adhesion promoter being optionally reactive in a polymerization of solvent-borne monomers, reactive with a substrate, and/or reactive with metal oxides; a dry/wet adhesion promoter being optionally reactive being optionally reactive in a polymerization of solvent-borne monomers, reactive with a substrate, and/or reactive with metal oxides; or a combination thereof.

27. The composition of any one of claims 1 to 26, wherein the adhesion promoter comprises an alkoxylated silane, such as an epoxy-functional alkoxylated silane, an amino-functional alkoxylated silane, or a combination thereof; a modified polyester, such as a modified polyester having a hydroxyl value enough about 30 mg to about 100 mg KOH/g, a polyacrylic, a modified polyester oligomer, a polyacrylate, a metal-doped phosphosilicate, a benzotriazole, a mercaptane-comprising polymer or pre-polymer, or a combination thereof.

28. The composition of any one of claims 1 to 27, wherein the adhesion promoter comprises 3-(2,3-Epoxypropoxy)propyltrimethoxysilane; glycidoxypropyltrimethoxysilane; aminopropyltriethoxysilane; 3-aminopropyltriethoxysilane; an secondary amino bis-silane; a modified polyester, such as Tego Addbond LTW-B®, Tego Addbond 2220 ND®; a strontium phosphosilicate, such as HALOX® SW-111; a zinc calcium strontium aluminum orthophosphate silicate hydrate, such as HEUCOPHOS® ZCP-Plus; a zinc phosphosilicate, such as InvoCor CI-3315 (Invotec); an alkyl-substituted, hydroxylamine-substituted benzotriazole, such as CCI-01 Copper Adhesion Promoter; a mercaptane-comprising polymer or pre-polymer, such as CAPCURE® 3-800, CAPCURE® 40 SEC HV; or a combination thereof.

29. The composition of any one of claims 1 to 28, wherein the adhesion promoter is present in a range about 1 wt % to about 10 wt %, or about 2 wt % to about 10 wt %, or about 2 wt % to about 8 wt %, based on Part A wt %; or of about 0.1 wt % to about 5 wt %, or about 0.1 wt % to about 1 wt %, or about 1 wt % to about 5 wt %, based on total wt %.

30. The composition of any one of claims 1 to 29, wherein a sufficient amount of the adhesion promoter provides a coating formed from the composition having a substrate adhesion of about 3 MPa to about 15 MPa, or about 3 MPa to about 10 MPa when measured according to ASTM D4541, an overcoat adhesion of about 3 MPa to about 15 MPa, or about 3 MPa to about 10 MPa when measured according to ASTM D4541, or a recoat adhesion window between about 4 hours to about 72 hours when measured according to ASTM D3359; or a combination thereof.

31. The composition of any one of claims 1 to 30, wherein the ceramic performance additive comprises hollow ceramics and non-hollow ceramics.

32. The composition of any one of claims 1 to 31, wherein the hollow ceramics comprises hollow ceramic spheres having a particle size of about 10 μm to about 40 μm; about 20 μm to about 40 μm, or about 25 μm to about 35 μm; or about 10 μm to about 15 μm, or about 12 μm.

33. The composition of any one of claims 1 to 32, wherein when the hollow ceramic spheres have a particle size of about 20 μm to about 40 μm, or about 25 μm to about 35 μm, the hollow ceramic spheres are present in a range of about 30 wt % to about 70 wt %, or about 35 wt % to about 65 wt %, or about 30 wt % to about 50 wt %, based on Part A wt %; or in a range of about 15 wt % to about 50 wt %, or about 20 wt % to about 50 wt %, or about 20 wt % to about 45 wt % about 15 wt % to about 40 wt %, based on Part A wt % or total wt %.

34. The composition of any one of claims 1 to 33 wherein, when the hollow ceramic spheres have a particle size of about 10 μm to about 15 μm, or about 12 μm, the hollow ceramic spheres are present in a range of about 5 wt % to about 70 wt %, about 15 wt % to about 70 wt %, about 25 wt % to about 70 wt %, about 35 wt % to about 70 wt %, about 40 wt % to about 70 wt %, or about 5 wt % to about 20 wt %, or about 10 wt % to about 20 wt %, or about 10 wt % to about 18 wt %, or about 10 wt % to about 15 wt %, based on Part A; or in a range of about 20 wt % to about 50 wt %, or about 20 wt % to about 45 wt %, or about 15 wt % to about 40 wt %, based on total wt %.

35. The composition of any one of claims 1 to 34, wherein the hollow ceramic spheres comprise Zeeospheres® G 600 hollow ceramic spheres, W410® hollow ceramic spheres, W610® hollow ceramic spheres, Zeeospheres® N-200PC hollow ceramic spheres, W210® hollow ceramic spheres, W410® hollow ceramic spheres, W610® hollow ceramic spheres, or a combination thereof.

36. The composition of any one of claims 1 to 35, wherein the non-hollow ceramics comprises non-hollow ceramic particles having a particle size of about 0.1 μm to about 5 μm; about 0.5 μm to about 5 μm, or about 1 μm to about 5 μm; or about 2 μm to about 5 μm.

37. The composition of any one of claims 1 to 36, wherein the non-hollow ceramic particles are present in a range of about 10 wt % to about 50 wt %, or about 10 wt % to about 45 wt %; or about 15 wt % to about 40 wt %, based on Part A wt %; or in a range of about 5 wt % to about 40 wt %, or about 10 wt % to about 35 wt %, or about 20 wt % to about 35 wt %, or about 10 wt % to about 20 wt %, based on total wt %.

38. The composition of any one of claims 1 to 37, wherein the non-hollow ceramic particles comprise titanium oxide, brown aluminium (Ill) oxide, fused aluminium (Ill) oxide, titanium alloys, or a combination thereof.

39. The composition of any one of claims 1 to 38, wherein the sufficient amount of the ceramic performance additive provides a coating formed from the composition having reduced noise radiation of about 3 dB to about 9 dB, or about 5 dB to about 7 dB per about 100 μm of coating thickness, or a hardness of about 6H to about 8H, or about 8H.

40. The composition of any one of claims 1 to 39, wherein the rheology modifier comprises an anti-settling rheology modifier, an anti-sagging rheology modifier, or a combination thereof.

41. The composition of any one of claims 1 to 40, wherein the rheology modifier comprises aluminum phyllosilicate clay; organo-modified derivative of aluminium phyllosilicate clay; organo-modified bentonite clay; organo-modified montmorillonite clay, such as Claytone-HY® or Claytone-APA®; organo-modified castor oil derivative wax, such as Thixatrol ST®; micronized organo-modified polyamide wax derivative, such as Crayvallac Super®; fumed silica, fumed silica surface modified with silane, fumed silica surface modified with dimethyldichlorosilane, such as Cab-O—Sil TS-610®; micronized barium sulphate, such as VB Techno®; microcrystalline magnesium silicate, such as Talc SIlverline 202® or Mistron 002®; polyether siloxane copolymer, such as TEGO® Glide 410® (Evonik); or a combination thereof.

42. The composition of any one of claims 1 to 41, wherein the anti-settling rheology modifier comprises fumed silica, fumed silica surface modified with silane, fumed silica surface modified with dimethyldichlorosilane; aluminum phyllosilicate clay; organo-modified derivative of aluminium phyllosilicate clay; organo-modified bentonite clay; organo-modified montmorillonite clay; or a combination thereof.

43. The composition of any one of claims 1 to 42, wherein the anti-sagging rheology modifier comprises micronized organo-modified polyamide wax derivative, organo-modified castor oil derivative wax, or a combination thereof.

44. The composition of any one of claims 1 to 43, wherein the rheology modifier is present; or in a range of about 1 wt % to about 5 wt %, or about 1 wt % to about 3 wt %, or about 1 w % to about 1.5 wt %, based on Part A wt %; or in a range of about 0.3 wt % to about 5 wt %, or about 0.3 wt % to about 3 wt %, or about 0.3 w % to about 1.5 wt %, based on total wt %.

45. The composition of any one of claims 1 to 44, wherein the anti-sagging rheology modifier or anti-settling rheology modifier is present in a range of about 0.1 wt % to about 5 wt %, or about 0.3 wt % to about 3 wt %, or about 0.3 w % to about 1.5 wt %, based on total wt %.

46. The composition of any one of claims 1 to 45, further comprising a dispersant.

47. The composition of any one of claims 1 to 46, wherein the dispersant comprises a polymeric dispersant, such as a polymeric non-ionic dispersant, polymeric ionic dispersant, a polymeric pigment dispersant, or a combination thereof.

48. The composition of any one of claims 1 to 47, wherein the dispersant comprises ADDITOL VXW 6208® (polymeric non-ionic dispersant), K-SPERSE A504 (polymeric non-ionic dispersant), Disperbyk 140® (polymeric ionic dispersant, alkyl ammonium salt of an acidic polymer), MULTIWET EF-LQ-AP® (polymeric non-ionic dispersant), HPERMER KD6-LQ-MV® (polymeric non-ionic dispersant blend), ECO NatraSense 125 MBAL-LQ-AP®(non-ionic alcohol ethoxylate dispersant), BRIJ-03-LQ-AP® (nonionic alkyl polyglycol ethers dispersant), SP BRIJ 02 MBAL LQ-AP® (nonionic alkyl polyglycol ethers dispersant), ANTI-TERRA-204® (polymeric ionic dispersant, polycarboxylic acid salt of polyamine amides), TEGO Dispers 670® (polymeric non-ionic dispersant), TEGO Disperse 1010® (polymeric non-ionic dispersant), TEGO® Glide 410® (polyether siloxane copolymer); or a combination thereof.

49. The composition of any one of claims 1 to 48, wherein the dispersant is present in a range of about 0.1 wt % to about 2 wt %, or about 0.1 wt % to about 1.5 wt %, or about 0.1 wt % to about 1 wt %, based on Part A wt %; or in a range of about 0.1 wt % to about 5 wt %, or about 0.1 wt % to about 4 wt %, or about 0.1 wt % to about 3 wt %; or about 0.1 wt % to about 2 wt %, or about 0.1 wt % to about 1 wt %, based on total wt %.

50. The composition of any one of claims 1 to 49, further comprising a wear inhibitor, such as graphite oxide, multilayered graphene flakes, titanium dioxide, microcrystalline magnesium silicate, fumed silica, micronized barium sulphate, or a combination thereof.

51. The composition of any one of claims 1 to 50, wherein the wear inhibitor is present in a range of about 0.01 wt % to about 5 wt %, 0.05 wt % to about 5 wt %, 0.5 wt % to about 5 wt %, or about 0.5 wt % to about 2 wt %, based on Part A wt % or total wt %.

52. The composition of any one of claims 1 to 51, further comprising a hydrophobicity-modifying additive, the hydrophobicity-modifying additive comprising an epoxy-functional silane, an epoxy-functional polydialkylsiloxane, or a combination thereof.

53. The composition of any one of claims 1 to 52, wherein the hydrophobicity-modifying additive comprises an epoxy-functional polydialkylsiloxane.

54. The composition of any one of claims 1 to 53, wherein the hydrophobicity-modifying additive comprises an epoxy-functional polydialkylsiloxane.

55. The composition of any one of claims 1 to 54, wherein the epoxy-functional silane comprises glycidoxypropyltrimethoxysilane.

56. The composition of any one of claims 1 to 55, further comprising a defoamer, such as a polymeric defoamer.

57. The composition of any one of claims 1 to 56, wherein the defoamer comprises a silicone-based oligomeric defoamer, such as a polysiloxane oligomer.

58. The composition of any one of claims 1 to 57, wherein the defoamer comprises BYK-066 N, BYK-1790, ADDITOL VXW 6210 N, TEGO Airex 900, or a combination thereof; and is optionally present in a range of about 1 wt % to about 5 wt %, or about 1 wt % to about 3 wt %, or about 1 wt % to about 1.5 wt %, based on Part A wt %; or in a range of about 0.1 wt % to about 5 wt %, or about 0.1 wt % to about 1 wt %, or about 1 wt % to about 5 wt %, based on total wt %.

59. The composition of any one of claims 1 to 58, further comprising a weather-resistance additive.

60. The composition of any one of claims 1 to 59, wherein the weather-resistance additive comprises 95% Benzenepropanoic acid, 3-(2H-benzotriazol-2-yl)-5-(1,1-dimethylethyl)-4-hydroxy-, C7-9-branched and linear alkyl esters, 5% 1-methoxy-2-propyl acetate (Tinuvin 99-2®), 2-(2H-benzotriazol-2-yl)-4,6-bis(1-methyl-1-phenylethyl)phenol (Tinuvin 900®), 2-[4-[2-Hydroxy-3-tridecyloxypropyl]oxy]-2-hydroxyphenyl]-4,6-bis(2,4-dimethylphenyl)-1,3,5-triazine and 2-[4-[2-hydroxy-3-didecyloxypropyl]oxy]-2-hydroxyphenyl]-4,6-bis(2,4-dimethylphenyl)-1,3,5-triazine (Tinuvin 400®), or a combination thereof; optionally present in a range of about 0.5 wt % to about 5 wt %, or about 1 wt % to about 5 wt %.

61. The composition of any one of claims 1 to 60, wherein the weather-resistance additive is a wet/dry adhesion promotor.

62. The composition of any one of claims 1 to 61, further comprising a curing catalyst.

63. The composition of any one of claims 1 to 62, wherein the curing catalyst comprises 2,4,6-tris[(dimethylamino)methyl]phenol.

64. The composition of any one of claims 1 to 63, wherein the composition comprises about 80 wt % to about 90 wt % solids.

65. The composition of any one of claims 1 to 64, further comprising a hardener composition, the hardener composition comprising a hardener and optionally a diluent, the hardener being reactive in curing the composition to form a coating having a resistance to abrasive treatment with organic solvents of at least 50 passes, or between 50 and 80 passes when measured according to ASTM D1640.

66. The composition of any one of claims 1 to 65, wherein the hardener comprises an amine hardener, amide hardener, or a combination thereof, such as phenalkamine, amine-modified phenalkamine, phenalkamides, amine-modified phenalkamides, polyamidoamine, organo-modified polyamidoamine, or a combination thereof; or a silamine hardener, such as aminopropyltriethoxysilane, triamino-functional propyltrimethoxysilane; or a combination thereof; optionally present in a range of about 40 wt % to about 100 wt %, or 40 wt % to about 90 wt %, or about 70 wt % to about 100 wt %, or about 70 wt % to about 90 wt % of the hardener composition.

67. The composition of any one of claims 1 to 66, wherein the diluent comprises a non-reactive diluent, such as xylene, benzyl alcohol, methyl ethyl ketone, methyl acetate, ethers, aromatic solvents, or a combination thereof; optionally present in a range of about 1 to 30% wt % of the hardener composition; optionally, wherein the xylene is present in a range of about 1 wt % to about 5 wt %, and methyl acetate is present in a range of about 10 wt % to about 25 wt %.

68. A coating comprising a reaction product of a composition for a coating of any one of claims 1 to 64 and a hardener.

69. A coating comprising a reaction product of a composition for a coating of any one of claims 1 to 64 and the hardener composition according to any one of claims 65 to 67.

70. The coating of claim 68 or 69 having a bending strength of at least 10 mm when measured by a cylindrical bend test.

71. The coating of any one of claims 68 to 70 having a bending strength of at least 8 mm, or at least 6 mm when measured by a cylindrical bend test.

72. The coating of any one of claims 68 to 71 having a substrate adhesion of at least 3 MPa when measured according to ASTM D4541, an overcoat adhesion of at least 3 MPa when measured according to ASTM D4541, or a recoat adhesion window of at least 4 hours when measured according to ASTM D3359, or a combination thereof.

73. The coating of any one of claims 68 to 72 having a substrate adhesion of about 3 MPa to about 15 MPa, or about 3 MPa to about 10 MPa when measured according to ASTM D4541, an overcoat adhesion of about 3 MPa to about 15 MPa, or about 3 MPa to about 10 MPa when measured according to ASTM D4541, or a recoat adhesion window between about 4 hours to about 72 hours when measured according to ASTM D3359; or a combination thereof.

74. The coating of any one of claims 68 to 73 having a reduced noise radiation of about 2 dB to about 10 dB per about 100 μm of coating thickness at frequencies of about 10 Hz to about 10 kHz when measured on a 3 mm thickness cold rolled steel metal plate relative to a 3 mm thickness cold rolled steel metal plate coated with a coating free of the ceramic performance additive, or a hardness of at least 5H when measured according to ASTM D3363.

75. The coating of any one of claims 68 to 74 having reduced noise radiation of about 3 dB to about 9 dB, or about 5 dB to about 7 dB per about 100 μm of coating thickness, or a hardness of about 6H to about 8H, or about 8H.

76. A composition for a coating, comprising:
a solvent-borne epoxy resin;
a diluent;
an adhesion promoter;
an anti-settling rheology modifier;
an anti-sagging rheology modifier; and
a ceramic performance additive comprising hollow ceramic spheres.

77. The composition of claim 76, wherein the epoxy resin comprises a bisphenol A epoxy resin, a bisphenol F epoxy resin, a bisphenol S epoxy resin, a cycloaliphatic polyglycidyl ether-modified epoxy resin, a cycloaliphatic polyglycidyl ether resin having a viscosity in a range of about 350 to about 550 cps, a cycloaliphatic polyglycidyl ether-modified resin having a viscosity in a range of about 400 to about 1000 cps, an aliphatic glycidyl ether-modified epoxy resin having a viscosity in a range of about 800 to about 1000 cps, or a combination thereof.

78. The composition of any one of claims 76 to 77, wherein the epoxy resin is present at an amount between about 5 to about 30 wt %, or between about 5 to about 20 wt %, or between about 15 to about 20 wt %, or between about 10 wt % to about 20 wt %, based on Part A wt %.

79. The composition of any one of claims 76 to 78, wherein the diluent comprises a reactive diluent that is reactive in a epoxy polymerization, a non-reactive diluent, or a combination thereof.

80. The composition of any one of claims 76 to 79, wherein the reactive diluent comprises butyl glycidyl ether, C12-14 aliphatic glycidyl ether, phenyl glycidyl ether, alkenyl-substituted phenyl glycidyl ether, 2-ethylhexyl glycidyl ether, o-cresol glycidyl ether, cycloaliphatic glycidyl ether, 1,2-epoxy-3-phenoxypropane; epoxy-functional polydimethylsiloxane, or a combination thereof.

81. The composition of any one of claims 76 to 80, wherein the reactive diluent comprises butyl glycidyl ether, C12-14 aliphatic glycidyl ether, or a combination thereof.

82. The composition of any one of claims 76 to 81, wherein the reactive diluent is present in a range of about 1 wt % to about 15 wt %, or about 1 wt % to about 10 wt %, or about 5 wt % to about 10 wt %, or about 1 wt % to about 5 wt %, based on Part A wt %; or in a range of about 1 wt % to about 10 wt %, or about 2 wt % to about 8 wt %, based on total wt %.

83. The composition of any one of claims 76 to 82, wherein the non-reactive diluent comprises xylene, cyclohexane, toluene, methyl acetate, methyl ethyl ketone, tert-butyl acetate, nonyl phenol, cyclohexanedimethanol, n-butyl alcohol, benzyl alcohol, isopropyl alcohol, polyethylene glycol, propylene glycol, phenol, or a combination thereof.

84. The composition of any one of claims 76 to 83, wherein the non-reactive diluent comprises benzyl alcohol, xylene, methyl ethyl ketone, methyl acetate, ethers, aromatic solvents, or a combination thereof.

85. The composition of any one of claims 76 to 84, wherein the non-reactive diluent is present in a range of about 1 wt % to about 20 wt %, or about 1 wt % to about 10 wt %, or about 5 wt % to about 20 wt %, based on Part wt % or total wt %.

86. The composition of any one of claims 76 to 85, wherein the adhesion promoter comprises an alkoxylated silane, the silane being optionally reactive in a epoxy polymerization; a hydroxyphenyl-benzotriazole, a hydroxyphenyl-triazine, or a combination thereof.

87. The composition of any one of claims 76 to 86, wherein the adhesion promoter comprises epoxy-functional alkoxylated silane, an amino-functional alkoxylated silane, a hydroxyphenyl-benzotriazole, a hydroxyphenyl-triazine, or a combination thereof.

88. The composition of any one of claims 76 to 87, wherein the adhesion promoter comprises 3-(2,3-epoxypropoxy)propyl-trimethoxysilane; glycidoxypropyl-trimethoxysilane; aminopropyl-triethoxysilane; 3-aminopropyl-triethoxysilane; an secondary amino bis-silane; 95% Benzenepropanoic acid, 3-(2H-benzotriazol-2-yl)-5-(1,1-dimethylethyl)-4-hydroxy-, C7-9-branched and linear alkyl esters, 5% 1-methoxy-2-propyl acetate (Tinuvin 99-2®), 2-(2H-benzotriazol-2-yl)-4,6-bis(1-methyl-1-phenylethyl)phenol (Tinuvin 900®), 2-[4-[2-Hydroxy-3-tridecyloxypropyl]oxy]-2-hydroxyphenyl]-4,6-bis(2,4-dimethylphenyl)-1,3,5-triazine and 2-[4-[2-hydroxy-3-didecyloxypropyl]oxy]-2-hydroxyphenyl]-4,6-bis(2,4-dimethylphenyl)-1,3,5-triazine (Tinuvin 400®); or a combination thereof.

89. The composition of any one of claims 76 to 88, wherein the adhesion promoter is present in a range of about 0.1 wt % to about 5 wt %, or about 0.1 wt % to about 1 wt %, or about 1 wt % to about 5 wt % based on Part A wt % or total wt %.

90. The composition of any one of claims 76 to 89, wherein the anti-settling rheology modifier comprises a silica, a clay, or a combination thereof.

91. The composition of any one of claims 76 to 90, wherein the anti-settling rheology modifier comprises fumed silica, fumed silica surface modified with silane, fumed silica surface modified with dimethyldichlorosilane; aluminum phyllosilicate clay; organo-modified derivative of aluminium phyllosilicate clay; organo-modified bentonite clay; organo-modified montmorillonite clay; or a combination thereof.

92. The composition of any one of claims 76 to 91, wherein the anti-settling rheology modifier is present in a range of about 0.1 wt % to about 5 wt %, or about 0.3 wt % to about 3 wt %, or about 0.3 w % to about 2 wt %, based on Part A wt %; or about in a range of about 0.1 wt % to about 2 wt %, or about 0.2 wt % to about 1.5 wt %, or about 0.3 wt % to about 1.3 wt %, based on total wt %.

93. The composition of any one of claims 76 to 92, wherein the anti-sagging rheology modifier comprises a wax, a micronized wax, or a combination thereof.

94. The composition of any one of claims 76 to 93, wherein the an anti-sagging rheology modifier comprises a polyamide wax, a micronized polyamide wax, a micronized organo-modified polyamide wax, a micronized organo-modified polyamide wax derivative, a castor oil wax, an organically-modified castor oil-derivative wax, or a combination thereof.

95. The composition of any one of claims 76 to 94, wherein the an anti-sagging rheology modifier comprises a polyamide wax, a micronized polyamide wax, a micronized organo-modified polyamide wax, a micronized organo-modified polyamide wax derivative, or a combination thereof.

96. The composition of any one of claims 76 to 95, wherein the anti-sagging rheology modifier is present in a range of about 0.1 wt % to about 1.5 wt %, or about 0.1 wt % to about 1 wt %, or about 0.1 w % to about 0.5 wt %; based on Part A wt % or total wt %.

97. The composition of any one of claims 76 to 96, wherein the ceramic performance additive comprises hollow ceramic spheres having a particle size of about 20 μm to about 40 μm, or about 25 μm to about 35 μm.

98. The composition of any one of claims 76 to 97, wherein the hollow ceramic spheres are present in a range of about 20 wt % to about 40 wt %, or about 25 wt % to about 35 wt %; based on Part A wt % or total wt %.

99. The composition of any one of claims 76 to 98, wherein the hollow ceramic spheres comprise Zeeospheres® G 600 hollow ceramic spheres, W410® hollow ceramic spheres, W610® hollow ceramic spheres, or a combination thereof.

100. The composition of any one of claims 76 to 99, further comprising a dispersant.

101. The composition of any one of claims 76 to 100, wherein the dispersant comprises a polymeric dispersant.

102. The composition of any one of claims 76 to 101, wherein the dispersant comprises a polymeric non-ionic dispersant, polymeric ionic dispersant, a polymeric pigment dispersant, or a combination thereof.

103. The composition of any one of claims 76 to 102, wherein the dispersant comprises ADDITOL VXW 6208® (polymeric non-ionic dispersant), K-SPERSE A504 (polymeric non-ionic graphene dispersant), MULTIWET EF-LQ-AP® (polymeric non-ionic dispersant), HPERMER KD6-LQ-MV® (polymeric non-ionic dispersant blend), BRIJ-03-LQ-AP® (nonionic alkyl polyglycol ethers dispersant), SP BRIJ 02 MBAL LQ-AP® (nonionic alkyl polyglycol ethers dispersant), ANTI-TERRA-204® (polymeric ionic dispersant, polycarboxylic acid salt of polyamine amides), TEGO Dispers 670® (polymeric non-ionic dispersant), TEGO Dispers 1010® (polymeric non-ionic dispersant), TEGO® Glide 410® (polyether siloxane copolymer); or a combination thereof.

104. The composition of any one of claims 76 to 103, wherein the dispersant is present in a range of about 0.1 wt % to about 1.5 wt %, or about 0.1 wt % to about 1 wt %, or about 0.1 wt % to about 0.5 wt %, based on Part A wt % or total wt %.

105. The composition of any one of claims 76 to 104, further comprising a wear inhibitor.

106. The composition of any one of claims 76 to 105, wherein the wear inhibitor comprises graphite oxide, graphene, multilayered graphene flakes, titanium dioxide, microcrystalline magnesium silicate, fumed silica, micronized barium sulphate, or a combination thereof.

107. The composition of any one of claims 76 to 106, wherein the wear inhibitor is present in a range of about 0.01 wt % to about 1 wt %, or about 0.05 wt % to about 0.5 wt % or about 0.05 wt % to about 0.8 wt %, based on Part A wt % or total wt %.

108. The composition of any one of claims 76 to 107, further comprising a defoamer.

109. The composition of any one of claims 76 to 108, wherein the defoamer comprises a polymeric defoamer.

110. The composition of any one of claims 76 to 109, wherein the defoamer comprises a silicone-based oligomeric defoamer.

111. The composition of any one of claims 76 to 110, wherein the defoamer comprises BYK-066 N, BYK-1790, ADDITOL VXW 6210 N, TEGO Airex 900, or a combination thereof.

112. The composition of any one of claims 76 to 111, wherein the defoamer is optionally in a range of about 0.1 wt % to about 5 wt %, or about 0.1 wt % to about 1.5 wt %, or about 0.3 wt % to about 1.2 wt %, or about 1 wt % to about 5 wt %, based on Part A wt % or total wt %.

113. The composition of any one of claims 76 to 112, further comprising a curing catalyst.

114. The composition of any one of claims 76 to 113, wherein the curing catalyst comprises 2,4,6-tris[(dimethylamino)methyl]phenol.

115. The composition of any one of claims 76 to 114, further comprising a hardener composition, the hardener composition comprising a hardener and optionally a diluent, the hardener being reactive in curing the composition to form a coating having a resistance to abrasive treatment with organic solvents of at least 50 passes, or between 50 and 80 passes when measured according to ASTM D1640.

116. The composition of any one of claims 76 to 115, wherein the hardener comprises an amine hardener, amide hardener, or a combination thereof.

117. The composition of any one of claims 76 to 116, wherein the hardener comprises phenalkamine, amine-modified phenalkamine, phenalkamides, amine-modified phenalkamides, polyamidoamine, organo-modified polyamidoamine, or a combination thereof.

118. The composition of any one of claims 76 to 117, wherein the hardener is present at an amount to provide an epoxy group/NH ratio of about 1.2 to about 1.4.

119. The composition of any one of claims 76 to 118, wherein the hardener is present in a range of about 70 wt % to about 100 wt %, or about 70 wt % to about 90 wt % of the hardener composition.

120. The composition of any one of claims 76 to 119, wherein the diluent comprises a non-reactive diluent.

121. The composition of any one of claims 76 to 120, wherein the diluent comprises such as xylene, benzyl alcohol, methyl ethyl ketone, methyl acetate, ethers, aromatic solvents, or a combination thereof.

122. The composition of any one of claims 76 to 121, wherein the diluent is present in a range of about 1 to 30 wt %, or about 5 to 25 wt %, about 10 to 25 wt %; or about 1 to 5 wt % of the hardener composition.

123. A coating comprising a reaction product of a composition for a coating of any one of claims 76 to 114 and a hardener.

124. A coating comprising a reaction product of a composition for a coating of any one of claims 76 to 114 and the hardener composition according to any one of claims 115 to 122.

125. The coating of claim 123 or 124, further comprising a primer coating.

126. The coating of any one of claims 123 to 125, further comprising a topcoat coating.

127. The coating of any one of claims 123 to 126, having a bending strength of at least 10 mm when measured by a cylindrical bend test.

128. The coating of any one of claims 123 to 127, having a bending strength of at least 8 mm, or at least 6 mm when measured by a cylindrical bend test.

129. The coating of any one of claims 123 to 128, having a substrate adhesion of at least 3 MPa when measured according to ASTM D4541, an overcoat adhesion of at least 3 MPa when measured according to ASTM D4541, or a recoat adhesion window of at least 4 hours when measured according to ASTM D3359, or a combination thereof.

130. The coating of any one of claims 123 to 129, having a substrate adhesion of about 3 MPa to about 15 MPa, or about 3 MPa to about 10 MPa when measured according to ASTM D4541, an overcoat adhesion of about 3 MPa to about 15 MPa, or about 3 MPa to about 10 MPa when measured according to ASTM D4541, or a recoat adhesion window between about 4 hours to about 72 hours when measured according to ASTM D3359; or a combination thereof.

131. The coating of any one of claims 123 to 130, having a reduced noise radiation of about 2 dB to about 10 dB per about 100 μm of coating thickness at frequencies of about 10 Hz to about 10 kHz when measured on a 3 mm thickness cold rolled steel metal plate relative to a 3 mm thickness cold rolled steel metal plate coated with a coating free of the ceramic performance additive.

132. The coating of any one of claims 123 to 131, having reduced noise radiation of about 3 dB to about 9 dB, about 5 dB to about 9 dB, or about 5 dB to about 7 dB per about 100 μm of coating thickness.

133. Use of a composition for a coating of any one of claims 123 to 132 for forming a coating on a substrate.

134. The use of claim 133, wherein the substrate is a surface of a marine vessel, such as a boat or ship; or marine equipment, such as a sensor or propeller.

135. The use of any one of claims 133 to 134, wherein the substrate is a surface of a marine vessel hull.

136. Use of a coating comprising a reaction product of a composition for a coating of any one of claims 76 to 114 and a hardener for reducing underwater radiated noise.

137. Use of a coating comprising a reaction product of a composition for a coating of any one of claims 76 to 114 and the hardener composition according to claims 115 to 122 for reducing underwater radiated noise.

138. A composition for a coating, comprising:
a solvent-borne epoxy resin;
a diluent;
an adhesion promoter comprising a dry adhesion promoter, a wet adhesion promoter, a dry/wet adhesion promoter, or a combination thereof;
a rheology modifier comprising an anti-settling rheology modifier; an anti-sagging rheology modifier; surface-leveling rheology modifier, or a combination thereof; and
a ceramic performance additive comprising hollow ceramic spheres, non-hollow ceramic particles, or a combination thereof.

139. The composition of claim 138, wherein the epoxy resin comprises a hybrid epoxy-siloxane resin.

140. The composition of any one of claims 138 to 139, wherein the epoxy resin is present at an amount between about 30 to about 55 wt %, or between about 40 to about 50 wt %, based on Part A.

141. The composition of any one of claims 138 to 140, further comprising a hydrophobicity-modifying additive, the hydrophobicity-modifying additive comprising an epoxy-functional silane, an epoxy-functional polydialkylsiloxane, or a combination thereof.

142. The composition of any one of claims 138 to 141, wherein the hydrophobicity-modifying additive comprises an epoxy-functional polydialkylsiloxane.

143. The composition of any one of claims 138 to 142, wherein the hydrophobicity-modifying additive comprises an epoxy-functional polydialkylsiloxane.

144. The composition of any one of claims 138 to 143, wherein the epoxy-functional silane comprises glycidoxypropyltrimethoxysilane.

145. The composition of any one of claims 138 to 144, wherein the diluent comprises a non-reactive diluent.

146. The composition of any one of claims 138 to 145, wherein the non-reactive diluent comprises xylene, cyclohexane, toluene, methyl acetate, methyl ethyl ketone, tert-butyl acetate, nonyl phenol, cyclohexanedimethanol, n-butyl alcohol, benzyl alcohol, isopropyl alcohol, polyethylene glycol, propylene glycol, phenol, or a combination thereof.

147. The composition of any one of claims 138 to 146, wherein the non-reactive diluent comprises benzyl alcohol, xylene, methyl ethyl ketone, methyl acetate, ethers, or aromatic solvents, or a combination thereof.

148. The composition of any one of claims 138 to 147, wherein the non-reactive diluent is present in a range of about 1 wt % to about 20 wt %, or about 1 wt % to about 10 wt %, or about 5 wt % to about 20 wt %; or about 5 wt % to about 15 wt %, based on Part A wt %; or in a range of about 1 wt % to about 25 wt %, or about 5 wt % to about 20 wt %, or about 5 wt % to about 15 wt, based on total wt %.

149. The composition of any one of claims 138 to 148, wherein the dry adhesion promoter, the dry/wet adhesion promoter, and/or the wet adhesion promoter are non-reactive, reactive in a epoxy resin polymerization, reactive with a substrate, and/or reactive with metal oxides; or a combination thereof.

150. The composition of any one of claims 138 to 149, wherein the dry adhesion promoter is non-reactive, reactive in a epoxy resin polymerization, reactive with a substrate, and/or reactive with metal oxides.

151. The composition of any one of claims 138 to 150, wherein the dry adhesion promoter comprises an alkoxylated silane.

152. The composition of any one of claims 138 to 151, wherein the dry adhesion promoter comprises an epoxy-functional alkoxylated silane, an amino-functional alkoxylated silane, or a combination thereof.

153. The composition of any one of claims 138 to 152, wherein the dry adhesion promoter comprises 3-(2,3-epoxypropoxy)propyltrimethoxysilane; glycidoxypropyltrimethoxysilane; aminopropyltriethoxysilane; 3-aminopropyltriethoxysilane; an secondary amino bis-silane; or a combination thereof.

154. The composition of any one of claims 138 to 153, wherein the wet adhesion promoter is reactive with a substrate.

155. The composition of any one of claims 138 to 154, wherein the wet adhesion promoter comprises a metal-doped phosphosilicate.

156. The composition of any one of claims 138 to 155, wherein the wet adhesion promoter comprises a strontium phosphosilicate; a zinc phosphosilicate, a zinc calcium strontium aluminum orthophosphate silicate hydrate; or a combination thereof.

157. The composition of any one of claims 138 to 156, wherein the dry/wet adhesion promoter is non-reactive, reactive with a substrate, and/or reactive with metal oxides.

158. The composition of any one of claims 138 to 157, wherein the dry/wet adhesion promoter comprises a modified polyester, a modified polyester oligomer, a polyacrylic, a polyacrylate, a benzotriazole, a mercaptane-comprising polymer or pre-polymer, or a combination thereof.

159. The composition of any one of claims 138 to 158, wherein the modified polyester comprises a modified polyester having a hydroxyl value enough about 30 mg to about 100 mg KOH/g.

160. The composition of any one of claims 138 to 159, wherein the benzotriazole comprises an alkyl-substituted, hydroxylamine-substituted benzotriazole; a hydroxyphenyl-benzotriazole; or a combination thereof.

161. The composition of any one of claims 138 to 160, wherein the dry adhesion promoter, the dry/wet adhesion promoter, and/or the wet adhesion promoter are metal adhesion promoters.

162. The composition of any one of claims 138 to 161, wherein the dry adhesion promoter, the dry/wet adhesion promoter, and/or the wet adhesion promoter are copper or aluminum adhesion promoters.

163. The composition of any one of claims 138 to 162, wherein the adhesion promoter is present in a range of about 0.1 wt % to about 10 wt %, about 0.1 wt % to about 8 wt %, about 0.1 wt % to about 5 wt %, or about 0.1 wt % to about 1 wt %, or about 1 wt % to about 5 wt %, or about 1 wt % to about 8 wt %; based on Part A wt % or total wt %.

164. The composition of any one of claims 138 to 163, wherein the anti-settling rheology modifier comprises a silica, a clay, or a combination thereof.

165. The composition of any one of claims 138 to 164, wherein the anti-settling rheology modifier comprises fumed silica, fumed silica surface modified with silane, fumed silica surface modified with dimethyldichlorosilane; or a combination thereof.

166. The composition of any one of claims 138 to 165, wherein the anti-settling rheology modifier is present in a range of about 0.1 wt % to about 5 wt %, or about 0.3 wt % to about 3 wt %, or about 0.3 w % to about 2 wt %; based on Part A wt % or total wt %.

167. The composition of any one of claims 138 to 166, wherein the an anti-sagging rheology modifier comprises a wax, a derivatized wax, or a combination thereof.

168. The composition of any one of claims 138 to 167, wherein the anti-sagging rheology modifier comprises a castor oil wax, an organically-modified castor oil-derivative wax, a polyamide wax, a micronized polyamide wax, a micronized organo-modified polyamide wax, a micronized organo-modified polyamide wax derivative, or a combination thereof.

169. The composition of any one of claims 138 to 168, wherein the anti-sagging rheology modifier comprises a castor oil wax, an organically-modified castor oil-derivative wax, or a combination thereof.

170. The composition of any one of claims 138 to 169, wherein the anti-sagging rheology modifier is present in a range of about 0.1 wt % to about 1.5 wt %, or about 0.1 wt % to about 1 wt %, or about 0.1 w % to about 0.5 wt %, based on Part A wt % or total wt %.

171. The composition of any one of claims 138 to 170, wherein the surface-leveling rheology modifier comprises a polyether siloxane copolymer.

172. The composition of any one of claims 138 to 171, wherein the surface-leveling rheology modifier is present in a range of about 0.1 wt % to about 1.5 wt %, or about 0.1 wt % to about 1 wt %, or about 0.1 w % to about 0.5 wt %; based on Part A wt % or total wt %.

173. The composition of any one of claims 138 to 172, wherein the hollow ceramics comprises hollow ceramic spheres having a particle size of about 10 μm to about 40 μm; about 20 μm to about 40 μm, or about 25 μm to about 35 μm; or about 10 μm to about 15 μm, or about 12 μm.

174. The composition of any one of claims 138 to 173, wherein the hollow ceramic spheres are present in a range of about 5 wt % to about 15 wt.

175. The composition of any one of claims 138 to 174, wherein the non-hollow ceramics particles having a particle size of about 0.1 μm to about 5 μm; about 0.5 μm to about 5 μm, or about 1 μm to about 5 μm; or about 2 μm to about 5 μm.

176. The composition of any one of claims 138 to 175, wherein the non-hollow ceramic particles are present in a range of about 5 wt % to about 40 wt %, or about 10 wt % to about 35 wt %, or about 20 wt % to about 35 wt %, or about 10 wt % to about 20 wt %; based on Part A wt % or total wt %.

177. The composition of any one of claims 138 to 176, wherein the non-hollow ceramic particles comprise titanium oxide, fumed silica, brown aluminium (Ill) oxide, fused aluminium (III) oxide, titanium alloys, or a combination thereof.

178. The composition of any one of claims 138 to 177, wherein the non-hollow ceramic particles comprise titanium alloys titanium carbonitride, titanium carbide, or a combination thereof.

179. The composition of any one of claims 138 to 178, further comprising a dispersant.

180. The composition of any one of claims 138 to 179, wherein the dispersant comprises a polymeric dispersant.

181. The composition of any one of claims 138 to 180, wherein the dispersant comprises a polymeric non-ionic dispersant, polymeric ionic dispersant, a polymeric pigment dispersant, or a combination thereof.

182. The composition of any one of claims 138 to 181, wherein the dispersant comprises ADDITOL VXW 6208® (polymeric non-ionic dispersant), K-SPERSE A504 (polymeric non-ionic graphene dispersant), MULTIWET EF-LQ-AP® (polymeric non-ionic dispersant), HYPERMER KD6-LQ-MV® (polymeric non-ionic dispersant blend), BRIJ-03-Lam Q-AP® (nonionic alkyl polyglycol ethers dispersant), SP BRIJ 02 MBAL LQ-AP® (nonionic alkyl polyglycol ethers dispersant), ANTI-TERRA-204® (polymeric ionic dispersant, polycarboxylic acid salt of polyamine amides), TEGO Dispers 670® (polymeric non-ionic dispersant), TEGO Disperse 1010® (polymeric non-ionic dispersant), TEGO® Glide 410® (polyether siloxane copolymer); or a combination thereof.

183. The composition of any one of claims 138 to 182, wherein the dispersant is present in a range of about 0.1 wt % to about 1.5 wt %, or about 0.1 wt % to about 1 wt %, or about 0.1 wt % to about 0.5 wt %; based on Part A wt % or total wt %.

184. The composition of any one of claims 138 to 183, further comprising a wear inhibitor.

185. The composition of any one of claims 138 to 184, wherein the wear inhibitor comprises graphite oxide, graphene, multilayered graphene flakes, titanium dioxide, microcrystalline magnesium silicate, fumed silica, micronized barium sulphate, or a combination thereof.

186. The composition of any one of claims 138 to 185, wherein the wear inhibitor is present in a range of about 0.01 wt % to about 1 wt %, or about 0.05 wt % to about 0.5 wt %; or about 0.05 wt % to about 0.8 wt %, based on total wt %.

187. The composition of any one of claims 138 to 186, further comprising a defoamer.

188. The composition of any one of claims 138 to 187, wherein the defoamer comprises a polymeric defoamer.

189. The composition of any one of claims 138 to 188, wherein the defoamer comprises a silicone-based oligomeric defoamer.

190. The composition of any one of claims 138 to 189, wherein the defoamer comprises BYK-066 N, BYK-1790, ADDITOL VXW 6210 N, TEGO Airex 900, or a combination thereof.

191. The composition of anyone of claims 138 to 190, wherein the defoamer is optionally in a range of about 0.1 wt % to about 5 wt %, or about 0.1 wt % to about 1 wt %, or about 1 wt % to about 5 wt %, based on Part A wt % or total wt %.

192. The composition of any one of claims 138 to 191, further comprising a weather-resistance additive.

193. The composition of any one of claims 138 to 192, wherein the weather-resistance additive comprises a hydroxyphenyl-benzotriazole, a hydroxyphenyl-triazine, or a combination thereof.

194. The composition of any one of claims 138 to 193, wherein the weather-resistance additive comprises 95% Benzenepropanoic acid, 3-(2H-benzotriazol-2-yl)-5-(1,1-dimethylethyl)-4-hydroxy-, C7-9-branched and linear alkyl esters, 5% 1-methoxy-2-propyl acetate (Tinuvin 99-2®); 2-(2H-benzotriazol-2-yl)-4,6-bis(1-methyl-1-phenylethyl)phenol (Tinuvin 900®); 2-[4-[2-Hydroxy-3-tridecyloxypropyl]oxy]-2-hydroxyphenyl]-4,6-bis(2,4-dimethylphenyl)-1,3,5-triazine and 2-[4-[2-hydroxy-3-didecyloxypropyl]oxy]-2-hydroxyphenyl]-4,6-bis(2,4-dimethylphenyl)-1,3,5-triazine (Tinuvin 400®); or a combination thereof.

195. The composition of any one of claims 138 to 194, wherein the weather-resistance additive is a wet/dry adhesion promotor.

196. The composition of any one of claims 138 to 195, wherein the weather-resistance additive is present in a range of about 0.5 wt % to about 5 wt %, or about 1 wt % to about 5 wt %.

197. The composition of any one of claims 138 to 196, further comprising a curing catalyst.

198. The composition of any one of claims 138 to 197, wherein the curing catalyst comprises 2,4,6-tris[(dimethylamino)methyl]phenol.

199. The composition of any one of claims 138 to 198, further comprising a hardener composition, the hardener composition comprising a hardener and optionally a diluent, the hardener being reactive in curing the composition to form a coating having a resistance to abrasive treatment with organic solvents of at least 50 passes, or between 50 to 80 passes when measured according to ASTM D1640.

200. The composition of any one of claims 138 to 199, wherein the hardener comprises an silamine, amine hardener, amide hardener, or a combination thereof.

201. The composition of any one of claims 138 to 200, wherein the hardener comprises a silamine hardener.

202. The composition of any one of claims 138 to 201, wherein the silamine hardener comprises aminopropyltriethoxysilane, triamino-functional propyltrimethoxysilane; or a combination thereof.

203. The composition of any one of claims 138 to 202, wherein the hardener is present at an amount to provide an epoxy group/NH ratio of about 0.9 to about 1.1, or about 1.

204. The composition of any one of claims 138 to 203, wherein the hardener is present in a range of about 70 wt % to about 100 wt %, or about 70 wt % to about 90 wt % of the hardener composition.

205. The composition of any one of claims 138 to 204, wherein the diluent comprises a non-reactive diluent.

206. The composition of any one of claims 138 to 205, wherein the diluent comprises xylene, benzyl alcohol, methyl ethyl ketone, methyl acetate, ethers, aromatic solvents, or a combination thereof.

207. The composition of any one of claims 138 to 205, wherein the diluent is present in a range of about 1 to about 20 wt %, or about 1 to about 30 wt % of the hardener composition.

208. The composition of any one of claims 138 to 206, wherein the hardener composition further comprises a curing catalyst.

209. The composition of any one of claims 138 to 207, wherein the curing catalyst comprises 2,4,6-tris[(dimethylamino)methyl]phenol.

210. A coating comprising a reaction product of a composition for a coating of any one of claims 138 to 198 and a hardener.

211. A coating comprising a reaction product of a composition for a coating of any one of claims 138 to 198 and the hardener composition according to claims 199 to 209.

212. The coating of any one of claims 210 to 211, further comprising a primer coating, the primer coating comprising a reaction product of a composition for a primer coating and a hardener.

213. The coating of any one of claims 210 to 212, wherein the composition for a primer coating comprises an epoxy resin or a urethane resin.

214. The coating of any one of claims 210 to 213, wherein the composition for a primer coating comprises an epoxy resin.

215. The coating of any one of claims 210 to 214, wherein the composition for a primer coating comprises at least 10 wt % epoxy resin.

216. The coating of any one of claims 210 to 215, wherein the composition for a primer coating comprises an adhesion promoter comprising a dry adhesion promoter, a wet adhesion promoter, a dry/wet adhesion promoter, or a combination thereof.

217. The coating of any one of claims 210 to 216, wherein the composition for a primer coating comprises fillers for producing micro-roughness and inducing the gas-liquid barrier properties in the dried primer.

218. The coating of any one of claims 210 to 217, wherein the fillers comprise magnesium silicate (talc), wollastonite, barium sulfate, fumed silica, or a combination thereof, in amount not less than 30% wt based on total formula weight.

219. The coating of any one of claims 210 to 218, having a bending strength of at least 10 mm when measured by a cylindrical bend test.

220. The coating of any one of claims 210 to 219, having a bending strength of at least 8 mm, or at least 6 mm when measured by a cylindrical bend test.

221. The coating of any one of claims 210 to 220, having a substrate adhesion of at least 3 MPa when measured according to ASTM D4541, an overcoat adhesion of at least 3 MPa when measured according to ASTM D4541, or a combination thereof.

222. The coating of any one of claims 210 to 221, having a substrate adhesion of about 3 MPa to about 15 MPa, or about 3 MPa to about 10 MPa, or about 3 MPa to about 7 MPa, or about 5 MPa to about 7 MPa when measured according to ASTM D4541, an overcoat adhesion of about 3 MPa to about 15 MPa, or about 3 MPa to about 10 MPa, or about 3 MPa to about 7 MPa, or about 5 MPa to about 7 MPa when measured according to ASTM D4541; or a combination thereof.

223. The coating of any one of claims 210 to 222, having a dry adhesion to metal substrate of at least 3 MPa, wet adhesion to metal substrate of at least 4 MPa, or a combination thereof.

224. The coating of any one of claims 210 to 223, having a dry adhesion of about 3 to about 15 MPa, or about 3 to about 10 MPa, to about 3 to about 5 MPa, a wet adhesion of about 4 to about 15 MPa, or about 4 to about 10 MPa, or about 5 to about 7 MPa, or a combination thereof.

225. The coating of any one of claims 210 to 224, having a hardness of at least 5H when measured according to ASTM D3363.

226. The coating of any one of claims 210 to 225, having a hardness of about 6H to about 8H, or about 8H.

227. Use of a composition for a coating of any one of claims 210 to 226 for forming a coating on a substrate.

228. The use of claim 227, wherein the substrate is a surface of a marine vessel, such as a boat or ship; or marine equipment, such as a sensor or propeller.

229. The use of any one of claims 227 to 228, wherein the substrate is a surface of a propeller.

230. Use of a coating comprising a reaction product of a composition for a coating of any one of items 138 to 198 and a hardener for reducing cavitation.

231. Use of a coating comprising a reaction product of a composition for a coating of any one of items 138 to 198 and the hardener composition according to claims 199 to 209 for reducing cavitation.
